(19) United States
(12) Patent Application Publication
(10) Pub. No.: US 2025/0388482 A1
(43) Pub. Date: Dec. 25, 2025

(54) PROCESSES FOR PRODUCING ALKALI COMPOUNDS USING ACID GAS

(71) Applicant: INNOVATOR ENERGY LLC, Houston, TX (US)

(72) Inventor: ETHAN NOVEK, Houston, TX (US)

(21) Appl. No.: 19/249,326

(22) Filed: Jun. 25, 2025

Related U.S. Application Data
(60) Provisional application No. 63/663,995, filed on Jun. 25, 2024.
(60) Provisional application No. 63/667,259, filed on Jul. 3, 2024.
(60) Provisional application No. 63/668,123, filed on Jul. 5, 2024.
(60) Provisional application No. 63/670,323, filed on Jul. 12, 2024.
(60) Provisional application No. 63/687,345, filed on Aug. 27, 2024.
(60) Provisional application No. 63/744,532, filed on Jan. 13, 2025.
(60) Provisional application No. 63/800,539, filed on May 6, 2025.

(51) Int. Cl. C01F 11/46; B01D 69/02; C01F 11/06

(52) U.S. Cl. CPC C01F 11/46; B01D 69/02; C01F 11/06

(57) ABSTRACT

The present application pertains in one embodiment to a process which reacts a component comprising an alkaline-earth cation− weak acid anion with a component comprising an acid to form a component comprising an alkaline-earth cation− acid anion and a component comprising a weak acid derivative. At least a portion of the formed alkaline-earth cation− acid anion is reacted with a component comprising an alkali sulfate to form a component comprising an alkali cation− acid anion and a component comprising an alkaline-earth sulfate. At least a portion of a component comprising carbon dioxide is dissolved in a solution comprising at least a portion of the component comprising an alkali cation− acid anion. At least a portion of the acid is separated from at least a portion of the alkali in the presence of carbon dioxide and the presence of a membrane to form an alkali cation− carbon dioxide species anion.

### CROSS-REFERENCE TO RELATED APPLICATIONS

The present application claims priority to the following provisional applications, each of which is incorporated herein by reference:
Application Number: 63/663,995; Filing Date: Jun. 25, 1924;
Application Number: 63/667,259; Filing Date: Jul. 3, 1924;
Application Number: 63/668,123; Filing Date: Jul. 5, 1924;
Application Number: 63/670,323; Filing Date: Jul. 12, 1924;
Application Number: 63/687,345; Filing Date: Aug. 27, 1924;
Application Number: 63/744,532; Filing Date: Jan. 13, 1925; and
Application No. 63/800,539; Filing Date: May 6, 1925

This application is also related to the following patents and applications that are incorporated herein by reference: PCT/US25/12754 filed Jan. 23, 2025; US2025/0019336; U.S. Pat. Nos. 12,017,985; 11,542,219; 11,512,036; 11,897,840; 11,236,033; 11,034,619; 11,897,840; WO2023/225089; U.S. Pat. No. 12,017,985; US2025/0019253; WO2023/220380; U.S. Pat. Nos. 12,030,846; 12,030,847; and 11,174,169.

### BACKGROUND AND SUMMARY

The production of alkali hydroxides, such as sodium hydroxide and potassium hydroxide, are expensive, energy intensive, and CO₂ emitting. Additionally, the production of byproduct or waste sodium sulfate from various industries, including, but not limited to, lithium production, lithium refining, lithium-ion battery recycling, battery recycling, lead acid battery recycling, textile production, neutralization reactions, mining, copper production, copper refining, metal refining, flue gas desulfurization, rare earth processing, cathode material product, manganese refining, nickel refining, cobalt refining, pigment production, silica production, sodium chloride purification, trona processing, or ore processing, to name a few, is a significant and is expected to grow significantly in the coming years.

Some embodiments may pertain to systems and methods for producing alkali hydroxides, or alkali carbonates, or alkali bicarbonates, or alkali salts, or alkali sulfites, or alkali bisulfites, or a derivative thereof, or any combination thereof from, for example, alkali sulfates, alkali chlorides, or water, or carbon dioxide, or sulfur dioxide, or calcium carbonate, or any combination thereof.

### BRIEF DESCRIPTION OF THE DRAWINGS

FIG. 1A: Carbon dioxide speciation vs. pH.

FIG. 1B: Acetic acid speciation vs. pH.

FIG. 2A: Embodiment producing an alkali− carbon dioxide species salt from an alkali sulfate.

FIG. 2B: Embodiment producing an alkali− carbon dioxide species salt from an alkali sulfate.

FIG. 3A: Embodiment producing an alkali− carbon dioxide species salt from an alkali sulfate.

FIG. 3B: Embodiment producing an alkali− carbon dioxide species salt from an alkali sulfate.

FIG. 3C: Embodiment producing an alkali− carbon dioxide species salt from an alkali sulfate.

FIG. 3D: Embodiment producing an alkali− carbon dioxide species salt from an alkali sulfate.

FIG. 4A: Embodiment producing an alkali− carbon dioxide species salt from an alkali sulfate.

FIG. 5A: Embodiment producing an alkali− carbon dioxide species salt from an alkali sulfate.

FIG. 6A: Embodiment producing an alkali− carbon dioxide species salt from an alkali sulfate.

FIG. 7A: Embodiment producing an alkali− carbon dioxide species salt from an alkali sulfate.

FIG. 8A: Embodiment producing an alkali− carbon dioxide species salt from an alkali sulfate.

FIG. 9A: Embodiment producing an alkali− carbon dioxide species salt from an alkali sulfate.

FIG. 9B: Embodiment producing an alkali− carbon dioxide species salt from an alkali sulfate.

FIG. 9C: Embodiment producing an alkali− carbon dioxide species salt from an alkali sulfate.

FIG. 9D: Embodiment producing an alkali− carbon dioxide species salt from an alkali sulfate.

FIG. 10A: Embodiment comprising a concentration or osmotic pressure recovery system.

FIG. 10B: Embodiment comprising a concentration or osmotic pressure recovery system.

FIG. 11C: Embodiment producing an alkali− carbon dioxide species salt from an alkali sulfate.

FIG. 11E: Embodiment producing an alkali− carbon dioxide species salt from an alkali sulfate.

FIG. 11G: Embodiment producing an alkali− carbon dioxide species salt from an alkali sulfate.

FIG. 11I: Embodiment producing an alkali derivative from an alkali sulfate.

FIG. 12: Sulfur dioxide speciation vs. pH.

FIG. 13: Acetic acid speciation vs. pH.

FIG. 14: Embodiment producing an alkali hydroxide from an alkali sulfate.

FIG. 15A: Embodiment reacting alkali cation− acid anion and separating a portion of acid species from a portion of alkali− sulfur dioxide species, or alkali− carbon dioxide species, or any combination thereof.

FIG. 15B: Embodiment reacting alkali cation− acid anion and separating a portion of acid species from a portion of alkali− sulfur dioxide species, or alkali− carbon dioxide species, or any combination thereof.

FIG. 15C: Embodiment reacting alkali cation− acid anion and separating a portion of acid species from a portion of alkali− sulfur dioxide species, or alkali− carbon dioxide species, or any combination thereof.

FIG. 16: Embodiment reacting alkali cation− acid anion and separating a portion of acid species from a portion of alkali− sulfur dioxide species, or alkali− carbon dioxide species, or any combination thereof.

FIG. 17: Embodiment reacting alkali cation− acid anion and separating a portion of acid species from a portion of alkali− sulfur dioxide species, or alkali− carbon dioxide species, or any combination thereof.

FIG. 18A: Embodiment reacting alkali cation− acid anion and separating a portion of acid species from a portion of alkali− sulfur dioxide species, or alkali− carbon dioxide species, or any combination thereof.

FIG. 18B: Embodiment reacting alkali cation− acid anion and separating a portion of acid species from a portion of alkali− sulfur dioxide species, or alkali− carbon dioxide species, or any combination thereof.

FIG. 18C: Embodiment reacting alkali cation− acid anion and separating a portion of acid species from a portion of alkali− sulfur dioxide species, or alkali− carbon dioxide species, or any combination thereof.

FIG. 19: Embodiment of a counter-current acid separator.

FIG. 20: Embodiment of a counter-current acid separator.

FIG. 21: Embodiment reacting alkali cation− acid anion and separating a portion of acid species from a portion of alkali− sulfur dioxide species, or alkali− carbon dioxide species, or any combination thereof.

FIG. 22: Embodiment reacting alkali cation− acid anion and separating a portion of acid species from a portion of alkali− sulfur dioxide species, or alkali− carbon dioxide species, or any combination thereof.

FIG. 23: Embodiment reacting alkali cation− acid anion and separating a portion of acid species from a portion of alkali− sulfur dioxide species, or alkali− carbon dioxide species, or any combination thereof.

FIG. 24: Embodiment reacting alkali cation− acid anion and separating a portion of acid species from a portion of alkali− sulfur dioxide species, or alkali− carbon dioxide species, or any combination thereof.

FIG. 25: Integrated embodiment producing alkali hydroxide.

FIG. 26: Integrated embodiment producing alkali hydroxide.

FIG. 27: Embodiment of a counter-current acid separator.

FIG. 28: Embodiment of a counter-current acid separator.

FIG. 29: Embodiment of a counter-current acid separator.

FIG. 30: Embodiment of a counter-current acid separator.

FIG. 31: Embodiment of a counter-current acid separator.

FIG. 32: Embodiment of a counter-current acid separator.

FIG. 33: Embodiment of a counter-current acid separator.

FIG. 34: Embodiment of a counter-current acid separator.

FIG. 35: Embodiment of a counter-current acid separator.

FIG. 36: Embodiment of a counter-current acid separator.

FIG. 37: Embodiment of a counter-current acid separator.

FIG. 38: Embodiment of a counter-current acid separator.

FIG. 39: Embodiment reacting alkali cation− acid anion and separating a portion of acid species from a portion of alkali− sulfur dioxide species, or alkali− carbon dioxide species, or any combination thereof.

FIG. 40: Embodiment reacting alkali cation− acid anion and separating a portion of acid species from a portion of alkali− sulfur dioxide species, or alkali− carbon dioxide species, or any combination thereof.

FIG. 41: Embodiment reacting alkali cation− acid anion and separating a portion of acid species from a portion of alkali− sulfur dioxide species, or alkali− carbon dioxide species, or any combination thereof.

FIG. 42: Integrated embodiment producing alkali hydroxide.

FIG. 43: Integrated embodiment producing alkali hydroxide.

FIG. 44: Integrated embodiment producing alkali hydroxide.

FIG. 45: Integrated embodiment producing alkali hydroxide.

FIG. 46: Embodiment recovering acid using carrier gas extraction.

FIG. 47: Integrated embodiment producing alkali− carbon dioxide species.

FIG. 48: Integrated embodiment producing alkali hydroxide.

### DETAILED DESCRIPTION

As used herein, the terms “alkali cation− carbon dioxide species anion” or “alkali− carbon dioxide species” are interchangeably employed to describe substances with cations comprising an alkali metal associated with anions comprising carbon and one, two, or three, or more oxygen atoms such as, for example, alkali carbonates, or alkali bicarbonates, or alkali sesquicarbonates, such as sodium carbonate, or sodium bicarbonate, or sodium sesquicarbonate, or lithium carbonate, or lithium bicarbonate, or lithium sesquicarbonate, potassium carbonate, or potassium bicarbonate, or potassium sesquicarbonate. The terms “alkali cation− carbon dioxide species anion” or “alkali− carbon dioxide species” also include, but are not limited to, the potential non-ionic and/or ionic states of dissolved carbon dioxide in solutions with a pH of below about 8 such as, for example, a pH below about 7, or alternatively below about 6 or lower.

As used herein, the terms “carbon dioxide species anion” or “carbon dioxide species” are interchangeably employed to describe substances comprising carbon and one, two, or three, or more oxygen atoms such as, for example, carbonates, or bicarbonates, or sesquicarbonates. The terms “carbon dioxide species anion” or “carbon dioxide species” also include, but are not limited to, the potential non-ionic and/or ionic states of dissolved carbon dioxide in solutions with a pH of below about 8 such as, for example, a pH below about 7, or alternatively below about 6 or lower.

As used herein, the term “alkali cation− acid anion” is employed to describe substances with cations comprising an alkali metal or alkali metal cation associated with acids, or anions of acid, or both with one or more or any combination of the following characteristics: (1) monovalent charge or monovalent species; (2) molecular weight less than about 300 g/mol; (3) forms an aqueous soluble ionic compound in a substantially aqueous solution with a calcium salt or compound, wherein the formed calcium cation− acid anion salt has a solubility greater than about 10 g/L at 20 deg C.; (4) is a carboxylic acid anion; (5) the acid or acid associated with the anion has an acid strength or pKa weaker than the first pKa of sulfurous acid (pKa of about 1.81 to 1.89); (6) the acid or acid associated with the anion has an acid strength or pKa stronger than the hydrous first pKa of carbonic acid (pKa of about 6.35); (7) a chemical comprising sodium sulfate can react with a solution comprising a salt comprising calcium cation+ acid anion in the alkali cation− acid anion to form a solid comprising calcium sulfate and a solution comprising sodium+ acid anion from the alkali cation− acid anion.

As used herein, the terms “alkali cation− sulfur dioxide species anion” or “alkali− sulfur dioxide species” are interchangeably employed to describe substances with cations comprising an alkali metal associated with anions comprising sulfur and one, two, or three, or more oxygen atoms such as, for example, alkali sulfites, or alkali bisulfites, or alkali metabisulfites, or alkali sesquisulfites, such as sodium sulfite, or sodium bisulfite, or sodium sesquisulfite, or lithium sulfite, or lithium bisulfite, or lithium sesquisulfite, potassium sulfite, or potassium sulfite, or potassium sesquisulfite. The terms “alkali cation− sulfur dioxide species anion” or “alkali− sulfur dioxide species” also include, but are not limited to, the potential non-ionic and/or ionic states of dissolved sulfur dioxide in solutions with a pH of below about 4 such as, for example, a pH below about 3, or alternatively below about 2 or lower.

As used herein, the terms “sulfur dioxide species anion” or “sulfur dioxide species” are interchangeably employed to describe substances comprising sulfur and one, two, or three, or more oxygen atoms such as, for example, sulfites, or bisulfites, or sesquisulfites. The terms “sulfur dioxide species anion” or “sulfur dioxide species” also include, but are not limited to, the potential non-ionic and/or ionic states of dissolved carbon dioxide in solutions with a pH of below about 4 such as, for example, a pH below about 3, or alternatively below about 2 or lower.

As used herein, the terms “acetic acid species anion” or “acetate species” or “acetic acid species” are interchangeably employed to describe substances comprising low molecular weight carboxylic acids such as, for example, acetic acid, or acetate, or acetate ion, or formic acid, or formate, or formate ion, or propanoic acid, or propanoate, or propanoate ion. The terms “acetic acid species anion” or “acetate species” or “acetic acid species” also include, but are not limited to, acids, or anions of acid, or both with one or more or any combination of the following characteristics: (1) monovalent charge or monovalent species; (2) molecular weight less than 300 g/mol; (3) forms a soluble ionic compound with calcium, wherein the calcium cation− acid anion salt has a solubility greater than 10 g/L at 20 deg C.; (4) is a carboxylic acid; (5) the acid or acid associated with the anion has an acid strength or pKa weaker than the first pKa of sulfurous acid (pKa of about 1.81 to 1.89); (6) the acid or acid associated with the anion has an acid strength or pKa stronger than the hydrous first pKa of carbonic acid (pKa of about 6.35); (7) a chemical comprising sodium sulfate can react with a solution comprising a salt comprising calcium cation+ acid anion form a solid comprising calcium sulfate and a solution comprising sodium+ acid anion.

Some embodiments may comprise systems and/or methods for producing chemicals comprising alkali chemicals, or alkali derivatives, or any combination thereof. Some embodiments may comprise systems and/or methods for producing chemicals comprising alkali hydroxides, or alkali− carbon dioxide species chemicals, or alkali− sulfur dioxide species chemicals, or alkali− carboxylic acid species chemicals, or alkaline-earth sulfates, or alkaline-earth carboxylates, or alkaline earth oxides, or sulfur derivatives, or any combination thereof. Some embodiments may comprise converting chemicals comprising lower value or lower quality or lower purity or any combination thereof alkali salts into, for example, relatively higher quality or higher value or higher purity or any combination thereof alkali salts. For example, some embodiments may comprise converting a chemical comprising an alkali sulfate, or alkali bicarbonate, or alkali carbonate, or alkali chloride, or alkali carboxylate, or impurities comprising heavy metals, or impurities comprising multivalent ions, or impurities, or any combination thereof into a chemical comprising a relatively higher value or higher purity or higher quality, such as a chemical comprising an alkali hydroxide, or an alkali carbonate, or an alkali bicarbonate, or an alkali carboxylate, or any combination thereof.

Some embodiments may comprise reacting a chemical comprising an alkaline earth cation− weak acid anion, such as calcium carbonate, with an a chemical comprising an acid, such as a carboxylic acid, to form, for example, a chemical comprising an alkaline earth cation− acid anion, and/or form, for example, a chemical comprising a weak acid derivative, such as, for example a chemical comprising carbon dioxide. For example, in some embodiments, a chemical comprising calcium carbonate may be reacted with a chemical comprising acetic acid to form, for example, a solution comprising calcium acetate and a chemical comprising carbon dioxide, which may comprise a gas, or aqueous, or any combination thereof. In some embodiments, the chemical comprising acetic acid may comprise, at least in part, an aqueous solution and/or, in some embodiments, it may be desirable for the chemical comprising acetic acid to comprise, at least in part, an intermediate or a regenerated reactant, such as wherein the chemical comprising acetic acid may be formed or regenerated within a process. In some embodiments, a chemical comprising acetic acid may comprise other chemicals or residual chemicals, such as sulfur dioxide, or carbon dioxide, or pH reducer, or alkalis, or alkali-earths, or any combination thereof.

In some embodiments, if, for example, a reagent may comprise a portion of an alkali cation− weak acid anion, such as sodium carbonate or sodium bicarbonate, it may be desirable to react a portion of said reagent with an acid, such as a carboxylic acid or sulfur dioxide or sulfurous acid. For example, in some embodiments, some input reagents or reagents comprising sodium sulfate may comprise a portion of sodium carbonate or sodium bicarbonate, and/or it may be desirable to react a portion of a carboxylic acid, such as acetic acid, to form, for example, a portion of a chemical comprising sodium acetate. For example, in some embodiments, waste streams from the battery recycling industry may comprise sodium sulfate with residual sodium carbonate, or sodium bicarbonate, or heavy metal impurities, or cobalt, or nickel, or copper, or iron, or aluminum, or manganese, or lead, and/or it may be desirable react a portion of acid.

Some embodiments may comprise reacting a solution or chemical comprising an alkaline earth cation− acid anion, such as a solution comprising calcium acetate, with a chemical comprising an alkali sulfate, such as sodium sulfate, to form, for example, a chemical comprising an alkaline-earth sulfate, such as calcium sulfate, and a chemical comprising an alkali cation− acid anion, such as sodium acetate. In some embodiments, the chemical comprising an alkaline-earth sulfate may possess a relatively low solubility in water, and/or, in some embodiments, a portion of the chemical comprising alkaline-earth sulfate may be separated from a remaining solution comprising alkali cation− acid anion, using, for example, solid-liquid separation. In some embodiments, separated chemical comprising alkaline-earth sulfate may be further purified, for example, using rinsing or other method, and/or may comprise a valuable or useful product. In some embodiments, for a chemical comprising alkaline-earth sulfate may be rinsed with water entering the process, or water recovered or regenerated or separated within the process, or any combination thereof, and/or, in some embodiments, said water post-rinsing may be transferred or utilized in one or more or any combination of steps within the process if desired. In some embodiments, the remaining solution comprising a chemical comprising alkali cation− acid anion may comprise residual alkaline-earth and/or residual sulfate. In some embodiments, the presence of residual alkaline-earth and/or residual sulfate may be minimized by, for example, optimizing the concentration, or conditions, or mixing, or temperature, or the presence of promoting reagents or intermediates, or presence of crystallization promoters, or residence time, or any combination thereof. In some embodiments, it may be desirable to separate or recover a portion of alkaline-earth, or sulfate, or any combination thereof, or prevent scaling or fouling from alkaline-earth sulfate, or any combination thereof. For example, in some embodiments, the addition of a portion of sulfur dioxide, or sulfur dioxide gas, or aqueous sulfur dioxide, or sulfurous acid, or sulfite, or bisulfite, or metabisulfite, or any combination thereof may result in a precipitation react with a portion of the alkali earth species, which may result in the formation and/or precipitation and/or separation of a portion of residual alkaline-earth as, for example, a chemical comprising an alkaline-earth sulfite, such as calcium sulfite or magnesium sulfite, which may be separable or separated using, for example, a solid-liquid separation. For example, in some embodiments, the addition of a portion of a chemical comprising an alkali− carbonate, or alkali-bicarbonate, such as sodium carbonate, or sodium bicarbonate, or ammonium bicarbonate, or ammonium carbonate, or any combination thereof, may result in the formation and/or precipitation and/or separation of a portion of alkaline earth, for example, comprising a chemical comprising an alkaline-earth carbonate. For example, in some embodiments, the addition of or regeneration of a portion of a chemical comprising an antiscalant, or scale inhibitor, or any combination thereof may, for example, prevent the desolubilization of an alkaline-earth sulfate and/or may enable the operation of one or more or any combination of process steps, such as reactions or separations, while reducing the potential for alkaline-earth sulfate scaling or fouling.

In some embodiments, a solution comprising an alkali cation− acid anion may comprise residual impurities, such as residual dissolved impurities. In some embodiments, it may be desirable to separate or remove at least a portion of said residual impurities or residual dissolved impurities. For example, in some embodiments, a portion of residual dissolved impurities may comprise divalent, or multivalent, or larger hydration radius, or any combination thereof cations, or anions, or any combination thereof. For example, in some embodiments, a portion of residual dissolved impurities may comprise ions or chemicals with a larger molecular weight, or a larger hydration radius, or any combination thereof than the ions or species comprising the alkali cation− acid anion. For example, in some embodiments, a chemical comprising an alkali cation− acid anion may comprise a monovalent cation, or a monovalent anion, or any combination thereof. For example, in some embodiments, a chemical comprising an alkali cation− acid anion may comprise a cation comprising an alkali and/or an anion comprising a monovalent species, or an anion comprising a noncharged species due to a sufficiently low pH, or an anion comprising a monovalent species due to a sufficiently low pH, or any combination thereof. For example, in some embodiments, at a portion of one or more or any combination of impurities may be separated from a chemical comprising an alkali cation− acid anion using a selective membrane, or a size based membrane, or any combination thereof, such as a nanofiltration membrane, or reverse osmosis membrane, or a semi-permeable membrane, or forward osmosis, or osmotically assisted reverse osmosis, or osmotically assisted nanofiltration, or any combination thereof. For example, in some embodiments, at a portion of one or more or any combination of impurities may be separated from a chemical comprising an alkali cation− acid anion using a charge selective separation, such as electrodialysis, or monovalent selective electrodialysis, or electrodeionization, or EDI, or continuous electrodeionization (CEDI), or any combination thereof. For example, in some embodiments, at a portion of one or more or any combination of impurities may be separated from a chemical comprising an alkali cation− acid anion using an ion exchange, or a resin, or chemical reaction, or a solubility based separation, or a physical property based separation, or an oxidation based separation, or a charge based separation, or an electrochemical based separation, or a phase change separation, or a separation described herein, or a separation in the art, or any combination thereof.

In some embodiments, a chemical comprising an alkali cation− acid anion may comprise a valuable product.

In some embodiments, a chemical comprising an alkali cation− acid anion may be reacted to form a valuable alkali salt or a valuable chemical. For example, in some embodiments, it may be desirable to react a chemical comprising an alkali cation− acid anion in a manner or process to form a chemical with a value or desirability greater than one or more inputs or feeds into the process. For example, in some embodiments, a valuable chemical may comprise an alkali hydroxide, or an alkali carbonate, or an alkali bicarbonate, or an alkali bisulfite, or an alkali sulfite, or an alkali metabisulfite, or an alkali carboxylate, or an alkali, or a free alkali, or an alkali metal, or an alkali oxide, or an alkaline-earth oxide, or an alkaline earth hydroxide, or sulfur dioxide, or a sulfur derivative, or ammonia, or an ammonia derivative. In some embodiments, it may be desirable to form a valuable chemical in a manner which results in the at least partial regeneration or recovery of one or more or any combination of intermediates or other reagents. For example, in some embodiments, it may be desirable to form a valuable chemical in a manner which results in the at least partial regeneration or recovery of, for example, an acid or acid species, or a carboxylic acid, or sulfur dioxide or sulfur dioxide species, or water, or carbon dioxide, or any combination thereof.

In some embodiments, a chemical comprising an alkali cation− acid anion may be reacted to form an intermediate which may be convertible or capable of being converted into a valuable chemical or chemical product. For example, in some embodiments, a chemical comprising an alkali cation− acid anion may be reacted in a manner to form a second chemical, wherein the second chemical may be reacted or otherwise converted into a valuable chemical. For example, in some embodiments, a chemical comprising an alkali cation− acid anion may be reacted to form a chemical intermediate or second chemical which may be capable of being reacted with a chemical comprising an alkaline-earth hydroxide, such as calcium hydroxide, to form an alkali hydroxide. For example, in some embodiments, a chemical comprising sodium acetate may be reacted with a chemical comprising sulfur dioxide in a manner to form a chemical comprising sodium− sulfur dioxide species, and/or the chemical comprising sodium− sulfur dioxide species may be reacted with a chemical comprising calcium hydroxide to form a chemical comprising sodium hydroxide, which may comprise a valuable chemical, and/or a chemical comprising calcium sulfite, which may be capable of being converted into a chemical comprising calcium oxide, or calcium hydroxide, or sulfur dioxide, or any combination thereof which may enable the regeneration of a portion of reagents or intermediates or intermediate reagents. For example, in some embodiments, a chemical comprising sodium acetate may be reacted with a chemical comprising carbon dioxide in a manner to form a chemical comprising sodium− carbon dioxide species, and/or the chemical comprising sodium− carbon dioxide species may be reacted with a chemical comprising calcium hydroxide to form a chemical comprising sodium hydroxide, which may comprise a valuable chemical, and/or a chemical comprising calcium carbonate, which may be capable of being converted into a chemical comprising calcium oxide, or calcium hydroxide, or sulfur dioxide, or any combination thereof and/or may be recycled within the process as a calcium carbonate input, or any combination thereof. For example, in some embodiments, a chemical comprising sodium acetate may be reacted with a chemical comprising carbon dioxide and sulfur dioxide in a manner to form a chemical comprising sodium− carbon dioxide species, or sodium− sulfur dioxide species, or any combination thereof and/or the chemical(s) comprising chemical comprising sodium− carbon dioxide species, or sodium− sulfur dioxide species, or any combination thereof may be reacted with a chemical comprising calcium hydroxide to form a chemical comprising sodium hydroxide, which may comprise a valuable chemical, and/or a chemical comprising calcium carbonate, or calcium sulfite, or a derivative thereof, or any combination thereof, which may be capable of being converted into a chemical comprising calcium oxide, or calcium hydroxide, or sulfur dioxide, or any combination thereof, if desired, and/or may be recycled within the process as a calcium carbonate input, if desired, or any combination thereof.

In some embodiments, a reaction of a chemical comprising an alkali cation− acid anion to form an intermediate, or a valuable chemical, or any combination thereof may be conducted in a manner or process which enables high separation efficiency, or high yield, or any combination thereof.
For example, in some embodiments employing an acid comprising a carboxylic acid and a reagent comprising sulfur dioxide or sulfur dioxide species, the carboxylic acid species and sulfur dioxide species may be simultaneously soluble in solution, and/or may require special processes or systems or methods for enabling high yield operation. In some embodiments, for example, at low or ultra-low pH, both sulfur dioxide and carboxylic acid species may be volatile or have vapor pressure. In some embodiments, for example, sulfur dioxide species may be prone to oxidation to sulfate species, which may reduce yield. In some embodiments, for example, higher temperature, or higher exposure to oxygen, or lower pH, or any combination thereof may facilitate the oxidation of sulfur dioxide species to sulfate species. In some embodiments, for example, lower temperature, or reduced exposure to oxygen, or reducing atmosphere, or reducing environment, or higher pH, or any combination thereof may inhibit or prevent the oxidation of sulfur dioxide species to sulfate species. In some embodiments, it may be desirable to separation a portion of carboxylic acid species from a portion of sulfur dioxide species with high separation efficiency, or high yield, or low energy consumption, or low capital cost, or high reliability, or any combination thereof.
For example, in some embodiments employing an acid comprising a carboxylic acid and a reagent comprising carbon dioxide or carbon dioxide species, may require special processes or systems or methods for enabling high yield operation. For example, in some embodiments, high pressure and/or excess chemical recirculation may be employed to enable the reaction of carbon dioxide due to, for example, high vapor pressure, relatively low solubility, and relatively weak pKa of some carbon dioxide species or carbonic acid.

In some embodiments, reaction, and/or separation, and/or any combination thereof may include, but is not limited to, one or more or any combination of the following: semi-permeable membrane, or reverse osmosis, or forward osmosis, or nanofiltration, or microfiltration, or size selective membranes, or species selective membranes, or pH selective membranes, or charge selective membranes, or sulfur selective membranes, or alkali selective membranes, or carbon selective membranes, or alkaline earth selective membranes, or carboxylic acid selective membranes, or tunable membranes, or switchable membranes, or multi-stage membrane based process, or multi-step membrane based process, or multi-step reaction and separation process, or multi-step reaction process, or carrier gas extraction, or vapor pressure extraction, or vacuum distillation, or solvent extraction, or solventing out, or precipitation, or crystallization, or freeze distillation, or freeze desalination, or cryodesalination, or extractive distillation, or reducing environment, or oxygen scavenger, or compression, or high pressure gas, or high pressure carbon dioxide, or low temperature separation, or osmotically assisted reverse osmosis, or osmotically assisted nanofiltration, or hydration radius selective membrane, or pH swing process, or pH adjustment process, or customized pH process, or optimized pH process, or tunable pH, or tunable pH process, or evaporation, or distillation, or multi-stage flash distillation, or multi-effect distillation, or conventional distillation, or distillation column, or evaporator column, or mechanical vapor compression distillation, or mechanical vapor recompression distillation, or mixing, or countercurrent membrane, or countercurrent membrane, or dialysis, or diffusion, or selective diffusion, or electrochemical separation, or electrodialysis, or selective electrodialysis, or monovalent selective electrodialysis, or ion exchange, or a resin, electrodeionization, or EDI, or continuous electrodeionization (CEDI), or chemical reaction, or a solubility based separation, or a physical property based separation, or an oxidation based separation, or cooling crystallization, or heating solubilization, or heating crystallization, or cooling solubilization, or a charge based separation, or an electrochemical based separation, or a phase change separation, or a separation described herein, or a separation in the art, or any combination thereof.

### Example Embodiment Reacting, Separating, and/or Production Using Reagent or Intermediate Comprising Sulfur Dioxide

In some embodiments, a chemical comprising an alkali cation− acid anion may be reacted with a chemical comprising a pH reducer, such as sulfur dioxide, or sulfurous acid, or sulfite, or bisulfite, or any combination thereof, to form, for example, a chemical comprising an alkali cation− sulfur dioxide anion, such as an alkali sulfite, or alkali bisulfite, or alkali metabisulfite, or any combination thereof, and/or an acid, which may comprise an acid derived from the acid anion. In some embodiments, a chemical comprising an alkali cation− acid anion may be reacted with a chemical comprising sulfur dioxide, or sulfurous acid, or sulfite, or bisulfite, or any combination thereof, which may comprise a sulfur dioxide species, to form, for example, a chemical comprising an alkali cation− sulfur dioxide anion, such as an alkali sulfite, or alkali bisulfite, or alkali metabisulfite, or any combination thereof, and/or an acid, which may comprise an acid derived from the acid anion. In some embodiments, the reaction and/or separation and/or production of may be conducted in a process or manner which may enable high yield, or high quality, or lower energy consumption, or minimum footprint, or low capital cost, or high reliability, or minimal maintenance, or modularity, or scalability, or effective economics at small scale, or effective economics at medium scale, or effective economics at large scale, or automatability, or any combination thereof. For example, in some embodiments, sodium may be provided as an example alkali or alkali cation, or acetate may be provided as an example acid anion or acetic acid may be provided as an example acid, or sulfite or bisulfite or sulfur dioxide or a derivative thereof or any combination thereof may comprise a sulfur dioxide species and/or may comprise an example pH reducer, or any combination thereof. For example, in some embodiments, a chemical comprising an alkali cation− acid anion may comprise a chemical comprising sodium acetate, and/or a some embodiments may react a chemical comprising sodium acetate with a chemical comprising sulfur dioxide to form a portion of a chemical comprising sodium− sulfur dioxide species, such as sodium sulfite, or sodium bisulfite, or sodium metabisulfite, or any combination thereof, and/or an acid comprising acetic acid. In some embodiments, separation of a portion of an acid comprising acetic acid from a solution comprising sodium species, or sulfur dioxide species, or acetic acid species, or any combination thereof may require customized systems and methods to achieve high yield and low energy consumption operation. In some embodiments, for example, may facilitate or enable the separation of a portion of acetic acid species from a portion sodium species and/or sulfur dioxide species by using a membrane based process, such as a semi-permeable membrane based process, or a size based separation membrane based process, or an ion selective membrane based process, or a charge selective membrane based process, or a pressure driven membrane based process, or a concentration different membrane based process, or an osmotic pressure driven membrane based process, or a diffusion driven membrane based process, or an electrochemical driven membrane based process, or any combination thereof. For example, in some embodiments, a portion of acetic acid species may be separated from a portion of sodium species, or sulfur dioxide species, or any combination thereof using a size based separation or the difference in hydration radius using a semi-permeable membrane, such as reverse osmosis (RO), or nanofiltration (NF), or sulfur selective membrane, or ion selective membrane, or other semi-permeable membrane process described herein. For example, in some embodiments, a portion of acetic acid species may be separated from a portion of sodium species, or sulfur dioxide species, or any combination thereof using a charge-based separation or the difference in ion charge using a charge-based separation method, such as electrodialysis or selective electrodialysis or monovalent selective electrodialysis, or divalent or multivalent selective electrodialysis. In some embodiments, for example, the ion speciation state, or hydration radius, or charge state, or any combination thereof of, for example, acid species, such as acetic acid species or sulfur dioxide species, may be adjusted or optimized by, for example, adjusting the pH. For example, in some embodiments, the acid anion, such as acetate or acetic acid, and the pH reducer acid, such as sulfur dioxide or sulfur dioxide species, may have different speciation and/or hydration radius and/or charge in a solution with changes pH or at a given pH, which may enable or facilitate a separation. For example, in some embodiments, at a given pH in a solution, acetic acid species may comprise a greater proportion of a smaller hydration radius species relative to the sulfur dioxide species and/or sodium species, which may enable the at least partial separation of a portion of acetic acid species from a portion of sulfur dioxide species and/or sodium species using a semi-permeable membrane. For example, in some embodiments, a membrane may be designed or optimized to preferentially reject sulfur dioxide species and/or preferentially permeate acetic acid species, which may enable the at least partial separation of a portion of acetic acid species from a portion of sulfur dioxide species and/or sodium species using a semi-permeable membrane. In some embodiments, for example, a separation may result in a permeate solution comprising a greater proportion of acetic acid species relative to sodium species, or a greater proportion of acetic acid species relative to sulfur dioxide species, or any combination thereof compared to the feed solution and/or a retentate solution comprising a greater proportion of sulfur dioxide species relative to sodium species, or a greater proportion of sulfur dioxide species relative to acetic acid species, or any combination thereof. In some embodiments, separation to a desired yield may employ more than one stage, or multiple separation stages, and/or may be conducted in a batch, semi-batch, or continuous, or countercurrent, or parallel, or any combination thereof manner. In some embodiments, for example, the pH and/or concentration may be optimized to enable separation, for example, before, or during, or after, or any combination thereof, a separation. In some embodiments, for example, the pH and/or concentration of a solution may be actively adjusted to enable or facilitate separation. For example, in some embodiments, the pH and/or concentration of a solution may be actively managed or adjusted by, for example, adjusting the conditions and/or adjusting the concentration of, or adding, or dosing, or removing, or any combination thereof reagents, or intermediates, or any combination thereof which may include, but are not limited to, one or more or any combination of the following: water, sulfur dioxide species, or sulfur dioxide, or a pH reducer, or carbon dioxide, or boric acid, or a recoverable pH reducer, or sodium acetate, or acetic acid, or calcium carbonate, or sodium carbonate, or calcium hydroxide, or calcium sulfite, or any combination thereof. For example, in some embodiments, during the permeation of a portion of acetic acid may result in a permeate comprising a lower pH than the feed solution and a retentate comprising a higher pH than the feed solution. In some embodiments, for example, a pH reducer, such as sulfur dioxide, or sulfurous acid, or sulfur dioxide species, or carbon dioxide, or boric acid, or an acid species, or a recoverable acid species, or any combination thereof, may be dosed or added to a retentate to enable or provide or maintain or any combination thereof a suitable or an optimized pH to facilitate separation and/or facilitate further separation. In some embodiments, for example, a pH reducer, such as sulfur dioxide, or sulfurous acid, or sulfur dioxide species, or carbon dioxide, or boric acid, or an acid species, or a recoverable acid species, or any combination thereof, and/or water may be dosed or added to a retentate to enable or provide or maintain or any combination thereof a suitable pH, or concentration of one or more chemicals, or any combination thereof, for example, to facilitate separation and/or facilitate further separation. In some embodiments, it may be desirable for a recoverable pH reducer to comprise an acid or acid species or acid chemical which may be separable or recoverable with relatively low energy or relatively low cost, such as, using, for example, including, but not limited to, one or more or any combination of the following: reaction with calcium hydroxide, or reaction with magnesium hydroxide, or reaction with alkaline-earth, or reaction with alkaline-earth carbonate, or reaction with a chemical, or reaction with a resin, or ion exchange, or phase transition, or solubility transition, or phase change, or solubility change, or change in conditions, or change in solubility or phase with change in conditions, or pH sensitive, or a separation described herein, or a separation in the art, or a reaction described herein, or a reaction in the art, or a process described herein, or a process in the art, or any combination thereof.

In some embodiments, for example, a solution comprising acetic acid species and sulfur dioxide species may possess a pH or pH range wherein a greater relative proportion of sulfur dioxide species may be rejected by a membrane and/or a greater relative proportion of acetic acid species may be permeable through a membrane. For example, in some embodiments, aqueous acetic acid species may possess a different speciation that aqueous sulfur dioxide with pH. For example, in some embodiments, sulfur dioxide species may comprise a greater proportion of ionic or charged species at a lower pH than, for example, acetic acid species. For example, in some embodiments, it may be desirable to adjust the pH and/or concentration of a solution to facilitate the rejection of sulfur dioxide species and/or facilitate the permeation of acetic acid species, which may enable or facilitate the separation of a portion of acetic acid species from sulfur dioxide species and/or may facilitate the formation of a portion of a chemical comprising sodium− sulfur dioxide species, or sodium cation− sulfur dioxide species anion. For example, in some embodiments, within, for example, a pH of 2-5.5, in some solutions, a greater proportion of acetic acid species may be non-ionic or more permeable species compared to sulfur dioxide species, a greater proportion of sulfur dioxide species may be ionic or more rejected species compared to acetic acid species, which may facilitate a separation of a portion of acetic acid species from a portion of sulfur dioxide species. For example, in some embodiments, even low pH, such as a pH less than 2, may be applicable and/or feasible. For example, in some embodiments, at some pHs or in some solutions, such as some solutions with pHs greater than 5 or 6 or 7, a portion of sulfur dioxide species may comprise divalent or multivalent species or larger hydration radius species, while acetic acid species may comprise monovalent species, which may enable the separation of a portion of acetic acid species or sodium acetate from, for example, a portion of sulfur dioxide species or sodium sulfite, using, for example, including, but not limited to, one or more or any combination of the following: nanofiltration, or reverse osmosis, or electrodialysis, or monovalent selective electrodialysis, or a separation described herein, or a separation in the art. In some embodiments, selective membranes may enable or facilitate separation of species. For example, in some embodiments, ion selective membranes, such as membranes selective for sulfur, or sulfite, or carboxylic acids, or acetate, or sodium, or alkali, or certain charges, or other selectivity described herein, or other selectivity in the art, may enable or facilitate separation. For example, in some embodiments, ion selective membranes, such as membranes selective for sulfur, or sulfite, or carboxylic acids, or acetate, or sodium, or alkali, or certain charges, or other selectivity described herein, or other selectivity in the art, may enable or facilitate separation, for example, independent of or with less dependence on pH and/or concentration.

In some embodiments, it may be desirable to minimize or prevent sulfur dioxide species oxidation or formation of sulfate species. In some embodiments, for example, one or more or any combination of the following may be desirable: operating at lower or more mild temperatures, or minimizing diatomic oxygen or dissolved oxygen exposure, or operating at a relatively higher pH, or optimizing concentration, or minimizing or optimizing concentration and amount of sulfur dioxide, or using other pH reducers in addition to sulfur dioxide, or employing an oxidation inhibitor, or employing a reducing agent, or creating a reducing environment, or employing oxygen scavengers, or any combination thereof.

In some embodiments, for example, in may be desirable to dose or add a chemical comprising sulfur dioxide and/or a chemical comprising water to a feed and/or retentate solution, for example, before or during or after or any combination thereof a separation of a portion of a chemical comprising acetic acid species. For example, in some embodiments, a portion of sulfur dioxide, or other pH reducer, or water, or any combination thereof may be added to a feed solution or a retentate solution, while a portion of acetic acid species may be separated or removed from said solution. For example, in some embodiments, a portion of sulfur dioxide, or other pH reducer, or water, or any combination thereof may be added to a feed solution or a retentate solution, while a portion of acetic acid species may be separated or removed from said solution, which may enable the pH and/or concentration to be maintained in a range to facilitate separation.

In some embodiments, for example, the reaction of a pH reducer chemical, such as a chemical comprising sulfur dioxide, with a chemical comprising an alkali species, such as a sodium species, and an acid species, such as acetic acid species, and/or the production of a portion for a chemical comprising sodium− sulfur dioxide species and/or a portion of a chemical comprising acetic acid species, and/or the separation of a portion of sodium− sulfur dioxide species from acetic acid species, and/or the separation of a portion of acetic acid species from a portion of sodium− sulfur dioxide species, or any combination thereof may comprise a batch, or semi-batch, or continuous, or any combination thereof process. In some embodiments, a separation may be conducted in multiple stages until a desired separation yield or purity is achieved.

In some embodiments, adjustments to concentration, or pH, or other treatments, or other purifications, or other separations, or any combination thereof may be conducted between separation stages.

In some embodiments, a permeate or diluate comprising acetic acid species may comprise a portion of pH reducer species, such as sulfur dioxide species, or carbon dioxide species, or any combination thereof. For example, in some embodiments, the separation of a portion of acetic acid species from a feed solution, or a retentate solution, or concentrate solution, or any combination thereof may involve the carry-over or presence of residual sulfur dioxide species, or carbon dioxide species, or sodium species, or any combination thereof. In some embodiments, for example, a portion of sulfur dioxide species, or carbon dioxide species, or any combination thereof may be separated from a solution comprising acetic acid by utilizing separation systems and/or methods which may utilize the difference in vapor pressure between aqueous acetic acid and/or aqueous sulfur dioxide species, or carbon dioxide species, or any combination thereof. For example, in some embodiments, a solution comprising acetic acid may be depressurized, or heated, or any combination thereof to remove and/or recover a portion of sulfur dioxide, or carbon dioxide, or any combination thereof as a vapor. In some embodiments, a portion of a chemical comprising residual sodium may be separated using a membrane-based process, such as reverse osmosis. In some embodiments, the presence of residual sulfur dioxide species, or carbon dioxide species, or sodium species, or any combination thereof in a solution comprising acetic acid may be tolerated, or may be beneficial, or any combination thereof. In some embodiments, the chemical comprising acetic acid species formed may be transferred to and/or employed in a react with a chemical comprising an alkaline earth, such as calcium carbonate, for example, within the process.

In some embodiments, a solution comprising an alkali species, such as a sodium species, or a pH reducer species, such as sulfur dioxide species, or an acid species, such as acetic acid species, or any combination thereof may be separated using, for example, a separation. For example, in some embodiments, the pH or concentration of a solution comprising sodium species, or sulfur dioxide species, or acetic acid species, or any combination thereof may be adjusted into a pH range or concentration to facilitate a separation process. In some embodiments, a separation may be conducted in multiple stages until, for example, a desired separation yield or purity is achieved.

In some embodiments, a solution comprising sodium species, or sulfur dioxide species, or acetic acid species, or any combination thereof may be separated using, for example, a membrane-based separation. For example, in some embodiments, the pH or concentration of a solution comprising sodium species, or sulfur dioxide species, or acetic acid species, or any combination thereof may be adjusted into a pH range or concentration to facilitate a membrane-based separation process, such as reverse osmosis, or nanofiltration, or a membrane based process described herein, or a membrane based process known in the art. In some embodiments, a separation may be conducted in multiple stages until, for example, a desired separation yield or purity is achieved.

In some embodiments, a solution comprising sodium species, or sulfur dioxide species, or acetic acid species, or any combination thereof may be separated using, for example, an electrochemical separation. For example, in some embodiments, the pH or concentration of a solution comprising sodium species, or sulfur dioxide species, or acetic acid species, or any combination thereof may be adjusted into a pH range or concentration to facilitate an electrochemical separation process, such as electrodialysis. In some embodiments, a separation may be conducted in multiple stages until, for example, a desired separation yield or purity is achieved.

In some embodiments, a solution comprising sodium species, or sulfur dioxide species, or acetic acid species, or any combination thereof may be separated using, for example, electrodialysis. For example, in some embodiments, the pH of a solution comprising sodium species, or sulfur dioxide species, or acetic acid species, or any combination thereof may be adjusted into a pH range wherein a greater proportion of sulfur dioxide species may be in an ionic form relative to acetic acid species, which may enable an electrochemical separation process, such as electrodialysis, to separate or concentrate primarily sulfur dioxide species and/or sodium species. For example, in some embodiments, an electrodialysis process may form a concentrate solution comprising a greater proportion of sulfur dioxide species or sodium− sulfur dioxide species relative to the feed solution, and/or a diluate solution comprising a greater proportion of acetic acid species relative to the feed solution. In some embodiments, a separation may be conducted in multiple stages until, for example, a desired separation yield or purity is achieved.

In some embodiments, a solution comprising sodium species, or sulfur dioxide species, or acetic acid species, or any combination thereof may be separated using, for example, electrodialysis. For example, in some embodiments, the pH of a solution comprising sodium species, or sulfur dioxide species, or acetic acid species, or any combination thereof may be adjusted into a pH range wherein a greater proportion of sulfur dioxide species may be in a divalent or multi-valent ionic form relative to acetic acid species, which may enable a charge selective separation or size selective separation, such as nanofiltration or monovalent selective electrodialysis, to separate a portion of monovalent species from a portion of divalent or multivalent species. For example, in some embodiments, an electrodialysis process may form a concentrate solution comprising a greater proportion of acetic acid species or sodium acetate relative to the feed solution, and/or a diluate solution comprising a greater proportion of sodium− sulfur dioxide species or sodium sulfite relative to the feed solution. For example, in some embodiments, a semi-permeable membrane based process, such as nanofiltration or reverse osmosis, may reject a portion of sodium− sulfur dioxide species, such as sodium sulfite, while allowing the permeation of a portion of acetic acid species, such as sodium− acetic acid species or sodium acetate. In some embodiments, a separation may be conducted in multiple stages until, for example, a desired separation yield or purity is achieved.

In some embodiments, a portion of concentrate, or diluate, or retentate, or permeate, or any combination thereof may comprise a recycle stream or a recirculated stream.

In some embodiments, a retentate solution comprising sodium species and sulfur dioxide species may form. In some embodiments, a solution may comprise sodium species and sulfur dioxide species and/or may comprise a stoichiometric excess of sulfur dioxide species. In some embodiments, a solution may comprise sodium species and sulfur dioxide species and/or may comprise a molar ratio of sulfur to sodium greater than 1:2. In some embodiments, it may be desirable to remove a portion of any excess sulfur dioxide. For example, in some embodiments, a portion of an alkaline earth, such as calcium carbonate or calcium hydroxide or magnesium carbonate or magnesium hydroxide or calcium oxide or magnesium oxide, may be reacted to remove a portion of sulfur dioxide species. For example, in some embodiments, a portion of a chemical comprising an alkaline earth, such as calcium carbonate or calcium hydroxide or magnesium carbonate or magnesium hydroxide or calcium oxide or magnesium oxide, may be reacted to remove a portion of sulfur dioxide species, by forming, for example, a chemical comprising an alkaline earth sulfite. In some embodiments, it may be desirable to remove a portion of excess sulfur dioxide species using relatively low energy consumption methods, to, for example, reduce the proportional amount of sulfur dioxide which may be removed in a reaction to form an alkali hydroxide, such as sodium hydroxide. In some embodiments, it may be desirable to remove a portion of excess sulfur dioxide species to, for example, sufficiently increase pH to facilitate or enable the separation of a portion of residual acetate species, or sodium acetate, or any combination thereof and/or improve the purity of a chemical comprising sodium− sulfur dioxide species, which may comprise a chemical intermediate or a product.

In some embodiments, it may be desirable to raise the pH of a solution. In some embodiments, it may be desirable to raise the pH of a retentate solution or a concentrate solution during or after forming a portion of a solution comprising alkali species and recoverable pH reducer species, such as sulfur dioxide species or carbon dioxide species, and/or during or after the separation of a portion of acetic acid species. In some embodiments, it may be desirable to raise the pH of a retentate solution during or after forming a portion of a solution comprising alkali species and sulfur dioxide species, and/or during or after the separation of a portion of acetic acid species. For example, in some embodiments, pH may be increased, which may include, but is not limited to, one or more or any combination of the following: removing a portion of pH reducer species, or removing a portion of acetic acid species, or reacting or adding an alkaline chemical, or adjusting a concentration. For example, in some embodiments, pH may be increased by removing a portion of pH reducer species, such as sulfur dioxide species, or removing a portion of acid species, such as acetic acid, or any combination thereof, which may include, but is not limited to, one or more or any combination of the following: reaction with an alkaline chemical, or reaction with a chemical comprising an alkaline earth, or precipitation reaction with a chemical comprising an alkaline earth, or reaction with calcium carbonate to form calcium sulfite, or reducing pressure, or desolubilization, or reducing partial pressure, or changing conditions, or freeze separation, or phase change separation, or ion exchange, or electrochemical ion separation, or selective separation, or electrochemical separation, or membrane based separation, or a distillation based separation, or a separation described herein, or a separation in the art.

In some embodiments, a solution comprising sodium species, or sulfur dioxide species, or any combination thereof may comprise acetic acid species. In some embodiments, it may be desirable to separate or remove a portion of acetic acid species and/or increase the purity of sulfur dioxide species. In some embodiments, for example, it may be desirable to separate a portion of species using, for example, a membrane-based process, or nanofiltration, or electrodialysis, or a selective separation, or an ion exchange, or a resin, or electrochemical ion exchange, or an electrochemical separation, or any combination thereof. In some embodiments, for example, the pH of the solution may be increased and/or a portion of residual acetic acid species or sodium acetate may be separated from a portion of sodium− sulfur dioxide species, such as sodium sulfite.

For example, in some embodiments, (1) a solution comprising sodium species, sulfur dioxide species, and acetic acid species may be reacted with an a chemical comprising an alkaline earth, such as calcium carbonate or calcium hydroxide or magnesium carbonate or magnesium hydroxide, to form a portion of an alkaline earth sulfite, a portion which may be separated as a solid, which may raise the pH and/or reduce the molar ratio of sulfur to sodium to enable the sulfur dioxide species to be at a divalent state; (2) separate a portion of the residual acetic acid species, which may comprise sodium acetate, form a portion of the sulfur dioxide species, which may comprise sodium sulfite, using, for example, a charge or size selective separation, such as nanofiltration or monovalent selective electrodialysis; (3) recirculating or transferring the solution comprising sodium acetate to a step in the process reacting a solution comprising sodium acetate, which may involve mixing with other solutions; (4a) transferring the solution comprising sodium sulfite or sodium− sulfur dioxide species to further processing and/or wherein a chemical comprising sodium sulfite or sodium− sulfur dioxide may comprise a valuable product, such as aqueous or solid sodium sulfite, or sodium bisulfite, or sodium metabisulfite, or any combination thereof, or (4b) transferring the solution comprising sodium sulfite or sodium− sulfur dioxide species to one or more or any combination of steps to convert into or react to form valuable products, such as aqueous or solid sodium hydroxide, or sodium carbonate, or sodium bicarbonate, or any combination thereof.

In some embodiments, a chemical comprising alkaline-earth sulfite or alkaline-earth species− sulfur dioxide species may be decomposed to form a portion of a chemical comprising alkaline-earth oxide or alkaline-earth hydroxide and a chemical comprising sulfur dioxide, and/or, in some embodiments, a portion of a chemical comprising alkaline-earth oxide or alkaline-earth hydroxide may be employed internally within the process. In some embodiments, for example, excess alkaline-earth oxide or alkaline-earth hydroxide may be produced, and/or may comprise a valuable product. In some embodiments, for example, excess alkaline-earth oxide or alkaline-earth hydroxide may be produced, if, for example, alkaline-earth carbonate may be employed as an input in the reaction to remove a portion of sulfur dioxide species, and/or if an alkaline-earth sulfite is decomposed or reacted to form an alkaline-earth oxide or an alkaline-earth hydroxide.

In some embodiments, a portion of any excess sulfur dioxide may be removed by volatilization, or carrier gas extraction, or vaporization. For example, in some embodiments, an acidic carrier gas, such as carbon dioxide, may facilitate the evaporation of or extraction of a portion of sulfur dioxide into the gas phase, while reducing energy consumption and/or cost.

In some embodiments, a solution comprising alkali species, such as sodium, and pH reducer species, such as sulfur dioxide species or carbon dioxide species, or any combination thereof may be reacted to form a portion of a solution comprising alkali hydroxide, such as sodium hydroxide. In some embodiments, for example, a solution comprising sodium− sulfur dioxide species, such as sodium sulfite or sodium bisulfite or any combination thereof, may be reacted with a chemical comprising an alkaline-earth oxide or an alkaline-earth hydroxide, such as calcium hydroxide, to form a portion for a solution comprising sodium hydroxide and/or a portion of a solid comprising calcium sulfite. In some embodiments, it may be desirable to separate a portion of the formed solid comprising calcium sulfite from a portion of the formed solution comprising sodium hydroxide using, for example, a solid-liquid separation. In some embodiments, the formed solution comprising sodium hydroxide may comprise residual sodium sulfite, or sodium− sulfur dioxide species, or residual sulfur dioxide species, or sulfate species, or any combination thereof. In some embodiments, a portion of residual sulfur species, such as sulfur dioxide species or sulfate species, may be separated from a portion of a chemical comprising sodium hydroxide using one or more or any combination of separation processes described herein or in the art. In some embodiments, for example, a solution comprising sodium hydroxide and residual sodium sulfite, or sodium sulfate, or sulfur dioxide species, or sulfur species, or any combination thereof may be employed as a feed solution into a nanofiltration process, and/or a portion the sodium hydroxide species may permeate the membrane and/or a portion of the sodium− sulfur dioxide species may be retained by the membrane, which may enable or result in the separation of a portion of sodium hydroxide from a portion of sodium− sulfur dioxide species. In some embodiments, the retentate comprising sodium− sulfur dioxide species may be recirculated to or transferred to a reaction of sodium− sulfur dioxide species to form sodium hydroxide, which may involve transferred or mixing the retentate comprising sodium− sulfur dioxide species with other solutions comprising sodium− sulfur dioxide species in the process. In some embodiments, it may be desirable to separate a solution comprising sodium species, or sulfur dioxide species, or sulfate species, or any combination thereof into a portion of a solution comprising sodium− sulfur dioxide species and a separate solution comprising sodium sulfate. In some embodiments, it may be desirable to separate a solution comprising sodium species, or sulfur dioxide species, or sulfate species, or any combination thereof into a portion of a solution comprising sodium− sulfur dioxide species and a separate solution comprising sodium sulfate, which may be conducted, for example, using a sulfate selective membrane, or a sulfate selective nanofiltration membrane, or any combination thereof. In some embodiments, a solution comprising sulfate species, or an alkali sulfate, or any combination thereof may be transferred to or employed in one or more or any combination of steps which may employ sulfate, or alkali sulfate, or any combination thereof as a reactant.

In some embodiments, a solution comprising sodium hydroxide may undergo purification or polishing. For example, in some embodiments, a solution comprising sodium hydroxide may be purified using precipitation or crystallization. For example, in some embodiments, a solution comprising sodium hydroxide may be purified by precipitating or crystallizing from solution a portion of, for example, including, but not limited to, one or more or any combination of the following: sodium sulfite, or sodium bisulfite, or sodium metabisulfite, or sodium sulfate, or sodium− sulfur, or sodium acetate, or acetic acid species, or acid species, or carbon dioxide species, or pH reducer species, or calcium, or alkaline-earth, or alkali. For example, in some embodiments, a solution comprising sodium hydroxide may be purified or polished by using, for example, including, but not limited to, one or more or any combination of the following: electrodialysis, or electrodeionization, or ion exchange, or ion exchange resin, or resin, or CEDI, or a separation described herein, or a separation in the art, or a reaction described herein, or a reaction in the art, or any combination thereof.

In some embodiments, a solution comprising sodium hydroxide may be reacted with a portion of carbon dioxide to form, for example, a portion of sodium carbonate, or sodium bicarbonate, or sodium− carbon dioxide species, or any combination thereof. In some embodiments, a portion of a chemical comprising sodium carbonate, or sodium bicarbonate, or sodium− carbon dioxide species, or any combination thereof may be separated from a portion of any residual, for example, sodium acetate, using, for example, including, but not limited to, one or more or any combination of the following: nanofiltration, or membrane based process, or crystallization, or precipitation, or solubility based separation, or a separation using the difference solubility between sodium acetate and/or sodium carbonate or sodium bicarbonate, or a separation described herein, or a separation known in the art, or any combination thereof.

In some embodiments, a chemical comprising alkali− sulfur dioxide species, such as sodium sulfite, or sodium bisulfite, or any combination thereof, may be reacted with a chemical comprising an alkaline-earth carbonate, or alkaline-earth bicarbonate, or any combination thereof, such as calcium carbonate, or magnesium carbonate, calcium bicarbonate, or magnesium bicarbonate, or any combination thereof, to form, for example, a chemical comprising an alkali− carbon dioxide species, such as an alkali carbonate, or alkali bicarbonate, or alkali sesquicarbonate, or any combination thereof, and/or a chemical comprising an alkaline-earth-sulfur dioxide species, such as an alkaline-earth sulfite. In some embodiments, a solution comprising alkali− carbon dioxide species may be separated from a solid comprising alkaline-earth sulfite using, for example, a solid-liquid separation. In some embodiments, a solution comprising alkali− carbon dioxide species may comprise residual alkali− sulfur dioxide species, and/or it may be desirable to separate a portion of alkali− carbon dioxide species from a portion of alkali− sulfur dioxide species, such as, by employing one or more or any combination of separation methods described herein or in the art. In some embodiments, a chemical comprising an alkaline earth sulfite may be decomposed to form a chemical comprising an alkaline earth oxide, or an alkaline earth hydroxide, or any combination thereof, and/or a chemical comprising sulfur dioxide. In some embodiments, a chemical comprising an alkaline earth oxide, or alkaline earth hydroxide, or any combination thereof may be employed within the process, or may be reacted to form alkaline earth carbonate or alkaline earth sulfite or alkaline earth bicarbonate or alkaline earth bisulfite and/or employed within the process, or may comprise a product, or may comprise a valuable product, or any combination thereof.

### Example Embodiment Reacting, Separating, and/or Production Using Reagent or Intermediate Comprising Carbon Dioxide, or Sulfur Dioxide, or Any Combination Thereof

In some embodiments, it may be desirable to convert a chemical comprising an alkali cation− acid anion into a valuable alkali chemical, such as an alkali hydroxide, or alkali carbonate, or alkali bicarbonate, or alkali sulfite, or alkali bisulfite, or alkali metabisulfite, or any combination thereof. In some embodiments, it may be desirable to react a chemical comprising an alkali cation− acid anion with a chemical comprising carbon dioxide to form a portion of a chemical comprising an alkali− carbon dioxide species, such as an alkali carbonate, or an alkali bicarbonate, or alkali sesquicarbonate, or any combination thereof. In some embodiments, it may be desirable to react a chemical comprising an alkali cation− acid anion with a chemical comprising carbon dioxide to form a portion of a chemical comprising an alkali− carbon dioxide species, such as an alkali carbonate, or an alkali bicarbonate, or alkali sesquicarbonate, or any combination thereof and/or an acid comprising an acid. Some embodiments may enable a reaction of a chemical comprising an alkali cation− acid anion with a chemical comprising carbon dioxide to form a portion of a chemical comprising an alkali− carbon dioxide species, such as an alkali carbonate, or an alkali bicarbonate, or alkali sesquicarbonate, or any combination thereof and/or an acid comprising an acid. Some embodiments may enable a reaction of a chemical comprising an alkali cation− acid anion with a chemical comprising carbon dioxide to form a portion of a chemical comprising an alkali− carbon dioxide species, such as an alkali carbonate, or an alkali bicarbonate, or alkali sesquicarbonate, or any combination thereof and/or an acid comprising an acid, wherein, for example, the alkali may comprise sodium, or the acid anion may comprise acetate, or the acid may comprise acetic acid, or any combination thereof.

In some embodiments, a pH reducer may be dissolved in a solution comprising an alkali cation− acid anion to form a solution which may be employed as a feed solution in a membrane based process. For example, in some embodiments, a gas or fluid comprising carbon dioxide may be dissolved in a solution comprising sodium acetate and/or the formed solution comprising sodium, acetic acid species, and carbon dioxide species may comprise a feed solution in a membrane based process, such as reverse osmosis or nanofiltration. In some embodiments, the dissolution of a pH reducer may sufficiently reduce the pH of a solution comprising alkali cation− acid anion to enable a portion of the acid anion species to convert or form a species which may be permeable through a membrane, such as an acid species or a free acid species. In some embodiments, the dissolution of a pH reducer may sufficiently reduce the pH of a solution comprising sodium acetate to enable a portion of the acetic acid species to convert or form a species which may be permeable through a membrane, such as a free acetic acid species. In some embodiments, for example, gas comprising carbon dioxide may be dissolved in a solution comprising sodium acetate, and/or the pH reached may be sufficiently low to enable the permeation of a portion of acetic acid and/or the retention of a portion of sodium species and/or the retention or presence of a portion of carbon dioxide species. In some embodiments, other pH reducer species, such as acid gases, may be employed, which may include, but are not limited to, one or more or any combination of the following: hydrogen sulfide, or sulfur dioxide, or carbon dioxide, hydrogen cyanide, or an acid gas, or a derivative thereof, or an acid gas described herein, or any acid gas in the art, or any combination thereof. In some embodiments, an objective may be to separate at least a portion of acetic acid species from a portion of sodium species to enable, for example, at least a portion of sodium species to react with or associate with at least a portion of pH reducer species, such as acid gas species, and/or to form at least a portion of a chemical comprising sodium species− pH reducer species (or acid gas species), which may include, but are not limited to, one or more or any combination of the following: sodium carbonate, or sodium bicarbonate, or sodium sesquicarbonate, or sodium sulfite, or sodium bisulfite, or sodium metabisulfite, or sodium sesquisulfite, or sodium sulfide, or sodium hydrogen sulfide, or any combination thereof. In some embodiments, by separating a portion of acid species, such as acetic acid, from a portion of alkali species, such as sodium, the molar ratio of acid to sodium may decrease below a stoichiometric ratio, such as 1:1 for sodium cation− acetate anion, which may result in some of the alkali having capacity to react with or associate with other acidic species which may be present, such as a pH reducer species, such as carbon dioxide species, or sulfur dioxide species, or hydrogen sulfide species, or any combination thereof.

In some embodiments, a portion of pH reducer species, such as acid gas species, may permeate a membrane and/or a permeate solution may comprise acid species, such as acetic acid species, and pH reducer species, such as carbon dioxide species. In some embodiments, significant carbon dioxide species may be present in the solution comprising acetic acid or the permeate solution comprising acetic acid. In some embodiments, for example, the concentration of carbon dioxide species in a permeate solution comprising acetic acid may be greater than the concentration of acetic acid. In some embodiments, for example, a portion of carbon dioxide may be removed or recovered from a solution comprising acetic acid, for example, using, for example depressurization. In some embodiments, a portion of energy or power may be recovered from the depressurization and/or expansion, using, for example, a turbocharger, or pressure exchanger, or power recovery device, or a power exchange or recovery system described herein, or a power exchange or recovery system in the art.

In some embodiments, it may be desirable for the pH reducer or pH reducers to reduce the pH of a solution comprising alkali cation− acid anion to a pH wherein a portion of the acid species may comprise permeable species, or non-ionic species, or any combination thereof. For example, in some embodiments, a sufficient pH may be dependent on, for example, including, but not limited to, the solution composition, or concentration, or the properties of the acid, or the speciation of the acid chemical, or any combination thereof. In some embodiments, for example, acetic acid species may form a portion of non-ionic species in some solutions with a pH less than 6, or less than 5.5, or any combination thereof. For example, in some embodiments, a pH reducer comprising carbon dioxide may be compressed and/or dissolved in a solution comprising sodium and acetic acid species to reduce the pH to a pH less than 6, or a pH less than 5.5, or any combination thereof. In some embodiments, it may be desirable to use multiple or a combination of pH reducer chemicals to achieve a desired solution composition, or a desired pH, or any combination thereof. For example, in some embodiments, a pH reducer may comprise a sulfur dioxide, or carbon dioxide, or any combination thereof. For example, in some embodiments, carbon dioxide may be employed to minimize the desired concentration or amount or stoichiometric ratio of sulfur dioxide, which may enable lower energy consumption, or less excess sulfur dioxide species, or prevent excess sulfur dioxide species, or any combination thereof. For example, in some embodiments, sulfur dioxide may be employed to enable a pH reducer comprising carbon dioxide to achieve a lower pH or achieve a desired pH or require less pressure, which may enable lower energy consumption, or lower cost, or any combination thereof. Some embodiments may comprise a batch configuration or operation, or semi-continuous configuration or operation, or continuous configuration or operation, or other configuration or operation described herein, or other configuration or operation in the art, or any combination thereof.

In some embodiments, a solution comprising alkali species, or carbon dioxide species, or sulfur dioxide species, or any combination thereof may form. In some embodiments, it may be desirable to separation a portion of a chemical comprising alkali cation− carbon dioxide species anion from a portion of a chemical comprising alkali cation− sulfur dioxide species anion. For example, in some embodiments, in some solutions, a portion of sulfur dioxide species may be ionic or monovalent or divalent, simultaneous to a portion of carbon dioxide species being monovalent or non-ionic species. For example, in some embodiments, at a pH in the range of about 7-10, carbon dioxide species may comprise a portion of monovalent bicarbonate species, while sulfur dioxide species may comprise a portion of divalent or multivalent sulfite species, which may enable or facilitate separation. For example, in some embodiments a portion of monovalent bicarbonate species and alkali species may be separated from a portion of divalent sulfite species, using, for example, a charge or size-based separation method, which may include, but is not limited to, one or more or any combination of the following: nanofiltration, or reverse osmosis, or electrodialysis, or monovalent selective electrodialysis, or electrodeionization, or selective membrane, or a separation described herein, or a separation in the art. In some embodiments, the separation of a portion of sulfite from a portion of bicarbonate may enable or facilitate or result in the formation of a portion of a chemical comprising an alkali sulfite and/or the formation of a portion of a chemical comprising an alkali bicarbonate. In some embodiments, for example, a sulfur selective, or carbon selective, or species selective, or any combination thereof membrane or separation process may be employed. In some embodiments, species or chemicals may be separated using differences in solubility, or reactivity. For example, in some embodiments, a chemical comprising an alkali− carbon dioxide species may exhibit a lower solubility than a chemical comprising an alkali− sulfur dioxide species, which may enable the precipitation or crystallization or separation of a portion of a chemical comprising alkali− carbon dioxide species. For example, in some embodiments, a chemical comprising an alkali− sulfur dioxide species may exhibit a lower solubility than a chemical comprising an alkali− carbon dioxide species, which may enable the precipitation or crystallization or separation of a portion of a chemical comprising alkali− sulfur dioxide species.

In some embodiments, a solution comprising sodium species, or sulfur dioxide species, or carbon dioxide species, or any combination thereof may comprise residual acid species, such as residual acetic acid species, such as residual acetate. For example, in some embodiments, it may be desirable to remove or separation of a portion of residual acid species, such as, for example, removal or separation of a portion of a chemical comprising acetic acid species, using, for example, separation systems or methods described herein, or separation systems and methods in the art, or any combination thereof. For example, in some embodiments, a solution comprising sodium− carbon dioxide species may comprise residual acetic acid species, and/or it may be desirable to separate or remove a portion of acetic acid species. For example, in some embodiments, a solution comprising sodium− carbon dioxide species may comprise residual acetic acid species, and/or, in some embodiments, it may be desirable to raise the pH or achieve a pH such that at least a portion of carbon dioxide species may comprise divalent species or multi-valent species, which may enable the separation of monovalent acetate species form divalent or multi-valent species, such as carbonate species, using, for example, size or charge based separation methods, such as nanofiltration, or monovalent selective electrodialysis, or other separation method described herein, or other separation method in the art, or any combination thereof. For example, in some embodiments, a solution comprising sodium− sulfur dioxide species may comprise residual acetic acid species, and/or, in some embodiments, it may be desirable to raise the pH or achieve a pH such that at least a portion of sulfur dioxide species may comprise divalent species or multi-valent species, which may enable the separation of monovalent acetate species form divalent or multi-valent sulfite species, using, for example, size or charge based separation methods, such as nanofiltration, or monovalent selective electrodialysis, or other separation method described herein, or other separation method in the art, or any combination thereof. For example, in some embodiments, a solution comprising sodium species, or sulfur dioxide species, or carbon dioxide species, or any combination thereof may comprise residual acetic acid species, and/or, in some embodiments, it may be desirable to raise the pH or achieve a pH such that at least a portion of sulfur dioxide species and/or carbon dioxide species may comprise divalent species or multi-valent species, which may enable the separation of monovalent acetate species form divalent or multi-valent species, using, for example, size or charge based separation methods, such as nanofiltration, or monovalent selective electrodialysis, or other separation method described herein, or other separation method in the art, or any combination thereof. In some embodiments, raising or increasing the pH may comprise, including, but not limited to, one or more or any combination of the following: adding a chemical, or reacting a chemical, or changing a concentration, or changing a temperature, or electrochemical methods, or other methods described herein, or other methods in the art, or any combination thereof. For example, in some embodiments, a chemical comprising an alkaline-earth, such as an alkaline earth hydroxide or alkaline earth carbonate or alkaline earth oxide, may be added or reacted, which may result in the formation of a portion of a chemical comprising an alkaline earth sulfite, or alkaline earth carbonate, or any combination thereof and/or a may result in an increase in pH. In some embodiments, sodium− carbon dioxide species and/or sodium− sulfur dioxide species may exhibit a different solubility in solution compared to sodium acetate, which may enable a portion of separation using solubility-based methods, if desired.

In some embodiments, a valuable product may comprise a chemical comprising an alkali− carbon dioxide species. In some embodiments, a valuable product may comprise a chemical comprising an alkali− carbon dioxide species, such as sodium carbonate, or sodium bicarbonate, or sodium sesquicarbonate, or any combination thereof. In some embodiments, it may be desirable to crystalize, or concentrate, or separate, or further separate, or purify, or polish, or treat, or any combination thereof a chemical comprising an alkali− carbon dioxide species to produce a product with desired specifications. For example, in some embodiments, it may be desirable to thermally decompose a portion of a chemical comprising sodium bicarbonate or sodium sesquicarbonate to form a portion of a chemical comprising sodium carbonate or soda ash, which may exhibit more market value or a large commercial market. For example, in some embodiments, it may be desirable to remove impurities, or increase purity, or any combination thereof using one or more methods described herein, or one or more methods in the art, or any combination thereof.

In some embodiments, a valuable product may comprise a chemical comprising an alkali− sulfur dioxide species. In some embodiments, a valuable product may comprise a chemical comprising an alkali− sulfur dioxide species, such as sodium sulfite, or sodium bisulfite, or sodium metabisulfite, or sodium sesquisulfite, or any combination thereof. In some embodiments, it may be desirable to crystalize, or concentrate, or separate, or further separate, or purify, or polish, or treat, or any combination thereof a chemical comprising an alkali− sulfur dioxide species to produce a product with desired specifications. For example, in some embodiments, it may be desirable to remove impurities, or increase purity, or any combination thereof using one or more methods described herein, or one or more methods in the art, or any combination thereof.

In some embodiments, a valuable product may comprise a chemical comprising an alkali− carbon dioxide species and an alkali− sulfur dioxide species. In some embodiments, a valuable product may comprise a chemical comprising an alkali− carbon dioxide species and an alkali− sulfur dioxide species, such as sodium carbonate, or sodium bicarbonate, or sodium sesquicarbonate, or sodium sulfite, or sodium bisulfite, or sodium metabisulfite, or sodium sesquisulfite, or any combination thereof. In some embodiments, it may be desirable to crystalize, or concentrate, or separate, or further separate, or purify, or polish, or treat, or any combination thereof a chemical comprising an alkali− sulfur dioxide species and alkali− carbon dioxide species to produce a product with desired specifications. For example, in some embodiments, it may be desirable to remove impurities, or increase purity, or any combination thereof using one or more methods described herein, or one or more methods in the art, or any combination thereof.

In some embodiments, a chemical comprising an alkaline earth hydroxide may be reacted with a an chemical comprising an alkali− pH reducer species, such as an alkali− carbon dioxide species, or an alkali− sulfur dioxide species, or an alkali-sulfide species, or any combination thereof to form, for example, a chemical comprising an alkaline-earth-carbon dioxide species, or any alkaline-earth-sulfur dioxide species, or an alkaline-earth-sulfide species, or any combination thereof, and/or a chemical comprising an alkali hydroxide. In some embodiments, a chemical solid or slurry comprising calcium hydroxide may be reacted with a solution comprising sodium− carbon dioxide species, or sodium− sulfur dioxide species, or any combination thereof to form a solid comprising a calcium carbonate, or calcium sulfite, or any combination thereof and/or a solution comprising sodium hydroxide. In some embodiments, it may be desirable to separate a portion of residual carbon dioxide species, or sulfur dioxide species, or sodium carbonate, or sodium sulfite, or any combination thereof from a chemical comprising sodium hydroxide, to, for example, recover chemicals and/or to improve yield and/or to improve the quality or purity of a chemical comprising sodium hydroxide.

In some embodiments, a chemical comprising an alkaline-earth-carbon dioxide species, or any alkaline-earth-sulfur dioxide species, or any combination thereof may be decomposed to form a chemical comprising an alkaline earth oxide or alkaline earth hydroxide, or any combination thereof and/or a chemical comprising carbon dioxide, or sulfur dioxide, or any combination thereof. In some embodiments, a solid comprising calcium carbonate, or calcium sulfite, or any combination thereof may be decomposed to form a solid comprising calcium oxide and/or a gas comprising carbon dioxide, or sulfur dioxide, or any combination thereof.

In some embodiments, it may be desirable for a gas comprising carbon dioxide to comprise captured, or higher pressure, or high purity, or relatively pure, or relatively high partial pressure, or any combination thereof carbon dioxide, which, if desired, may be employed internally. In some embodiments, it may be desirable for a gas comprising carbon dioxide to comprise flue gas, emissions gas, or gas to be vented, or any combination thereof.

In some embodiments, it may be desirable for a gas comprising carbon dioxide, or sulfur dioxide, or any combination thereof to comprise a mixture. In some embodiments, it may be desirable for a gas comprising carbon dioxide, or sulfur dioxide, or any combination thereof to be at least partially separated. In some embodiments, for example, a gas comprising carbon dioxide, or sulfur dioxide, or any combination thereof may be at least partially separated utilizing the difference in phase change temperature between the chemicals, such as the difference in boiling point, or the difference in freezing point. In some embodiments, for example, a gas comprising carbon dioxide, or sulfur dioxide, or any combination thereof may be at least partially separated utilizing the difference in solubility. In some embodiments, for example, a gas comprising carbon dioxide, or sulfur dioxide, or any combination thereof may be at least partially separated utilizing the difference in reactivity. In some embodiments, a gas comprising carbon dioxide and sulfur dioxide may be at least partially separated using a method described herein, or a method in the art, or any combination thereof. In some embodiments, for example, a gas comprising carbon dioxide, or sulfur dioxide, or any combination thereof may be at least partially separated by contacting with a solution comprising water, which may result in greater proportional dissolution of sulfur dioxide relative to carbon dioxide due to the greater solubility of sulfur dioxide in water. In some embodiments, for example, a gas comprising carbon dioxide, or sulfur dioxide, or any combination thereof may be contacted with a solution comprising an alkali cation− acid anion, such as a solution comprising sodium acetate, which may result in the dissolution or reaction of sulfur dioxide, which may occur at a wide range of concentrations, including, for example, relatively low sulfur dioxide concentrations. In some embodiments, at greater pressures, or lower temperatures, or other conditions, or any combination thereof, an increased proportion or amount of carbon dioxide may dissolve in a solution comprising alkali species and acid species. In some embodiments, for example, a gas comprising carbon dioxide and sulfur dioxide may be first contacted with a solution comprising sodium acetate such that a portion of sulfur dioxide may dissolve and/or react with the solution, then, second, if desired, a portion of the carbon dioxide may be pressured or compressed and/or dissolved in the solution. In some embodiments, a gas comprising carbon dioxide and sulfur dioxide may be dissolved in a solution comprising an alkali cation− acid anion and/or may reduce the pH of the solution.

In some embodiments, a small molecular weight carboxylic acid, such as acetic acid or formic acid or propanoic acid, may be provided as an example acid chemical which may comprise at least partially ionic species under some conditions, such as a first pH range, and/or may comprise at least partially non-ionic species under some conditions, such as a second pH range. In some embodiments, a small molecular weight carboxylic acid, such as acetic acid or formic acid or propanoic acid, may be provided as an example acid chemical which may comprise a species which is at least partially permeable through a given semi-permeable membrane under some conditions, such as a first pH range or in the presence of an ion selective membrane, and/or may comprise at least partially impermeable or at least partially rejected species under some conditions, such as a second pH range or in the presence of an ion selective membrane. In some embodiments, a small molecular weight carboxylic acid, such as acetic acid or formic acid or propanoic acid, may be provided as an example acid chemical which may comprise a species which is at least partially electrochemically separable under some conditions, such as a first pH range or in the presence of an ion selective membrane, and/or may comprise a species which is at least partially electrochemically uncharged under some conditions, such as a second pH range or in the presence of an ion selective membrane.

### Example Chemistry and Processes of Some Embodiments

Some embodiments, for example, may comprise one or more or any combination of the following stages:
(1) Forming solution comprising alkaline earth, such as calcium carboxylate, for example: reacting a material comprising alkaline-earth− weak acid derivative, such as calcium carbonate, with a solution comprising a carboxylic acid, such as acetic acid, to form a solution comprising alkaline earth carboxylate, such as calcium acetate, and a fluid or gas comprising carbon dioxide or weak acid derivative;
(2) Forming solution comprising alkali or alkali+ weak acid anion, such as sodium carboxylate, for example: reacting a solution comprising an alkaline earth carboxylate, such as calcium acetate, with a solid or solution or any combination thereof comprising an alkali sulfate, such as sodium sulfate or ammonium sulfate, to form, for example, a portion of a solid comprising an alkaline earth sulfate, such as calcium sulfate, and a solution comprising an alkali carboxylate, such as sodium acetate or ammonium acetate;
(3) Dissolving SO2, or CO2, or any combination thereof into a solution comprising alkali+ weak acid anion, such as sodium acetate or sodium+ acetic acid, at a sufficiently high pressure or sufficiently high concentration to lower the pH to or to achieve a pH wherein at least a portion of the weak acid anion may comprise a non-ionic or free or permeable weak acid, which may enable at least a portion of separation or permeation of a portion of a weak acid or weak acid species, such as acetic acid, using, for example, a membrane-based process, and/or producing at least a portion of an alkali+ carbon dioxide salt, or alkali+ sulfur dioxide salt, or a derivative thereof, or any combination thereof:
In some embodiments, SO₂ may be added to or dissolved in a solution comprising an alkali+ weak acid or weak acid anion, such as a solution comprising sodium acetate or sodium+ acetic acid, to, for example, lower the pH. In some embodiments, CO₂ may be added to or dissolved in a solution comprising an alkali+ weak acid or weak acid anion, such as a solution comprising sodium acetate or sodium+ acetic acid, to, for example, lower the pH. In some embodiments, CO₂ and SO₂ may be added to or dissolved in a solution comprising an alkali+ weak acid or weak acid anion, such as a solution comprising sodium acetate or sodium+ acetic acid, to, for example, lower the pH. In some embodiments, sulfur dioxide or a derivative species may be added or dissolved, then carbon dioxide may be added or dissolved. In some embodiments, sulfur dioxide or a derivative species may be added or dissolved, then carbon dioxide may be added or dissolved, wherein the added or dissolved carbon dioxide may reduce the proportional amount of sulfur dioxide which is required, which may increase yield, or reduce sulfite oxidation, or reduce cost, or increase recovery, or improve process economics, or improve product quality or any combination thereof. In some embodiments, SO₂ or related species or chemical may be added first, followed by the addition of CO₂ or related species or chemical. In some embodiments, CO₂ or related species or chemical may be added first, followed by the addition of SO₂ or related species or chemical. In some embodiments, CO₂ or related species or chemical may be added at the same time or at overlapping time(s) as the addition of SO₂ or related species or chemical.
CO₂, or SO₂, or any combination thereof:
   (3a) CO₂ may be pressurized into and/or dissolved into and/or present in a solution comprising alkali+ weak acid anion. For example, in some embodiments, the presence of dissolved CO₂ or carbonic acid species may lower the solution pH to a level wherein a portion of the weak acid anion, such as acetate, may partially comprise non-ionic, such as acetic acid or free acetic acid. SO₂ may be pressurized into and/or dissolved into and/or present in a solution comprising alkali+ weak acid anion. For example, in some embodiments, the presence of dissolved SO₂ or sulfurous acid species may lower the solution pH to a level wherein a portion of the weak acid anion, such as acetate, may partially comprise a non-ionic, such as acetic acid or free acetic acid;
   (3b) The solution from 3a may be employed as or may comprise a feed solution into a membrane based process, such as reverse osmosis, or nanofiltration, or electrodialysis, or any combination thereof, wherein at least a portion of the free carboxylic acid, such as acetic acid, and/or species comprising CO₂ and/or species comprising SO₂, or any combination thereof may partially separate from at least a portion of the alkali, such as sodium, which may result in the formation of a solution comprising alkali bicarbonate, or alkali carbonate, or alkali carbon dioxide species, or alkali bisulfite, or alkali sulfite, or alkali sulfite species, or alkali carboxylate, or alkali acetate, or carbon dioxide, or sulfur dioxide, or a derivative thereof, or any combination thereof, such as, for example, sodium bicarbonate, or sodium carbonate, or sodium sulfite, or sodium bisulfite, or sodium sulfate, or sodium sesquicarbonate, or sodium acetate, carbon dioxide, or sulfur dioxide, or any combination thereof,
   (3c) A portion of a chemical comprising carbon dioxide in a solution comprising a carboxylic acid, such as acetic acid, may be separated and/or a portion may be recompressed/recirculated. A portion of a chemical comprising sulfur dioxide in a solution comprising carboxylic acid, such as acetic acid, may be separated and/or a portion may be recompressed/recirculated. In some embodiments, a solution comprising sodium acetate, or sodium bicarbonate, or sodium carbonate, or sodium sesquicarbonate, or sodium sulfite, or sodium bisulfite, or sulfur dioxide, or carbon dioxide, or a derivative thereof, or any combination thereof, may be separated into a solution or solid or a combination thereof comprising sodium+ carbon dioxide species salt(s), or sodium+sulfur dioxide species salt(s), and/or a solution or solid or any combination thereof comprising sodium+ acid anion salt(s) or sodium+ carboxylic acid anion salt(s), such as sodium acetate. In some embodiments, a solution or solid comprising sodium bicarbonate, or sodium carbonate, or sodium sesquicarbonate, or sodium sulfite, or sodium bisulfite, or any combination thereof may comprise a product, or may be further processed into other valuable chemicals, or useful intermediates, or any combination thereof, which may include, but are not limited to, sodium carbonate, or sodium hydroxide, or sodium sesquicarbonate, or a carbon dioxide, or captured carbon dioxide, or a derivative thereof, or any combination thereof. In some embodiments, for example, Steps 3a, or 3b, or 3c, or any combination thereof may be repeated, or may be conducted in multiple stages, or may be conducted in multiple cycles, or may be conducted a batch manner, or may be conducted in a semi-continuous manner, or may be conducted in a continuous manner, or any combination thereof.

In some embodiments, a solution comprising alkali+ sulfur dioxide species, or alkali+ carbon dioxide species, or a derivative thereof, or any combination thereof may be reacted with an chemical comprising an alkaline earth hydroxide to form, for example, a portion of a chemical comprising an alkali hydroxide and a portion of a chemical comprising an alkaline earth sulfite, or alkaline earth carbonate, or any combination thereof. In some embodiments, a solution or chemical comprising sodium carbonate, or sodium sesquicarbonate, or sodium bicarbonate, or sodium sulfite, or sodium bisulfite, or sodium sesquisulfite, or a derivative thereof, or any combination thereof may be reacted with an chemical comprising an alkaline earth hydroxide to form, for example, a portion of a chemical comprising an alkali hydroxide and a portion of a chemical comprising an alkaline earth sulfite, or alkaline earth carbonate, or any combination thereof.

### Example Description

In some embodiments, it may be desirable to employ two or more stages, or steps or cycles, or any combination thereof of NF, or RO, or membrane-based process, or separation process, or separation method, or a derivative thereof, or any combination thereof.
In some embodiments, CO2 may be employed to reduce the amount of SO2 required and/or SO2 recovered, which may save energy. Some embodiments may produce sodium bicarbonate or a mixture of sodium sulfite+ carbonate, or sodium+sulfur dioxide+ carbon dioxide salts.
In some embodiments, a permeate comprising a mixture of SO2(aq) and carboxylic acid, such as acetic acid, may be at least partially separated. For example, in some embodiments, a portion of a component comprising SO2 may be at least partially separated from a component comprising a carboxylic acid, such as acetic acid, using the potential significant difference in vapor pressure between SO2 and acetic acid. For example, in some embodiments, SO2 may exhibit a higher vapor pressure than acetic acid. In some embodiments, SO2 species may be less prone to oxidation to sulfuric acid or sulfate, enabling high recovery of CO2. In some embodiments, SO2 species may be less prone to oxidation to sulfuric acid or sulfate, enabling high recovery of CO2, in a solution or environment with less presence or concentration of sodium or cations and/or with less exposure to diatomic oxygen or dissolved oxygen.
In some embodiments, a purpose of the NF may be to separate a substantial portion of acid (such as acetic acid and/or sulfur dioxide or sulfurous acid) from the cation (such as sodium).
In some embodiments, such as membrane embodiments, potentially separate a portion of salt which may be present in the permeate, such as sodium acetate or sodium sulfite or sodium sulfate, from the acetic acid in the permeate (using, for example, another NF or electrodialysis step). Alternatively, or additionally, in some embodiments, allow a portion of a salt present in a permeate to transfer to a reaction with an alkaline earth+ weak acid anion, such as calcium carbonate. Alternatively, or additionally, in some embodiments, allow a portion of the a salt present in a permeate comprising a carboxylic acid, such as acetic acid, to transfer to or be present in the solution or any combination thereof in a reaction with an alkaline earth+ weak acid anion, such as calcium carbonate.
In some embodiments, the concentration of the solution that may be employed with NF or RO and separate acetic acid may be greater if a mixture of sulfur dioxide and carbon dioxide is employed. For example, a portion of SO2 may be added, then CO2 may be added or pressurized. For example, the solubility of carbon dioxide may be more limited relative to sulfur dioxide. Additionally, the influence of carbon dioxide on pH in proportion to concentration may be less than sulfur dioxide, which may mean sulfur dioxide, or sulfur dioxide+ carbon dioxide, or any combination thereof, may be more effective at sufficiently reducing the pH of a higher concentration solution comprising an alkali carboxylate, such as sodium acetate or sodium+ acetic acid species.
In some embodiments, an alkaline earth+ weak acid anion, such as calcium carbonate, may be added to a solution comprising an alkali+ sulfur dioxide species, or an alkali+ carbon dioxide species, or any combination thereof, such as a chemical or solution comprising sodium bisulfite or sodium bicarbonate, to form, for example, chemical(s) comprising sodium sulfite and calcium sulfite and/or carbon dioxide, or sodium carbonate and calcium sulfite, or any combination thereof.
In some embodiments, an alkaline earth+ weak acid anion, such as calcium carbonate, may be added to a solution comprising an alkali sulfite or alkali+ sulfur dioxide species, such as sodium sulfite or sodium bisulfite, in the presence of, for example, a high CO₂ partial pressure, or a dissolved carbon dioxide, or dissolved sulfur dioxide, or any combination thereof, which may result in a portion of the calcium carbonate to partially dissolve and/or react with the sulfite or bisulfite to form calcium sulfite or calcium bisulfite and/or form sodium carbonate, or sodium bicarbonate. In some embodiments, this may enable lower cost or simpler production of alkali salts, such as alkali+ carbon dioxide salts. In some embodiments, this may reduce the concentration of sodium sulfite in solution, or may potentially reduce lime consumption in some steps, and/or increasing the potential concentration or amount of the available sodium which may be causticized by calcium hydroxide (sodium carbonate may react with calcium hydroxide to form sodium hydroxide at a higher solution concentration than sodium sulfite).
In some embodiments, a retentate formed may comprise sodium− carbon dioxide species, or sodium− sulfur dioxide species, or any combination thereof. In some embodiments, a portion of a chemical comprising sodium bicarbonate may be at least partially separated from a portion of a chemical comprising sodium− sulfur dioxide species. In some embodiments, a portion of a chemical comprising sodium bicarbonate may be at least partially separated from a portion of a chemical comprising sodium− sulfur dioxide species, for example, using the significantly difference in solubility, if desired. In some embodiments, calcium carbonate and/or lime may be added to the solution to form calcium sulfite, or calcium carbonate, or a derivative thereof, or any combination thereof.

### Example Chemistry and Processes of Some Embodiments

Some embodiments, for example, may comprise one or more or any combination of the following stages:
(1) Forming solution comprising alkaline earth, such as calcium carboxylate, for example: reacting a material comprising alkaline-earth− weak acid derivative, such as calcium carbonate, with a solution comprising a carboxylic acid, such as acetic acid, to form a solution comprising alkaline earth carboxylate, such as calcium acetate, and a fluid or gas comprising carbon dioxide;
(2) Forming solution comprising alkali or alkali+ weak acid anion, such as sodium carboxylate, for example: reacting a solution comprising an alkaline earth carboxylate, such as calcium acetate, with a solid or solution or any combination thereof comprising an alkali sulfate, such as sodium sulfate, to form, for example, a portion of a solid comprising an alkaline earth sulfate, such as calcium sulfate, and a solution comprising an alkali carboxylate, such as sodium acetate;
(3) Dissolving CO₂ into a solution comprising alkali+ weak acid anion at a sufficiently high pressure to lower the pH to or achieve a pH at a level wherein at least a portion of the weak acid anion becomes non-ionic or free or permeable weak acid, enabling at least a portion of separation or permeation of the weak acid using, for example, a membrane-based process, and/or producing at least a portion of an alkali+ carbon dioxide salt: (3a) CO₂ may be pressurized into and/or dissolved into and/or present in a solution comprising alkali+ weak acid anion. For example, in some embodiments, the presence of dissolved CO₂ or carbonic acid species may lower the solution pH to a level wherein a portion of the weak acid anion, such as acetate, may become non-ionic, such as acetic acid or free acetic acid; (3b) The solution from 3a may comprise a feed solution into a membrane based process, such as reverse osmosis, or nanofiltration, or electrodialysis, or any combination thereof, wherein at least a portion of the free carboxylic acid, such as acetic acid, and/or CO₂ may separate from at least a portion of the alkali, such as sodium, which may result in the formation of a solution comprising alkali bicarbonate, or alkali carboxylate, or alkali acetate, or carbon dioxide, or any combination thereof, such as, for example, sodium bicarbonate, sodium acetate, carbon dioxide, or any combination thereof, (3c) A portion of carbon dioxide in the solution with acetic acid may be separated and/or a portion may be recompressed/recirculated. In some embodiments, a solution comprising sodium acetate, or sodium bicarbonate, or a derivative thereof, or any combination thereof, may be separated into a solution or solid comprising sodium bicarbonate and a solution or solid comprising sodium acetate. In some embodiments, a solution or solid comprising sodium bicarbonate may comprise a product, or may be further processed into other valuable chemicals, or useful intermediates, or any combination thereof, which may include, but are not limited to, sodium carbonate, or sodium hydroxide, or sodium sesquicarbonate, or a carbon dioxide, or captured carbon dioxide, or a derivative thereof, or any combination thereof. In some embodiments, for example, Steps 3a and 3b may be repeated, for example, to increase yield.

### Example Figure Descriptions of Some Embodiments

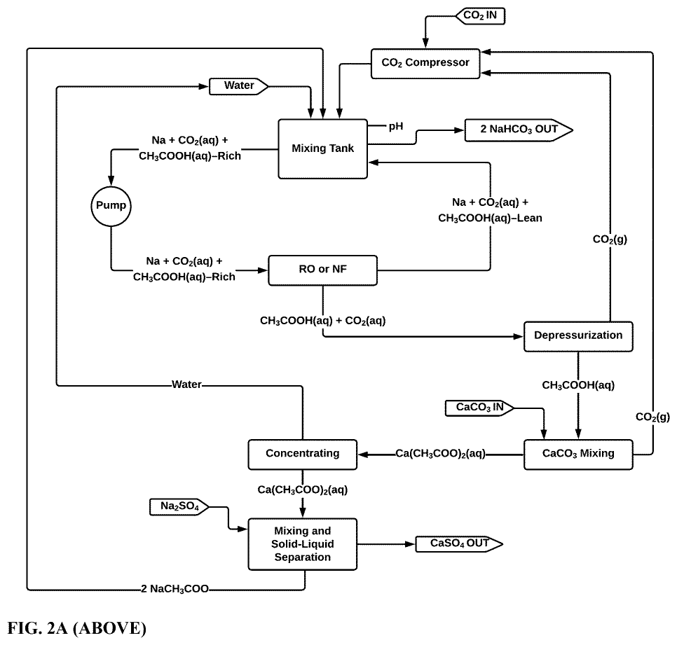

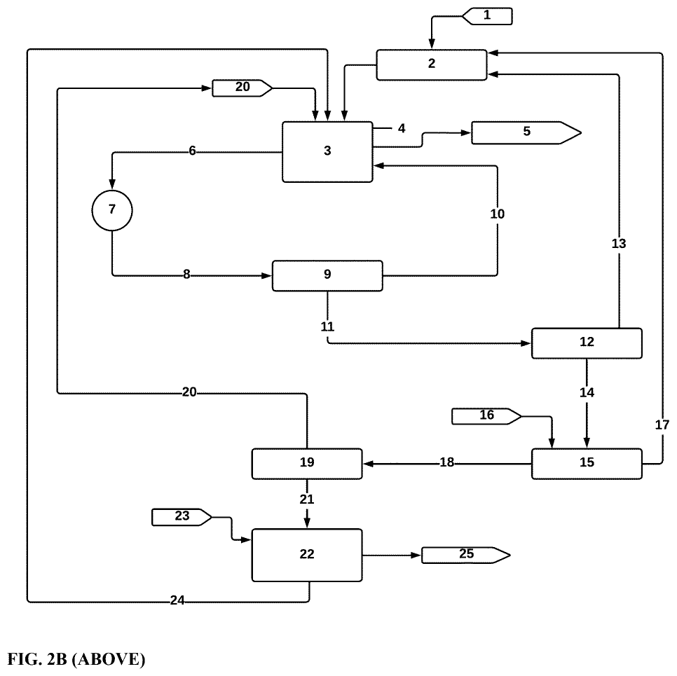

### FIG. 2A, 2B Example Summary

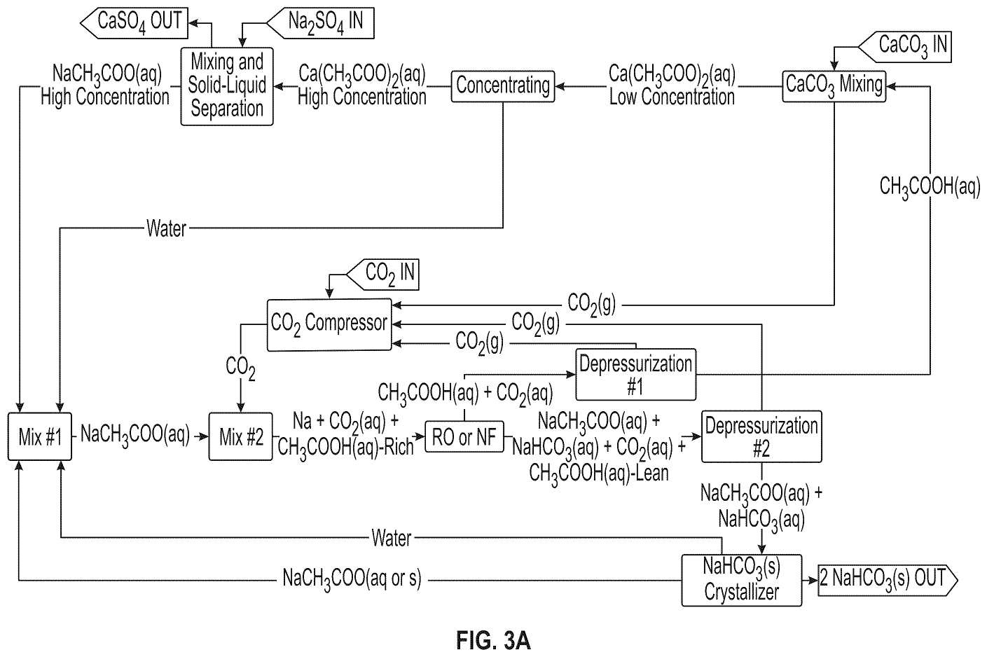

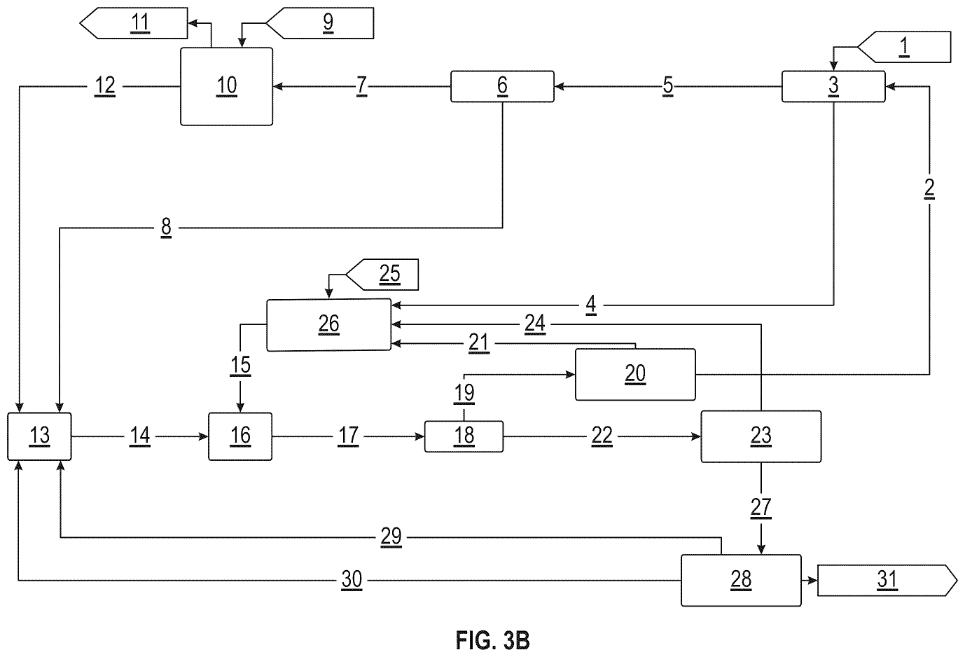

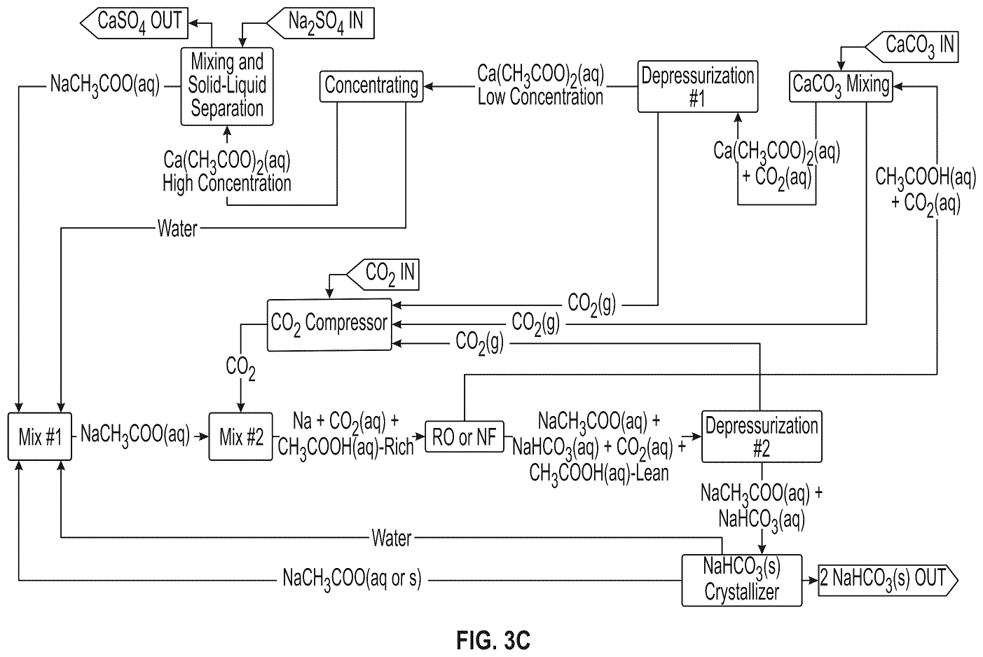

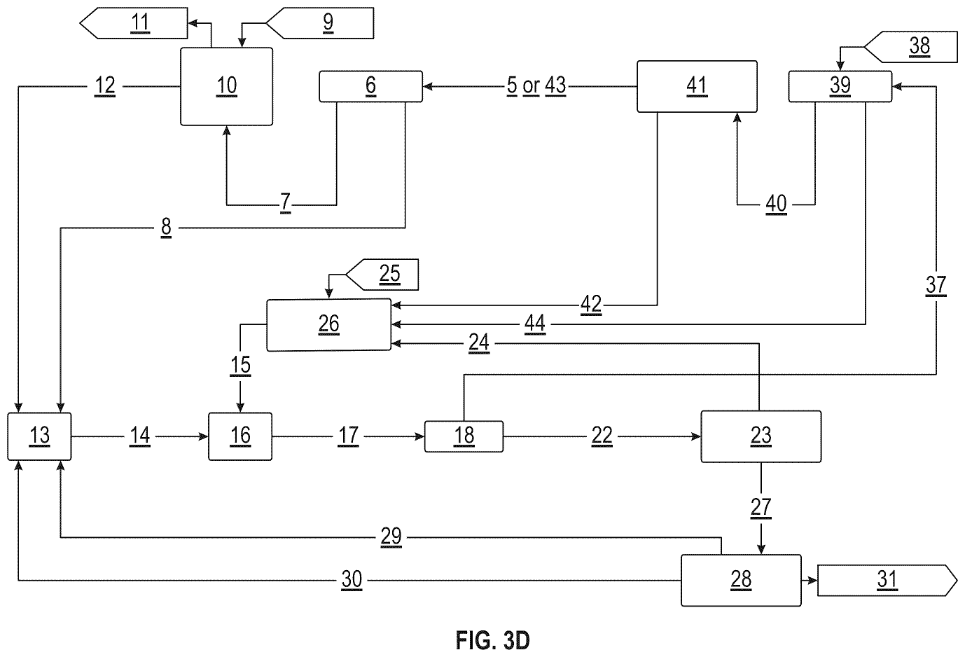

In some embodiments, FIGS. 2A and 2B may show a configuration of the membrane-based separation process and may be applicable to other figures or embodiments herein, which may include, but is not limited to, FIGS. 3-11.

In some embodiments, FIGS. 2A and 2B may show continuous or semi-continuous recirculation, or concentration control, or pH control, or pressure control, or partial removal of reagents or products, or any combination thereof.

### FIG. 3A-D, 9A-D, 10A, 10B Example Description

### FIGS. 3A, 3B, 3C, 3D Example Summary

FIG. 3 may comprise a process for producing a chemical comprising alkali, or alkali acid gas anion salt, or any combination thereof from a chemical comprising an alkali sulfate, which may employ acid gas input, or acid gas intermediate, or carboxylic acid intermediate, or membrane-based process, or any combination thereof. In some embodiments, FIG. 3 may form a chemical comprising an alkali carboxylate from a chemical comprising an alkali sulfate. In some embodiments, FIG. 3 may form a chemical comprising an alkali carboxylate, such as sodium acetate or ammonium acetate, from a chemical comprising an alkali sulfate, such as sodium sulfate or ammonium sulfate. In some embodiments, FIG. 3 may employ the pressurization and/or dissolution of an acid gas to into a solution comprising an alkali carboxylate to reduce the pH and/or enable at least a portion of the carboxylic acid species to form non-ionic or permeable carboxylic acid species, which may enable the separation of a portion of carboxylic acid species from a portion of alkali species and/or the separation of a portion of alkali species from a portion of carboxylic acid species using a membrane based process, such as using a semi-permeable membrane, or an electrodialysis membrane, or any combination thereof. In some embodiments, FIG. 3 may employ the pressurization and/or dissolution of an acid gas to into a solution comprising an alkali carboxylate to reduce the pH and/or enable at least a portion of the carboxylic acid species to form non-ionic or permeable carboxylic acid species, which may enable the separation of a portion of carboxylic acid species from a portion of alkali species using a semi-permeable membrane, such as reverse osmosis, or nanofiltration, or a membrane based process described herein, or a membrane based process in the art. In some embodiments, the separation of at least a portion of a carboxylic acid species from a portion of alkali species may result in some of the alkali species, which may have been previously paired with some of the carboxylic acid species, to pair with some of another anion species. In some embodiments, the separation of at least a portion of a carboxylic acid species from a portion of alkali species may result in some of the alkali species, which may have been previously paired with some of the carboxylic acid species, to pair with some of the acid gas species which may be present in the solution, which may enable the formation of a portion of a salt comprising alkali and acid gas species. In some embodiments, for example, the separation of at least a portion of acetic acid species from a portion of sodium species may result in some of the sodium species, which may have been previously paired with some of the acetic acid species, to pair with some of the carbon dioxide species which may be present in the solution, which may enable the formation of a portion of a salt comprising sodium and carbon dioxide species, which may include, but is not limited to, one or more or any combination of the following: sodium bicarbonate, or sodium carbonate, or sodium sesquicarbonate. In some embodiments, a solution comprising alkali, or acid gas, or carboxylic acid, or any combination thereof may form, wherein the molar ratio of alkali species to carboxylic acid species may be greater than 1:1, or may be greater than the stoichiometric ratio, or may comprise a stoichiometric excess of alkali species relative to carboxylic acid species, or any combination thereof, which may enable the formation of a portion of a salt comprising alkali and acid gas species. In some embodiments, a solution comprising sodium, or carbon dioxide, or acetic acid, or any combination thereof may form, wherein the molar ratio of sodium species to acetic acid species may be greater than 1:1, or may be greater than the stoichiometric ratio, or may comprise a stoichiometric excess of sodium species relative to acetic acid species, or any combination thereof, which may enable the formation of a portion of a salt comprising sodium and carbon dioxide species. In some embodiments, a portion of alkali and/or acid gas species, or a salt comprising alkali cation acid gas species anion, or any combination thereof may be at least partially separated from a portion of an alkali carboxylate. In some embodiments, a portion of sodium and/or carbon dioxide species, or a salt comprising sodium cation carbon dioxide species anion, or any combination thereof may be at least partially separated from a portion of a solution comprising sodium acetate. Some embodiments may comprise a batch, or semi-batch, or continuous, or any combination thereof configuration. In some embodiments, some components, which may include, but are not limited to, pumps, or high-pressure pumps, or separators, or solid-liquid separations, or any combination thereof, may be employed.

FIG. 3 may comprise a process for producing a chemical comprising alkali bicarbonate from a chemical comprising alkali sulfate, which may employ carbon dioxide input, or carbon dioxide intermediate, or carboxylic acid intermediate, or membrane-based process, or any combination thereof.

### FIGS. 3A, 3B

In some embodiments, FIGS. 3A and 3B may show a process concentrating a solution comprising a relatively low concentration of an alkaline earth carboxylate conducted separately from diluting a solution comprising a relatively high concentration of alkali carboxylate.

In some embodiments, FIGS. 3A and 3B may show a process employing depressurization and/or separation of a portion of dissolved acid gas, such as carbon dioxide, from a solution comprising carboxylic acid prior to, or during, or any combination thereof a reaction with a chemical comprising an alkaline earth.

### FIGS. 3C, 3D

FIGS. 3C and 3D may be similar to FIGS. 3A and 3B. FIGS. 3C and 3D may show a process employing depressurization and/or separation of a portion of dissolved acid gas, such as carbon dioxide, from a solution comprising alkaline earth carboxylate after, or during, or any combination thereof a reaction of a chemical comprising an alkaline earth with a chemical comprising a carboxylic acid.

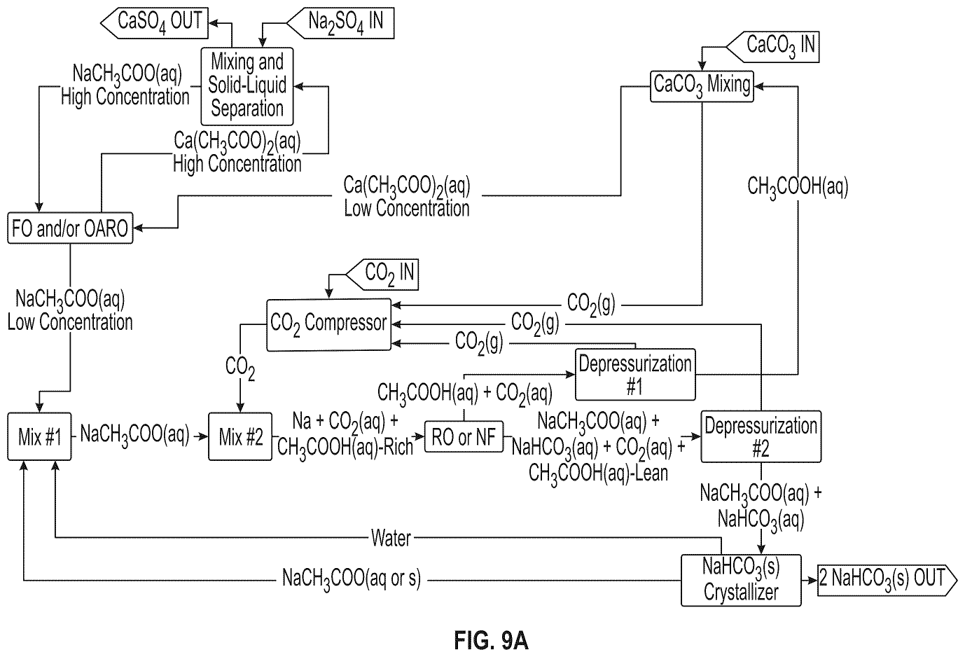

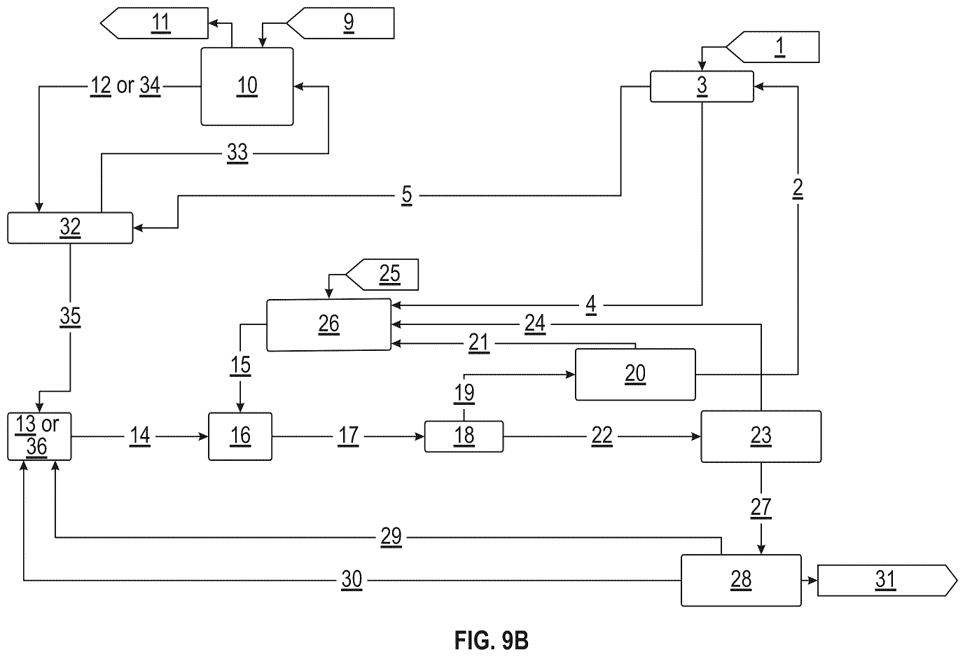

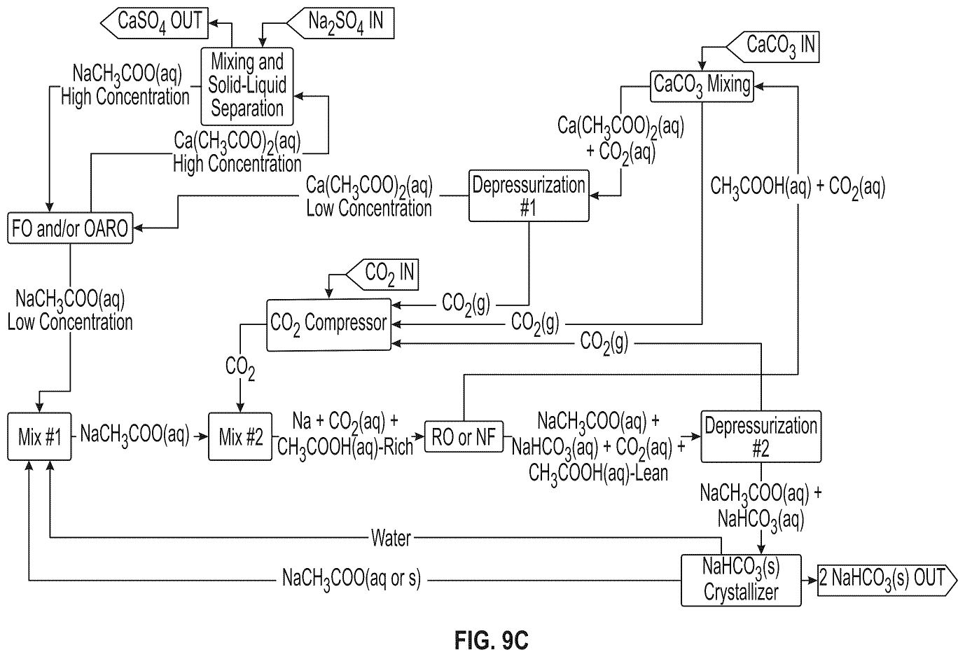

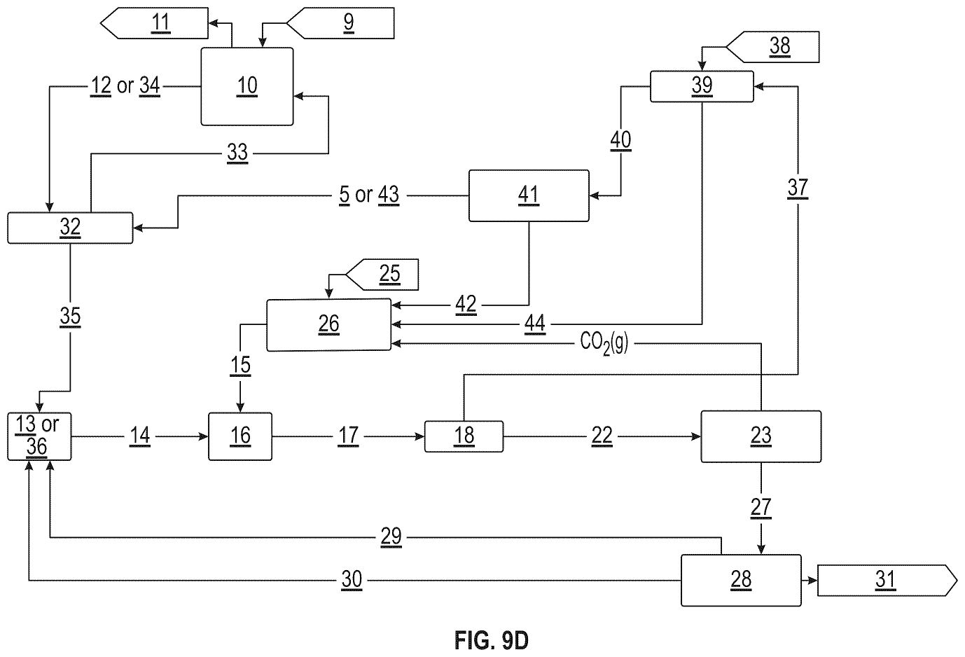

### FIGS. 9A, 9B, 9C, 9D Example Summary

### FIG. 9 May be Similar to FIG. 3

### FIGS. 9A, 9B

FIGS. 9A and 9B may be similar to FIGS. 3A and 3B. In some embodiments, FIGS. 9A and 9B may show a process concentrating a solution comprising a relatively low concentration of an alkaline earth carboxylate integrated with diluting a solution comprising a relatively high concentration of alkali carboxylate. In some embodiments, for example, forward osmosis, or osmotically assisted reverse osmosis, or any combination thereof may be employed to transfer at least a portion of water from the relatively low concentration solution to the relatively high concentration solution, which may reduce process energy consumption, or decrease system size, or reduce complexity, or improve operations, or reduce CAPEX, or reduce OPEX, or any combination thereof.

### FIGS. 9C, 9D

FIGS. 9C and 9D may be similar to FIGS. 3C and 3D. In some embodiments, FIGS. 9C and 9D may show a process employing depressurization and/or separation of a portion of dissolved acid gas, such as carbon dioxide, from a solution comprising alkaline earth carboxylate after, or during, or any combination thereof a reaction of a chemical comprising an alkaline earth with a chemical comprising a carboxylic acid.

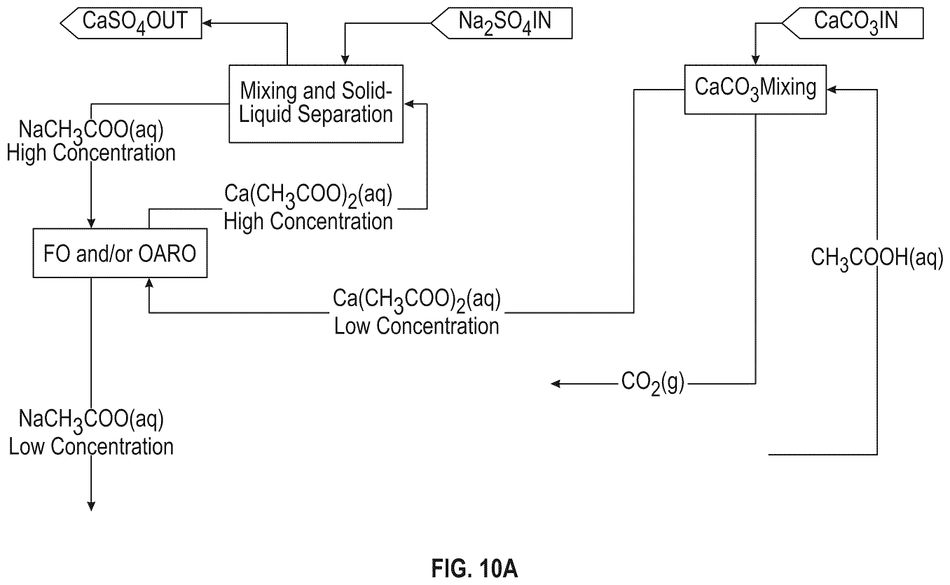

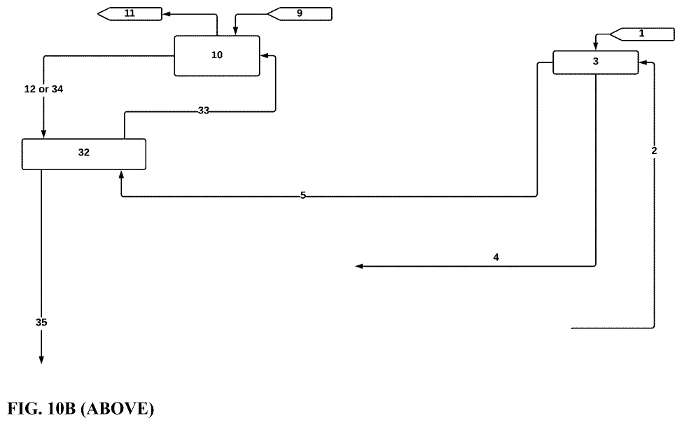

### FIG. 10A, 10B Example Summary

FIG. 10A, 10B may comprise a process, or a portion of a process, or any combination thereof for forming a portion of a chemical comprising an alkali carboxylate from a chemical comprising an alkali sulfate, or a chemical comprising an alkaline earth, or a chemical comprising a carboxylic acid, or any combination thereof. In some embodiments, FIGS. 10A and 10B may show a process for concentrating a solution comprising a relatively low concentration of an alkaline earth carboxylate while diluting a solution comprising an alkali carboxylate.

### FIG. 3A-D, 9A-D, 1A, 10B Example Key (Description)

FIG. 3A-D, 9A-D, 10A, 10B Example Key (Description)

| ID | Description |
|---|---|
| 1 | ‘1’ may comprise a chemical comprising alkaline earth - weak acid, which may |
| | include, but is not limited to, one or more or any combination of the following: |
| | calcium carbonate, or magnesium carbonate, calcium silicate, or ferrite, or |
| | aluminate, or sulfide, or other weak acid anion described herein, or other weak |
| | acid anion known in the art. In some embodiments, for example, ‘1’ may |
| | comprise calcium carbonate. |
| 2 | ‘2’ may comprise a chemical comprising an acid, such as a carboxylic acid. In |
| | some embodiments, ‘2’ may comprise acetic acid. In some embodiments, ‘2’ |
| | may comprise a solution comprising acetic acid following the separation of at |
| | least a portion of residual dissolved carbon dioxide, such as, for example, |
| | following the separation of at least a portion of carbon dioxide by |
| | depressurization or reducing the pressure of the solution. |
| 3 | ‘3’ may comprise a reactor to form, for example, at least a portion of a solution |
| | comprising alkaline earth - weak acid. In some embodiments, for example, ‘3’ |
| | may comprise a reactor which may react at least a portion of a chemical |
| | comprising calcium carbonate with at least a portion of a chemical comprising |
| | acetic acid to form, for example, at least a portion of a chemical comprising |
| | calcium acetate and at least a portion of a fluid comprising carbon dioxide. In |
| | some embodiments, it may be desirable to recover at least a portion of the |
| | carbon dioxide formed and/or employ within the process. |
| 4 | ‘4’ may comprise carbon dioxide. In some embodiments, ‘4’ may comprise at |
| | least a portion of a fluid comprising carbon dioxide which may be formed from |
| | the reaction of calcium carbonate and acetic acid, and/or may be transferred to |
| | one or more steps of the process which may employ carbon dioxide. |
| 5 | ‘5’ may comprise a chemical comprising an alkaline earth + weak acid, or a |
| | solution comprising an alkaline earth + weak acid. In some embodiments, ‘5’ |
| | may comprise a solution comprising an alkaline earth carboxylate. For example, |
| | in some embodiments, ‘5’ may comprise a solution comprising calcium acetate. |
| | For example, in some embodiments, ‘5’ may comprise a solution comprising |
| | calcium acetate which may comprise residual dissolved CO₂. |
| 6 | ‘6’ may comprise a method for concentrating or increasing the concentration of, |
| | for example, at least a portion of the solute in ‘5’ and/or recovering or |
| | generating a solution comprising a solvent, such as a solution comprising water. |
| | For example, in some embodiments, ‘6’ may comprise a method for increasing |
| | the concentration of a solute comprising calcium acetate and/or producing a |
| | solution comprising water. For example, in some embodiments, ‘6’ may |
| | comprise a membrane based process or separation process, which may include, |
| | but is not limited to, one or more or any combination of the following: reverse |
| | osmosis, or nanofiltration, or electrodialysis, or distillation, or MVC, or MED, |
| | or OARO, or FO, or other separation process described herein, or other |
| | separation process in the art, or any combination thereof. In some embodiments, |
| | it may be desirable to concentrate a solution comprising calcium carboxylate, |
| | such as calcium acetate, to a concentration sufficient to enable or facilitate the |
| | precipitation of a solid comprising calcium sulfate. |
| 7 | ‘7’ may comprise a solution comprising an alkaline earth + weak acid. ‘7’ may |
| | comprise a solution comprising an alkaline earth carboxylate, such as calcium |
| | acetate. In some embodiments, ‘7’ may comprise a solution comprising calcium |
| | acetate, wherein the concentration of calcium acetate in ‘7’ may be greater than |
| | the concentration of calcium acetate in ‘5’, and/or wherein ‘7’ may comprise a |
| | retentate or concentrate formed from the concentrating of a portion of ‘5’. In |
| | some embodiments, it may be desirable for the concentration of ‘7’ to be |
| | sufficient to enable or facilitate the precipitation of a solid comprising calcium |
| | sulfate. |
| 8 | ‘8’ may comprise water. ‘8’ may comprise a solution comprising water. In some |
| | embodiments, ‘8’ may comprise a portion of dissolved carbon dioxide. In some |
| | embodiments, ‘8’ may comprise carbon dioxide. For example, in some |
| | embodiments, a portion of dissolved carbon dioxide, which may be residual |
| | from the reaction of calcium carbonate with an acid, may desirably be present in |
| | ‘8’, which may be beneficial. In some embodiments, for example, the presence |
| | of a portion of carbon dioxide in ‘8’ may reduce the potential energy |
| | consumption required for CO₂ recovery and/or CO₂ compression. |
| 9 | ‘9’ may comprise a chemical comprising an alkali salt. ‘9’ may comprise a |
| | chemical comprising an alkali sulfate. ‘9’ may comprise a chemical comprising |
| | sodium sulfate. In some embodiments, for example, ‘9’ may comprise a solution |
| | comprising sodium sulfate, or a solid comprising sodium sulfate, or any |
| | combination thereof. |
| 10 | ‘10’ may comprise a reactor, or mixer, or separator, or any combination thereof. |
| | ‘10’ may comprise reacting a chemical comprising an alkaline earth + weak acid |
| | with a chemical comprising an alkali sulfate to form at portion of a chemical |
| | comprising an alkaline earth sulfate and a portion of a chemical comprising an |
| | alkali + weak acid. In some embodiments, for example, ‘10’ may comprise |
| | reacting a solution comprising calcium acetate with a solid or solution |
| | comprising sodium sulfate to form at portion of a solid comprising calcium |
| | sulfate and a portion of a solution comprising sodium acetate. In some |
| | embodiments, it may be desirable to employ systems or methods to promote the |
| | reaction, or optimize calcium sulfate particle size, or optimize calcium sulfate |
| | separation, or any combination thereof. In some embodiments, at least a portion |
| | of a chemical comprising calcium sulfate may be separated from at least a |
| | portion of a solution comprising sodium acetate. |
| 11 | ‘11’ may comprise an alkaline earth sulfate. ‘11’ may comprise a chemical |
| | comprising calcium sulfate. In some embodiments, a chemical comprising |
| | calcium sulfate may be treated, or further treated, or purified, or may undergo |
| | additional purification, or may undergo additional purification to remove or |
| | recover residual chemicals or impurities, or any combination thereof. |
| 12 | ‘12’ may comprise an alkali + weak acid. In some embodiments, ‘12’ may |
| | comprise a solution comprising an alkali carboxylate. In some embodiments, |
| | ‘12’ may comprise a solution comprising sodium acetate. |
| 13 | ‘13’ may comprise a mixer. In some embodiments, for example, ‘13’ may mix a |
| | solution comprising an alkali carboxylate, such as sodium acetate, with water to |
| | form a lower concentration solution comprising sodium acetate. In some |
| | embodiments, recovered streams comprising water and/or comprising sodium |
| | acetate may be transferred to or mixed in ‘13’ and/or may comprise other |
| | chemicals, such as, for example, carbon dioxide, or sodium bicarbonate, or |
| | acetic acid, or potential impurities, or any combination thereof. |
| 14 | ‘14’ may comprise a chemical comprising an alkali carboxylate. In some |
| | embodiments, ‘14’ may comprise a solution comprising an alkali carboxylate, |
| | such as sodium acetate. In some embodiments, it may be desirable for the |
| | solution to have a sufficiently low concentration of alkali to enable CO₂ to |
| | sufficiently or desirably lower the pH, for example, in later steps. In some |
| | embodiments, for example, it may be desirable for the solution to have a |
| | sufficiently low concentration to enable CO₂ to sufficiently influence the pH to, |
| | for example, enable the separation of at least a portion of acetic acid species |
| | and/or the formation of at least a portion of a salt comprising sodium + carbon |
| | dioxide anion or carbon dioxide derivative. |
| 15 | ‘15’ may comprise an acid, or acid gas. ‘15’ may comprise an acid, or acid gas |
| | comprising, for example, carbon dioxide. In some embodiments, it may be |
| | desirable for ‘15’ to be at a sufficient pressure, or sufficient partial pressure, or |
| | any combination thereof to, for example, enable the dissolution of sufficient |
| | carbon dioxide to, for example, sufficiently lower the solution pH to enable the |
| | separation of at least a portion of carboxylate species from at least a portion of |
| | alkali species. |
| 16 | ‘16’ may comprise a mixer or reactor. ‘16’ may comprise a mixer or reactor for |
| | dissolving a portion of an acid or acid gas, such as carbon dioxide. ‘16’ may |
| | comprise a mixer or reactor for dissolving a portion of an acid or acid gas, such |
| | as carbon dioxide, and/or may be pressurized. ‘16’ may comprise a mixer or |
| | reactor for dissolving a portion of an acid or acid gas, such as carbon dioxide, in |
| | a solution comprising alkali carboxylate. In some embodiments, it may be |
| | desirable for ‘16’ to employ a pH measurement to monitor the pH and/or may |
| | ensure the pH of the formed solution may be sufficiently low to enable |
| | separation with a membrane or membrane based process. |
| 17 | ‘17’ may comprise a solution comprising an alkali carboxylate and/or an acid, |
| | which may be rich in dissolved acid gas or dissolved acid. In some |
| | embodiments, it may be desirable for the solution to have a sufficiently low pH. |
| | In some embodiments, it may be desirable for the solution to have a sufficiently |
| | low pH to, for example, enable the separation of at least a portion of carboxylic |
| | acid species and/or the formation of at least a portion of a salt comprising |
| | alkali + acid gas anion or acid gas derivative. In some embodiments, it may be |
| | desirable for the solution to have a sufficiently low pH to, for example, enable |
| | the separation of at least a portion of carboxylic acid species and/or the |
| | formation of at least a portion of a salt comprising sodium + carbon dioxide |
| | anion or carbon dioxide derivative. |
| 18 | ‘18’ may comprise a separation method, or a membrane based separation |
| | method, or any combination thereof. In some embodiments, ‘18’ may comprise |
| | reverse osmosis, or nanofiltration, or electrodialysis, or any combination thereof. |
| | In some embodiments, ‘18’ may involve separating at least a portion of |
| | carboxylic acid species from at least a portion of alkali species. In some |
| | embodiments, ‘18’ may involve retaining at least a portion of alkali species, |
| | while allowing the permeation of at least a portion of carboxylic acid species, or |
| | acid gas species, or any combination thereof. In some embodiments, ‘18’ may |
| | involve retaining at least a portion of sodium species, while allowing the |
| | permeation of at least a portion of acetic acid species, or carbon dioxide species, |
| | or any combination thereof. |
| 19 | ‘19’ may comprise a solution comprising carboxylic acid, or acid gas, or any |
| | combination thereof. In some embodiments, ‘19’ may comprise a solution |
| | comprising acetic acid, or carbon dioxide, or any combination thereof. In some |
| | embodiments, ‘19’ may comprise a solution comprising a molar ratio of |
| | carboxylic acid species to alkali greater than the molar ratio of carboxylic acid |
| | species to alkali species in ‘17’ or ‘22’. In some embodiments, ‘19’ may |
| | comprise a solution comprising a molar ratio of acetic acid species to alkali |
| | species greater than the molar ratio of acetic acid species to alkali species in ‘17’ |
| | or ‘22’. In some embodiments, the permeate may comprise a solution |
| | comprising a molar ratio of acetic acid species to alkali species greater than the |
| | molar ratio of acetic acid species to alkali species in the feed or the retentate. In |
| | some embodiments, ‘22’ may comprise a retentate. In some embodiments, it |
| | may be desirable for ‘19’ to comprise at a molar ratio of carboxylic acid species |
| | to alkali species of greater than 1 or greater than 1:1, respectively. In some |
| | embodiments, it may be desirable for the permeate to comprise at a molar ratio |
| | of acetic acid species to sodium species of greater than 1 or greater than 1:1, |
| | respectively. |
| 20 | ‘20’ may comprise a method for separation at least a portion of acid gas from a |
| | solution. ‘20’ may comprise a method for removing or recovering a portion of an |
| | acid gas from a solution comprising carboxylic acid and acid gas. ‘20’ may |
| | comprise a method for removing or recovering a portion of a fluid comprising |
| | carbon dioxide from a solution comprising acetic acid and carbon dioxide. ‘20’ |
| | may comprise a method for separation at least a portion of carbon dioxide from a |
| | solution. ‘20’ may comprise a method for separating a portion of a dissolved |
| | gas, such as by reducing the pressure. ‘20’ may comprise a method for |
| | separating a portion of dissolved carbon dioxide, such as by reducing the |
| | pressure. ‘20’ may comprise separating or recovering a portion of carbon |
| | dioxide from a solution comprising a carboxylic acid and carbon dioxide. ‘20’ |
| | may comprise separating or recovering a portion of carbon dioxide from a |
| | solution comprising an acetic acid and carbon dioxide. In some embodiments, |
| | ‘20’ may recover at least a portion of energy, or power, or pressure, or any |
| | combination thereof from the depressurization. In some embodiments, for |
| | example, at least a portion of energy, or power, or pressure, or any combination |
| | thereof may be extracted from, for example, including, but not limited to, one or |
| | more or any combination of the following: the solution, such as ‘19’, or from the |
| | gas phase, or from volume expansion, or from a pressurized stream described |
| | herein, or any combination thereof. In some embodiments, for example, at least |
| | a portion of energy, or power, or pressure, or any combination thereof may be |
| | extracted using, for example, one or more or any combination of the following: a |
| | pressure exchanger, or a turbocharger, or an expansion turbine, or a PX pressure |
| | exchanger, or a turbocharger pressure exchanger, or a turbine, or a hydroturbine, |
| | or a pneumatic turbine, or an expansion turbine, or a system or method described |
| | herein, or an energy recovery system or method described in the art. In some |
| | embodiments, at least a portion of pressure or power recovered may be |
| | transferred to a compressor, or a pump, or a generator, or power consuming |
| | component, or any combination thereof. |
| 21 | ‘21’ may comprise an acid gas. ‘21’ may comprise a portion of separated or |
| | recovered acid gas. ‘21’ may comprise a portion of separated or recovered |
| | carbon dioxide. |
| 22 | ‘22’ may comprise a solution comprising alkali carboxylate, or alkali acid anion, |
| | or acid species, or carboxylic acid species, or acid species, or any combination |
| | thereof. ‘22’ may comprise a solution comprising sodium, or acetic acid, or |
| | carbon dioxide, or derivatives thereof, or any combination thereof. ‘22’ may |
| | comprise a retentate or concentrate. ‘22’ may comprise a solution comprising a |
| | higher molar ratio of alkali to carboxylic acid species than ‘17’ or ‘19’. ‘22’ may |
| | comprise a solution comprising a higher molar ratio of sodium to acetic acid |
| | species than ‘17’ or ‘19’. In some embodiments, the retentate may comprise a |
| | solution comprising a molar ratio of alkali species to acetic acid species greater |
| | than the molar ratio of alkali species to acetic acid species in the feed or the |
| | permeate. In some embodiments, ‘22’ may comprise a retentate. In some |
| | embodiments, it may be desirable for ‘22’ to comprise at a molar ratio of alkali |
| | species to carboxylic acid species of greater than 1 or greater than 1:1, |
| | respectively. In some embodiments, it may be desirable for the retentate to |
| | comprise at a molar ratio of alkali species to carboxylic acid species of greater |
| | than 1 or greater than 1:1, respectively. In some embodiments, it may be |
| | desirable for ‘22’ to comprise at a molar ratio of sodium species to acetic acid |
| | species of greater than 1 or greater than 1:1, respectively. |
| 23 | ‘23’ may comprise a method for separation at least a portion of acid gas from a |
| | solution. ‘23’ may comprise a method for separation at least a portion of carbon |
| | dioxide from a solution. ‘23’ may comprise a method for separating a portion of |
| | a dissolved gas, such as by reducing the pressure. ‘23’ may comprise a method |
| | for separating a portion of dissolved carbon dioxide, such as by reducing the |
| | pressure. ‘23’ may comprise separating or recovering a portion of carbon |
| | dioxide from a solution comprising a carboxylic acid and carbon dioxide. ‘23’ |
| | may comprise separating or recovering a portion of carbon dioxide from a |
| | solution comprising acetic acid and carbon dioxide. |
| 24 | ‘24’ may comprise an acid gas. ‘24’ may comprise a portion of separated or |
| | recovered acid gas. ‘24’ may comprise a portion of separated or recovered |
| | carbon dioxide. |
| 25 | ‘25’ may comprise an acid. ‘25’ may comprise an acid gas. ‘25’ may comprise |
| | an acid gas input. ‘25’ may comprise carbon dioxide. ‘25’ may comprise an |
| | input carbon dioxide, or a recovered carbon dioxide, or a captured carbon |
| | dioxide, or a separated carbon dioxide, or a recirculated carbon dioxide, or a |
| | feed carbon dioxide, or emissions carbon dioxide, or flue gas carbon dioxide, or |
| | flue gas, or air, or air carbon dioxide, or any combination thereof. ‘25’ may |
| | comprise a gas comprising carbon dioxide. ‘25’ may comprise a fluid |
| | comprising carbon dioxide. ‘25’ may comprise a solid comprising carbon |
| | dioxide. |
| 26 | ‘26’ may comprise a method for transferring or feeding acid, or an acid gas, or |
| | any combination thereof. ‘26’ may comprise a gas or fluid feeding method. ‘26’ |
| | may comprise a gas stream treater, or a gas stream combiner, or a gas |
| | distribution unit, or a fluid distribution unit, or a delivery mechanism, or a |
| | compressor, or any combination thereof. ‘26’ may comprise a compressor. In |
| | some embodiments, ‘26’ may comprise a compressor to compress at least a |
| | portion of a fluid comprising an acid gas, such as carbon dioxide, to a pressure |
| | sufficient or to a desirable pressure, to, for example, dissolve in a solution, in, |
| | for example, ‘16’. |
| 27 | ‘27’ may comprise a solution comprising an alkali, or acid species, or carboxylic |
| | acid species, or any combination thereof. In some embodiments, ‘27’ may |
| | comprise a solution comprising sodium bicarbonate, or sodium acetate, or any |
| | combination thereof. |
| 28 | ‘28’ may comprise one or more or any combination of separation methods. ‘28’ |
| | may comprise a method for separating a portion of a chemical comprising alkali |
| | acid species from a chemical comprising alkali carboxylic acid species. ‘28’ may |
| | comprise a method for separation a portion of a chemical comprising sodium |
| | bicarbonate, or sodium carbonate, or any combination thereof from a portion of |
| | a chemical comprising sodium acetate. In some embodiments, ‘28’ may |
| | comprise method(s) for concentrating, or cooling, or other mechanism, or any |
| | combination thereof which may enable the separation of separation a portion of |
| | a chemical comprising sodium bicarbonate, or sodium carbonate, or any |
| | combination thereof from a portion of a chemical comprising sodium acetate. |
| | For example, in some embodiments, ‘28’ may comprise reverse osmosis or |
| | nanofiltration or osmotically assisted reverse osmosis, or forward osmosis, or |
| | any combination thereof to concentrate at least a portion of the solute and/or |
| | form a portion of water. For example, some embodiments may employ the |
| | significantly lower solubility of a chemical comprising sodium bicarbonate, or |
| | sodium carbonate, or any combination thereof compared to a chemical |
| | comprising sodium acetate to, for example, enable or facilitate the separate of a |
| | portion of a chemical comprising sodium bicarbonate, or sodium carbonate, or |
| | any combination thereof from a portion of a chemical comprising sodium |
| | acetate. For example, ‘28’ may comprise a crystallizer, which may separate at |
| | least a portion of a chemical comprising sodium bicarbonate, or sodium |
| | carbonate, or any combination thereof as a solid. In some embodiments, a |
| | portion of acid gas, such as carbon dioxide gas, may be recovered, or generated, |
| | or captured, or any combination thereof in ‘28’. |
| 29 | ‘29’ may comprise a solution comprising water. ‘29’ may comprise a solution |
| | comprising water, or acid gas, or carboxylic acid, or any combination thereof. |
| 30 | ‘30’ may comprise a solution comprising an alkali carboxylate. ‘30’ may |
| | comprise a solution comprising sodium acetate. In some embodiments. ‘30’ may |
| | comprise a relatively concentrated solution, or solid, or any combination thereof |
| | comprising an alkali carboxylate, such as sodium acetate. ‘30’ may comprise a |
| | relatively concentrated solution, or solid, or any combination thereof comprising |
| | an alkali carboxylate, such as sodium acetate, which may have been |
| | concentrated and/or separated in ‘28’. ‘30’ may comprise a solution comprising |
| | sodium acetate, which may comprise residual acid gas species, such as residual |
| | carbon dioxide species. |
| 31 | ‘31’ may comprise an output comprising alkali acid species, or alkali hydroxide, |
| | or any combination thereof. ‘31’ may comprise an output comprising alkali |
| | bicarbonate, or alkali carbonate, or alkali hydroxide, or any combination thereof. |
| | ‘31’ may comprise an output comprising sodium bicarbonate, or sodium |
| | carbonate, or sodium hydroxide, or any combination thereof. ‘31’ may comprise |
| | an output comprising sodium bicarbonate, or sodium carbonate, or any |
| | combination thereof. In some embodiments, an alkali bicarbonate, or carbonate, |
| | or any combination thereof may be further processed to produce other |
| | chemicals, which may include, but are not limited to, one or more or any |
| | combination of the following: hydroxides, or surfactants, or other derivatives, or |
| | carbon dioxide, or captured carbon dioxide, or a derivative, or any combination |
| | thereof. In some embodiments, ‘31’ may be treated, or may be treated to remove |
| | or recover a portion of chemicals or reagents, or may be treated to remove or |
| | recover a portion of residual chemicals or reagents, or may be treated to remove |
| | a portion of impurities, or any combination thereof. |
| 32 | ‘32’ may comprise a one or more or any combination of methods for |
| | concentrating a first solution while diluting a second solution, or transferring |
| | water or solvent from a first solution to a second solution, or concentrating a |
| | solution while diluting another solution, or transferred water or solvent from a |
| | solution to another solution, or any combination thereof. ‘32’ may comprise, for |
| | example, a method for transferring water or solvent from a lower osmotic |
| | pressure solution to a higher osmotic pressure solution. In some embodiments, |
| | for example, ‘32’ may comprise forward osmosis, or osmotically assisted |
| | reverse osmosis, or reverse osmosis, or nanofiltration, or electrodialysis, or |
| | membrane-based process, or any combination thereof. In some embodiments, for |
| | example, ‘32’ may comprise a method for concentrating or increasing the |
| | concentration of a solute comprising an alkaline earth carboxylate, such as |
| | calcium acetate, while decreasing the concentration or diluting the concentration |
| | of a solute comprising an alkali carboxylate, such as sodium acetate. In some |
| | embodiments, for example, ‘32’ may comprise a method for reducing the energy |
| | consumption, or reducing the CAPEX, or increasing energy efficiency, or |
| | increasing simplicity, or any combination thereof involving utilizing the higher |
| | osmotic pressure of a solution comprising concentrated alkali carboxylate, such |
| | as concentrated sodium acetate, to facilitate the concentrating of a lower osmotic |
| | pressure solution comprising alkaline earth carboxylate, such as calcium acetate, |
| | and/or dilute the higher osmotic pressure of a solution comprising concentrated |
| | alkali carboxylate. For example, in some embodiments, a relatively dilute |
| | solution comprising an alkaline earth carboxylate, such as calcium acetate, may |
| | need to be concentrated, while a relatively concentrated solution comprising an |
| | alkali carboxylate, such as sodium acetate, may need to be diluted, which may |
| | enable potentially energy efficient transfer of at a portion of water from the |
| | relatively dilute solution to the relatively concentrated solution. For example, in |
| | some embodiments, a relatively dilute solution comprising an alkaline earth |
| | carboxylate, such as calcium acetate, may be transferred into a forward osmosis, |
| | or osmotically assisted reverse osmosis, or any combination thereof process as a |
| | feed solution and/or a relatively concentrated solution comprising an alkali |
| | carboxylate, such as sodium acetate may be transferred into the forward |
| | osmosis, or osmotically assisted reverse osmosis, or any combination thereof |
| | process as a draw solution, for example, wherein, water may move or transfer or |
| | permeate a membrane from the alkaline earth carboxylate solution to the alkali |
| | carboxylate solution. For example, in some embodiments, a countercurrent flow |
| | may be employed, for example, wherein the relatively concentrated solution |
| | comprising alkali carboxylate may enter a membrane stage at a first end, and the |
| | relatively dilute solution comprising alkaline earth carboxylate may enter the |
| | membrane stage at a second end, which may be the opposite end, and/or a |
| | portion of water or solvent may transfer or permeate from the solution |
| | comprising alkaline earth carboxylate to the solution comprising alkali |
| | carboxylate, concentrating the solution comprising alkaline earth carboxylate |
| | and diluting the solution comprising alkali carboxylate, and/or, for example, the |
| | solution comprising alkaline earth carboxylate may exit the first end of the |
| | membrane stage as a relatively concentrated solution and/or, for example, the |
| | solution comprising alkali carboxylate may exit the second end of the membrane |
| | stage as a relatively dilute solution. |
| 33 | ‘33’ may comprise a relatively concentrated solution comprising an alkaline |
| | earth carboxylate. ‘33’ may comprise a relatively concentrated solution |
| | comprising an alkaline earth carboxylate, such as calcium acetate. ‘33’ may |
| | comprise a solution with a concentration greater than the concentration of ‘5’. In |
| | some embodiments, for example, ‘33’ may comprise a solution comprising |
| | calcium acetate comprising a sufficient concentration to enable the precipitation |
| | of a portion of a solid comprising calcium sulfate in, for example, ‘10’. |
| 34 | ‘34’ may comprise a relatively concentrated solution comprising an alkali |
| | carboxylate. In some embodiments, ‘34’ may comprise a solution comprising an |
| | alkali carboxylate which may have been separated from a portion of an alkaline |
| | earth sulfate and/or formed in a reaction in ‘10’. In some embodiments, for |
| | example, ‘34’ may be mixed with ‘30’. In some embodiments, for example, ‘34’ |
| | or ‘35’ may be further treated or purified to remove, for example, a portion of |
| | any impurities, or to remove, for example, a portion of any sulfates, or may be |
| | treated with antiscalants, or any combination thereof |
| 35 | ‘35’ may comprise a relatively diluted solution comprising an alkali carboxylate. |
| | In some embodiments, ‘35’ may comprise a relatively diluted solution |
| | comprising an alkali carboxylate which may have been formed by, for example, |
| | forward osmosis, or osmotically assisted reverse osmosis, or reverse osmosis, or |
| | nanofiltration, or a membrane based process, or any combination thereof. |
| 36 | ‘36’ may comprise a mixer. In some embodiments, ‘36’ may combine or mix |
| | solutions, or water, or chemicals, or solids, or fluids, or any combination thereof. |
| 37 | ‘37’ may comprise a solution comprising carboxylic acid and/or acid gas. In |
| | some embodiments, ‘37’ may comprise a permeate, or dilute, or any |
| | combination thereof. In some embodiments, ‘37’ may comprise a solution |
| | comprising acetic acid and carbon dioxide. In some embodiments. ‘37’ may |
| | comprise a relatively pressurized solution, or a solution comprising a relatively |
| | high concentration of carbon dioxide, or a solution comprising a relatively high |
| | partial pressure of carbon dioxide. In some embodiments, ‘37’ may comprise the |
| | permeate from separating in ‘18’. In some embodiments, ‘37’ may comprise the |
| | permeate from separating from an alkali. |
| 38 | ‘38’ may comprise an alkaline earth. ‘38’ may comprise an alkaline earth + |
| | weak acid. ‘38’ may comprise calcium carbonate. ‘38’ may comprise calcium. In |
| | some embodiments, it may be desirable for ‘38’ to be pressurized. In some |
| | embodiments, it may be desirable for ‘38’ to be pressurized, or placed in a |
| | pressurized vessel, or any combination thereof. In some embodiments, it may be |
| | desirable for ‘38’ to be pressurized to a pressure near the pressure of ‘39’, for |
| | example, prior to or during the addition of ‘38’ to ‘39’. In some embodiments, a |
| | solid comprising an alkaline earth may be mixed with a liquid and/or the |
| | combined mixture or fluid may be pressurized prior to transfer into ‘39’. In some |
| | embodiments, it may be desirable for the amount of alkaline earth added, or the |
| | amount of alkaline earth capable of reacting, or any combination thereof to be |
| | in, or about, or near stoichiometric proportion to the amount of carboxylic acid, |
| | such as acetic acid. In some embodiments, it may be desirable for the amount of |
| | alkaline earth added, or the amount of alkaline earth capable of reacting, or any |
| | combination thereof to be in, or about, or near stoichiometric proportion to the |
| | amount of carboxylic acid, such as acetic acid, such as the amount of carboxylic |
| | acid, such as acetic acid, in ‘37’. In some embodiments, for example, the |
| | presence of acid gas, such as carbon dioxide, in ‘37’ may facilitate the |
| | dissolution and/or reaction of alkaline earth, such as calcium. In some |
| | embodiments, for example, the presence of acid gas, such as carbon dioxide, in |
| | ‘37’ may facilitate the dissolution and/or reaction of alkaline earth, such as |
| | calcium, by, for example, lowering the pH and/or improving the reaction |
| | kinetics. In some embodiments, for example, the presence of acid gas, such as |
| | carbon dioxide, in ‘37’ may facilitate the dissolution and/or reaction of alkaline |
| | earth, such as calcium, and/or it may be desirable for the alkaline earth added, or |
| | reactable alkaline earth added, to be in or near stoichiometric proportion to the |
| | carboxylic acid, such as acetic acid, to, for example, prevent excess dissolution |
| | of alkaline earth which may precipitate or crystallize or desolubilize in the event |
| | the concentration of carbon dioxide is reduced, or the solution is depressurized, |
| | or any combination thereof. In some embodiments, the presence of dissolved |
| | carbon dioxide may facilitate the reaction and/or dissolution of alkaline earth, |
| | such as calcium, while the presence of carboxylic acid, such as acetic acid, may |
| | prevent the alkaline earth from precipitating or scaling or crystallizing, for |
| | example, if/when including, but not limited to, one or more or any combination |
| | of the following: the solution may be depressurized, or a portion of acid gas, |
| | such as carbon dioxide, may be removed from solution, or if/when the |
| | concentration of acid gas, such as carbon dioxide, may be reduced or decreased. |
| 39 | ‘39’ may comprise a reactor, or mixer, or any combination thereof. ‘39’ may |
| | comprise a reactor, or mixer, or any combination thereof to, for example, |
| | reactor, or dissolve, or any combination thereof a chemical comprising an |
| | alkaline earth. ‘39’ may comprise a reactor, or mixer, or any combination |
| | thereof to, for example, react, or dissolve, or any combination thereof a solid |
| | comprising an alkaline earth. ‘39’ may comprise a reactor, or mixer, or any |
| | combination thereof to, for example, react, or dissolve, or any combination |
| | thereof a solid comprising an alkaline earth weak acid anion with a solution |
| | comprising a carboxylic acid, or acid gas, or any combination thereof. In some |
| | embodiments, weak acid anion may comprise the anion of an acid gas. ‘39’ may |
| | comprise a reactor, or mixer, or any combination thereof to react a solid |
| | comprising calcium carbonate in with a solution comprising acetic acid, or |
| | carbon dioxide, or any combination thereof to form, for example, a solution |
| | comprising calcium acetate, or carbon dioxide, or acetic acid species, or carbon |
| | dioxide species, or calcium species, or any combination thereof. In some |
| | embodiments, for example, it may be desirable for the reactor or mixer to be |
| | pressurized or maintained at a sufficient pressure to enable a relatively high |
| | concentration of carbon dioxide, which may, for example, enable a lower pH |
| | and/or accelerate the dissolution of calcium or the reaction kinetics. In some |
| | embodiments, for example, the presence of carbon dioxide in solution may |
| | facilitate or act as a catalyst to facilitate the dissolution of calcium and/or |
| | reaction with carboxylic acid, such as acetic acid. In some embodiments, for |
| | example, it may be desirable for the product from the reaction comprising |
| | carbon dioxide to at least partially remain dissolved in solution. In some |
| | embodiments, the relatively high concentration of dissolved carbon dioxide, |
| | which may comprise residual dissolved carbon dioxide in a permeate or dilute, |
| | may greatly accelerate the dissolution of alkaline earth, such as calcium |
| | carbonate, and/or may enable smaller reactors, or faster throughput, or faster |
| | reaction time with carboxylic acid, or any combination thereof. In some |
| | embodiments, it may be desirable for the alkaline earth, such as ‘38’, to be |
| | added under positive pressure conditions, for example, to prevent loss of |
| | pressure, or to prevent or minimize release of carbon dioxide, or any |
| | combination thereof. In some embodiments, a reactor or mixer may employ |
| | systems and/or methods for recovering or removing impurities, which may be |
| | present, for example, in the alkaline earth or ‘38’, or may be present due to other |
| | streams, or any combination thereof. In some embodiments, it may be desirable |
| | for the amount of alkaline earth, or reactable alkaline earth, or any combination |
| | thereof, added or mixed to be in desired proportions to carboxylic acid. In some |
| | embodiments, for example, it may be desirable for calcium added or reacted to |
| | be in stoichiometric proportion to the amount of acetic acid to, for example, |
| | prevent potentially undesirable scaling or precipitation of calcium in, for |
| | example, steps which may involve removing or recovering a portion of carbon |
| | dioxide. In some embodiments, for example, residual solids, or residual |
| | unreacted solids, or solids, or solids comprising impurities, or any combination |
| | thereof may form or may be present and/or may be separated. |
| 40 | ‘40’ may comprise a solution comprising alkaline earth, or carboxylic acid |
| | species, or acid gas species, or any combination thereof. ‘40’ may comprise a |
| | solution comprising calcium, or acetic acid species, or carbon dioxide species, or |
| | any combination thereof. In some embodiments, ‘40’ may be pressurized or |
| | under pressure to enable the solubility of at least a portion of carbon dioxide. In |
| | some embodiments, ‘40’ may comprise a solution produced in a reactor or mixer |
| | with alkaline earth, such as, for example, ‘39’. In some embodiments, for |
| | example, ‘40’ may be transferred to a system and/or method for separating or |
| | recovering at least a portion of acid gas, such as ‘41’. In some embodiments, it |
| | may be desirable for the concentration of alkaline earth to be in or near |
| | stoichiometric ratio with the carboxylic acid in solution. In some embodiments, |
| | it may be desirable for the concentration of calcium to be in or near |
| | stoichiometric ratio with the acetic acid in solution. |
| 41 | ‘41’ may comprise a method for separation at least a portion of acid gas from a |
| | solution. ‘41’ may comprise a method for separation at least a portion of carbon |
| | dioxide from a solution. ‘41’ may comprise a system or method for recovering |
| | or removing a portion of acid gas from a solution comprising alkaline earth, or |
| | carboxylic acid species, or acid gas species, or any combination thereof. ‘41’ |
| | may comprise a method for separating a portion of a dissolved gas, such as by |
| | reducing the pressure. ‘41’ may comprise a method for separating a portion of |
| | dissolved carbon dioxide, such as by reducing the pressure. ‘41’ may comprise |
| | separating or recovering a portion of carbon dioxide from a solution comprising |
| | calcium, acetic acid species, and carbon dioxide species. In some embodiments, |
| | removing a portion of a carbon dioxide from a solution comprising calcium, |
| | acetic acid species, and carbon dioxide species may result in the formation of a |
| | solution comprising calcium acetate. |
| | In some embodiments, ‘41’ may recover at least a portion of energy, or power, |
| | or pressure, or any combination thereof from the depressurization. In some |
| | embodiments, for example, at least a portion of energy, or power, or pressure, or |
| | any combination thereof may be extracted from, for example, including, but not |
| | limited to, one or more or any combination of the following: the solution, such |
| | as ‘40’, or from the gas phase, or from volume expansion, or from a pressurized |
| | stream described herein, or any combination thereof. In some embodiments, for |
| | example, at least a portion of energy, or power, or pressure, or any combination |
| | thereof may be extracted using, for example, one or more or any combination of |
| | the following: a pressure exchanger, or a turbocharger, or an expansion turbine, |
| | or a PX pressure exchanger, or a turbocharger pressure exchanger, or a turbine, |
| | or a hydroturbine, or a pneumatic turbine, or an expansion turbine, or a system |
| | or method described herein, or an energy recovery system or method described |
| | in the art. In some embodiments, at least a portion of pressure or power |
| | recovered may be transferred to a compressor, or a pump, or a generator, or |
| | power consuming component, or any combination thereof. In some |
| | embodiments, a portion of acid gas, such as carbon dioxide, which may be |
| | removed or recovered may be transferred to a process step within the process |
| | and/or may comprise an intermediate. In some embodiments, a portion of acid |
| | gas, such as carbon dioxide, which may be removed or recovered may comprise |
| | a product, or byproduct, or valuable product, or any combination thereof. |
| | In some embodiments, removing or recovering at least a portion of a chemical |
| | comprising acid gas from a solution comprising alkaline earth, or carboxylic |
| | acid species, or acid gas species, or any combination thereof may result in at |
| | least a portion of the alkaline earth pairing with or reacting with a portion of the |
| | carboxylic acid, which may prevent the potential precipitation of alkaline earth |
| | during the removing or recovering at least a portion of a chemical comprising |
| | acid gas and/or may facilitate an objective of forming dissolved alkaline earth, |
| | or forming a solution comprising an alkaline earth carboxylate, or any |
| | combination thereof. |
| | In some embodiments, removing or recovering at least a portion of a chemical |
| | comprising carbon dioxide from a solution comprising calcium, or acetic acid |
| | species, or carbon dioxide species, or any combination thereof may result in at |
| | least a portion of the calcium pairing with or reacting with a portion of the acetic |
| | acid, which may prevent the potential precipitation of calcium during the |
| | removing or recovering at least a portion of a chemical comprising carbon |
| | dioxide and/or may facilitate an objective of forming dissolved calcium, or |
| | forming a solution comprising an calcium acetate, or any combination thereof. |
| 42 | ‘42’ may comprise a chemical comprising acid gas. ‘42’ may comprise a |
| | removed or recovered chemical comprising acid gas. ‘42’ may comprise a |
| | removed or recovered chemical comprising carbon dioxide. ‘42’ may comprise a |
| | fluid comprising an acid gas, such as carbon dioxide. In some embodiments, |
| | ‘42’ may comprise a chemical which may be recirculated, or used, or employed, |
| | or any combination thereof in the process, or may comprise an intermediate, or |
| | any combination thereof. In some embodiments, ‘42’ may comprise a product, |
| | or a byproduct, or a valuable product, or any combination thereof. In some |
| | embodiments, it may be desirable for a portion of ‘42’ to comprise relatively |
| | high pressure. In some embodiments, it may be desirable for a portion of ‘42’ to |
| | comprise relatively low pressure. In some embodiments, a portion of ‘42’ may |
| | comprise acid gas, such as carbon dioxide, which may have been produced as a |
| | byproduct from the reaction of alkaline earth, such as calcium carbonate, and |
| | carboxylic acid, such as acetic acid. |
| 43 | ‘43’ may comprise a solution comprising an alkaline earth. ‘43’ may comprise a |
| | solution comprising an alkaline earth carboxylate. ‘43’ may comprise a solution |
| | comprising calcium acetate. ‘43’ may comprise a solution comprising a |
| | relatively low concentration of an alkaline earth carboxylate. ‘43’ may comprise |
| | a solution comprising a relatively low concentration of alkaline earth |
| | carboxylate. In some embodiments, for example, the concentration of alkaline |
| | earth carboxylate in ‘43’ may be lower than the concentration of alkaline earth |
| | carboxylate in ‘33’. In some embodiments, ‘43’ may comprise a portion of an |
| | acid gas. In some embodiments, ‘43’ may comprise a portion of residual acid |
| | gas. In some embodiments, ‘43’ may comprise a portion of residual carbon |
| | dioxide. In some embodiments, ‘43’ may be similar to ‘5’. |
| 44 | ‘44’ may comprise an acid gas. In some embodiments, ‘44’ may be similar to, |
| | for example, ‘42’. |

### FIG. 3A-D, 9A-D, 10A, 10B Example Key

### Example Flow Stream Compositions and Conditions

FIG. 3A-D, 9A-D, 10A, 10B Example Key
(Example Flow Stream Compositions and Conditions)

| ID | Example Flow Stream Compositions and Example Conditions |
|---|---|
| 1 | |
| 2 | |
| 3 | |
| 4 | |
| 5 | |
| 6 | |
| 7 | |
| 8 | |
| 9 | |
| 10 | |
| 11 | |
| 12 | |
| 13 | |
| 14 | 0.05M sodium acetate, 15° C. |
| 15 | 20-50 Bar carbon dioxide |
| 16 | |
| 17 | 0.05M Na, 0.05M Acetic Acid Species, 0.5-3M Carbon Dioxide |
| | Species, pH of 4 to 5 |
| 18 | |
| 19 | 0.05M Acetic Acid Species, 0.5-3M Carbon Dioxide Species to, |
| | for example, 0.15M Acetic Acid Species, 0.5-3M Carbon Dioxide |
| | Species |
| 20 | |
| 21 | |
| 22 | 0.25M Na, 0.05M Acetic Acid Species, 1-3M Carbon Dioxide |
| | Species |
| 23 | |
| 24 | |
| 25 | |
| 26 | |
| 27 | |
| 28 | 0.20M sodium bicarbonate, 0.05 molar sodium acetate |
| 29 | |
| 30 | 0.5-2M sodium acetate |
| 31 | Sodium bicarbonate solid |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |

### FIGS. 3A, 3B Example Step-by-Step Description

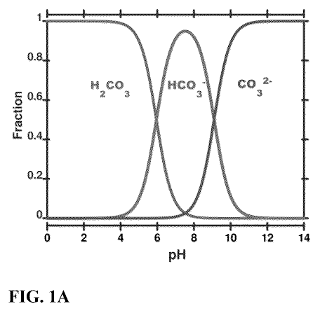

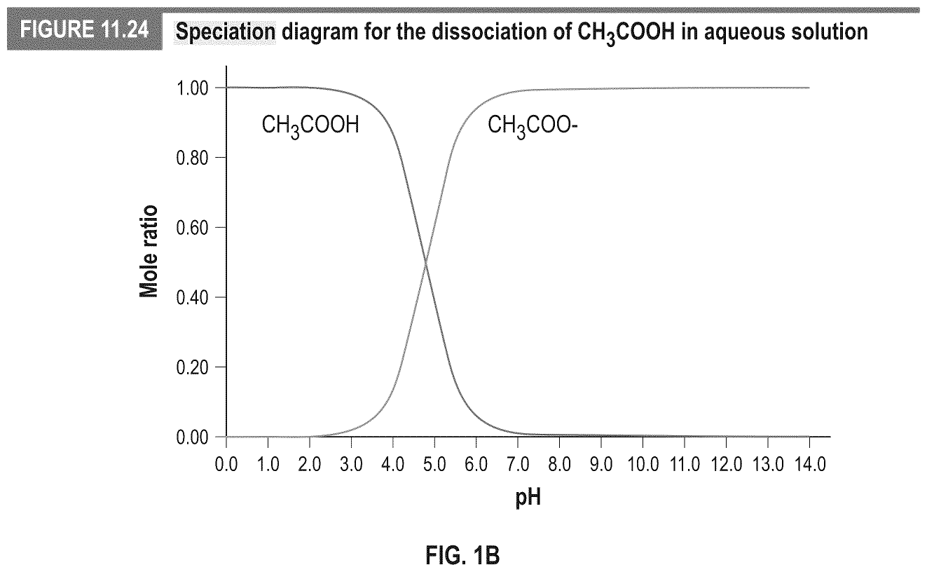

Some embodiments may comprise one or more or any combination of the following:
(1) Forming Solution Comprising Alkaline Earth Carboxylate: In some embodiments, a solution comprising a carboxylic acid may be mixed with a chemical, or material, or any combination thereof comprising an alkaline earth. In some embodiments, a solution comprising a carboxylic acid may be mixed with a chemical, or material, or any combination thereof comprising an alkaline earth, to form, for example, a portion of a solution comprising an alkaline earth carboxylate. In some embodiments, a solution comprising a carboxylic acid may be mixed with a chemical, or material, or any combination thereof comprising an alkaline earth. In some embodiments, for example, a solution comprising a carboxylic acid may be mixed with a chemical, or material, or any combination thereof comprising an alkaline earth+ weak acid, to form, for example, a portion of a solution comprising an alkaline earth carboxylate, or weak acid derivative, or any combination thereof and/or a gas or solid or fluid comprising a weak acid derivative. In some embodiments, for example, a solution comprising a carboxylic acid, such as acetic acid, may be mixed with a chemical, or material, or any combination thereof comprising an alkaline earth+ weak acid anion, such as a solid comprising calcium carbonate, to form, for example, a portion of a solution comprising an alkaline earth carboxylate, such as calcium acetate, and/or weak acid derivative, such as carbon dioxide, or any combination thereof and/or a gas or solid or fluid comprising a weak acid derivative. In some embodiments, for example, a solution comprising acetic acid may be reacted with a solid comprising calcium carbonate, to form, for example, a portion of a solution comprising calcium acetate, or carbon dioxide, or any combination thereof, and/or a gas comprising carbon dioxide. In some embodiments, a portion of the solution comprising carboxylic acid, such as the solution comprising acetic acid, may comprise aa portion of carboxylic acid separated from a portion of a solution comprising an alkali, such as a solution comprising sodium, or acetic acid species, or carbon dioxide species, or any combination thereof. In some embodiments, a solution comprising carboxylic acid, such as acetic acid, may comprise a portion of makeup carboxylic acid, or fresh carboxylic acid, or any combination thereof. In some embodiments, a solution comprising carboxylic acid, such as acetic acid, may comprise residual carbon dioxide or residual dissolved carbon dioxide. In some embodiments, a solution comprising acetic acid may comprise residual carbon dioxide, or a portion of dissolved carbon dioxide, which may comprise a carryover or residual of a portion of carbon dioxide from other process steps. In some embodiments, a solution comprising acetic acid may comprise residual carbon dioxide, or a portion of dissolved carbon dioxide, which may be beneficial in, for example, reducing pH and/or facilitating the dissolution of the calcium and/or facilitating the formation of a solution comprising calcium acetate. In some embodiments, for example, the concentration of acetic acid may be less than or greater than or equal to, including, but not limited to, one or more or any combination of the following: 0.0001M, or 0.0005M, or 0.001M, or 0.005M, or 0.01M, or 0.025M, or 0.05M, or 0.0M, or 0.125M, or 0.15M, or 0.175M, or 0.20M, or 0.25M, or 0.35M, or 0.50M, or 0.75M, or 1.00M, or 1.5M, or 2.0M, or 2.5M, or 3M, or 3.5M, or 4M, or 4.5M, or 5M, or 6M, or 7M, or 8M, or 9M, or 10M. In some embodiments, for example the concentration of acetic acid may be relatively dilute and/or it may be desirable to configure the reaction to facilitate a longer residence time, such as, for example, a large volume mixing vessel, or large volume reactor, or smaller calcium carbonate particle size, or any combination thereof. Some embodiments may employ various configurations, which may include, but are not limited to, one or more or any combination of the following: continuous, or semi-batch, or batch, or any combination thereof. In some embodiments, a portion of dissolved carbon dioxide may be present in the solution comprising alkaline earth carboxylate, such as calcium carboxylate. In some embodiments, a portion of dissolved carbon dioxide may be present in the solution comprising alkaline earth carboxylate, such as calcium carboxylate, wherein a portion of the dissolved carbon dioxide may comprise carbon dioxide formed from the reaction of calcium carbonate and acetic acid. In some embodiments, the presence of dissolved carbon dioxide in the solution comprising alkaline earth carboxylate may be beneficial and/or may reduce energy consumption for CO₂ compression or CO₂ recovery. In some embodiments, a portion of carbon dioxide may be separated and/or may be recovered as a gas and/or may be, for example, transferred to CO₂ compression, or transferred to another use, or transferred within the process, or any combination thereof. In some embodiments, it may be desirable to employed depressurization, or pressure reduction, or vacuum separation, or any combination thereof to remove and/or recover at least a portion of dissolved carbon dioxide. In some embodiments, some of the chemical or material comprising alkaline earth, such as calcium carbonate, may comprise impurities. In some embodiments, it may be desirable to separate or remove or recover at least a portion of any impurities. In some embodiments, it may be desirable to remove or separate residual undissolved solids from the reactor. In some embodiments, it may be desirable to remove or separate residual undissolved solids from the reactor, which may comprise impurities.
In some embodiments, it may be desirable to employ systems and/or methods and/or configurations to accelerate or facilitate the reaction kinetics, or dissolution kinetics, or any combination thereof.
   For example, in some embodiments, depressurization or a portion of carbon dioxide removal, such as ‘Depressurization #1’ or ‘20’, may be conducted after ‘CaCO₃ Mixing’ or ‘3’, and/or the lower pH and/or high acid concentration enabled by the high dissolved CO₂ concentration may facilitate the dissolution of alkaline earth, such as calcium, and/or if/when the solution comprising dissolved calcium is at least partially depressurized and/or if/when at least a portion of CO₂ is removed or recovered, the calcium may be reacted with or paired with the acetic acid species in solution. In some embodiments, it may be desirable to add alkaline earth, such as calcium carbonate, in near stoichiometric proportion to the acetic acid to, for example, prevent the formation of calcium carbonate precipitate or calcium carbonate scaling during the recovery or removal of a portion of the dissolved CO₂, for example, during a solution depressurization.
   For example, in some embodiments, the solution comprising carboxylic acid, such as acetic acid, may be heated and/or the reaction may be heated. In some embodiments, heating or raising the temperature of the solution may facilitate or accelerate reaction kinetics. In some embodiments, heating or raising the temperature of the solution may reduce the solubility of formed and/or dissolved gases, such as carbon dioxide, and/or may facilitate the formation of a portion of gas phase carbon dioxide. In some embodiments, heat recovery may be employed. In some embodiments, heat recovery may be employed, such as, for example, a counter current heat exchange may be employed between, for example, the solution comprising carboxylic acid transferred to the reactor and/or the solution comprising alkaline earth carboxylate exiting the reactor.
   For example, some embodiments may employ mixing or agitation.
   For example, some embodiments may employ reduced calcium carbonate particle size or smaller particle size to accelerate reaction kinetics.
   For example, some embodiments may employ reaction promoters.
(2) Concentrating Solution Comprising Alkaline Earth Carboxylate: In some embodiments, a solution comprising an alkaline earth at a relatively low concentration may be concentrated to a relatively high concentration. In some embodiments, a solution comprising an alkaline earth at a relatively low concentration may be separated to form, for example, a portion of a solution comprising a relatively high concentration and/or a portion of a solution comprising a solvent. In some embodiments, a solution comprising an alkaline earth carboxylate, such as relatively low concentration of calcium acetate, at a relatively low concentration may be separated to form, for example, a portion of a solution comprising a relatively high concentration, such as a relatively high concentration of calcium acetate and/or a portion of a solution comprising a solvent, such as a solution comprising water. In some embodiments, it may be desirable for the concentration of the solution comprising a relatively high concentration of alkaline earth, such as a solution comprising a relatively high concentration of calcium acetate, to comprise a sufficient concentration to enable the formation of at least a portion of a solid comprising alkaline earth sulfate precipitate, such as a solid comprising calcium sulfate precipitate, in a reaction with an alkali sulfate. In some embodiments, separating, or concentrating, or any combination thereof may comprise, including, but not limited to, one or more or any combination of the following: reverse osmosis, or nanofiltration, or osmotically assisted reverse osmosis, or osmotically assisted nanofiltration, or forward osmosis, or distillation, or MVC, or MVR, or MSF, or MED, or vacuum distillation, or heat recovery distillation, or freeze desalination, or a separation method described herein, or a separation method known in the art, or any combination thereof. For example, in some embodiments, a solution comprising a relatively low concentration comprising calcium acetate may be concentrated using reverse osmosis. For example, in some embodiments, a solution comprising a relatively low concentration comprising calcium acetate may be concentrated in stages, for example, first concentrated using reverse osmosis, then the retentate formed may be further concentrated using, for example, osmotically assisted reverse osmosis, or multi-effect distillation (MED), or mechanical vapor compression distillation (MVC), or a separation method described herein, or a separation method known in the art, or any combination thereof. For example, in some embodiments, it may be desirable to utilize the potential desire to dilute a solution comprising a relatively high concentration solution comprising an alkali with the need to concentrate a solution comprising a relatively dilute concentration solution comprising an alkaline earth by, for example, enabling the transfer of a portion of water or other solvent from the solution comprising alkaline earth to the solution comprising alkali, which may comprise using, for example, including, but not limited to, one or more or any combination of the following: forward osmosis, or nanofiltration, or osmotically assisted reverse osmosis, or a separation process described herein, or a separation process described herein the art.
(3) Reaction of Alkaline Earth Carboxylate with Alkali Sulfate: In some embodiments, a solution comprising a dissolved or aqueous alkaline earth may be reacted with a chemical comprising an alkali sulfate to form, for example, a portion of a chemical comprising an alkaline earth sulfate. In some embodiments, a solution comprising a dissolved or aqueous alkaline earth carboxylate may be reacted with a chemical comprising an alkali sulfate to form, for example, a portion of a chemical comprising an alkaline earth sulfate and a portion of a chemical comprising an alkali carboxylate. In some embodiments, a solution comprising a dissolved or aqueous alkaline earth carboxylate, such as calcium acetate, may be reacted with a solid, or solution, or any combination thereof comprising an alkali sulfate, such as sodium sulfate, to form, for example, a portion of a solid comprising an alkaline earth sulfate, such as calcium sulfate, and a portion of a solution comprising an alkali carboxylate, such as sodium acetate. For example, in some embodiments, it may be desirable for the reaction to be conducted in a manner or under conditions which may facilitate the separation of at least a portion of the reaction products. For example, in some embodiments, it may be desirable for the concentration of the alkaline earth, or the concentration of the alkali, or the concentration of a portion of any other potential solutes, or a mixing method, or any combination thereof to facilitate the precipitation and/or separation of, for example, at least a portion of the alkaline earth sulfate. For example, in some embodiments, it may be desirable to mix at least a portion of a chemical comprising an alkali sulfate, such as sodium sulfate, with at least a portion of a solution comprising an alkaline earth carboxylate, such as calcium acetate, and/or form at least a portion of a solid comprising alkaline earth sulfate, such as calcium sulfate, and at least a portion of a solution comprising alkali carboxylate, such as sodium acetate, and/or separate at least a portion of the solid comprising alkaline earth sulfate from at least a portion of the solution comprising an alkali carboxylate. For example, in some embodiments, a solution comprising an alkali may be at least partially separated from a solid comprising an alkaline earth using a solid-liquid separation method which may include, but is not limited to, one or more or any combination of the following: decanting, or centrifuge, or filter, or separation funnel, or settling, or gravitational separation, or particle size based separation, or density based separation, or rotating filter, or filter pressure, or a solid-liquid separation, or a separation described herein, or a separation known in the art. Some embodiments may employ reacting methods, or mixing methods, or temperatures, or conditions, or nucleation promotors, or any combination thereof to, for example, facilitate larger particle size or larger precipitate particle size which may, for example, enable separation facilitating, for example, including, but not limited to, one or more or any combination of the following: higher recovery, or higher efficiency, or lower cost, or lower energy, or more effective, or any combination thereof separation. In some embodiments, the solution comprising an alkali acetate may be purified, or further purified, or any combination thereof. For example, in some embodiments, the solution comprising an alkali acetate may be purified, or further purified, or treated, or any combination thereof using, for example, including, but not limited to, one or more or any combination of the following: nanofiltration, or ion exchange, or precipitation reaction, or removal of a portion of residual calcium sulfate, or removal of a portion of residual sulfate, or removal of a portion of residual calcium, or solubilizing or increasing the solubility of a portion of an ion, or addition of or presence of an anti-sealant. In some embodiments, a solid comprising an alkaline earth, such as a solid comprising an alkaline earth sulfate, may be treated, or purified, or any combination thereof. For example, in some embodiments, a solid comprising an alkaline earth sulfate may be rinsed to remove or recover, for example, a portion of, for example, residual reagents, or residual carboxylic acid species, or residual alkali species, or impurities, or any combination thereof. For example, in some embodiments, a solid comprising an alkaline earth sulfate may be dried or dehydrated.
(4) Diluting Solution Comprising Alkali Carboxylate: In some embodiments, a portion of a solvent may be added to a solution comprising a relatively high concentration of an alkali. In some embodiments, a portion of a solvent may be added to a solution comprising a relatively high concentration of an alkali carboxylate, such as sodium acetate. For example, in some embodiments, it may be desirable to dilute or lower the concentration of a solution comprising an alkali carboxylate, for example, to enable the solution to comprise a sufficiently low concentration for the pH of the solution to be sufficiently adjusted or reduced by an acid gas or the dissolution of an acid gas to, for example, enable the separation of at least a portion of carboxylic acid species, such as acetic acid species, from at least a portion of alkali species, such as sodium species. In some embodiments, a portion of dilution may comprise mixing water, or a solvent, or any combination thereof with a solution comprising a relatively high concentration of an alkali carboxylate, such as sodium acetate. In some embodiments, a portion of dilution may comprise employing at least a portion of the solution comprising a relatively high concentration of an alkali carboxylate, such as sodium acetate, as a draw solution and/or employing at least a portion of the solution comprising a relatively high concentration of alkaline earth carboxylate, such as calcium acetate, as a feed solution, and/or employing forward osmosis, or osmotically assisted reverse osmosis, or any combination thereof to transfer at least a portion of water from the solution comprising a feed solution to the solution comprising a draw solution. In some embodiments, at least a portion of the water employed in dilution may comprise water regenerated, or recovered, or otherwise transferred within the end-to-end process.
(5) Dissolving an Acid Gas into Solution Comprising Alkali Carboxylate: In some embodiments, an acid may be dissolved in a solution comprising an alkali carboxylate. In some embodiments, an acid may be dissolved in a solution comprising an alkali carboxylate to, for example, lower the pH. For example, in some embodiments, a chemical comprising carbon dioxide may be dissolved in a solution comprising an alkali carboxylate, such as sodium acetate, to form a solution with a lower pH comprising alkali species, or carboxylic acid species, or carbon dioxide species, or any combination thereof. In some embodiments, it may be desirable to add acid prior to step ‘6’ or Separation of a Solution Comprising Carboxylic Acid from a Solution Comprising Alkali. In some embodiments, it may be desirable to add acid during the step ‘6’ or Separation of a Solution Comprising Carboxylic Acid from a Solution Comprising Alkali. In some embodiments, it may be desirable to add acid prior to and during the step ‘6’ or Separation of a Solution Comprising Carboxylic Acid from a Solution Comprising Alkali. In some embodiments, for example, a solution comprising water, or a solution comprising solvent, or a solution comprising alkali, or a solution comprising carboxylic acid, or a solution comprising alkali carboxylate, or any combination thereof may comprise carbon dioxide. In some embodiments, for example, a gas comprising carbon dioxide may be contacted with, or dissolved in, or compressed, or mixed with, or sparged in, or any combination thereof into a solution comprising an alkali carboxylate, such as sodium acetate. In some embodiments, it may be desirable to dissolve at a portion of an acid gas, such as carbon dioxide, with a significant partial pressure, such as greater than 1 bar, or 2.5 bar, or 5 bar, or 10 bar, or 15 bar, or 20 bar, or 25 bar, or 30 bar, or 35 bar, or 40 bar, or 45 bar, or 50 bar, or a pressure described herein, or any combination thereof, for example, to enable a sufficient dissolved concentration of carbon dioxide and/or to enable a sufficiently low solution pH. In some embodiments, it may be desirable for the pH of the formed solution to comprise a pH sufficiently low for at least a portion of the carboxylic acid species to comprise non-ionic species, or potentially permeable species, or any combination thereof. In some embodiments, it may be desirable for the pH of the formed solution comprising alkali+ carboxylic acid+ carbon dioxide to comprise a pH sufficiently low for at least a portion of the carboxylic acid species to comprise non-ionic species, or potentially permeable species, or any combination thereof. For example, FIG. 1B may show the speciation of a carboxylic acid comprising acetic acid species vs. pH. For example, in some embodiments, it may be desirable for the pH of the formed solution to be less than a pH of 7, or a pH of 6.5, or a pH of 6, or a pH of 5.9, or a pH of 5.8, or a pH of 5.7, or a pH of 5.6, or a pH of 5.5, or a pH or 5.4, or a pH of 5.3, or a pH of 5.2, or a pH of 5.1, or a pH of 5.0, or a pH of 4.9, or a pH of 4.8, or a pH of 4.7, or a pH, or 4.6, or a pH of 4.5, or a pH of 4.4, or a pH of 4.3, or a pH of 4.2, or a pH of 4.1, or a pH of 4, or a pH of 3.9, or a pH described herein, or a pH known in the art, or any combination thereof. In some embodiments, it may be desirable to cool a solution to increase the solubility of an acid gas, such as carbon dioxide, or employ other methods for increasing the solubility of an acid gas, or any combination thereof.
(6) Separation of a Solution Comprising Carboxylic Acid from a Solution Comprising Alkali: In some embodiments, a solution comprising alkali species, or carboxylic acid species, or acid gas species, or any combination thereof may be at least partially separated into a solution comprising alkali species and a solution comprising carboxylic acid species. In some embodiments, a solution comprising alkali, or carboxylic acid, or acid gas, or any combination thereof may be at least partially separated into a solution comprising carboxylic acid, or acid gas, or any combination thereof, and/or a solution comprising alkali, or acid gas, or carboxylic acid species, or any combination thereof. In some embodiments, a solution comprising sodium species+ acetic acid species+ carbon dioxide species may be at least partially separated into a solution comprising sodium species, or carbon dioxide species, or acetic acid species, or any combination thereof, and/or a solution comprising acetic acid species, or carbon dioxide species, or any combination thereof a solution comprising sodium species+ acetic acid species+carbon dioxide species may be at least partially separated into a solution comprising sodium species, or carbon dioxide species, or acetic acid species, or any combination thereof, and/or a solution comprising acetic acid species, or carbon dioxide species, or any combination thereof using, for example, including, but not limited to, one or more or any combination of the following: reverse osmosis, or nanofiltration, or electrodialysis, or a semipermeable membrane, or a membrane based process, or freeze desalination, or freeze crystallization, or cryodesalination, or freeze separation, or forward osmosis, or osmotically assisted reverse osmosis, or osmotically assisted nanofiltration, or a separation described herein, or a separation known in the art, or any combination thereof. In some embodiments, for example, the pH of the solution comprising the feed solution, such as the solution comprising sodium species, or carbon dioxide species, or acetic acid species, or any combination thereof, may comprise a sufficiently low pH such that a portion of acetic acid species may comprise non-ionic or permeable species and/or at least a portion of the acetic acid species, such as non-ionic or permeable species, may permeate a semi-permeable membrane, which may comprise separating a portion of acetic acid species from a portion of sodium species. In some embodiments, a portion of species comprising acetic acid species and/or carbon dioxide species may permeate a semi-permeable membrane, while at least a portion of alkali species may be retained or rejected by the semi-permeable membrane and/or a portion of carbon dioxide may be added or dissolved or may be periodically or selectively or continuously added to the retained solution or retentate. In some embodiments, a portion of species comprising acetic acid species and/or carbon dioxide species may permeate a semi-permeable membrane, while at least a portion of alkali species may be retained or rejected by the semi-permeable membrane and/or a portion of carbon dioxide may be added or dissolved or may be periodically or selectively or continuously added to the retained solution or retentate which may enable a portion of the sodium, which may have been paired with acetic acid species, to pair with carbon dioxide species. In some embodiments, the capability to add acid gas, such as by pressurizing with carbon dioxide, and the capability to remove acid gas, such as by depressurizing a solution comprising dissolved carbon dioxide, may enable a process wherein a carboxylic acid (which may comprise a significantly lower vapor pressure than carbon dioxide), such as acetic acid, to permeate a membrane, while an acid gas, such as carbon dioxide, may be added to the feed and/or retentate and/or removed from the permeate and/or retentate, which may enable, for example, the at least partial substitution of a non-volatile or low volatile or low vapor pressure weak acid species, such as acetate or acetic acid species, with a relatively higher vapor pressure or higher volatility weak acid species, such as carbonate, or bicarbonate, or carbon dioxide species, in a dissolved salt. In some embodiments, for example, dissolved solutes comprising carbon dioxide and acetic acid may permeate a membrane, while only carbon dioxide may be replenished or added to the retained solution, which may result in a decline in the concentration, or amount, or presence, or any combination thereof of the acetic acid species in the retained solution or retentate; and/or at makeup of, or at least partial stability, or increase, or control, or adjustability, or maintenance, or less of a decline, or a stable, or increase in the concentration, or amount, or presence, or any combination thereof of the carbon dioxide species in the retained solution or retentate. In some embodiments, acetic acid may comprise an example weak acid with a relatively lower volatility, or a relatively lower vapor pressure, or any combination thereof compared to or relative to an acid gas, such as carbon dioxide. In some embodiments, it may be desirable for the weak acid or carboxylic acid to comprise a monovalent weak acid which may at least partially permeate a membrane if, for example, in an at least partially nonionic form, and/or wherein said membrane may retain or reject at least a portion of an alkali or alkaline earth species. In some embodiments, for example, it may be desirable for at least a portion of acetic acid species to permeate a membrane, while at least a portion of alkali species may be rejected by a membrane. In some embodiments, for example, a solution may be at least partially separated using electrodialysis. In some embodiments, for example, at least a portion of a feed solution comprising alkali species, or carboxylic acid species, or acid gas species, or any combination thereof may be separated using electrodialysis into at least a portion of a solution comprising carboxylic acid species, or acid gas species, or any combination thereof and a solution comprising alkali species, or carboxylic acid species, or acid gas species, or any combination thereof. In some embodiments, for example, at least a portion of a feed solution comprising alkali species, or carboxylic acid species, or acid gas species may be separated using electrodialysis into a solution comprising alkali, or carbon dioxide, or any combination thereof and/or a solution comprising alkali species, or carboxylic acid species, or acid gas species. In some embodiments, for example, a solution may be at a sufficiently low pH wherein at least a portion of acetic acid species and/or carbon dioxide species may comprise non-ionic species, while alkali species may comprise ionic species, and/or electrodialysis may at least partially separate or concentrate the ionic species, which may result in the formation of a solution comprising alkali, or carbon dioxide species, or any combination thereof. In some embodiments, it may be desirable for the electrodialysis concentrate solution to comprise at least a portion of carbon dioxide species, which may enable at least a portion of the alkali species to pair with at least a portion of the carbon dioxide species.
(7) Recovering a Portion of Acid Gas from a Solution Comprising Carboxylic Acid: In some embodiments, a portion of a gas comprising an acid gas may be at least partially separated or recovered from a solution comprising carboxylic acid. In some embodiments, a portion of a gas comprising an acid gas may be at least partially separated or recovered from a permeate, or diluate, or any combination thereof solution comprising carboxylic acid. In some embodiments, a portion of a gas comprising an acid gas, such as carbon dioxide, may be at least partially separated or recovered from a solution comprising a carboxylic acid, such as acetic acid. In some embodiments, for example, a solution comprising carboxylic acid and/or acid gas may be at least partially depressurized, or the headspace pressure may be reduced, or any combination thereof, which may result in at least a portion of dissolved acid gas, such as carbon dioxide, transitioning to a gas phase. In some embodiments, for example, a solution comprising acetic acid and/or carbon dioxide may be at least partially depressurized, or the headspace pressure may be reduced, or any combination thereof, which may result in at least a portion of dissolved carbon dioxide transitioning to a gas phase. In some embodiments, for example, it may be desirable to recover at least a portion of energy, or pressure, or any combination thereof from depressurization, using, for example, including, but not limited to, one or more or any combination of the following: energy recovery device, or pressure exchange, or PX pressure exchanger, or turbine, or turbocharger, or turbocharger pressure exchanger, or turbine pressure exchanger, or power recovery, or electric generation, or hydrogenerator, or gas turbine, or expansion turbine, or pneumatic turbine, or an energy recovery or transfer device herein, or an energy recovery or transfer device in the art. In some embodiments, for example, a solution comprising carboxylic acid solution may remain pressurized and may be transferred to a reaction with an alkaline earth to form an alkaline earth carboxylate, wherein the reaction with an alkaline earth may be conducted under pressure or with a relatively high concentration of dissolved acid gas, and/or depressurization or other acid gas separation may be conducted from the solution formed comprising alkaline earth carboxylate, such as a solution comprising calcium acetate. In some embodiments, at least a portion of acid gas may be recovered from one or more or any combination of sources within the process, or from external sources, or any combination thereof and/or may be compressed and/or transferred to or supplied to or provided to, for example, step ‘5’.
(8) Recovering a Portion of Acid Gas from a Solution Comprising Alkali: In some embodiments, a portion of a gas comprising an acid gas may be at least partially separated or recovered from a solution comprising alkali. In some embodiments, a portion of a gas comprising an acid gas may be at least partially separated or recovered from a solution comprising alkali, or acid gas, or carboxylic acid, or any combination thereof. In some embodiments, a portion of a gas comprising an acid gas may be at least partially separated or recovered from a retentate, or concentrate, or any combination thereof solution comprising alkali. In some embodiments, a portion of a gas comprising a carbon dioxide may be at least partially separated or recovered from a retentate, or concentrate, or any combination thereof solution comprising sodium species, or carbon dioxide species, or acetic acid species, or any combination thereof. In some embodiments, for example, a solution comprising an alkali, or acid gas, or carboxylic acid, or any combination thereof may be at least partially depressurized, or the headspace pressure may be reduced, or any combination thereof, which may result in at least a portion of dissolved acid gas, such as carbon dioxide, transitioning to a gas phase. In some embodiments, for example, a solution comprising sodium species, or carbon dioxide species, or acetic acid species, or any combination thereof may be at least partially depressurized, or the headspace pressure may be reduced, or any combination thereof, which may result in at least a portion of dissolved carbon dioxide transitioning to a gas phase. In some embodiments, for example, it may be desirable to recover at least a portion of energy, or pressure, or any combination thereof from depressurization, using, for example, including, but not limited to, one or more or any combination of the following: energy recovery device, or pressure exchange, or PX pressure exchanger, or turbine, or turbocharger, or turbocharger pressure exchanger, or turbine pressure exchanger, or power recovery, or electric generation, or hydrogenerator, or gas turbine, or expansion turbine, or pneumatic turbine, or an energy recovery or transfer device herein, or an energy recovery or transfer device in the art. In some embodiments, at least a portion of acid gas may be recovered from one or more or any combination of sources within the process, or from external sources, or any combination thereof and/or may be compressed and/or transferred to or supplied to or provided to, for example, step ‘5’.
(9) Concentrating and/or Separating a Portion of Alkali Bicarbonate, or Alkali Carbonate, or any Combination Thereof from a Portion of Alkali Carboxylate: In some embodiments, a solution comprising an alkali, or acid gas, or carboxylic acid, or any combination thereof may be separated into, for example, at least a portion of a solid or solution comprising an alkali cation+acid gas anion species salt and/or a solution or solid comprising an alkali cation+ carboxylic acid anion species salt. In some embodiments, a retentate, or concentrate, or any combination thereof solution comprising an alkali, or acid gas, or carboxylic acid, or any combination thereof may be separated into, for example, at least a portion of a solid or solution comprising an alkali cation+ acid gas anion species salt and/or a solution or solid comprising an alkali cation+ carboxylic acid anion species salt. In some embodiments, a solution comprising sodium, or carbon dioxide species, or acetic acid species, or any combination thereof may be separated into, for example, at least a portion of a solid or solution comprising sodium bicarbonate, or sodium sesquicarbonate, or sodium carbonate, or any combination thereof and/or a solution or solid comprising sodium acetate. In some embodiments, for example, separation may be conducted utilizing the difference in solubility between sodium bicarbonate, or sodium sesquicarbonate, or sodium carbonate, or any combination thereof and sodium acetate. In some embodiments, for example, a solution may be concentrated and/or cooled to precipitate at least a portion of sodium bicarbonate, or sodium sesquicarbonate, or sodium carbonate, or any combination thereof, and/or solid may be at least partially separated, and/or the solution may be cycled in, for example, a precipitation, or crystallization, or separation loop. In some embodiments, for example, a solution may be concentrated, using, for example, reverse osmosis, or osmotically assisted reverse osmosis, or forward osmosis, or any combination thereof, and/or cooled to precipitate at least a portion of sodium bicarbonate, or sodium sesquicarbonate, or sodium carbonate, or any combination thereof, and/or solid may be at least partially separated, and/or the solution may be cycled in, for example, a precipitation, or crystallization, or separation loop. In some embodiments, for example, a solution may be concentrated and/or at least a portion of sodium bicarbonate, or sodium sesquicarbonate, or sodium carbonate, or any combination thereof crystallized or precipitated or separated using, for example, including, but not limited to, one or more or any combination of the following: mechanical vapor compression distillation, or multi-effect distillation, or cooling crystallization, or freeze desalination, or freeze crystallization, or distillation, or a membrane based process, or membrane distillation, or evaporation, or forward osmosis, or reverse osmosis, or nanofiltration, or a solid-liquid separation, or a process herein, or a process in the art. In some embodiments, a portion of a solution comprising alkali carboxylate, such as sodium acetate, may be recycled or recirculated within the process. In some embodiments, a portion of a solid or solution comprising alkali bicarbonate, or alkali sesquicarbonate, or alkali carbonate, or any combination thereof may comprise a valuable product, or may be further treated or purified, or any combination thereof. In some embodiments, for example, a portion of a solid or solution comprising alkali bicarbonate, or alkali sesquicarbonate, or alkali carbonate, or any combination thereof may be reacted with an alkaline earth hydroxide, such as calcium hydroxide, to form, for example, at least a portion of, for example, an alkali hydroxide. In some embodiments, a solid or solution comprising an alkali bicarbonate may be reacted or decomposed to form, for example, a portion of a solid or solution comprising alkali sesquicarbonate, or alkali carbonate, or alkali hydroxide, or a derivative thereof, or any combination thereof. In some embodiments, an alkali may comprise ammonia, or a basic chemical with a potential vapor pressure under some conditions, or any combination thereof. In some embodiments, an alkali may comprise ammonia, or a basic chemical with a potential vapor pressure under some conditions, or any combination thereof, and/or a portion a solution, or solid, or any combination thereof comprising alkali species, carboxylic acid species, and acid gas species may be heated to form at least a portion of a gas comprising alkali and/or acid gas, which may enable the separation of at least a portion of alkali and/or acid gas from at least a portion of alkali species, or carboxylic acid species, or alkali carboxylate, or any combination thereof. In some embodiments, an alkali may comprise ammonia, or a basic chemical with a potential vapor pressure under some conditions, or any combination thereof, and/or a portion a solution or solid comprising ammonia species, acetic acid species, and carbon dioxide species may be heated to form at least a portion of a gas or fluid comprising ammonia and/or carbon dioxide, which may enable the separation of at least a portion of ammonia species and/or carbon dioxide species from at least a portion of ammonia species, or acetic acid species, or ammonium acetate, or any combination thereof. In some embodiments, a solid or solution or fluid comprising ammonia species, or carbon dioxide species, or any combination thereof may be converted into a chemical comprising ammonium carbonate, or ammonium bicarbonate, or ammonium sesquicarbonate, or ammonium carbamate, or urea, or an ammonia derivative, or a carbon dioxide derivative, or any combination thereof.

### FIGS. 3C, 3D Example Step-by-Step Description

(1) Forming Solution Comprising Alkaline Earth, or Carboxylic Acid Species, or Acid Gas Species, or any combination thereof: In some embodiments, a solution comprising a carboxylic acid and an acid gas may be reacted with a chemical comprising an alkaline earth to form a solution comprising an alkaline earth species, or carboxylic acid species, or acid gas species, or any combination thereof. In some embodiments, a solution comprising acetic acid and carbon dioxide may be reacted with a solid comprising calcium carbonate to form a solution comprising calcium species, or acetic acid species, or carbon dioxide species, or any combination thereof. FIGS. 3C, 3D may be similar to FIGS. 3A, 3B. In some embodiments, FIGS. 3C, 3D may be different from FIGS. 3A, 3B in the present step in that, for example, in some embodiments, the solution comprising carboxylic acid may comprise a relatively high concentration of acid gas and/or may comprise a high pressure, or a relatively high partial pressure of acid gas, or any combination thereof. In some embodiments, FIGS. 3C, 3D may be different from FIGS. 3A, 3B in the present step in that, for example, in some embodiments, the solution comprising acetic acid may comprise a relatively high concentration of carbon dioxide and/or may comprise a high pressure, or a relatively high partial pressure of carbon dioxide, or any combination thereof. In some embodiments, for example, it may be desirable for the concentration and/or partial pressure of the acid gas to be elevated to, for example, facilitate or accelerate the reaction and/or dissolution of alkaline earth. In some embodiments, for example, the presence of a relatively high concentration of acid gas may reduce the pH and/or accelerate the reaction kinetics in the reaction, or dissolution, or any combination thereof. In some embodiments, a relatively high concentration of acid gas may comprise a molarity or molar concentration of acid gas greater than the molarity or molar concentration of carboxylic acid, for example, which may be in the same solution. In some embodiments, a relatively high concentration of carbon dioxide may comprise a molarity or molar concentration of carbon dioxide species greater than the molarity or molar concentration of acetic acid, for example, which may be in the same solution. In some embodiments, the presence of a relatively high concentration of acid gas, such as carbon dioxide, may be advantageous because the concentration of carboxylic acid, such as acetic acid, may be relatively low, and/or the presence of dissolved acid gas may facilitate the dissolution of alkaline earth and/or accelerate or facilitate the reaction of alkaline earth with carboxylic acid. In some embodiments, for example, a relatively high concentration of dissolved carbon dioxide species may comprise greater than, or less than, or equal to, for example, including, but not limited to, one or more or any combination of the following: 0.1M, or 0.2M, or 0.3M, or 0.5M, or 0.75M, or 1.00M, or 1.50M, or 2.00M, or 2.50M, or 3.00M, or 3.50M, or 4.00M, or 4.50M, or 5.00M, or a concentration described herein, or a concentration in the art, or any combination thereof. In some embodiments, for example, a relatively low concentration of dissolved carboxylic acid species may comprise less than, or greater than, or equal to, for example, including, but not limited to, one or more or any combination of the following: 0.001M, or 0.005M, or 0.01M, or 0.025M, or 0.05M, or 0.075M, or 0.1M, or 0.125M, or 0.150M, or 0.175M, or 0.2M, or 0.3M, or 0.5M, or 0.75M, or 1.00M, or 1.50M, or 2.00M, or a concentration described herein, or a concentration in the art, or any combination thereof.
(2) Recovering, or Removing, or Separating, or any combination thereof a Portion of Acid Gas: In some embodiments, a portion of an acid gas may be recovered, or removed or separated, or any combination thereof from a solution. In some embodiments, a portion of an acid gas may be recovered, or removed or separated, or any combination thereof from a solution comprising an alkaline earth species, or a carboxylic acid species, or an acid gas species, or any combination thereof. In some embodiments, a portion of a fluid comprising may be recovered, or removed or separated, or any combination thereof from a solution comprising a calcium species, or an acetic acid species, or a carbon dioxide species, or any combination thereof. In some embodiments, a portion of acid gas may be desorbed or separated by reducing the pressure or depressurizing a solution comprising an alkaline earth species, or a carboxylic acid species, or an acid gas species, or any combination thereof. In some embodiments, a portion of carbon dioxide may be desorbed or separated by reducing the pressure or depressurizing a solution comprising a calcium species, or an acetic acid species, or a carbon dioxide species, or any combination thereof, to form, for example, a gas or fluid comprising carbon dioxide and/or a solution comprising calcium acetate. In some embodiments, the removal of a portion of acid gas may result in an increase in pH, which may result in a portion of non-ionic carboxylic acid species transforming into a portion of ionic carboxylic acid species. In some embodiments, for example, the removal of a portion of acid gas may result in an increase in pH, which may result in a portion of non-ionic acetic acid transforming into a portion of ionic acetate ion and/or forming a solution comprising calcium acetate. In some embodiments, it may be desirable for the solution formed from the removal of at least a portion of acid gas to possess a sufficiently high pH for the alkaline earth species, or carboxylic acid species, or any combination thereof to be at least partially retained, or concentrated, or rejected, or any combination thereof by a semi-permeable membrane. In some embodiments, for example, it may be desirable to recover at least a portion of energy, or pressure, or any combination thereof from depressurization, using, for example, including, but not limited to, one or more or any combination of the following: energy recovery device, or pressure exchange, or PX pressure exchanger, or turbine, or turbocharger, or turbocharger pressure exchanger, or turbine pressure exchanger, or power recovery, or electric generation, or hydrogenerator, or gas turbine, or expansion turbine, or pneumatic turbine, or an energy recovery or transfer device herein, or an energy recovery or transfer device in the art. In some embodiments, ‘2)’ in FIGS. 3C and 3D may be similar to ‘8)’ in the step-by-step description of FIGS. 3A and 3B.

In some embodiments, other steps of FIGS. 3C and 3D may be similar to FIGS. 3A and 3B.

### FIGS. 9A, 9B Example Step-by-Step Description

(1) In some embodiments, a solution comprising an alkaline earth carboxylate may comprise a relatively low concentration and/or it may be desired to increase the concentration of said solution comprising an alkaline earth carboxylate to a relative high concentration. In some embodiments, a solution comprising an alkali carboxylate may comprise a relatively high concentration and/or it may be desired to decrease or dilute the concentration of said solution comprising an alkali carboxylate to a relative low concentration. In some embodiments, the solution comprising an alkali carboxylate comprising a relatively high concentration may comprise a significantly higher osmotic pressure than the solution comprising alkaline earth carboxylate comprising a relatively low concentration. In some embodiments, for example, the relatively higher osmotic pressure of the solution comprising an alkali carboxylate comprising a relatively high concentration may be utilized to transfer at least a portion of water from the solution comprising alkaline earth carboxylate comprising a relatively low concentration. In some embodiments, energy, or CAPEX, or sizing, or any combination thereof may be saved by, for example, at least partially utilizing the greater osmotic pressure of the solution comprising an alkali carboxylate comprising a relatively high concentration to facilitate the transfer of water from, for example, the solution comprising alkaline earth carboxylate comprising a relatively low concentration. In some embodiments, for example, the solution comprising a relatively high concentration of solute may comprise a draw solution and/or the solution comprising a relatively low concentration may comprise a feed solution and/or at least a portion of water may transfer from said feed solution to said draw solution by, for example, permeating through a semi-permeable membrane. In some embodiments, for example, forward osmosis, or osmotically assisted reverse osmosis, or osmotically assisted nanofiltration, or any combination thereof may be employed. In some embodiments, for example, a relatively low osmotic pressure solution comprising calcium acetate may be transferred into a forward osmosis membrane module as a feed solution and/or a relatively high osmotic pressure solution comprising sodium acetate may be transferred into the forward osmosis module as a feed solution and/or a portion of water may permeate from the feed solution to the draw solution, which may result in the at least partial concentrating or increase in concentration of the solution comprising calcium acetate and/or the at least partial diluting or decrease in concentration of the solution comprising sodium acetate. In some embodiments, osmotically assisted reverse osmosis may be employed. In some embodiments, for example, the transfer or permeation of water from the feed solution to the draw solution may be facilitated by the application of pressure on the feed solution, which may, for example, including, but not limited to, one or more or any combination of the following: enable smaller membrane module size, or enable shorter residence time, or enable the formation of higher concentration retentate, or enable the formation of higher osmotic pressure or higher concentration solutions, or enable the formation of solutions with higher osmotic pressure than the draw solution, or any combination thereof. In some embodiments, at least a portion of a solution comprising a relatively low concentration of alkaline earth carboxylate may be concentrated to form a solution comprising a relatively high concentration of alkaline earth carboxylate. In some embodiments, at least a portion of a solution comprising a relatively high concentration of alkali carboxylate may be diluted to form a solution comprising a relatively low concentration of alkali carboxylate. In some embodiments, at least a portion of a solution comprising a relatively low concentration of alkaline earth carboxylate may be concentrated to form a solution comprising a relatively high concentration of alkaline earth carboxylate and/or in some embodiments, at least a portion of a solution comprising a relatively high concentration of alkali carboxylate may be diluted to form a solution comprising a relatively low concentration of alkali carboxylate, wherein at least a portion of the diluting and/or concentrating may comprise the transfer or permeation of at least a portion of water or solvent from the solution comprising alkaline earth carboxylate to the solution comprising alkali carboxylate, which may be facilitated or enabled by a semi-permeable membrane. In some embodiments, it may be desirable for the solution comprising alkaline earth carboxylate at a relatively higher concentrate to comprise a concentration sufficiently high to enable the at least partial formation and/or precipitation of at least a portion of alkaline earth sulfate, such as calcium sulfate, in, for example, some step(s) of the process.

FIG. 3C and FIG. 3D may be similar to FIG. 3A and FIG. 3B. FIG. 3C and FIG. 3D may employ or utilize the potential desire to increase the concentration of a solution in a first part of the process and the potential desire to decrease or dilute the concentration of a soliton in a second part of the process to enable the energy efficient, or equipment efficient, or any combination thereof transfer of water or solvent from the solution desiring concentrating to the solution desiring diluting. In some embodiments, for example, forward osmosis, or osmotically assisted reverse osmosis, or osmotically assisted nanofiltration, or any combination thereof may be employed.

### FIGS. 9C, 9D Example Step-by-Step Description

FIGS. 9C, 9D may be similar to FIGS. 3C and 3D.

### Figures Example Additional Description

In some embodiments, it may be desirable to employ a counter-current flow approach in the separation of a portion of alkali from a portion of carboxylic acid, or a portion of carboxylic acid from a portion of alkali, or any combination thereof. In some embodiments, for example, a countercurrent approach may enable the concentration of the carboxylic acid produced to approach an optimized level or an equilibrium maximum and/or the concentration or yield of the salt comprising alkali acid gas species, such as sodium bicarbonate, or the molar ratio of alkali to carboxylic acid species in the retentate to approach an optimized level or an equilibrium maximum, or any combination thereof.

Example Approaches for, for Example, Separating a Portion of Alkali Species from a Portion of Carboxylic Acid Species, or a Portion of Carboxylic Acid Species from a Portion of Alkali Species, or any Combination Thereof May Include, but May not be Limited to, One or More or any Combination of the Following:
Alkali Concentration/Retentate Concentration
   In some embodiments, the concentration of alkali in a retentate may be allowed to increase, for example, while a permeate may be formed.
   In some embodiments, the concentration of alkali in a retentate may be at least partially maintained or constant, for example, as permeate forms. In some embodiments, for example, a solution, such as a solution comprising water, may be added periodically or continuously to retentate to at least partially maintain a desired concentration range, for example, while a permeate may be formed.
   In some embodiments, the concentration of alkali in a retentate may be at least partially diluted or decreased, for example, while a permeate may be formed. In some embodiments, for example, a solution comprising water may be added periodically or continuously to a retentate to dilute the concentration of alkali, for example, while permeate may be formed. In some embodiments, diluting or reducing the concentration of alkali may enable a relatively lower pH to be achieved and/or may enable greater separation effectiveness or efficiency of, for example, separating a portion of carboxylic acid species from a portion of alkali species. In some embodiments, diluting or reducing the concentration of alkali may enable a relatively lower pH to be achieved while the concentration or amount of carboxylic acid species may decrease or may be at least partially separated from a portion of alkali. In some embodiments, for example, as. In some embodiments, it may be desirable to add a solution comprising water to the retentate at a greater flow rate than the rate which permeate may be produced. In some embodiments, it may be desirable to conduct concentrating in batches, wherein, for example, a batch comprising alkali may be concentrated in a first batch concentrating and/or separating stage, then the batch formed in the first batch concentrating and/or separating stage may be diluted with a solution comprising water and/or transferred to a second batch stage wherein it may be concentrated and/or separated; and/or the process may comprise one or two or three or more or any combination thereof stages. In some embodiments, for example, lowering the alkali concentration may enable a low pH, or a lower pH, or greater pH reduction, or any combination thereof for the same or similar acid gas partial pressure, or acid gas concentration, or any combination thereof.
Acid Gas Pressure and/or Concentration
   In some embodiments, the pressure, or concentration, or any combination thereof of an acid gas in the retentate, or permeate, or concentrate, or diluate, or any combination thereof may increase. In some embodiments, the pressure, or concentration, or any combination thereof in the feed or retentate may be increased, for example, while, for example, a permeate may be formed. In some embodiments, for example, acid gas may be added into the solution comprising a feed or retentate, or the solution comprising alkali, or any combination thereof. In some embodiments, for example, acid gas may be added, or acid gas may be compressed, or any combination thereof into the solution comprising a feed or retentate, or the solution comprising alkali, or any combination thereof. In some embodiments, for example, the solubility of acid gas may be increased by, for example, reducing the temperature, or adding a solubility enhancer, or due to change or adjustment in a concentration, or change or adjustment in a composition, or any combination thereof. In some embodiments, the amount of acid gas added, or the rate of acid gas added, or the rate of acid gas added to a feed or retentate, or any combination thereof may be greater than the rate which acid gas may be transferred from the feed or retentate to the permeate, or the rate which dissolved acid gas may be removed through a permeate or diluate, or the rate of dissolved acid gas permeate a membrane, or the rate which acid gas may be removed, or any combination thereof.
   In some embodiments, the pressure, or concentration, or any combination thereof of an acid gas in the retentate, or permeate, or concentrate, or diluate, or any combination thereof may be at least partially maintained within a range. In some embodiments, the pressure, or concentration, or any combination thereof of acid gas in the feed or retentate may be maintained within a range, for example, while, for example, a permeate may be formed. In some embodiments, for example, acid gas may be added into the solution comprising a feed or retentate, or the solution comprising alkali, or any combination thereof. In some embodiments, for example, acid gas may be added, or acid gas may be compressed, or any combination thereof into the solution comprising a feed or retentate, or the solution comprising alkali, or any combination thereof may be about the same as the rate which acid gas may be removed or transferred from said solutions. In some embodiments, for example, the solubility of acid gas may be increased by, for example, reducing the temperature, or adding a solubility enhancer, or due to change or adjustment in a concentration, or change or adjustment in a composition, or any combination thereof. In some embodiments, the amount of acid gas added, or the rate of acid gas added, or the rate of acid gas added to a feed or retentate, or any combination thereof may be similar to or about the same as the rate which acid gas may be transferred from the feed or retentate to the permeate, or the rate which dissolved acid gas may be removed through a permeate or diluate, or the rate of dissolved acid gas permeate a membrane, or the rate which acid gas may be removed, or any combination thereof
   In some embodiments, the pressure, or concentration, or any combination thereof of an acid gas in the retentate, or permeate, or concentrate, or diluate, or any combination thereof may be decreased. In some embodiments, the pressure, or concentration, or any combination thereof of acid gas in the feed or retentate may be decreased, for example, while, for example, a permeate may be formed. In some embodiments, for example, acid gas may be added, if any, into the solution comprising a feed or retentate, or the solution comprising alkali, or any combination thereof. In some embodiments, for example, the rate which acid gas may be added, if any, into the solution comprising a feed or retentate, or the solution comprising alkali, or any combination thereof may be less than the rate which acid gas may be removed or transferred from said solutions. In some embodiments, for example, the solubility of acid gas may be increased by, for example, reducing the temperature, or adding a solubility enhancer, or due to change or adjustment in a concentration, or change or adjustment in a composition, or any combination thereof. In some embodiments, for example, the solubility of acid gas may be decreased by, for example, increasing the temperature, or removing a solubility enhancer, or due to change or adjustment in a concentration, or change or adjustment in a composition, or any combination thereof. In some embodiments, the amount of acid gas added, or the rate of acid gas added, or the rate of acid gas added to a feed or retentate, or any combination thereof may be less than the rate which acid gas may be transferred from the feed or retentate to the permeate, or the rate which dissolved acid gas may be removed through a permeate or diluate, or the rate of dissolved acid gas permeate a membrane, or the rate which acid gas may be removed, or any combination thereof. In some embodiments, acid gas may be transferred from a feed or retentate by, for example, including, but not limited to, one or more or any combination of the following: permeating a membrane, or exiting a process step through in a solution comprising a permeate, or exiting a process step through in a solution comprising a diluate, or any combination thereof.

In some description and/or in some embodiments, the term ‘retentate’ may be used to describe a ‘feed’ and/or the term ‘feed’ may be used to describe a ‘retentate’. In some embodiments, for example, a feed solution which may be undergoing concentrating may also comprise a retentate.

Approaches may include, but are not limited to, one or more or any combination of the following:
Low concentration alkali carboxylate, low acid gas partial pressure
Low concentration alkali carboxylate, medium acid gas partial pressure
Low concentration alkali carboxylate, high acid gas partial pressure
Low concentration alkali carboxylate, variable or adjusted acid gas partial pressure
Medium concentration alkali carboxylate, low acid gas partial pressure
Medium concentration alkali carboxylate, medium acid gas partial pressure
Medium concentration alkali carboxylate, high acid gas partial pressure
Medium concentration alkali carboxylate, variable or adjusted acid gas partial pressure
High concentration alkali carboxylate, low acid gas partial pressure
High concentration alkali carboxylate, medium acid gas partial pressure
High concentration alkali carboxylate, high acid gas partial pressure
High concentration alkali carboxylate, variable or adjusted acid gas partial pressure

### Example Notes

In some embodiments, the total pressure of a feed solution, or retentate, or permeate, or concentrate, or diluate, or any combination thereof may be significantly greater than the osmotic pressure of the rejectable or retainable solute in solution, or the pressure required to enable permeation or separation using a semi-permeable membrane, or the pressure required to enable separation, or the required pressure, or the required feed pressure for separation, or any combination thereof. In some embodiments, the total pressure of a feed solution, or retentate, or permeate, or concentrate, or diluate, or any combination thereof may be significantly greater than the osmotic pressure of the rejectable or retainable solute in solution because, for example, the pressure may be required to enable the dissolved concentration of acid gas, or the acid gas concentration in solution, or any combination thereof. In some embodiments, it may be desirable to conserve and recover energy. In some embodiments, it may be desirable to recover power, or pressure, or energy, or any combination thereof from the permeate, or retentate, or concentrate, or diluate, or any combination thereof. In some embodiments, it may be desirable for the permeate to maintain at least a portion of dissolved acid gas to, for example, facilitate or accelerate, for example, a dissolution and/or reaction of a chemical comprising alkaline earth, which, if desired, may be conducted in other process step(s), for example, which may be herein.
In some embodiments, it may be desirable to use consistent acid gas pressure.
In some embodiments, it may be desirable to use variable or adjustable pressure, or acid gas partial pressure, or any combination thereof.
In some embodiments, it may be desirable to employ a recirculating batch configuration.
In some embodiments, it may be desirable to add a solution comprising water. In some embodiments, for example, maintaining a lower alkali concentration, or diluting the alkali concentrating, or enabling a lower concentration of alkali relative to if a solution comprising water was not added, or any combination thereof may at least partially increase yield because, for example, the same acid gas pressure, or acid gas concentration, or any combination thereof may achieve a lower pH in at a lower alkali concentration. In some embodiments, for example, maintaining a lower alkali concentration, or diluting the alkali concentrating, or enabling a lower concentration of alkali relative to if a solution comprising water was not added, or any combination thereof may at least partially increase yield because, for example, acid gas dissolution may achieve a lower solution pH with a solution comprising a lower alkali concentration.
In some embodiments, a portion of the acid gas species, such as carbon dioxide species, formed by a reaction of a chemical comprising an alkaline earth, such as calcium carbonate, with a carboxylic acid may remain dissolved in solution and/or may be transferred to the stage where acid gas may be employed or needed.
In some embodiments, systems and/or methods may be employed to remove impurities. In some embodiments, it may be desirable to employ systems and/or methods to prevent or minimize or reduce potential scaling or fouling of membranes, for example, from impurities or contaminants, such as impurities or contaminants from an input chemical comprising alkaline earth, such as input limestone. from impurities in the limestone]
In some embodiments, for example, in pressure ranges where gas hydrates, such as CO₂ hydrates, may form, it may be desirable for the temperature to be controlled, for example, above the temperature range of gas hydrates, for example, greater than 0° C., or 1C, or 2° C., or 3° C., or 5° C., or 7° C., or 10° C., or 12° C., or 15° C., or any combination thereof.
In some embodiments, it may be desirable to employ mechanisms, or systems, or methods, or devices, or approaches, or conditions, or any combination thereof to facilitate or accelerate the kinetics of the dissolution and/or reaction of a chemical comprising alkaline earth and/or reaction of a portion of a chemical comprising an alkaline earth to form, for example, a portion of a chemical comprising an alkaline earth carboxylate.

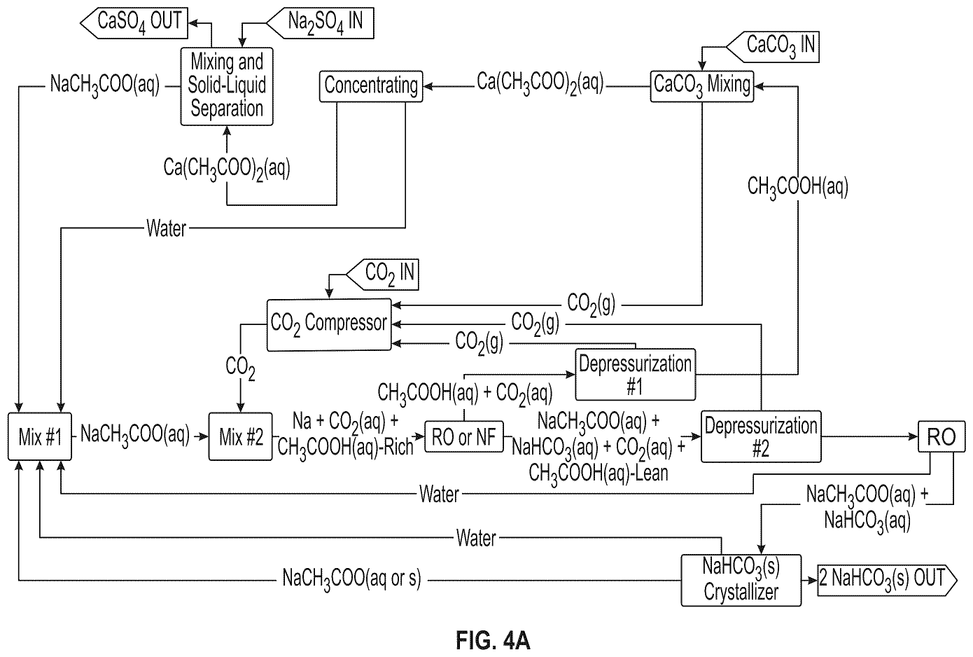

### FIG. 4A, 4B Example Description

### FIG. 4A, 4B Example Summary

FIGS. 4A and 4B may show an embodiment with the separation and/or crystallization of a portion of an alkali bicarbonate, or alkali carbon dioxide species salt, or any combination thereof from a portion of a chemical comprising an alkali carboxylate.

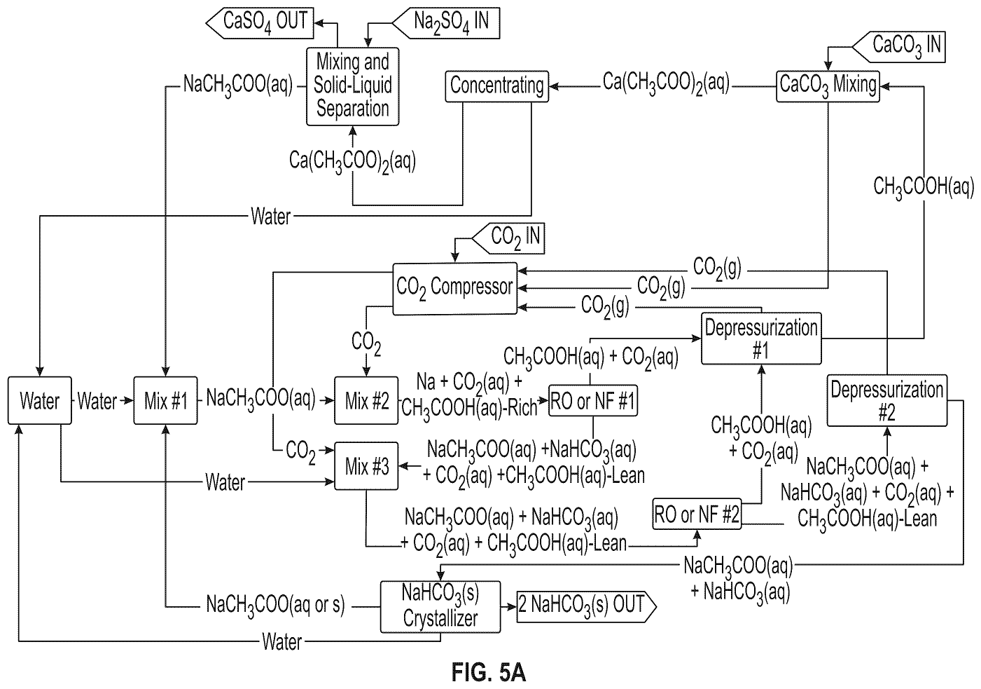

### FIG. 5A, 5B Example Description

### FIG. 5A, 5B Example Summary

FIGS. 5A and 5B may show an embodiment with the separation and/or crystallization of a portion of an alkali bicarbonate, or alkali carbon dioxide species salt, or any combination thereof from a portion of a chemical comprising an alkali carboxylate.

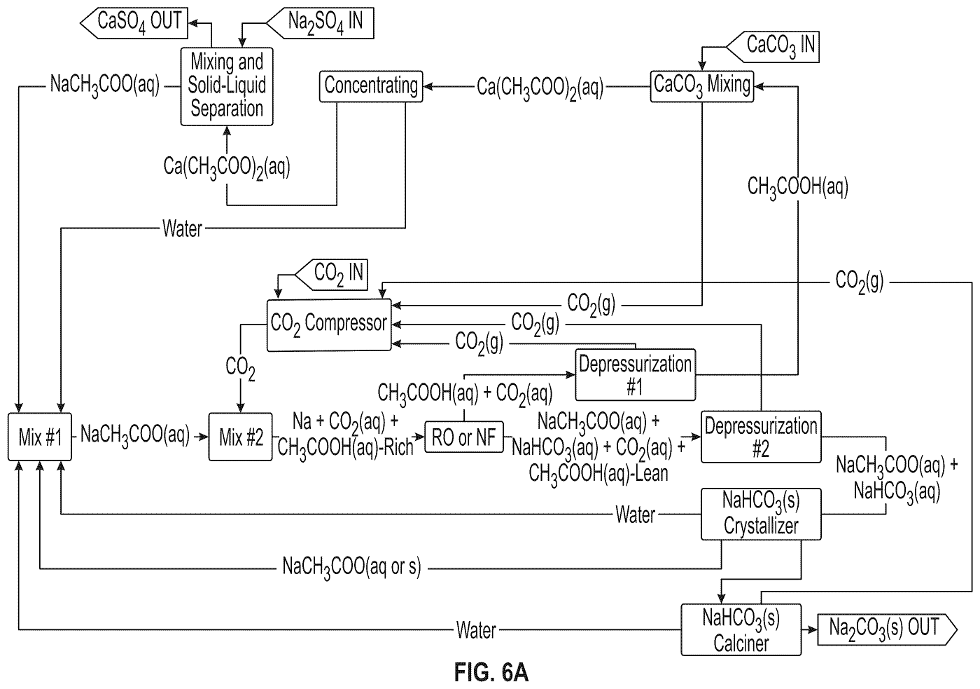

### FIG. 6A, 6B Example Detailed Description

### FIG. 6A, 6B Example Summary

FIGS. 6A and 6B may show an embodiment with the separation and/or crystallization and/or calcination of a portion of an alkali bicarbonate, or alkali carbon dioxide species salt, or any combination thereof to form a portion of an alkali carbonate, or alkali hydroxide, or alkali, or any combination thereof, or acid gas (such as carbon dioxide), or a chemical comprising an alkali carboxylate, or any combination thereof.

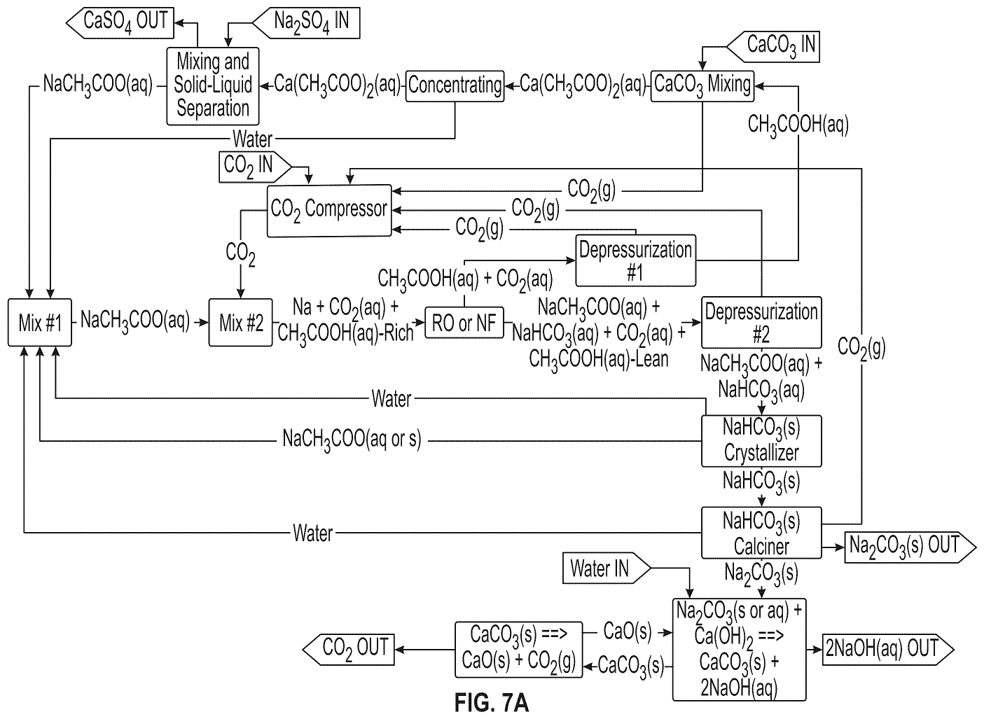

### FIG. 7A, 7B Example Detailed Description

### FIG. 7A, 7B Example Summary

FIGS. 7A and 7B may show an embodiment with the formation of an alkali hydroxide and/or an acid gas. FIGS. 7A and 7B may show an embodiment with the formation of sodium hydroxide and/or carbon dioxide, which may comprise captured carbon dioxide. In some embodiments, for example, a portion of a salt comprising an alkali species and an acid gas species may be reacted with a chemical comprising an alkaline earth oxide, or alkaline earth hydroxide, or any combination thereof to form, for example, a portion of a chemical comprising an alkali hydroxide and/or a portion of a chemical comprising an alkaline earth acid gas species. In some embodiments, it may be desirable to decompose and/or regenerate a portion of the chemical comprising an alkaline earth acid gas species to form, for example, a chemical comprising an alkaline earth oxide and/or a chemical comprising an acid gas, and/or it may be desirable to react at least a portion of the chemical comprising an alkaline earth oxide with a portion of water to form a chemical comprising alkaline earth hydroxide. In some embodiments, for example, a portion of a salt comprising sodium carbonate may be reacted with a chemical comprising a calcium oxide, or calcium hydroxide, or any combination thereof to form, for example, a portion of a chemical comprising a sodium hydroxide and/or a portion of a chemical comprising calcium carbonate. In some embodiments, it may be desirable to calcine, or decompose, or regenerate, or any combination thereof a portion of the chemical comprising calcium carbonate to form, for example, a chemical comprising calcium oxide and/or a chemical comprising an carbon dioxide, such as captured carbon dioxide, and/or it may be desirable to react at least a portion of the chemical comprising an calcium oxide with a portion of water to form a portion of a chemical comprising calcium hydroxide and/or heat.

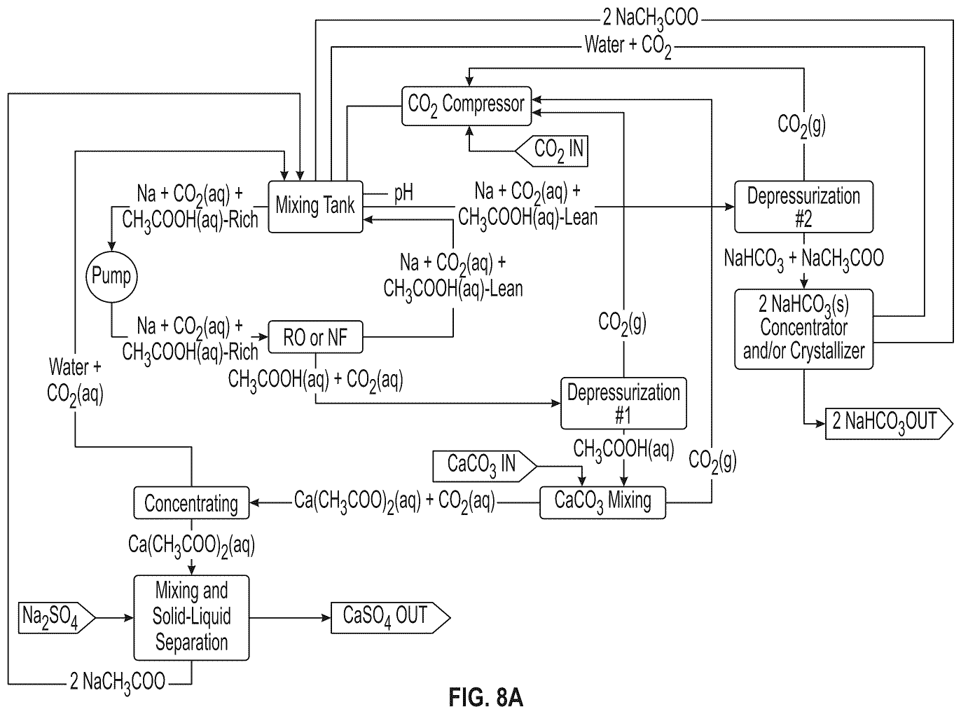

### FIG. 8A, 8B Example Detailed Description

### FIG. 8A, 8B Example Summary

FIGS. 8A and 8B may show an embodiment which may be similar to, for example, FIGS. 3A and 3B. In some embodiments, FIGS. 8A and 8B may show a configuration of the step separating a portion of alkali from a portion of carboxylic acid species with potentially greater control over parameters such as concentration, or pH, or pressure, or composition, or separations, or any combination thereof, for example, before, or during, or after, or any combination thereof the separation(s).

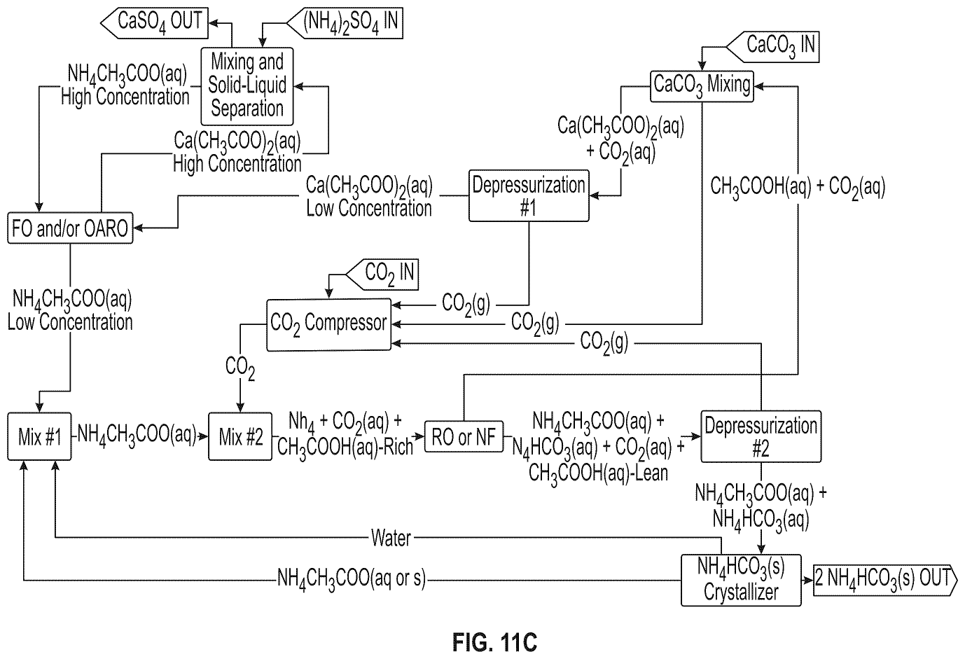

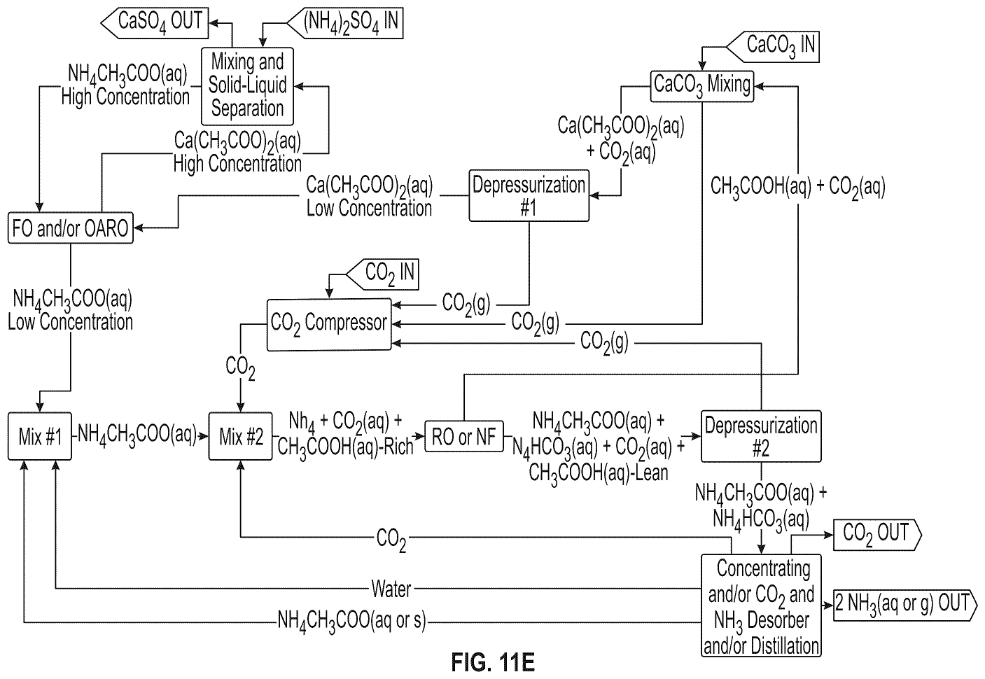

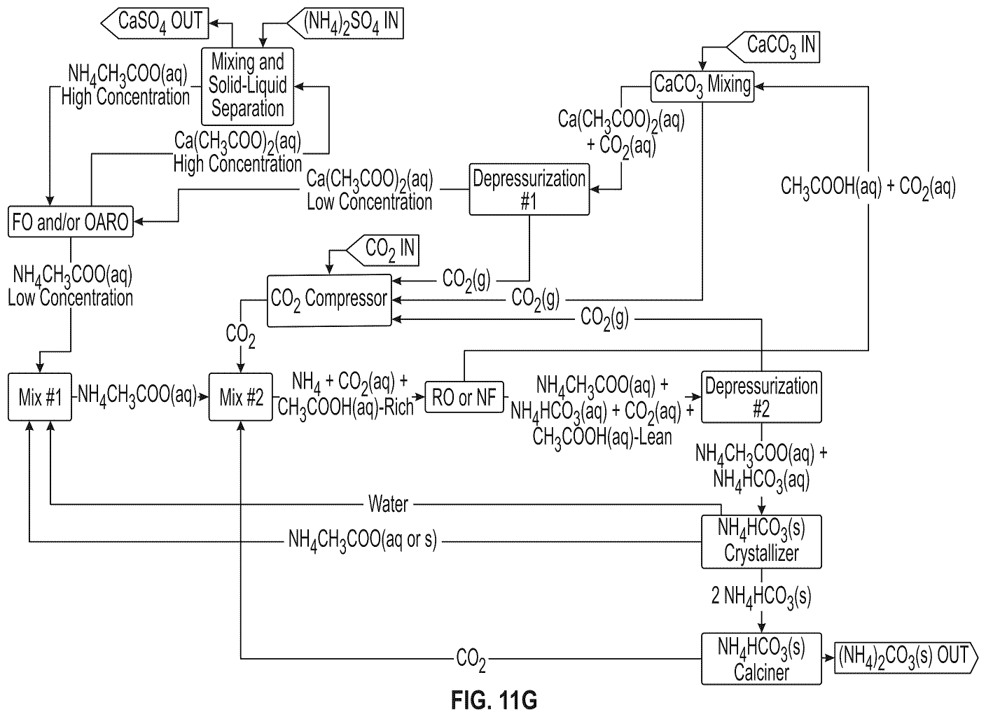

### FIG. 11C, 11E, 11G, 11I Example Detailed Description

### FIG. 11 Example Summary

In some embodiments, FIG. 11 may be similar to FIG. 9. In some embodiments, FIG. 11 may comprise example embodiments employing an alkali comprising ammonia or ammonium. Other figures or embodiments may employ ammonia or ammonium as an alkali. Other figures or embodiments may employ ammonia or ammonium as an alkali, for example, instead of or in addition to, for example, sodium or other alkalis.

### FIG. 11C Example Summary

FIG. 11C may show an example embodiment producing a chemical comprising ammonium bicarbonate, or a derivative thereof, or any combination thereof.

### FIG. 11E Example Summary

FIG. 11E may show an example embodiment producing a chemical comprising ammonia, or carbon dioxide, or a derivative thereof, or any combination thereof.

### FIG. 11G Example Summary

FIG. 11G may show an example embodiment producing a chemical comprising ammonium carbonate, or carbon dioxide, or a derivative thereof, or any combination thereof.

### FIG. 11I Example Summary

FIG. 11I may show an example embodiment producing a chemical comprising ammonium carbamate, or urea, or a derivative thereof.

### Example Description

Some embodiments may pertain to systems and methods for producing alkali or alkali-like cation salts. Some embodiments may pertain to systems and methods for producing alkali or alkali-like cation carbonates, or bicarbonates, or hydroxides, or carboxylates, or combinations thereof, or derivatives thereof.

In some embodiments, a solution or solid comprising an alkali carboxylate, such as sodium acetate, may be formed. In some embodiments, for example, the pH of a solution comprising an alkali carboxylate may be reduced such that it is in a pH range wherein at least a portion of the carboxylic acid species comprises non-ionic carboxylic acid. In some embodiments, the pH of a solution comprising an alkali carboxylate may be reduced such that it is in a pH range wherein at least a portion of the carboxylic acid species comprises non-ionic carboxylic acid by addition or dissolution of an acid. In some embodiments, the pH of a solution comprising an alkali carboxylate may be reduced such that it is in a pH range wherein at least a portion of the carboxylic acid species comprises non-ionic carboxylic acid by addition or dissolution of an acid or acid gas, which may be separable from a solution comprising the carboxylic acid and said acid or acid gas. For example, in some embodiments, a separable acid gas may be added to or dissolved in a solution comprising an alkali carboxylate at a sufficient concentration to decrease the pH of the solution to a pH in a range wherein at least a portion of the carboxylic acid species comprises a non-ionic carboxylic acid species. For example, in some embodiments, a separable acid gas may be added to or dissolved in a solution comprising an alkali carboxylate at a sufficient concentration to decrease the pH of the solution to a pH in a range wherein at least a portion of the carboxylic acid species comprises a non-ionic carboxylic acid species and/or form a solution comprising alkali+ arboxylic acid+ acid species. For example, in some embodiments, a gas or solid or liquid or fluid or any combination thereof comprising carbon dioxide may be dissolved in a solution comprising sodium acetate to form a solution comprising sodium+acetic acid+ carbon dioxide species, wherein at least a portion of the acetic acid species may comprise non-ionic acetic acid species. In some embodiments, at least a portion of the solution comprising alkali+ carboxylic acid+ acid species may be separated using a process or method or mechanism for separating at least a portion of the carboxylic acid species from the alkali species. For example, in some embodiments, at least a portion of the solution comprising alkali+ carboxylic acid+ acid species may be separated using a process or method or mechanism to separate at least a portion of non-ionic species from at least a portion of ionic species. For example, in some embodiments, at least a portion of the solution comprising alkali+ carboxylic acid+ acid species may be separated into at least a portion of a solution or fluid comprising carboxylic acid species and at least a portion of a solution or fluid comprising alkali+ acid species. For example, in some embodiments, at least a portion of the solution comprising alkali+ carboxylic acid+ acid species may be separated into at least a portion of a solution or fluid comprising carboxylic acid species and at least a portion of a solution or fluid comprising alkali+ acid species using a membrane based process, such as, including, but not limited to, one or more or any combination of the following: reverse osmosis, or nanofiltration, or forward osmosis, or electrodialysis, or electrodeionization, or ion concentration polarization (ICP), or membrane based process, or semi-permeable membrane based process. For example, in some embodiments, at least a portion of a carboxylic acid species, such as a non-ionic carboxylic acid species, may permeate a membrane, while at least a portion of an alkali species may be retained by the membrane and/or at least a portion of an acid species may exist or persist in the retentate. For example, in some embodiments, a solution comprising sodium acetate may be reacted with a solution or liquid or solid or fluid comprising carbon dioxide to form a solution comprising sodium+ acetic acid+ carbon dioxide species, and/or said solution comprising sodium+ acetic acid+ carbon dioxide species may be transferred to a membrane based process, such as reverse osmosis or nanofiltration or forward osmosis, wherein at least a portion of acetic acid species, such as non-ionic species, may permeate the membrane and form a permeate comprising acetic acid species and/or at least a portion of sodium species or carbon dioxide species may remain on the retentate side of the membrane or in the retentate solution. In some embodiments, for example, at least a portion of carbon dioxide species, such as non-ionic carbon dioxide species, may permeate the membrane with at least a portion of the acetic acid to form a solution comprising a mixture of acetic acid and carbonic acid species. In some embodiments, for example, at least a portion of carbon dioxide species may be present in the retentate solution, or may be added to the retentate solution, or any combination thereof. In some embodiments, for example, at least a portion of carbon dioxide species may be recovered or regenerated or separated from the permeate solution comprising acetic acid using, for example, including, but not limited to, one or more or any combination of the following: depressurization, or heat, or vacuum, or stripping, or carrier gas, or any combination thereof. In some embodiments, at least a portion of any carbon dioxide species which may be recovered or regenerated or separated from the permeate solution comprising acetic acid may be dissolved in a solution comprising sodium+ acetic acid species, or a solution comprising sodium+ acetic acid+ carbon dioxide species, or any combination thereof. In some embodiments, as at least a portion of acetic acid permeates the membrane, the molar ratio of acetic acid species to sodium species in the retentate solution may be insufficient for each sodium molecule to match with an acetic acid molecule, meaning there may be a stoichiometric excess of sodium relative to acetic acid species, which may enable at least a portion of said excess sodium to pair with or react with at least a portion of carbon dioxide species present in the retentate solution and/or form at least a portion of a salt or solution comprising sodium+ carbon dioxide species. In some embodiments, at least a portion of the solution comprising sodium+ carbon dioxide species, or at least a portion of the solution comprising sodium+ carbon dioxide+ acetic acid species after separating at least a portion of acetic acid species may be purified or further separated. For example, in some embodiments, at least a portion of the solution comprising sodium+ carbon dioxide+ acetic acid species after separating at least a portion of acetic acid species may be separated into at least a portion of a solution or solid comprising sodium+ carbon dioxide species, such as sodium carbonate, or sodium bicarbonate, or sodium sesquicarbonate, and/or at least a portion of a solution or solid comprising sodium acetate.
For example, in some embodiments, at least a portion of a solid comprising sodium+ carbon dioxide species may be separated by concentrating and/or precipitation or crystallization.
For example, in some embodiments, the solubility of a salt comprising sodium+ carbon dioxide species may be substantially less than the solubility of sodium acetate, which may enable the separation of a salt comprising sodium+ carbon dioxide using solubility, or differences in solubility, or cooling precipitation, or crystallization, or solubility difference—based separation, or any combination thereof.
For example, in some embodiments, at least a portion of sodium acetic acid species or sodium acetate may be separated from a solution comprising sodium+ carbon dioxide species using, for example, nanofiltration, or electrodialysis, or monovalent selective electrodialysis, or reverse osmosis, or a process for separating at least a portion of monovalent species from at least a portion of divalent or multivalent species, or any combination thereof. For example, in some embodiments, at least a portion of the solution comprising sodium+ carbon dioxide+acetic acid species after separating at least a portion of acetic acid species may be basified, to, for example, enable at least a portion of carbon dioxide species to comprise ionic species, such as bicarbonate or carbonate, and/or enable at least a portion of acetic acid species to comprise ionic species, such as acetate species. For example, in some embodiments, at least a portion of the solution comprising sodium+ carbon dioxide+ acetic acid species after separating at least a portion of acetic acid species may be basified, to, for example, enable at least a portion of carbon dioxide species to comprise divalent or multivalent ionic species, such as carbonate, and/or enable at least a portion of acetic acid species to comprise monovalent ionic species, such as acetate species. For example, in some embodiments, at least a portion of the solution comprising sodium+ carbon dioxide+ acetic acid species after separating at least a portion of acetic acid species may be basified by, for example, including, but not limited to, one or more or any combination of the following: depressurization, or removal or recovery or separation of at least a portion of excess carbon dioxide or dissolved carbon dioxide, or vacuum, or addition of calcium oxide, or addition of calcium hydroxide, or addition of magnesium oxide, or addition of magnesium hydroxide, or addition of a base, or addition of magnesium carbonate, or addition of calcium carbonate, or use of a stripping gas, or use of a carrier gas, or heat, or steam, or cooling, or precipitation, or freezing, or melting. For example, in some embodiments, at least a solution comprising sodium+ carbon dioxide+ acetic acid species may be at least partially separated using nanofiltration, wherein at least a portion of sodium+ acetic acid species or monovalent sodium acetate may permeate the nanofiltration membrane, while at least a portion of sodium+ carbon dioxide species or divalent sodium carbonate may be retained by the nanofiltration membrane. For example, in some embodiments, at least a solution comprising sodium+ carbon dioxide+ acetic acid species may be at least partially separated into a solution or solid comprising sodium+ carbon dioxide species and/or a solution or solid comprising sodium+ acetic acid species.

In some embodiments, a solid or solution comprising sodium+ carbon dioxide species may be transformed into a solution or solid comprising sodium hydroxide. For example, in some embodiments, a solid or solution comprising sodium+ carbon dioxide species may be reacted with a material or solution or slurry comprising calcium oxide or calcium hydroxide to form, for example at least a portion of sodium carbonate, or sodium hydroxide, or calcium carbonate, or any combination thereof.

Note: Carbon dioxide may be provided as an example ‘acid gas’ or pH reducer. Other acids or acid gases instead of, or in addition to, carbon dioxide may be employed, which may include, but are not limited to, one or more or any combination of the following: carbon dioxide, or hydrogen sulfide, or carbonic acid, or hydrosulfurous acid, or sulfur dioxide, or sulfurous acid, or nitrous acid, or nitrogen dioxide, or nitrite, or sulfite, or bisulfite, or sulfide, or hydrogen sulfide, or carboxylic acids, or volatile acids, or separable acids, or acids or acid species separable by size, or acids or acid species separable by semi-permeable membrane, or acids or acid species separable by valence state or ion state, or citric acid.

Note: Acetic acid or acetate may be provided as an example acid, or carboxylic acid, or low molecular weight carboxylic acid, or permeable acetic acid, or monovalent acetic acid species, or any combination thereof. Other carboxylic acids, instead of, or in addition to, acetic acid or acetate may be employed.

### Example Process Steps and/or Chemistry of Some Example Embodiments

### Example Process Steps of Some Embodiments

(1) A substance comprising an alkaline-earth+ weak acid ion salt may be reacted with a solution or fluid or solid or substance comprising a carboxylic acid to form a solid or solution or any combination thereof comprising an alkaline-earth carboxylate and/or a gas or solution or liquid or solid or any combination thereof comprising weak acid derivative.
(2) A substance or solution comprising an alkaline earth carboxylate may be reacted with a substance or solution comprising an alkali sulfate to form at least a portion of an alkaline earth sulfate and/or at least a portion of an alkali carboxylate.
(3) An acid or acid gas may be dissolved in a solution comprising an alkali carboxylate to form a solution comprising alkali+ carboxylic acid+ acid species. In some embodiments, an acid or acid gas may be dissolved in a solution comprising an alkali carboxylate to form a solution comprising alkali+ carboxylic acid+ acid species, wherein the solution may be in a pH range wherein at least a portion of the carboxylic acid species may comprise non-ionic carboxylic acid species. In some embodiments, at least a portion of the carboxylic acid species may be separated from at least a portion of the alkali species and/or at least a portion of the acid species may pair with or react with the alkali species or excess alkali species. For example, in some embodiments, at least a portion of non-ionic carboxylic acid species may permeate a semi-permeable membrane, while at least a portion of alkali species may be retained by or rejected by a semi-permeable membrane, and/or at least a portion of acid species which may be present in the retained solution or retentate solution may react with or pair with at least a portion of the alkali species or stoichiometrically excess alkali species which may be present in the retentate. In some embodiments, at least a portion of a salt comprising an alkali+ acid species may be separated from at least a portion of a salt comprising an alkali+ carboxylic acid species. In some embodiments, at least a portion of a salt comprising an alkali+ acid species may be separated from at least a portion of a salt comprising an alkali+ carboxylic acid species, using, for example, including, but not limited to, one or more or any combination of the following: precipitation, or crystallization, or nanofiltration, or electrodialysis, or solubility driven separation, or size-based separation, or ion valence based separation, or ion size based separation, or solubility difference based separation, or membrane based separation, or membrane based process, or phase change, or freezing, or melting, or distillation, or other separation methods described herein, or other methods for separation known in the art, or any combination thereof.

### Example Process Steps of Some Embodiments

(1) A solid comprising calcium carbonate may be reacted with a solution comprising acetic acid to form a solution comprising calcium acetate and/or a gas or fluid comprising carbon dioxide.
(2) A solution comprising calcium acetate may be reacted with a solid or solution comprising sodium sulfate to form at least a portion of calcium sulfate and at least a portion of an sodium acetate.
(3) A gas or fluid or solid comprising carbon dioxide may be dissolved in a solution comprising a sodium acetate to form a solution comprising sodium+ acetic acid+ carbon dioxide species. In some embodiments, at least a portion of carbon dioxide may be dissolved in a solution comprising sodium acetate to form a solution comprising sodium+ acetic acid+ carbon dioxide species, wherein the solution may comprise a pH range wherein at least a portion of the acetic acid species may comprise non-ionic acetic acid species. In some embodiments, at least a portion of the acetic acid species may be separated from at least a portion of the sodium species and/or at least a portion of the carbon dioxide species may pair with or react with at least a portion of the sodium species or excess sodium species. For example, in some embodiments, at least a portion of non-ionic acetic acid species may permeate a semi-permeable membrane, while at least a portion of sodium species may be retained by or rejected by a semi-permeable membrane, and/or at least a portion of carbon dioxide species which may be present in and/or added to the retained solution or retentate solution may react with or pair with at least a portion of the sodium species or stoichiometrically excess sodium species which may be present in the retentate. In some embodiments, at least a portion of a salt comprising a sodium+ carbon dioxide species may be separated from at least a portion of a salt comprising a sodium+ acetic acid species. In some embodiments, at least a portion of a salt comprising sodium+ carbon dioxide species may be separated from at least a portion of a salt comprising an sodium+ acetic acid species, using, for example, including, but not limited to, one or more or any combination of the following: precipitation, or crystallization, or nanofiltration, or electrodialysis, or solubility driven separation, or size-based separation, or ion valence based separation, or ion size based separation, or solubility difference based separation, or membrane based separation, or membrane based process, or phase change, or freezing, or melting, or distillation, or other separation methods described herein, or other methods for separation known in the art, or any combination thereof.

### Example Chemistry of Some Embodiments

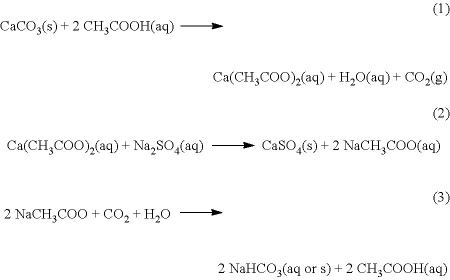

(with membrane based or membrane facilitated process or other processes, for example, described herein)

Note: In some embodiments, a portion of NaCH₃COO may be recirculated

Note: In some embodiments, a portion of NaHCO₃(aq or s) may be separated from, for example, a portion of NaCH₃COO(aq or s)

### Description of Some Example Embodiments

A solid comprising calcium carbonate may be reacted with a solution comprising acetic acid to form a solution comprising calcium acetate and/or a gas or fluid comprising carbon dioxide.
In some embodiments, at least a portion of the solution comprising calcium acetate may comprise relatively dilute or relatively low concentration of calcium acetate. In some embodiments, it may be desirable to remove at least a portion of water or otherwise concentrate at least a portion of the solution comprising calcium acetate to form a solution comprising calcium acetate at a higher concentration or a concentrated solution comprising calcium acetate and/or recovered water. In some embodiments, a solution comprising calcium acetate may be concentrated using one or more or any combination of concentrating or separation processes. For example, in some embodiments, at least a portion of a solution comprising calcium acetate may be concentrated using, including, but not limited to, one or more or any combination of the following: reverse osmosis, or nanofiltration, or high pressure reverse osmosis, or high pressure nanofiltration, or forward osmosis, or osmotically assisted reverse osmosis, or mechanical vapor compression distillation, or multi-effect distillation, or distillation, or freeze separation, or melt crystallization, or distillation, or electrodialysis, or other separation method described herein, or other separation method described in the art. In some embodiments, it may be desirable to treat the solution with a small amount of an acid or an antiscalant to prevent, or treat, or any combination thereof any potential calcium scale or calcium carbonate scale, which may form or may have the potential to form prior to, or during, or after the concentrating of at least a portion of calcium acetate.
In some embodiments, it may be desirable to remove or recovery or recycle at least a portion of the formed carbon dioxide. In some embodiments, at least a portion of carbon dioxide or residual carbon dioxide may be separated or recovered prior to, or during, or after, or independent of, or any combination thereof the concentrating or potential concentrating of the solution comprising calcium acetate. For example, in some embodiments, at least a portion of carbon dioxide may recovered by, for example, including, but not limited to, one or more or any combination of the following: depressurization, or vacuum, or carrier gas, or stripping gas, or carrier gas extraction, or distillation, or steam.
In some embodiments, a solid comprising calcium carbonate, or the solution comprising acetic acid, or any combination thereof may comprise impurities. In some embodiments, at least a portion of said impurities may be separated from the product(s) by, for example, including, but not limited to, one or more or any combination of the following: solid-liquid separation, or gas separation, or liquid-liquid separation, or phase separation, or membrane-based separation, or size based separation, or other separation process described herein, or other separation process described in the art, or any combination thereof.

A solution comprising calcium acetate may be reacted with a solution or solid comprising sodium sulfate to form a solid comprising calcium sulfate and a solution comprising sodium acetate.
In some embodiments, it may be desirable to separate at least a portion of a solid comprising calcium sulfate from a solution using, for example, at least a portion of a solid-liquid separation process, or solid separation process, or any combination thereof. In some embodiments, at least a portion of the solid comprising calcium sulfate may be rinsed or further purified, if desired.
In some embodiments, at least a portion of the solution comprising sodium acetate may comprise residual dissolved calcium sulfate. In some embodiments, at least a portion of residual calcium may be removed. In some embodiments, at least a portion of residual calcium may be removed by reaction and/or precipitation and/or solid-liquid separation. In some embodiments, a reagent comprising, for example, sulfur dioxide, or sulfite, or bisulfite, or carbonate, or bicarbonate, or sodium sulfite, or sodium bisulfite, or sodium carbonate, or sodium bicarbonate, or sodium sulfide, or sulfide, or any combination thereof, may be added to the solution to facilitate or react with or enable the precipitation of at least a portion of the calcium and/or removing at least a portion of the residual calcium from solution. In some embodiments, a precipitate comprising calcium may be at least partially removed using, for example, including, but not limited to, a solid-liquid separation. In some embodiments, at least a portion of residual calcium may be removed or separate or pacified or descaled or any combination thereof by, for example, an ion exchange, or ion exchange resin, or any combination thereof.

A fluid or gas or solid or supercritical fluid or liquid or substance or solution or any combination thereof comprising carbon dioxide or carbon dioxide species may be dissolved in a solution comprising sodium acetate to form a solution comprising sodium+ acetic acid+ carbon dioxide species. In some embodiments, it may be desirable to add a sufficient amount of carbon dioxide, or other acid, to reduce the pH such that the pH of at least a portion of the solution comprising sodium+ acetic acid+ carbon dioxide may be in a pH range wherein at least a portion of the acetic acid species may comprise non-ionic species, such as acetic acid. In some embodiments, at least a portion of the solution comprising sodium+ acetic acid+ carbon dioxide, which may comprise a feed solution, may be contacted with a semi-permeable membrane to form at least a portion of a permeate comprising acetic acid and/or at least a portion of a retentate comprising sodium+ carbon dioxide or sodium+ acetic acid+ carbon dioxide with a lower molar ratio of acetic acid to sodium than in the feed solution. In some embodiments, at least a portion of carbon dioxide may be recovered or separated from the permeate solution comprising acetic acid. In some embodiments, at least a portion of the permeate solution comprising acetic acid may be transferred to step 1 or the reaction of at least a portion of calcium carbonate with at least a portion of acetic acid. In some embodiments, at least a portion of the solution comprising sodium+ carbon dioxide or sodium+ acetic acid+ carbon dioxide with a lower molar ratio of acetic acid to sodium than in the feed solution may be recirculated, wherein, for example, additional carbon dioxide may be added to the solution, and/or the resulting or formed CO₂-enriched solution may be contacted with a semi-permeable membrane in a circulation loop or a cycle. In some embodiments, carbon dioxide or water may be added and/or acetic acid may be removed until, for example, a desired concentration of acetic acid species may be reached and/or the retained solution comprising sodium+ carbon dioxide or sodium+ carbon dioxide+ acetic acid may be further purified or further separated. For example, in some embodiments, the retained solution comprising sodium+ carbon dioxide or sodium+ carbon dioxide+ acetic acid may be further purified or further separated using, for example, including, but not limited to, one or more or any combination of the following: solubility difference based separation, or crystallization, or precipitation, or electrodialysis, or nanofiltration, or membrane based process, or other process described herein, or other separation process described in the art.
In some embodiments, the pressure of carbon dioxide or the partial pressure of carbon dioxide in a feed solution rich in acetic acid comprising sodium+ acetic acid+ carbon dioxide may be greater than or equal to one or more or any combination of the following: 1 Bar, or 5 Bar, or 10 Bar, or 15 Bar, or 20 Bar, or 25 Bar, or 30 Bar, or 40 Bar, or 50 Bar, or 60 Bar, or 70 Bar, or 80 Bar, or 90 Bar, or 100 Bar, or 110 Bar, or 120 Bar, or 130 Bar, or 140 Bar, or 150 Bar, or 175 Bar, or 200 Bar, or 225 Bar, or 250 Bar, 300 Bar, or 350 Bar, or 400 Bar, or 450 Bar, or 500 Bar, or 600 Bar, or 700 Bar, or 800 Bar, or 900 Bar, or 1,000 Bar, or 1,500 Bar, or 2,000 Bar.

In some embodiments, a product or intermediate may comprise sodium bicarbonate, or sodium sesquicarbonate, or any combination thereof. In some embodiments, it may be desirable to decompose at least a portion of said sodium bicarbonate, or sodium sesquicarbonate, or any combination thereof to form, for example, at least a portion of sodium carbonate and/or at least a portion of carbon dioxide and/or at least a portion of water. In some embodiments, at least a portion of said carbon dioxide may be recycled or recovered or reused in one or more embodiments, or within the process.

In some embodiments, a product or intermediate may comprise sodium carbonate, or sodium bicarbonate, or sodium sesquicarbonate, or any combination thereof. In some embodiments, it may be desirable to react at least a portion of a solution or solid or slurry or any combination thereof comprising sodium carbonate, or sodium bicarbonate, or sodium sesquicarbonate, or any combination thereof with at least a portion of a solid or solution or slurry comprising calcium hydroxide to form, for example, at least a portion of a solution comprising sodium hydroxide and/or at least a portion of a solid comprising calcium carbonate. In some embodiments, calcium carbonate may be decomposed or reacted in a manner to form at least a portion of calcium oxide or calcium hydroxide and/or at least a portion of carbon dioxide.

In some embodiments, carbon dioxide may be sourced from, including, but not limited to, one or more or any combination of the following: within the process, or recovered within the process, or may be provided from captured carbon dioxide, or may be provided from an external source, or may be provided from an emissions source, or any combination thereof.

In some embodiments, at least a portion of one portion of the process may be at a difference pressure than at least a portion of another or different portion of the process. In some embodiments, it may be desirable to recovery power or energy from the difference in pressure or pressure change, or any combination thereof of one or more or any combination of fluid streams or fluids in the process. For example, in some embodiments, at least a portion of power may be recovered from a fluid comprising carbon dioxide, or a liquid or solution comprising water, or any combination thereof. For example, in some embodiments, at least a portion of power may be recovered using, including, but not limited to, one or more or any combination of the following: a pressure exchanger, or a turbocharger, or a pneumatic turbine, or a piston, or a PX pressure exchange, or a hydraulic exchange, or any combination thereof.

### Example pH vs. Speciation of Carbon Dioxide and Acetic Acid in Aqueous Solutions in Some Embodiments

Summary: In some embodiments, a pH in the range of less than about 5 may be favorable for separating at least a portion of non-ionic acetic acid (CH₃COOH) from at least a portion of sodium.

In some embodiments:
Adding carbon dioxide may decrease pH. Removing carbon dioxide may increase pH.
Removing or separating acetic acid and/or carbon dioxide from the solution comprising sodium+carbon dioxide+ acetic solution may increase pH.
Adding a base, such as calcium carbonate, may increase pH. The pH may shift from acidic to basic if a base is added in an amount sufficient to neutralize at least a portion of any ‘free acid.’

In some embodiments, it may be desirable to add and/or pressurize carbon dioxide to maintain a pH wherein at least a portion of acetic acid species may comprise non-ionic acetic acid species. In some embodiments, at least a portion of acetic acid species and carbon dioxide species may permeate a semi-permeable membrane, while at least a portion of sodium species may be retained by the semi-permeable membrane. In some embodiments, acetic acid species may be continuously removed from the feed or retentate, forming a permeate comprising acetic acid, while at least a portion of carbon dioxide and/or water may be added to the feed or retentate and/or at least a portion of the carbon dioxide and/or water may be recovered from the permeate, which may mean the proportional concentration or amount of acetic acid or acetic acid species in the retentate side may continuously decrease while carbon dioxide species may be maintained, which may enable at least a portion of sodium species to pair with at least a portion of carbon dioxide species due to the potential resulting stoichiometric excess of sodium relative to acetic acid species.

### Example Description

Some embodiments may employ at least a portion of energy recovery, or power recovery, or recovery, or chemical recovery, or any combination thereof.
Some embodiments may employ at least a portion of energy recovery, or power recovery, or recovery, or chemical recovery, or any combination thereof. For example, in some embodiments, at least a portion of energy or power may be recovered from pressure, or excess pressure, or any combination thereof. For example, in some embodiments, at least a portion of energy or power may be recovered from the pressure of a retentate solution, using, for example, including, but not limited to, one or more or any combination of the following: a pressure exchanger, or a PX pressure exchanger, or a turbocharger pressure exchanger, or a continuous pressure exchanger, or a batch pressure exchanger, or other pressure exchanging mechanism, or other power recovery mechanism, or other energy recovery mechanism, or any combination thereof. For example, in some embodiments, at least a portion of energy or power may be recovered from the pressure which may be generated or released from the depressurization of a solution comprising dissolved gas, such as, for example, dissolved acid gas, such as, for example, dissolved carbon dioxide. For example, in some embodiments, a portion of power or energy may be generated, or transferred, or exchanged, using, for example, including, but not limited to, one or more or any combination of the following: a turbocharger, or a pneumatic turbine, or a gas turbine, or pneumatic generator, or an expansion turbine, or other energy recovery mechanism, or other power recovery mechanism, or any combination thereof.
In some embodiments, a solution comprising sodium+ carbon dioxide species may comprise sodium bicarbonate, or sodium carbonate, or sodium sesquicarbonate, or free carbon dioxide, or sodium acetate, or sodium sulfite, or sodium bisulfite, or sodium sesquisulfite, or sodium sulfate, or sulfate, or calcium, or any combination thereof. In some embodiments, the molar ratio of sodium:carbon may be greater than or equal to, including, but not limited to, one or more or any combination of the following: 1:0.001, or 1:0.01, or 1:0.1, or 1:0.2, or 1:0.3, or 1:0.4, or 1:0.5, or 1:0.6, or 1:0.7, or 1:0.8, or 1:0.9, or 1:1, or 1:1.1, or 1:1.2, or 1:1.3, or 1:1.4, or 1:1.5, or 1:1.75, or 1:2, or 1:2.5, or 1:3, or 1:3.5, or 1:4, or 1:4.5, or 1:5, or 1:7.5, or 1:10, or 1:15, or 1:20, or 1:30, or 1:40, or 1:50, or 1:60, or 1:70, or 1:80, or 1:90, or 1:100, or 1:125, or 1:150, or 1:200, or 1:250, or 1:300, or 1:400, or 1:500, or 1:750, or 1:1,000, or 1:1,500, or 1:2,000, or 1:10,000.
In some embodiments, a solution comprising sodium+sulfur dioxide species may comprise sodium sulfite, or sodium bisulfite, or sodium sesquisulfite, or sodium sulfate, or sulfate, sodium bicarbonate, or sodium carbonate, or sodium sesquicarbonate, or free carbon dioxide, or sodium acetate, or calcium, or any combination thereof. In some embodiments, the molar ratio of sodium:sulfur may be greater than or equal to, including, but not limited to, one or more or any combination of the following: 1:0.001, or 1:0.01, or 1:0.1, or 1:0.2, or 1:0.3, or 1:0.4, or 1:0.5, or 1:0.6, or 1:0.7, or 1:0.8, or 1:0.9, or 1:1, or 1:1.1, or 1:1.2, or 1:1.3, or 1:1.4, or 1:1.5, or 1:1.75, or 1:2, or 1:2.5, or 1:3, or 1:3.5, or 1:4, or 1:4.5, or 1:5, or 1:7.5, or 1:10, or 1:15, or 1:20, or 1:30, or 1:40, or 1:50, or 1:60, or 1:70, or 1:80, or 1:90, or 1:100, or 1:125, or 1:150, or 1:200, or 1:250, or 1:300, or 1:400, or 1:500, or 1:750, or 1:1,000, or 1:1,500, or 1:2,000, or 1:10,000.
Sodium may be provided as an example alkali. Other alkalis or alkali-like cations may be employed instead of, or in addition to, for example, sodium. For example, other alkalis or alkali-like cations may include, but may be not limited to, one or more or any combination of the following: lithium (Li), or sodium (Na), or potassium (K), or rubidium (Rb), or cesium (Cs), or ammonia, or ammonium, or ammonia (NH₃), or ammonium (NH₄), or amine, or ammonia-derivative, or nitrogenous cation.
Calcium may be provided as an example alkaline-earth. Other alkaline-earths or alkaline-earth-like cations may be employed instead of, or in addition to, for example, calcium. For example, other alkaline-earths or alkaline-earth-like cations may include, but may be not limited to, one or more or any combination of the following: beryllium (Be), magnesium (Mg), calcium (Ca), strontium (Sr), barium (Ba), and radium (Ra), or amine, or ammonia-derivative, or nitrogenous cation.
In some embodiments, acetic acid or acetate may be provided as an example carboxylic acid, or acid, or an acid with a vapor pressure less than water, or an acid with a vapor pressure less than carbon dioxide, or an acid with a boiling point greater than water, or an acid with a boiling point greater than carbon dioxide, a weak acid with a vapor pressure less than water, or an weak acid with a vapor pressure less than carbon dioxide, or a weak acid with a boiling point greater than water, or a weak acid with a boiling point greater than carbon dioxide, or any combination thereof. In some embodiments, acetic acid or acetate may be provided as an example carboxylic acid, or acid, or acid stronger than carbonic acid and weaker than sulfurous acid, or any combination thereof. Other carboxylic acids, or acids, or acids stronger than carbonic acid and weaker than sulfurous acid, or any combination thereof may be employed instead of, or in addition to, for example, acetic acid. In some embodiments, acids, or carboxylic acids, or any combination thereof may be employed and may include, but are not limited to, one or more or any combination of the following: formic acid, or acetic acid, or propanoic acid, or volatile acid, or non-volatile acid, or low vapor pressure acid, or acid with a vapor pressure low than that of water, or acid with a boiling point temperature higher than water, or organic acid with a boiling point temperature higher than water, or organic acid with a boiling point temperature similar to water, or citric acid, or malic acid, Tartaric Acid, or Fumaric acid, or Adipic Acid, or Benzoic Acid, or Succinic Acid, or oxalic acid, or Lactic acid, or glycolic acid, or Glyceric acid, or gluconic acid, or glyoxylic acid, or butyric acid, or Valeric acid, or Isocyanic acid, or C1 acids, or C2 acids, or C3 acids, or C4 acids, or C5 acids, or C6 acids, or C7 acids, or C8 acids, or C9 acids, or C10 acids, or an acid with a vapor pressure less than water, or an acid with a vapor pressure less than carbon dioxide, or an acid with a boiling point greater than water, or an acid with a boiling point greater than carbon dioxide, a weak acid with a vapor pressure less than water, or an weak acid with a vapor pressure less than carbon dioxide, or a weak acid with a boiling point greater than water, or a weak acid with a boiling point greater than carbon dioxide, or carboxylic acids known in the art, or acids known in the art.
Carbonate or bicarbonate or carbonic acid or carbon dioxide may be provided as an example of an acid gas, or acid gas species, or pH reducer. Other acids, or acids weaker than some carboxylic acids, or acid gases, or any combination thereof may be employed instead of, or in addition to, carbonate or bicarbonate or carbonic acid or carbon dioxide species. Other acids, or acids weaker than some carboxylic acids, or acid gases, or any combination thereof or any combination thereof may include, but may be not limited to, one or more or any combination of the following: silicates, or silicon derivatives, or iron derivatives, or transition metal derivatives, or metal derivative anions, or ferrites, or ferrates, or aluminates, or silicates, or oxide anions, or sulfides, or hydrogen sulfide, or nitrites, or sulfites, or sulfur dioxide.
In some embodiments, the concentration of a chemical or solute or dissolved gas or any combination thereof in a solution may be less than, or equal to, or greater than, including, but not limited to, one or more or any combination of the following: 0.01 g/L, or 0.05 g/L, or 0.1 g/L, or 0.25 g/L, or 0.5 g/L, or 0.75 g/L, or 1 g/L, or 2 g/L, or 3 g/L, or 4 g/L, or 5 g/L, or 10 g/L, or 15 g/L, or 20 g/L, or 25 g/L, or 30 g/L, or 35 g/L, or 40 g/L, or 45 g/L, or 50 g/L, or 55 g/L, or 60 g/L, or 65 g/L, or 70 g/L, or 75 g/L, or 80 g/L, or 85 g/L, or 90 g/L, or 95 g/L, or 100 g/L, or 105 g/L, or 110 g/L, or 115 g/L, or 120 g/L, or 125 g/L, or 130 g/L, or 135 g/L, or 140 g/L, or 145 g/L, or 150 g/L, or 155 g/L, or 160 g/L, or 165 g/L, or 170 g/L, or 175 g/L, or 180 g/L, or 185 g/L, or 190 g/L, or 195 g/L, or 200 g/L, or 205 g/L, or 210 g/L, or 215 g/L, or 220 g/L, or 225 g/L, or 230 g/L, or 235 g/L, or 240 g/L, or 245 g/L, or 250 g/L, or 255 g/L, or 260 g/L, or 265 g/L, or 270 g/L, or 275 g/L, or 280 g/L, or 285 g/L, or 290 g/L, or 295 g/L, or 300 g/L, or 305 g/L, or 310 g/L, or 315 g/L, or 320 g/L, or 325 g/L, or 330 g/L, or 335 g/L, or 340 g/L, or 345 g/L, or 350 g/L, or 355 g/L, or 360 g/L, or 365 g/L, or 370 g/L, or 375 g/L, or 380 g/L, or 385 g/L, or 390 g/L, or 395 g/L, or 400 g/L, or 405 g/L, or 410 g/L, or 415 g/L, or 420 g/L, or 425 g/L, or 430 g/L, or 435 g/L, or 440 g/L, or 445 g/L, or 450 g/L, or 455 g/L, or 460 g/L, or 465 g/L, or 470 g/L, or 475 g/L, or 480 g/L, or 485 g/L, or 490 g/L, or 495 g/L, or 500 g/L, or 505 g/L, or 510 g/L, or 515 g/L, or 520 g/L, or 525 g/L, or 530 g/L, or 535 g/L, or 540 g/L, or 545 g/L, or 550 g/L, or 555 g/L, or 560 g/L, or 565 g/L, or 570 g/L, or 575 g/L, or 580 g/L, or 585 g/L, or 590 g/L, or 595 g/L, or 600 g/L, or 605 g/L, or 610 g/L, or 615 g/L, or 620 g/L, or 625 g/L, or 630 g/L, or 635 g/L, or 640 g/L, or 645 g/L, or 650 g/L, or 655 g/L, or 660 g/L, or 665 g/L, or 670 g/L, or 675 g/L, or 680 g/L, or 685 g/L, or 690 g/L, or 695 g/L, or 700 g/L, or 705 g/L, or 710 g/L, or 715 g/L, or 720 g/L, or 725 g/L, or 730 g/L, or 735 g/L, or 740 g/L, or 745 g/L, or 750 g/L, or 755 g/L, or 760 g/L, or 765 g/L, or 770 g/L, or 775 g/L, or 780 g/L, or 785 g/L, or 790 g/L, or 795 g/L, or 800 g/L, or 805 g/L, or 810 g/L, or 815 g/L, or 820 g/L, or 825 g/L, or 830 g/L, or 835 g/L, or 840 g/L, or 845 g/L, or 850 g/L, or 855 g/L, or 860 g/L, or 865 g/L, or 870 g/L, or 875 g/L, or 880 g/L, or 885 g/L, or 890 g/L, or 895 g/L, or 900 g/L, or 905 g/L, or 910 g/L, or 915 g/L, or 920 g/L, or 925 g/L, or 930 g/L, or 935 g/L, or 940 g/L, or 945 g/L, or 950 g/L, or 955 g/L, or 960 g/L, or 965 g/L, or 970 g/L, or 975 g/L, or 980 g/L, or 985 g/L, or 990 g/L, or 995 g/L, or 1000 g/L
In some embodiments, the concentration of a chemical or solute or dissolved gas or any combination thereof in a solution may be less than, or equal to, or greater than, including, but not limited to, one or more or any combination of the following: 0.0001 g/1000 g water, or 0.001 g/1000 g water, or 0.01 g/1000 g water, or 0.05 g/1000 g water, or 0.10 g/1000 g water, or 0.20 g/1000 g water, or 0.50 g/1000 g water, or 0.75 g/1000 g water, or 1 g/1000 g water, or 2 g/1000 g water, or 3 g/1000 g water, or 4 g/1000 g water, or 5 g/1000 g water, 6 g/1000 g water, or 7 g/1000 g water, or 8 g/1000 g water, or 9 g/1000 g water, or 10 g/1000 g water, or 20 g/1000 g water, or 30 g/1000 g water, or 40 g/1000 g water, or 50 g/1000 g water, or 60 g/1000 g water, or 70 g/1000 g water, or 80 g/1000 g water, or 90 g/1000 g water, or 100 g/1000 g water, or 110 g/1000 g water, or 120 g/1000 g water, or 130 g/1000 g water, or 140 g/1000 g water, or 150 g/1000 g water, or 160 g/1000 g water, or 170 g/1000 g water, or 180 g/1000 g water, or 190 g/1000 g water, or 200 g/1000 g water, or 210 g/1000 g water, or 220 g/1000 g water, or 230 g/1000 g water, or 240 g/1000 g water, or 250 g/1000 g water, or 260 g/1000 g water, or 270 g/1000 g water, or 280 g/1000 g water, or 290 g/1000 g water, or 300 g/1000 g water, or 310 g/1000 g water, or 320 g/1000 g water, or 330 g/1000 g water, or 340 g/1000 g water, or 350 g/1000 g water, or 360 g/1000 g water, or 370 g/1000 g water, or 380 g/1000 g water, or 390 g/1000 g water, or 400 g/1000 g water, or 410 g/1000 g water, or 420 g/1000 g water, or 430 g/1000 g water, or 440 g/1000 g water, or 450 g/1000 g water, or 460 g/1000 g water, or 470 g/1000 g water, or 480 g/1000 g water, or 490 g/1000 g water, or 500 g/1000 g water, or 510 g/1000 g water, or 520 g/1000 g water, or 530 g/1000 g water, or 540 g/1000 g water, or 550 g/1000 g water, or 560 g/1000 g water, or 570 g/1000 g water, or 580 g/1000 g water, or 590 g/1000 g water, or 600 g/1000 g water, or 610 g/1000 g water, or 620 g/1000 g water, or 630 g/1000 g water, or 640 g/1000 g water, or 650 g/1000 g water, or 660 g/1000 g water, or 670 g/1000 g water, or 680 g/1000 g water, or 690 g/1000 g water, or 700 g/1000 g water, or 710 g/1000 g water, or 720 g/1000 g water, or 730 g/1000 g water, or 740 g/1000 g water, or 750 g/1000 g water, or 760 g/1000 g water, or 770 g/1000 g water, or 780 g/1000 g water, or 790 g/1000 g water, or 800 g/1000 g water, or 810 g/1000 g water, or 820 g/1000 g water, or 830 g/1000 g water, or 840 g/1000 g water, or 850 g/1000 g water, or 860 g/1000 g water, or 870 g/1000 g water, or 880 g/1000 g water, or 890 g/1000 g water, or 900 g/1000 g water, or 910 g/1000 g water, or 920 g/1000 g water, or 930 g/1000 g water, or 940 g/1000 g water, or 950 g/1000 g water, or 960 g/1000 g water, or 970 g/1000 g water, or 980 g/1000 g water, or 990 g/1000 g water, or 1000 g/1000 g water, or 1,250 g/1000 g water, or 1,500 g/1000 g water, or 2,000 g/1000 g water, or 2,500 g/1000 g water, or 3,000 g/1000 g water.
In some embodiments, a pressure, or a partial pressure, or any combination thereof may be greater than or equal to one or more or any combination of the following: 1 Bar, or 5 Bar, or 10 Bar, or 15 Bar, or 20 Bar, or 25 Bar, or 30 Bar, or 40 Bar, or 50 Bar, or 60 Bar, or 70 Bar, or 80 Bar, or 90 Bar, or 100 Bar, or 110 Bar, or 120 Bar, or 130 Bar, or 140 Bar, or 150 Bar, or 175 Bar, or 200 Bar, or 225 Bar, or 250 Bar, 300 Bar, or 350 Bar, or 400 Bar, or 450 Bar, or 500 Bar, or 600 Bar, or 700 Bar, or 800 Bar, or 900 Bar, or 1,000 Bar, or 1,500 Bar, or 2,000 Bar.
In some embodiments, a temperature may be, including, but not limited to, for example, less than, or equal to, or greater than one or more or any combination of the following: −100 degrees Celsius, or −90 degrees Celsius, or −80 degrees Celsius, or −70 degrees Celsius, or −60 degrees Celsius, or −50 degrees Celsius, or −40 degrees Celsius, or −30 degrees Celsius, or −20 degrees Celsius, or −18 degrees Celsius, or −16 degrees Celsius, or −14 degrees Celsius, or −12 degrees Celsius, or −10 degrees Celsius, or −8 degrees Celsius, or −6 degrees Celsius, or −4 degrees Celsius, or −2 degrees Celsius, or 0 degrees Celsius, or 2 degrees Celsius, or 4 degrees Celsius, or 6 degrees Celsius, or 8 degrees Celsius, or 10 degrees Celsius, or 12 degrees Celsius, or 14 degrees Celsius, or 16 degrees Celsius, or 18 degrees Celsius, or 20 degrees Celsius, or 22 degrees Celsius, or 24 degrees Celsius, or 26 degrees Celsius, or 28 degrees Celsius, or 30 degrees Celsius, or 32 degrees Celsius, or 34 degrees Celsius, or 36 degrees Celsius, or 38 degrees Celsius, or 40 degrees Celsius, or 42 degrees Celsius, or 44 degrees Celsius, or 46 degrees Celsius, or 48 degrees Celsius, or 50 degrees Celsius, or 52 degrees Celsius, or 54 degrees Celsius, or 56 degrees Celsius, or 58 degrees Celsius, or 60 degrees Celsius, or 62 degrees Celsius, or 64 degrees Celsius, or 66 degrees Celsius, or 68 degrees Celsius, or 70 degrees Celsius, or 72 degrees Celsius, or 74 degrees Celsius, or 76 degrees Celsius, or 78 degrees Celsius, or 80 degrees Celsius, or 82 degrees Celsius, or 84 degrees Celsius, or 86 degrees Celsius, or 88 degrees Celsius, or 90 degrees Celsius, or 92 degrees Celsius, or 94 degrees Celsius, or 96 degrees Celsius, or 98 degrees Celsius, or 100 degrees Celsius, or 102 degrees Celsius, or 104 degrees Celsius, or 106 degrees Celsius, or 108 degrees Celsius, or 110 degrees Celsius, or 112 degrees Celsius, or 114 degrees Celsius, or 116 degrees Celsius, or 118 degrees Celsius, or 120 degrees Celsius, or 122 degrees Celsius, or 124 degrees Celsius, or 126 degrees Celsius, or 128 degrees Celsius, or 130 degrees Celsius, or 132 degrees Celsius, or 134 degrees Celsius, or 136 degrees Celsius, or 138 degrees Celsius, or 140 degrees Celsius, or 142 degrees Celsius, or 144 degrees Celsius, or 146 degrees Celsius, or 148 degrees Celsius, or 150 degrees Celsius, or 160 degrees Celsius, or 170 degrees Celsius, or 180 degrees Celsius, or 190 degrees Celsius, or 200 degrees Celsius, or 210 degrees Celsius, or 220 degrees Celsius, or 230 degrees Celsius, or 240 degrees Celsius, or 250 degrees Celsius, or 260 degrees Celsius, or 270 degrees Celsius, or 280 degrees Celsius, or 290 degrees Celsius, or 300 degrees Celsius, or 310 degrees Celsius, or 320 degrees Celsius, or 330 degrees Celsius, or 340 degrees Celsius, or 350 degrees Celsius, or 360 degrees Celsius, or 370 degrees Celsius, or 380 degrees Celsius, or 390 degrees Celsius, or 400 degrees Celsius, or 410 degrees Celsius, or 420 degrees Celsius, or 430 degrees Celsius, or 440 degrees Celsius, or 450 degrees Celsius, or 460 degrees Celsius, or 470 degrees Celsius, or 480 degrees Celsius, or 490 degrees Celsius, or 500 degrees Celsius, or 510 degrees Celsius, or 520 degrees Celsius, or 530 degrees Celsius, or 540 degrees Celsius, or 550 degrees Celsius, or 560 degrees Celsius, or 570 degrees Celsius, or 580 degrees Celsius, or 590 degrees Celsius, or 600 degrees Celsius, or 610 degrees Celsius, or 620 degrees Celsius, or 630 degrees Celsius, or 640 degrees Celsius, or 650 degrees Celsius, or 660 degrees Celsius, or 670 degrees Celsius, or 680 degrees Celsius, or 690 degrees Celsius, or 700 degrees Celsius, or 710 degrees Celsius, or 720 degrees Celsius, or 730 degrees Celsius, or 740 degrees Celsius, or 750 degrees Celsius, or 760 degrees Celsius, or 770 degrees Celsius, or 780 degrees Celsius, or 790 degrees Celsius, or 800 degrees Celsius, or 810 degrees Celsius, or 820 degrees Celsius, or 830 degrees Celsius, or 840 degrees Celsius, or 850 degrees Celsius, or 860 degrees Celsius, or 870 degrees Celsius, or 880 degrees Celsius, or 890 degrees Celsius, or 900 degrees Celsius, or 910 degrees Celsius, or 920 degrees Celsius, or 930 degrees Celsius, or 940 degrees Celsius, or 950 degrees Celsius, or 960 degrees Celsius, or 970 degrees Celsius, or 980 degrees Celsius, or 990 degrees Celsius, or 1000 degrees Celsius, or 1010 degrees Celsius, or 1020 degrees Celsius, or 1030 degrees Celsius, or 1040 degrees Celsius, or 1050 degrees Celsius, or 1060 degrees Celsius, or 1070 degrees Celsius, or 1080 degrees Celsius, or 1090 degrees Celsius, or 1100 degrees Celsius, or 1110 degrees Celsius, or 1120 degrees Celsius, or 1130 degrees Celsius, or 1140 degrees Celsius, or 1150 degrees Celsius, or 1160 degrees Celsius, or 1170 degrees Celsius, or 1180 degrees Celsius, or 1190 degrees Celsius, or 1200 degrees Celsius, or 1210 degrees Celsius, or 1220 degrees Celsius, or 1230 degrees Celsius, or 1240 degrees Celsius, or 1250 degrees Celsius, or 1260 degrees Celsius, or 1270 degrees Celsius, or 1280 degrees Celsius, or 1290 degrees Celsius, or 1300 degrees Celsius, or 1310 degrees Celsius, or 1320 degrees Celsius, or 1330 degrees Celsius, or 1340 degrees Celsius, or 1350 degrees Celsius, or 1360 degrees Celsius, or 1370 degrees Celsius, or 1380 degrees Celsius, or 1390 degrees Celsius, or 1400 degrees Celsius, or 1410 degrees Celsius, or 1420 degrees Celsius, or 1430 degrees Celsius, or 1440 degrees Celsius, or 1450 degrees Celsius, or 1460 degrees Celsius, or 1470 degrees Celsius, or 1480 degrees Celsius, or 1490 degrees Celsius, or 1500 degrees Celsius, or 1600 degrees Celsius, or 1700 degrees Celsius, or 1800 degrees Celsius, or 1900 degrees Celsius, or 2000 degrees Celsius, or 2250 degrees Celsius, or 2500 degrees Celsius, or 2750 degrees Celsius, or 3000 degrees Celsius, or 4000 degrees Celsius, or 5000 degrees Celsius, or 6000 degrees Celsius, or 7000 degrees Celsius.
In some embodiments, a pH may be, including, but not limited to, for example, less than, or equal to, or greater than one or more or any combination of the following: pH of 0.1, or pH of 0.2, or pH of 0.3, or pH of 0.4, or pH of 0.5, or pH of 0.6, or pH of 0.7, or pH of 0.8, or pH of 0.9, or pH of 1.0, or pH of 1.1, or pH of 1.2, or pH of 1.3, or pH of 1.4, or pH of 1.5, or pH of 1.6, or pH of 1.7, or pH of 1.8, or pH of 1.9, or pH of 2.0, or pH of 2.1, or pH of 2.2, or pH of 2.3, or pH of 2.4, or pH of 2.5, or pH of 2.6, or pH of 2.7, or pH of 2.8, or pH of 2.9, or pH of 3.0, or pH of 3.1, or pH of 3.2, or pH of 3.3, or pH of 3.4, or pH of 3.5, or pH of 3.6, or pH of 3.7, or pH of 3.8, or pH of 3.9, or pH of 4.0, or pH of 4.1, or pH of 4.2, or pH of 4.3, or pH of 4.4, or pH of 4.5, or pH of 4.6, or pH of 4.7, or pH of 4.8, or pH of 4.9, or pH of 5.0, or pH of 5.1, or pH of 5.2, or pH of 5.3, or pH of 5.4, or pH of 5.5, or pH of 5.6, or pH of 5.7, or pH of 5.8, or pH of 5.9, or pH of 6.0, or pH of 6.1, or pH of 6.2, or pH of 6.3, or pH of 6.4, or pH of 6.5, or pH of 6.6, or pH of 6.7, or pH of 6.8, or pH of 6.9, or pH of 7.0, or pH of 7.1, or pH of 7.2, or pH of 7.3, or pH of 7.4, or pH of 7.5, or pH of 7.6, or pH of 7.7, or pH of 7.8, or pH of 7.9, or pH of 8.0, or pH of 8.1, or pH of 8.2, or pH of 8.3, or pH of 8.4, or pH of 8.5, or pH of 8.6, or pH of 8.7, or pH of 8.8, or pH of 8.9, or pH of 9.0, or pH of 9.1, or pH of 9.2, or pH of 9.3, or pH of 9.4, or pH of 9.5, or pH of 9.6, or pH of 9.7, or pH of 9.8, or pH of 9.9, or pH of 10.0, or pH of 10.1, or pH of 10.2, or pH of 10.3, or pH of 10.4, or pH of 10.5, or pH of 10.6, or pH of 10.7, or pH of 10.8, or pH of 10.9, or pH of 11.0, or pH of 11.1, or pH of 11.2, or pH of 11.3, or pH of 11.4, or pH of 11.5, or pH of 11.6, or pH of 11.7, or pH of 11.8, or pH of 11.9, or pH of 12.0, or pH of 12.1, or pH of 12.2, or pH of 12.3, or pH of 12.4, or pH of 12.5, or pH of 12.6, or pH of 12.7, or pH of 12.8, or pH of 12.9, or pH of 13.0, or pH of 13.1, or pH of 13.2, or pH of 13.3, or pH of 13.4, or pH of 13.5, or pH of 13.6, or pH of 13.7, or pH of 13.8, or pH of 13.9, or pH of 14.0, or pH of 14.1, or pH of 14.2, or pH of 14.3, or pH of 14.4, or pH of 14.5, or pH of 14.6, or pH of 14.7, or pH of 14.8, or pH of 14.9, or pH of 15.0
In some embodiments, a concentration, or molar concentration, or any combination thereof may be, including, but not limited to, for example, less than, or equal to, or greater than one or more or any combination of the following: 0.000001M, or 0.00001M, or 0.0001M, or 0.0005M, or 0.001M, or 0.005M, or 0.01M, or 0.015M, or 0.02M, or 0.025M, or 0.03M, or 0.035M, or 0.04M, or 0.045M, or 0.05M, or 0.055M, or 0.06M, or 0.065M, or 0.07M, or 0.075M, or 0.08M, or 0.085M, or 0.09M, or 0.095M, or 0.1M, or 0.105M, or 0.11M, or 0.115M, or 0.12M, or 0.125M, or 0.13M, or 0.135M, or 0.14M, or 0.145M, or 0.15M, or 0.155M, or 0.16M, or 0.165M, or 0.17M, or 0.175M, or 0.18M, or 0.185M, or 0.19M, or 0.195M, or 0.2M, or 0.205M, or 0.21M, or 0.215M, or 0.22M, or 0.225M, or 0.23M, or 0.235M, or 0.24M, or 0.245M, or 0.25M, or 0.255M, or 0.26M, or 0.265M, or 0.27M, or 0.275M, or 0.28M, or 0.285M, or 0.29M, or 0.295M, or 0.3M, or 0.305M, or 0.31M, or 0.315M, or 0.32M, or 0.325M, or 0.33M, or 0.335M, or 0.34M, or 0.345M, or 0.35M, or 0.355M, or 0.36M, or 0.365M, or 0.37M, or 0.375M, or 0.38M, or 0.385M, or 0.39M, or 0.395M, or 0.4M, or 0.405M, or 0.41M, or 0.415M, or 0.42M, or 0.425M, or 0.43M, or 0.435M, or 0.44M, or 0.445M, or 0.45M, or 0.455M, or 0.46M, or 0.465M, or 0.47M, or 0.475M, or 0.48M, or 0.485M, or 0.49M, or 0.495M, or 0.5M, or 0.505M, or 0.51M, or 0.515M, or 0.52M, or 0.525M, or 0.53M, or 0.535M, or 0.54M, or 0.545M, or 0.55M, or 0.555M, or 0.56M, or 0.565M, or 0.57M, or 0.575M, or 0.58M, or 0.585M, or 0.59M, or 0.595M, or 0.6M, or 0.605M, or 0.61M, or 0.615M, or 0.62M, or 0.625M, or 0.63M, or 0.635M, or 0.64M, or 0.645M, or 0.65M, or 0.655M, or 0.66M, or 0.665M, or 0.67M, or 0.675M, or 0.68M, or 0.685M, or 0.69M, or 0.695M, or 0.7M, or 0.705M, or 0.71M, or 0.715M, or 0.72M, or 0.725M, or 0.73M, or 0.735M, or 0.74M, or 0.745M, or 0.75M, or 0.755M, or 0.76M, or 0.765M, or 0.77M, or 0.775M, or 0.78M, or 0.785M, or 0.79M, or 0.795M, or 0.8M, or 0.805M, or 0.81M, or 0.815M, or 0.82M, or 0.825M, or 0.83M, or 0.835M, or 0.84M, or 0.845M, or 0.85M, or 0.855M, or 0.86M, or 0.865M, or 0.87M, or 0.875M, or 0.88M, or 0.885M, or 0.89M, or 0.895M, or 0.9M, or 0.905M, or 0.91M, or 0.915M, or 0.92M, or 0.925M, or 0.93M, or 0.935M, or 0.94M, or 0.945M, or 0.95M, or 0.955M, or 0.96M, or 0.965M, or 0.97M, or 0.975M, or 0.98M, or 0.985M, or 0.99M, or 0.995M, or 1.0M, or 1.005M, or 1.01M, or 1.015M, or 1.02M, or 1.025M, or 1.03M, or 1.035M, or 1.04M, or 1.045M, or 1.05M, or 1.055M, or 1.06M, or 1.065M, or 1.07M, or 1.075M, or 1.08M, or 1.085M, or 1.09M, or 1.095M, or 1.1M, or 1.105M, or 1.11M, or 1.115M, or 1.12M, or 1.125M, or 1.13M, or 1.135M, or 1.14M, or 1.145M, or 1.15M, or 1.155M, or 1.16M, or 1.165M, or 1.17M, or 1.175M, or 1.18M, or 1.185M, or 1.19M, or 1.195M, or 1.2M, or 1.205M, or 1.21M, or 1.215M, or 1.22M, or 1.225M, or 1.23M, or 1.235M, or 1.24M, or 1.245M, or 1.25M, or 1.255M, or 1.26M, or 1.265M, or 1.27M, or 1.275M, or 1.28M, or 1.285M, or 1.29M, or 1.295M, or 1.3M, or 1.305M, or 1.31M, or 1.315M, or 1.32M, or 1.325M, or 1.33M, or 1.335M, or 1.34M, or 1.345M, or 1.35M, or 1.355M, or 1.36M, or 1.365M, or 1.37M, or 1.375M, or 1.38M, or 1.385M, or 1.39M, or 1.395M, or 1.4M, or 1.405M, or 1.41M, or 1.415M, or 1.42M, or 1.425M, or 1.43M, or 1.435M, or 1.44M, or 1.445M, or 1.45M, or 1.455M, or 1.46M, or 1.465M, or 1.47M, or 1.475M, or 1.48M, or 1.485M, or 1.49M, or 1.495M, or 1.5M, or 1.55M, or 1.6M, or 1.65M, or 1.7M, or 1.75M, or 1.8M, or 1.85M, or 1.9M, or 1.95M, or 2.0M, or 2.05M, or 2.1M, or 2.15M, or 2.2M, or 2.25M, or 2.3M, or 2.35M, or 2.4M, or 2.45M, or 2.5M, or 2.55M, or 2.6M, or 2.65M, or 2.7M, or 2.75M, or 2.8M, or 2.85M, or 2.9M, or 2.95M, or 3.0M, or 3.05M, or 3.1M, or 3.15M, or 3.2M, or 3.25M, or 3.3M, or 3.35M, or 3.4M, or 3.45M, or 3.5M, or 3.55M, or 3.6M, or 3.65M, or 3.7M, or 3.75M, or 3.8M, or 3.85M, or 3.9M, or 3.95M, or 4.0M, or 4.05M, or 4.1M, or 4.15M, or 4.2M, or 4.25M, or 4.3M, or 4.35M, or 4.4M, or 4.45M, or 4.5M, or 4.55M, or 4.6M, or 4.65M, or 4.7M, or 4.75M, or 4.8M, or 4.85M, or 4.9M, or 4.95M, or 5.0M, or 5.05M, or 5.1M, or 5.15M, or 5.2M, or 5.25M, or 5.3M, or 5.35M, or 5.4M, or 5.45M, or 5.5M, or 5.55M, or 5.6M, or 5.65M, or 5.7M, or 5.75M, or 5.8M, or 5.85M, or 5.9M, or 5.95M, or 6.0M, or 6.05M, or 6.1M, or 6.15M, or 6.2M, or 6.25M, or 6.3M, or 6.35M, or 6.4M, or 6.45M, or 6.5M, or 6.55M, or 6.6M, or 6.65M, or 6.7M, or 6.75M, or 6.8M, or 6.85M, or 6.9M, or 6.95M, or 7.0M, or 7.05M, or 7.1M, or 7.15M, or 7.2M, or 7.25M, or 7.3M, or 7.35M, or 7.4M, or 7.45M, or 7.5M, or 7.55M, or 7.6M, or 7.65M, or 7.7M, or 7.75M, or 7.8M, or 7.85M, or 7.9M, or 7.95M, or 8.0M, or 8.05M, or 8.1M, or 8.15M, or 8.2M, or 8.25M, or 8.3M, or 8.35M, or 8.4M, or 8.45M, or 8.5M, or 8.55M, or 8.6M, or 8.65M, or 8.7M, or 8.75M, or 8.8M, or 8.85M, or 8.9M, or 8.95M, or 9.0M, or 9.05M, or 9.1M, or 9.15M, or 9.2M, or 9.25M, or 9.3M, or 9.35M, or 9.4M, or 9.45M, or 9.5M, or 9.55M, or 9.6M, or 9.65M, or 9.7M, or 9.75M, or 9.8M, or 9.85M, or 9.9M, or 9.95M, or 10.0M, or 10.05M, or 10.1M, or 10.15M, or 10.2M, or 10.25M, or 10.3M, or 10.35M, or 10.4M, or 10.45M, or 10.5M, or 10.55M, or 10.6M, or 10.65M, or 10.7M, or 10.75M, or 10.8M, or 10.85M, or 10.9M, or 10.95M, or 11.0M, or 11.05M, or 11.1M, or 11.15M, or 11.2M, or 11.25M, or 11.3M, or 11.35M, or 11.4M, or 11.45M, or 11.5M, or 11.55M, or 11.6M, or 11.65M, or 11.7M, or 11.75M, or 11.8M, or 11.85M, or 11.9M, or 11.95M, or 12.0M, or 12.05M, or 12.1M, or 12.15M, or 12.2M, or 12.25M, or 12.3M, or 12.35M, or 12.4M, or 12.45M, or 12.5M, or 12.55M, or 12.6M, or 12.65M, or 12.7M, or 12.75M, or 12.8M, or 12.85M, or 12.9M, or 12.95M, or 13.0M, or 13.05M, or 13.1M, or 13.15M, or 13.2M, or 13.25M, or 13.3M, or 13.35M, or 13.4M, or 13.45M, or 13.5M, or 13.55M, or 13.6M, or 13.65M, or 13.7M, or 13.75M, or 13.8M, or 13.85M, or 13.9M, or 13.95M, or 14.0M, or 14.05M, or 14.1M, or 14.15M, or 14.2M, or 14.25M, or 14.3M, or 14.35M, or 14.4M, or 14.45M, or 14.5M, or 14.55M, or 14.6M, or 14.65M, or 14.7M, or 14.75M, or 14.8M, or 14.85M, or 14.9M, or 14.95M, or 15.0M, 15.5M, or 16.0M, or 16.5M, or 17.0M, or 17.5M, or 18.0M, or 18.5M, or 19.0M, or 19.5M, or 20.0M, or 20.5M, or 21.0M, or 21.5M, or 22.0M, or 22.5M, or 23.0M, or 23.5M, or 24.0M, or 24.5M, or 25.0M, or 25.5M, or 26.0M, or 26.5M, or 27.0M, or 27.5M, or 28.0M, or 28.5M, or 29.0M, or 29.5M, or 30.0M, or 30.5M, or 31.0M, or 31.5M, or 32.0M, or 32.5M, or 33.0M, or 33.5M, or 34.0M, or 34.5M, or 35.0M, or 35.5M, or 36.0M, or 36.5M, or 37.0M, or 37.5M, or 38.0M, or 38.5M, or 39.0M, or 39.5M, or 40.0M, or 40.5M, or 41.0M, or 41.5M, or 42.0M, or 42.5M, or 43.0M, or 43.5M, or 44.0M, or 44.5M, or 45.0M, or 45.5M, or 46.0M, or 46.5M, or 47.0M, or 47.5M, or 48.0M, or 48.5M, or 49.0M, or 49.5M, or 50.0M, or 50.5M, or 51.0M, or 51.5M, or 52.0M, or 52.5M, or 53.0M, or 53.5M, or 54.0M, or 54.5M, or 55.0M, or 55.5M, or 56.0M, or 56.5M, or 57.0M, or 57.5M, or 58.0M, or 58.5M, or 59.0M, or 59.5M, or 60.0M, or 60.5M, or 61.0M, or 61.5M, or 62.0M, or 62.5M, or 63.0M, or 63.5M, or 64.0M, or 64.5M, or 65.0M, or 65.5M, or 66.0M, or 66.5M, or 67.0M, or 67.5M, or 68.0M, or 68.5M, or 69.0M, or 69.5M, or 70.0M, or 70.5M, or 71.0M, or 71.5M, or 72.0M, or 72.5M, or 73.0M, or 73.5M, or 74.0M, or 74.5M, or 75.0M, or 75.5M, or 76.0M, or 76.5M, or 77.0M, or 77.5M, or 78.0M, or 78.5M, or 79.0M, or 79.5M, or 80.0M

### Example Definitions

In some embodiments, for example, ‘Substantially separating’ or ‘separating a portion of’ may be defined as separating one or more or any combination of the following percentages of a first chemical or species from a second chemical or species, which may be greater than or equal to one or more or any combination of the following: 0.001%, or 0.01%, or 0.1%, or 1%, or 5%, or 10%, or 15%, or 20%, or 25%, or 30%, or 35%, or 40%, or 45%, or 50%, or 55%, or 60%, or 65%, or 70%, or 75%, or 80%, or 85%, or 90%, or 95%, or 96%, or 97%, or 98%, or 99%, or 99.5% or 99.9% or 99.99% or 99.999%.

In some embodiments, a low molecular weight acid may comprise an acid with a molecular weight which may include, but is not limited to, less than or equal to one or more or any combination of the following: 10 g/mol, or 20 g/mol, or 30 g/mol, or 40 g/mol, or 50 g/mol, or 60 g/mol, or 70 g/mol, or 80 g/mol, or 90 g/mol, or 100 g/mol, or 110 g/mol, or 120 g/mol, or 130 g/mol, or 140 g/mol, or 150 g/mol, or 160 g/mol, or 170 g/mol, or 180 g/mol, or 190 g/mol, or 200 g/mol, or 210 g/mol, or 220 g/mol, or 230 g/mol, or 240 g/mol, or 250 g/mol, or 260 g/mol, or 270 g/mol, or 280 g/mol, or 290 g/mol, or 300 g/mol, or 310 g/mol, or 320 g/mol, or 330 g/mol, or 340 g/mol, or 350 g/mol, or 360 g/mol, or 370 g/mol, or 380 g/mol, or 390 g/mol, or 400 g/mol, or 410 g/mol, or 420 g/mol, or 430 g/mol, or 440 g/mol, or 450 g/mol, or 460 g/mol, or 470 g/mol, or 480 g/mol, or 490 g/mol, or 500 g/mol, or 510 g/mol, or 520 g/mol, or 530 g/mol, or 540 g/mol, or 550 g/mol, or 560 g/mol, or 570 g/mol, or 580 g/mol, or 590 g/mol, or 600 g/mol, or 610 g/mol, or 620 g/mol, or 630 g/mol, or 640 g/mol, or 650 g/mol, or 660 g/mol, or 670 g/mol, or 680 g/mol, or 690 g/mol, or 700 g/mol, or 710 g/mol, or 720 g/mol, or 730 g/mol, or 740 g/mol, or 750 g/mol, or 760 g/mol, or 770 g/mol, or 780 g/mol, or 790 g/mol, or 800 g/mol, or 810 g/mol, or 820 g/mol, or 830 g/mol, or 840 g/mol, or 850 g/mol, or 860 g/mol, or 870 g/mol, or 880 g/mol, or 890 g/mol, or 900 g/mol, or 910 g/mol, or 920 g/mol, or 930 g/mol, or 940 g/mol, or 950 g/mol, or 960 g/mol, or 970 g/mol, or 980 g/mol, or 990 g/mol, or 1000 g/mol

High Purity Definition: High purity of a component may be defined as a volume percent or weight percent concentration which may be greater than or equal to one or more or any combination of the following: 20%, or 30%, or 40%, or 50%, or 55%, or 60%, or 65%, or 70%, or 75%, or 80%, or 85%, or 90%, or 95%, or 96%, or 97%, or 98%, or 99%, or 99.5%, or 99.9%, or 99.99%, or 99.999%.

High Purity of Carbon Dioxide Definition: High purity of carbon dioxide may be defined as a volume percent or weight percent concentration greater than or equal to one or more or any combination of the following: 20%, or 30%, or 40%, or 50%, or 55%, or 60%, or 65%, or 70%, or 75%, or 80%, or 85%, or 90%, or 95%, or 96%, or 97%, or 98%, or 99%, or 99.5%, or 99.9%, or 99.99%, or 99.999%.

High Concentration Definition: High concentration of a component may be defined as a volume percent or weight percent concentration greater than or equal to one or more or any combination of the following: 0.001%, or 0.01%, or 0.1%, or 1%, or 5%, or 10%, or 15%, or 20%, or 25%, or 30%, or 35%, or 40%, or 45%, or 50%, or 55%, or 60%, or 65%, or 70%, or 75%, or 80%, or 85%, or 90%, or 95%, or 96%, or 97%, or 98%, or 99%, or 99.5%, or 99.9%, or 99.99%, or 99.999%.

High Concentration of Carbon Dioxide Definition: High concentration of a carbon dioxide may be defined as a volume percent or weight percent concentration greater than or equal to one or more or any combination of the following: 0.001%, or 0.01%, or 0.1%, or 1%, or 5%, or 10%, or 15%, or 20%, or 25%, or 30%, or 35%, or 40%, or 45%, or 50%, or 55%, or 60%, or 65%, or 70%, or 75%, or 80%, or 85%, or 90%, or 95%, or 96%, or 97%, or 98%, or 99%, or 99.5%, or 99.9%, or 99.99% or 99.999%.

High Partial Pressure Definition: High partial pressure of a component may be defined as a partial pressure greater than or equal to one or more or any combination of the following: 0.01 Bar, or 0.05 Bar, or 0.1 Bar, or 0.25 Bar, or 0.5 Bar, or 0.75 Bar, or 1 Bar, or 2 Bar, or 3 Bar, or 4 Bar, or 5 Bar, or 6 Bar, or 7 Bar, or 8 Bar, or 9 Bar, or 10 Bar, or 15 Bar, or 20 Bar, or 30 Bar, or 40 Bar, or 50 Bar, or 60 Bar, or 70 Bar, or 80 Bar, or 90 Bar, or 100 Bar, or 110 Bar, or 120 Bar, or 130 Bar, or 140 Bar, or 150 Bar, or 175 Bar, or 200 Bar, or 225 Bar, or 250 Bar, or 275 Bar, or 300 Bar, or 325 Bar, or 350 Bar, or 375 Bar, or 400 Bar, or 425 Bar, or 450 Bar, or 475 Bar, or 500 Bar, or 600 Bar, or 700 Bar, or 800 Bar, or 900 Bar, or 1,000 Bar, or 1,250 Bar, or 1,500 Bar, or 1,750 Bar, or 2,000 Bar, or 2,500 Bar, or 3,000 Bar, or 3,500 Bar, or 4,000 Bar, or 4,500 Bar, or 5,000 Bar, or 7,500 Bar, or 10,000 Bar.

High Partial Pressure of Carbon Dioxide Definition: High partial pressure of a component may be defined as a partial pressure greater than or equal to one or more or any combination of the following: 0.001 Bar, or 0.01 Bar, or 0.05 Bar, or 0.1 Bar, or 0.25 Bar, or 0.5 Bar, or 0.75 Bar, or 1 Bar, or 2 Bar, or 3 Bar, or 4 Bar, or 5 Bar, or 6 Bar, or 7 Bar, or 8 Bar, or 9 Bar, or 10 Bar, or 15 Bar, or 20 Bar, or 30 Bar, or 40 Bar, or 50 Bar, or 60 Bar, or 70 Bar, or 80 Bar, or 90 Bar, or 100 Bar, or 110 Bar, or 120 Bar, or 130 Bar, or 140 Bar, or 150 Bar, or 175 Bar, or 200 Bar, or 225 Bar, or 250 Bar, or 275 Bar, or 300 Bar, or 325 Bar, or 350 Bar, or 375 Bar, or 400 Bar, or 425 Bar, or 450 Bar, or 475 Bar, or 500 Bar, or 600 Bar, or 700 Bar, or 800 Bar, or 900 Bar, or 1,000 Bar, or 1,250 Bar, or 1,500 Bar, or 1,750 Bar, or 2,000 Bar, or 2,500 Bar, or 3,000 Bar, or 3,500 Bar, or 4,000 Bar, or 4,500 Bar, or 5,000 Bar, or 7,500 Bar, or 10,000 Bar.

Note: In some embodiments, carbon dioxide may be provided as an example weak acid derivative, or acid gas, or any combination thereof. Other weak acid derivatives, or acid gases, or any combination thereof may be employed instead of, or in addition to, carbon dioxide where carbon dioxide is described, and/or may include, but are not limited to, one or more or any combination of the following: hydrogen sulfide, or carbon dioxide, or carbonic acid, or hydrosulfurous acid, or mercaptan, or nitrogen dioxide, or sulfur dioxide, or silicon dioxide, or iron oxide, or metal oxide, or transition metal oxide, or aluminum oxide, or a weak acid derivative described herein, or a weak acid derivative described in the art, or an acid gas described herein, or an acid gas in the art, or a derivative thereof, or any combination thereof.

### Example FIG. Summaries

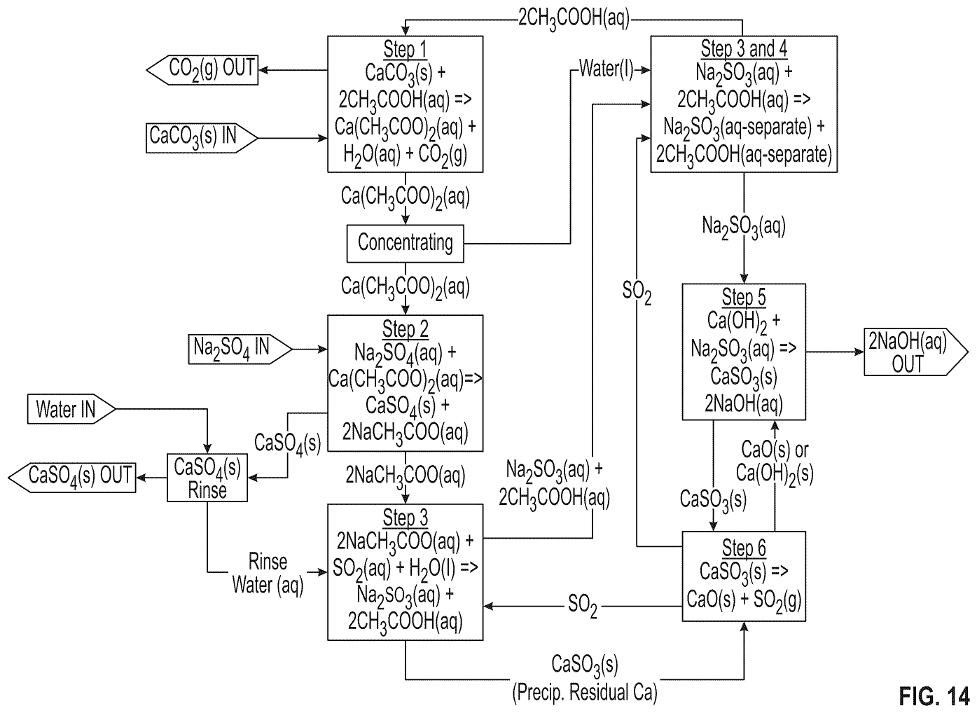

FIG. 14: Shows an example embodiment of a process for producing an alkali hydroxide from an alkali sulfate.

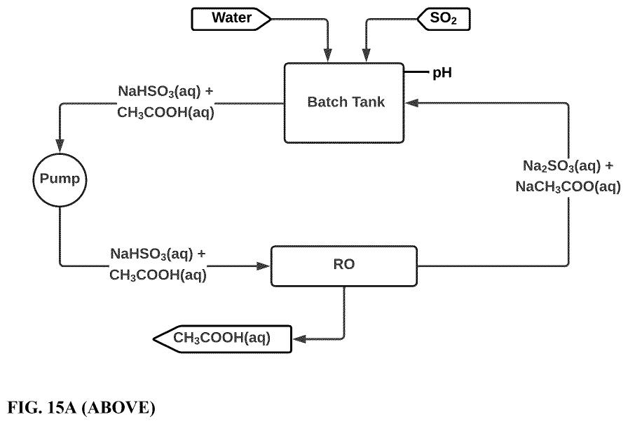

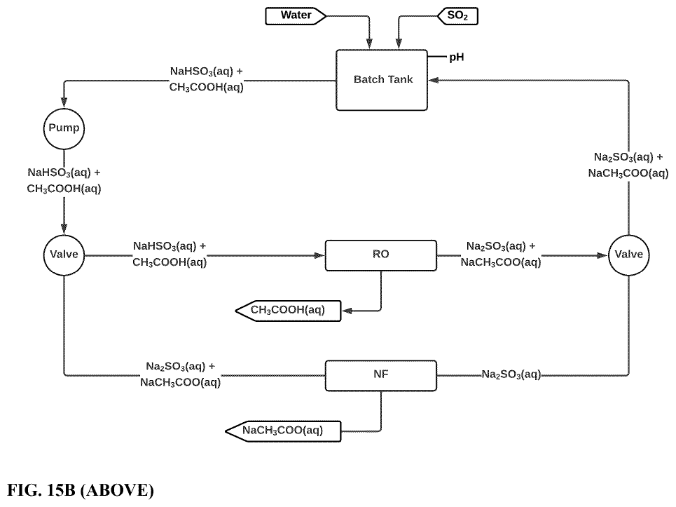

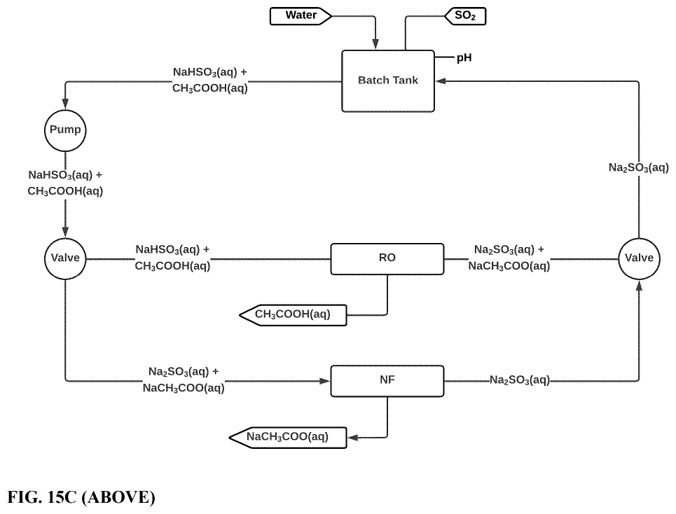

FIG. 15A: Shows an example embodiment of a batch configuration of an embodiment for separating at least a portion of acetic acid from a solution comprising at least a portion of sodium species and sulfur dioxide species.

FIG. 15B: Shows an example embodiment of a batch configuration of an embodiment for separating at least a portion of acetic acid from a solution comprising at least a portion of sodium species and sulfur dioxide species and employs NF to separate at least a portion of residual sodium acetate from sodium sulfite or sodium+sulfur dioxide species.

FIG. 15C: Shows an example embodiment of a batch configuration of an embodiment for separating at least a portion of acetic acid from a solution comprising at least a portion of sodium species and sulfur dioxide species and employs NF to separate at least a portion of residual sodium acetate from sodium sulfite or sodium+sulfur dioxide species.

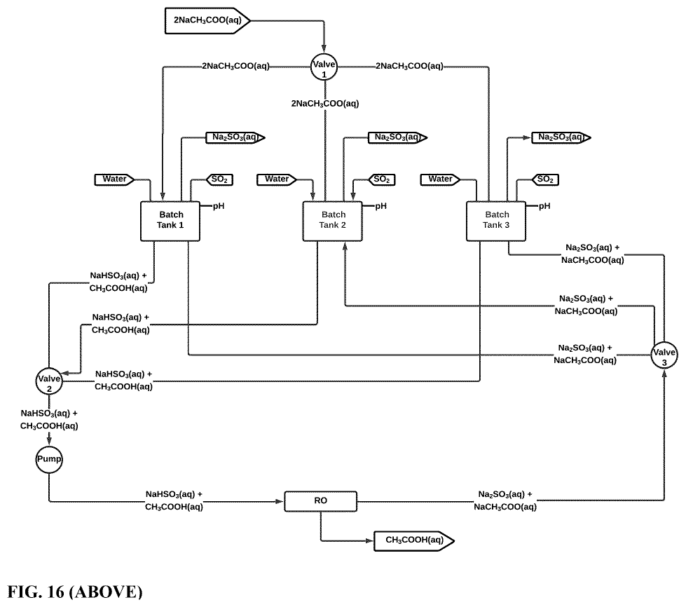

FIG. 16: Shows an example embodiment of a semi-batch configuration of an embodiment for separating at least a portion of acetic acid from a solution comprising at least a portion of sodium species and sulfur dioxide species.

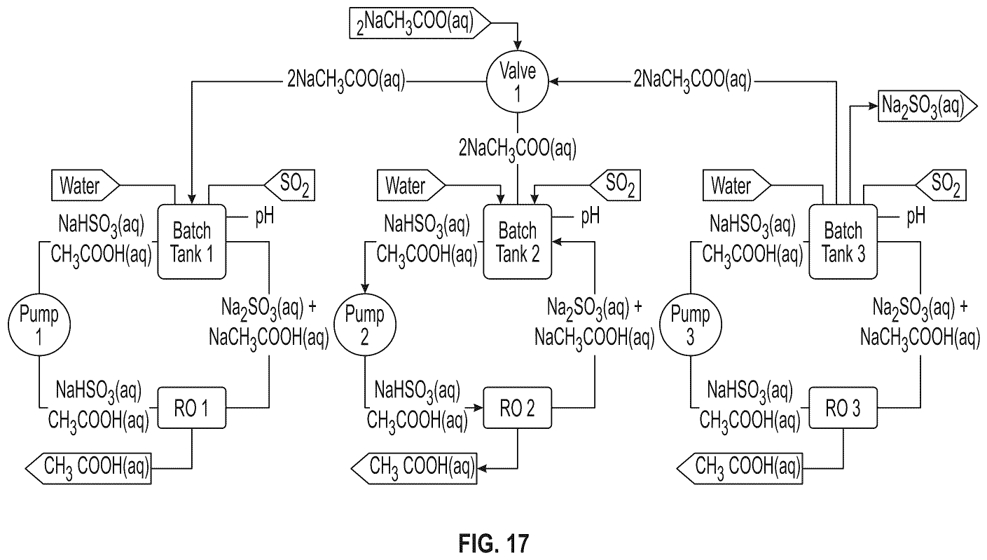

FIG. 17: Shows an example embodiment of a semi-batch configuration of an embodiment for separating at least a portion of acetic acid from a solution comprising at least a portion of sodium species and sulfur dioxide species with separate RO units for each batch.

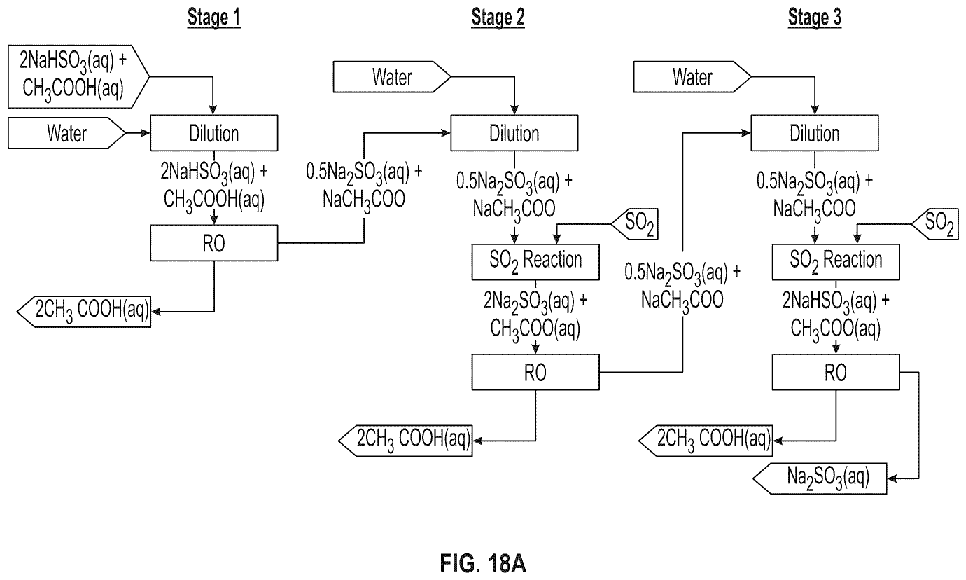

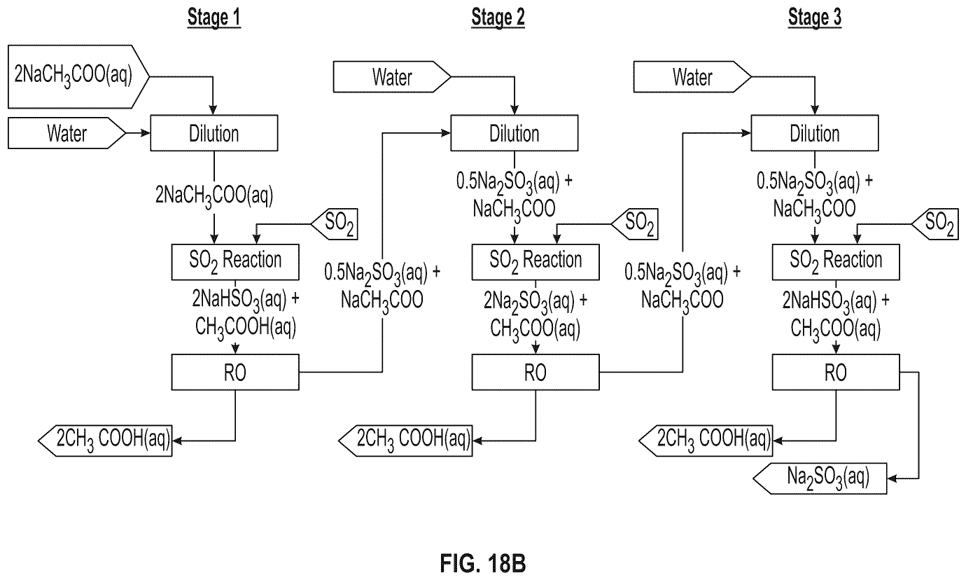

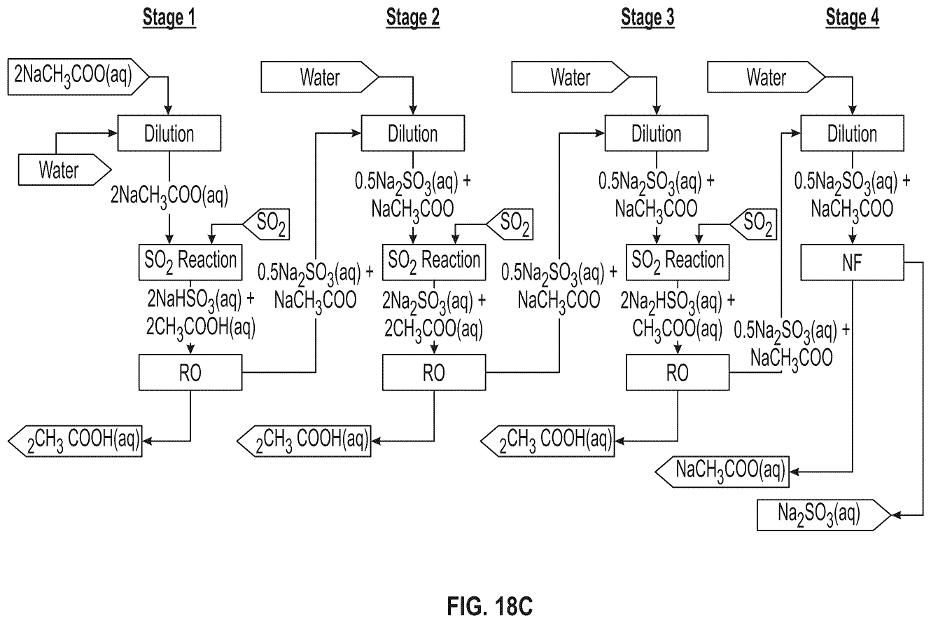

FIG. 18A: Shows a continuous configuration of an embodiment comprising multiple stages.

FIG. 18B: Shows a continuous configuration of an embodiment comprising multiple stages.

FIG. 18C: Shows a continuous configuration of an embodiment comprising multiple stages with RO stages and NF stages.

### SUMMARY

Some embodiments may pertain to systems and methods for Separating Carboxylic Acid Species from Sulfur Dioxide Species and/or integrated processes for the production of alkali hydroxides or alkali salts. Some embodiments may involve separating at least a portion of acetic acid from aqueous sodium and/or sulfur dioxide species, such as, for example sodium sulfite or sodium bisulfite, or any combination thereof. Some embodiments may utilize the difference in ionic and non-ionic species or speciation between sulfur dioxide species and acetic acid species in an aqueous solution with pH. For example, in some embodiments, within a pH range, sulfur dioxide species may be at least partially present in solution in an ionic form, while acetic acid species may be at least partially present in a solution in a non-ionic form, which may enable the separation of at least a portion of the non-ionic form acetic acid species from at least a portion of the ionic form sulfur dioxide species. Separation of at least a portion of acid species, such as acetic acid species, from a portion of pH reducer species, such as sulfur dioxide species, may be conducted using one or more or any combination of methods, which may include, but are not limited to, one or more or any combination of the following: reverse osmosis (RO), or nanofiltration (NF), or diffusion, or selective diffusion, or non-ionic selective diffusion, or electrodialysis (ED), or electro-deionization, or Ion Concentration Polarization (ICP), or membrane-based process, or forward osmosis, or high pressure reverse osmosis (HPRO), or osmotically assisted reverse osmosis, or monovalent selective electrodialysis, or ion selective separation, or vapor separation, or carrier gas separation, or carrier gas extraction, or membrane distillation, or stripping gas, or multi-effect distillation (MED), or multi-stage flash distillation (MSF), or mechanical vapor compression distillation (MVC), or extraction distillation, or conventional distillation, or column, or contactor, or membrane contactor, or countercurrent separation, or countercurrent exchange, or ion exchange, or ion exchange resin, or adsorption, or absorption. In some embodiments, at least a portion of the acetic acid non-ionic species may be separated from sulfur dioxide ionic species using a reverse osmosis-based approach. In some embodiments, at least a portion of acetate or sodium acetate species may be separated from at least a portion of sulfur dioxide species or sodium sulfite species using, for example, nanofiltration (NF). Some embodiments may be configured in a batch, or semi-batch, or continuous, or any combination thereof configuration(s).

### Chemistry of Mechanism of Some Embodiments and Steps of Some Embodiments

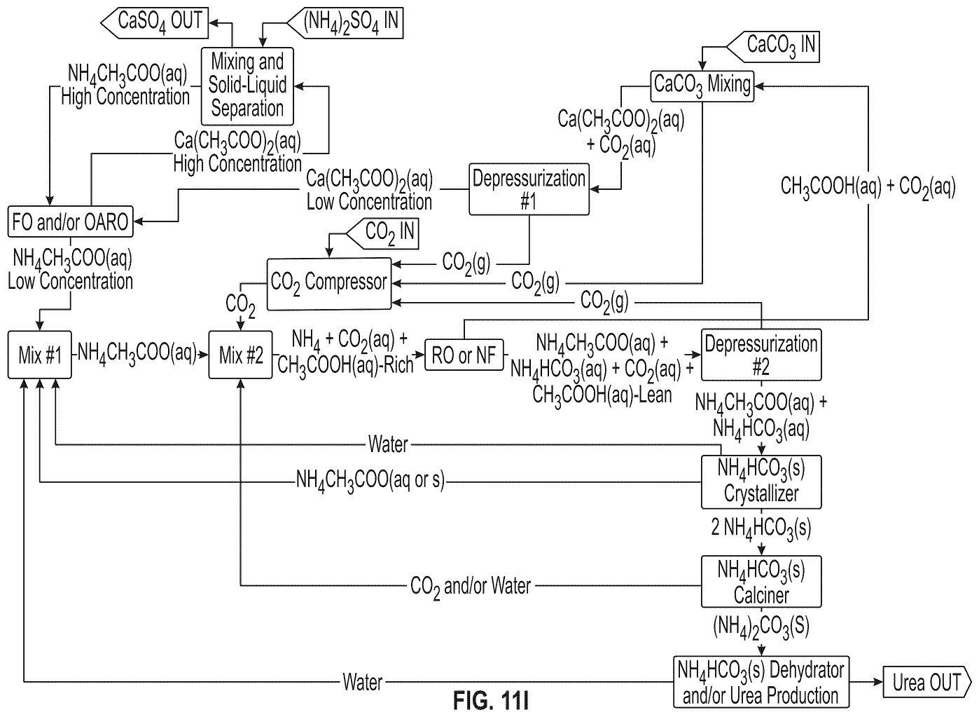

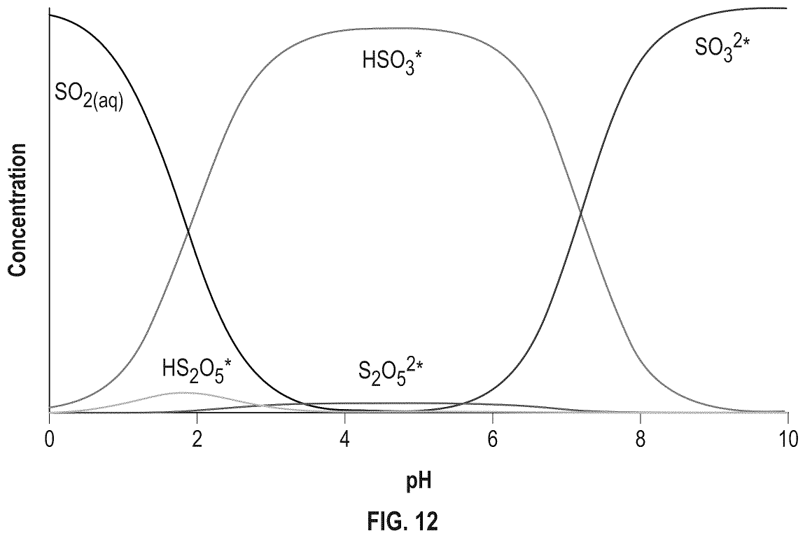

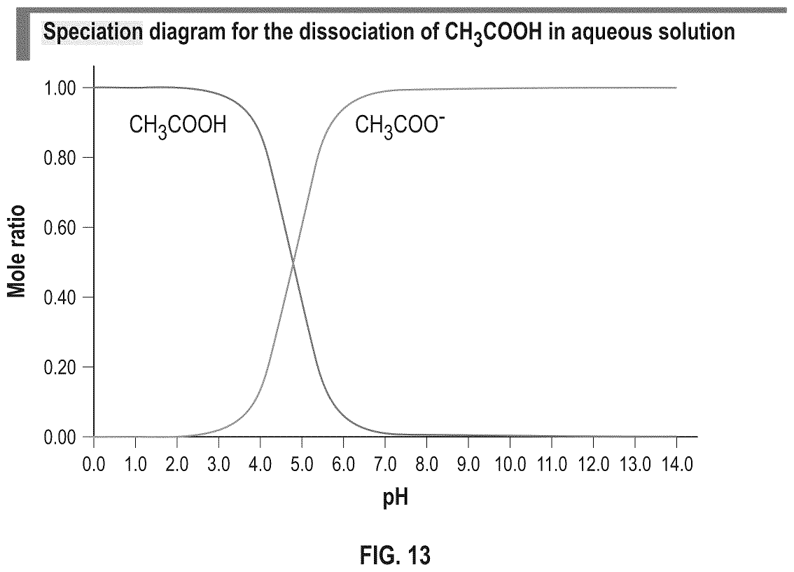

Some embodiments may employ or utilize the difference in speciation between sulfur dioxide species and acetic acid species vs. pH. As shown in FIG. 12 and FIG. 13 below, in the pH range of about 2 to 5, sulfur dioxide species may comprise ionic species (such as HSO₃_{⁻}), while acetic acid species may comprise non-ionic species (CH₃COOH or free acetic acid). For example, at a pH of about 3.8, the sulfur dioxide species may comprise almost entirely ionic species, while the acetic acid species may comprise almost entirely non-ionic species.

In some embodiments, at least a portion of sulfur dioxide may be added to a solution comprising at least a portion of sodium acetate to form a solution comprising sodium− acetic acid-sulfur dioxide species, wherein said formed solution may have a pH in a range wherein sulfur dioxide species comprise an ionic form and acetic acid species comprise a non-ionic form. In some embodiments, at least a portion of the solution may be separated using reverse osmosis to form a permeate comprising aqueous acetic acid and a retentate comprising ionic sodium− sulfur dioxide salt which may comprise residual acetic acid species. In some embodiments, as the reverse osmosis produces a permeate comprising acetic acid, the pH of the retentate may increase due to the increase in the molarity of sodium in proportion to the acetic acid species. In some embodiments, as acetic acid permeates the reverse osmosis membrane, the molar proportion of sulfur dioxide species may increase relative to acetic acid species, which may result in a decrease in the proportion of acetic acid species relative to sulfur dioxide species. In some embodiments, the lower molarity of acetic acid species in proportion to sulfur dioxide species, the greater the yield of sodium sulfite. In some embodiments, the retentate may be recirculated to the SO₂ and/or water addition step. The process operates as a loop, circulating solution continuously until the desired purity of the sodium− sulfur dioxide solution is achieved.

In some embodiments, a basic chemical, such as an alkali hydroxide or other basic chemical, may be added to a solution comprising sodium− sulfur dioxide and residual acetic acid species to, for example, increase the pH to a range where at least a portion of SO₃²⁻ or sulfite species may be present, which may enable at least a portion of sodium sulfite from sodium acetate, For example, in some embodiments, at least a portion of the acetate, such as sodium acetate, may be separated from at least a portion of the sulfite, such as sodium sulfite, using nanofiltration because, for example, sulfite may be divalent and acetate may be monovalent.

### Description of Some Example Embodiments

FIG. 14: Example embodiment integrated process using reverse osmosis and/or nanofiltration to separate acetic acid from sodium and sulfur dioxide species.

### Description of Some Example Embodiments

In some embodiments, a reaction product, or solution, or solid, or any combination thereof may comprise sodium bisulfite, or sodium metabisulfite, or sodium:sulfur ionic compound with a molar ratio of sulfur to sodium greater than 0.5. In some embodiments, it may be desirable to decompose at least a portion of the sodium+sulfur dioxide ionic compound to form at least a portion of sulfur dioxide and at least a portion of a sodium:sulfur ionic compound with a molar ratio of sulfur to sodium closer to 0.5.

Alternatively, or additionally, in some embodiments, it may be desirable to react at least a portion of a solution comprising sodium:sulfur ionic compound with a molar ratio of sulfur to sodium greater than 0.5 with a base, such as calcium carbonate, or calcium oxide, or calcium hydroxide, to form, for example, calcium sulfite solid, or carbon dioxide, or a sodium+sulfur dioxide ionic compound with a molar ratio of sulfur to sodium closer to 0.5, or any combination thereof. In some embodiments, it may be desirable to reduce the sulfur to sodium molar ratio of the sodium+sulfur dioxide species salt to, for example reduce the consumption of calcium hydroxide in, for example, the reaction of calcium hydroxide with sodium+sulfur dioxide species, or to reduce any unnecessary concentration or presence of calcium sulfite in a reaction producing sodium hydroxide, or any combination thereof.

### Example Embodiment with a Batch Configuration

FIG. 15A: FIG. 15A may show an example single batch configuration embodiment. In some embodiments, a mixing tank or batch tank may be filled with at least a portion of a solution comprising sodium acetate. Once the solution comprising sodium acetate may be added to the batch tank or mixing tank, at least a portion of sulfur dioxide and/or water may be added, while acetic acid may be separated from the solution as a permeate using reverse osmosis. In some embodiments, the process may continue until a desired purity of sodium− sulfur dioxide salt solution is achieved, or the process switches to a nanofiltration mode to achieve higher purity by removing residual acetate, or the process switches to a nanofiltration mode to achieve higher purity by removing residual acetate at a higher pH, or any combination thereof. In some embodiments, once the desired purity is achieved, the solution comprising sodium− sulfur dioxide salt may be transferred.

Please note that the species of the solutions and proportion of each reagent or chemical or species shown in one or more or any combination of figures herein may be shown as examples and may differ in an operating process. Additionally, in some embodiments, sodium and sulfite species may be at least partially in the bisulfite, or HSO₃—, or NaHSO₃ form in the feed and/or the retentate and/or vise versa.

In some embodiments, a batch tank may be filled with a solution comprising sodium acetate. In some embodiments, a chemical comprising sulfur dioxide and/or a chemical comprising water may be added to the solution, while a solution comprising acetic acid may be separated from the feed or retentate as a permeate using, for example, reverse osmosis or nanofiltration. In some embodiments, an operation may continue until a desired purity or concentration or amount of sodium− sulfur dioxide species may be achieved. In some embodiments, once a desired composition or amount may be achieved, a solution comprising sodium− sulfur dioxide salt may be transferred from a batch tank.

### FIG. 15A Example Step-by-Step Description

1. Filling Batch Tank: A solution comprising sodium acetate, for example, from Step 2, may be added to the batch tank or mixing tank, filling the batch tank or mixing tank to a desired liquid level.
2. Adding SO₂ and Water to the Solution in the Batch Tank while Simultaneously Separating Aqueous Acetic Acid using RO: Sulfur dioxide and/or water may be added to the solution comprising sodium acetate to form a solution comprising sodium− acetic acid-sulfur dioxide species at a desired pH, such as a pH wherein sulfur dioxide species comprise ionic species and acetic acid species comprise non-ionic species. The solution may be transferred from the batch tank or mixing tank into an RO system as a feed solution, forming a permeate solution comprising aqueous acetic acid, and a retentate solution comprising sodium− sulfur dioxide− acid species with a lower molar ratio of acetic acid. sulfur dioxide species than the feed solution. The retentate may be recirculated to the Batch Tank or mixing tank in a loop. In some embodiments, with each circulation, the concentration of acetic acid species relative to sodium− sulfur dioxide species may decrease and the purity of the sodium− sulfur dioxide solution may increase. The loop may circulate continuously until the desired purity of sodium− sulfur dioxide salt solution may be reached or achieved.
3. Emptying Batch Tank: In some embodiments, once the desired purity of sodium− sulfur dioxide salt solution may be achieved, the solution comprising sodium− sulfur dioxide salt may be transferred.

FIG. 15B (Above): FIG. 15B may show a process for separating at least a portion of acetic acid species from sodium+sulfur dioxide species.

FIG. 15C (Above): FIG. 15B may show a process for separating at least a portion of sodium acetate or sodium+ acetic acid species from sodium sulfite or sodium+sulfur dioxide species.

FIGS. 15B and 15C Example Description: In some embodiments, at least a portion of sulfur dioxide may be added to a solution comprising sodium+ acetic acid species to form a solution comprising sodium+ acetic acid+ sulfur dioxide species. In some embodiments, it may be desirable for the solution comprising sodium+ acetic acid+ sulfur dioxide species to be in a pH range wherein sulfur dioxide species may comprise ionic species and acetic acid species may comprise non-ionic species, which may enable or facilitate the separation of at least a portion of acetic acid from at least a portion of sulfur dioxide species, using a separation method, such as reverse osmosis. In some embodiments, at least a portion of acetic acid may be separated and the concentration or molar proportion of acetic acid species in the solution comprising sodium+ acetic acid+ sulfur dioxide species may decrease. FIG. 15B may show an example embodiment in the mode wherein acetic acid may be at least partially separated and the concentration of concentration or molar proportion of acetic acid species in the solution comprising sodium+ acetic acid+ sulfur dioxide species may be decreasing. In some embodiments, the concentration or molar proportion of acetic acid species in the solution comprising sodium+ acetic acid+ sulfur dioxide species may decrease to a sufficiently low level wherein it may be less desirable to continue adding sulfur dioxide or maintaining a low pH due to, for example, the need to potentially remove sulfur dioxide species in later steps. In some embodiments, when the concentration or molar proportion of acetic acid species in the solution comprising sodium+ acetic acid+ sulfur dioxide species may decrease to a sufficiently low level wherein it may be less desirable to continue adding sulfur dioxide or maintaining a low pH, it may be desirable to switch to a mode which separates sodium acetate species from sodium sulfite species, such as the NF mode shown in FIG. 15C. In some embodiments, a portion of a base, such as calcium carbonate, or calcium oxide, or calcium hydroxide, or sodium hydroxide, or sodium carbonate, or any combination thereof, may be added to the solution to increase the pH to a level wherein the sulfur dioxide species may comprise sulfite and the acetic acid species may comprise acetate, which may enable or facilitate the separation of sodium acetate or sodium+ acetic acid species from sodium sulfite or sodium+sulfur dioxide species using nanofiltration. FIG. 15C may be updated to include addition of a portion of a base, which may include, but are not limited to, the bases described herein. FIG. 15C and FIG. 15A may be updated to include a step of removing or transferring solution comprising sodium sulfite, or sodium bisulfite, or sodium+sulfur dioxide species, or any combination thereof. FIG. 15C and FIG. 15A may be updated to include a step of removing or transferring solution comprising sodium sulfite, or sodium bisulfite, or sodium+sulfur dioxide species, or any combination thereof such as, for example, transferring said solution to a step reacting to form at least a portion of sodium hydroxide.

### Example Embodiment Comprising an Example Multiple Batch or Semi-Batch Configuration

FIG. 16: FIG. 16 may show a semi-batch configuration embodiment. FIG. 16 may comprise similar characteristics to FIG. 15, except, for example, FIG. 16 may contain three Batch Tanks or mixing tanks, which may enable continuous operation/utilization of the RO. For example, in some embodiments, in a three or more tank or mixer configuration, a first batch tank may be filling simultaneous to a second batch tank operating, and a third batch tank emptying. In some embodiments, an NF separation may also be employed, such as the NF separation of at least a portion of sodium acetate from sodium+sulfur dioxide species solution, an example of which may be shown in FIG. 15B and FIG. 15C.

Please note the speciation shown in the figure may be provided as an example, and may not be representative of the speciation or composition in an actual operation. For example, in some embodiments, “Na₂SO₃” and “NaHSO₃” may be provided as example chemicals comprising sodium− sulfur dioxide species, and other chemicals or speciations comprising sodium− sulfur dioxide species may be applicable. In some embodiments, a solution comprising “NaHSO₃” may indicate a higher molar ratio of sulfur dioxide species to sodium species than a solution comprising “Na₂SO₃” within the same figure. In some embodiments, a solution comprising “NaHSO₃” may indicate a lower pH than a solution comprising “Na₂SO₃” within the same figure.

FIG. 17: FIG. 17 may show a semi-batch configuration comprising three or more repeated batches. Arrows may indicate an example of the operating mode of each batch assembly or unit. Each unit may be similar to, for example, FIG. 15A, FIG. 15B, and/or FIG. 15C.

FIG. 18A: FIG. 18A may show a continuous configuration comprising stages.

FIG. 18B: FIG. 18B may show a continuous configuration comprising stages.

FIG. 18C: FIG. 18C may show a continuous configuration comprising stages.

In some embodiments, a base, such as calcium carbonate, or calcium hydroxide, or calcium oxide, or sodium hydroxide, or sodium carbonate, or any combination thereof, may be added to the solution, for example, prior to nanofiltration (NF), to, for example, increase the pH of the solution into a pH range wherein sulfur dioxide species comprise sulfite or SO₃²⁻, which may enable or facilitate separation of sulfur dioxide species from acetic acid species using NF.

### Example Chemistry, Including Ions and Ionic Compounds, in Some Embodiments

In some embodiments, a solution comprising sodium sulfite may comprise sodium bisulfite, or sodium sulfite, or sodium sesquisulfite, or sodium metabisulfite, or free sulfur dioxide, or sodium acetate, or sodium sulfate, or sulfate, or calcium, or any combination thereof. In some embodiments, the molar ratio of sodium:sulfur may be greater than or equal to, including, but not limited to, one or more or any combination of the following: 1:0.001, or 1:0.01, or 1:0.1, or 1:0.2, or 1:0.3, or 1:0.4, or 1:0.5, or 1:0.6, or 1:0.7, or 1:0.8, or 1:0.9, or 1:1, or 1:1.1, or 1:1.2, or 1:1.3, or 1:1.4, or 1:1.5, or 1:1.75, or 1:2, or 1:2.5, or 1:3, or 1:3.5, or 1:4, or 1:4.5, or 1:5.
Sodium may be provided as an example alkali. Other alkalis or alkali-like cations may be employed instead of, or in addition to, for example, sodium. For example, other alkalis or alkali-like cations may include, but may be not limited to, one or more or any combination of the following: lithium (Li), or sodium (Na), or potassium (K), or rubidium (Rb), or cesium (Cs), or ammonia, or ammonium, or amine, or ammonia-derivative, or nitrogenous cation.
Calcium may be provided as an example alkaline-earth. Other alkaline-earths or alkaline-earth-like cations may be employed instead of, or in addition to, for example, calcium. For example, other alkaline-earths or alkaline-earth-like cations may include, but may be not limited to, one or more or any combination of the following: beryllium (Be), magnesium (Mg), calcium (Ca), strontium (Sr), barium (Ba), and radium (Ra), or amine, or ammonia-derivative, or nitrogenous cation.
Acetic acid or acetate may be provided as an example carboxylic acid, or acid, or acid stronger than carbonic acid and weaker than sulfurous acid, or any combination thereof. Other carboxylic acids, or acids, or acids stronger than carbonic acid and weaker than sulfurous acid, or any combination thereof may be employed instead of, or in addition to, for example, acetic acid. For example, other carboxylic acids, or acids, or acids stronger than carbonic acid and weaker than sulfurous acid, or any combination thereof may include, but may be not limited to, one or more or any combination of the following: formic acid, or acetic acid, or propanoic acid, or volatile acid, or non-volatile acid, or citric acid, or malic acid, or oxalic acid, or Lactic acid, or glycolic acid, or glyoxylic acid, or C1 acids, or C2 acids, or C3 acids, or C4 acids, or C5 acids, or C6 acids, or C7 acids, or C8 acids, or C9 acids, or C10 acids, or acids known in the art.
Carbonate or bicarbonate or carbonic acid may be provided as an example of a weak acid, or an example of an acid weaker than some carboxylic acids, or any combination thereof. Other weak acids, or acids weaker than most carboxylic acids, or any combination thereof may be employed instead of, or in addition to, carbonate or bicarbonate or carbonic acid. Other weak acids, or acids weaker than some carboxylic acids, or anions weaker than some carboxylic acid cations, or any combination thereof may include, but may be not limited to, one or more or any combination of the following: silicates, or silicon derivatives, or iron derivatives, or transition metal derivatives, or metal derivative anions, or ferrites, or ferrates, or aluminates, or silicates, or oxide anions, or sulfides, or hydrogen sulfide, or nitrites.

### Example Description of Some Embodiments

Some embodiments may facilitate sodium− pH reducer species, such as sodium− sulfur dioxide species, or sodium− carbon dioxide species, or any combination thereof separation from an acid species, such as acetic acid. Some embodiments may pertain to the separation of acetic acid species from sodium− sulfur dioxide, or the further polishing or purification of sodium sulfite, or integration of process steps, or any combination thereof. Some example embodiments may include, but are not limited to, one or more or any combination of the following:
Countercurrent Flow Membrane Configuration: In some embodiments, a countercurrent flow membrane configuration may enable continuous operation, while potentially enabling or facilitating a higher concentration of at least partially separated acetic acid species and/or may enable a potentially lower concentration of acidic acid species in the sodium+sulfur dioxide solution. In some embodiments, the separation of at least a portion of acetic acid species may involve two feed solutions: a first feed solution comprising a high concentration of acetic acid species (for example: solution comprising sodium+sulfur dioxide+ acetic acid) and/or a second feed solution comprising a low or very low or negligible or any combination thereof concentration of acetic acid species (for example: water, or sodium sulfate, or calcium carbonate+ water slurry, or a combination thereof). In some embodiments, an objective of a separation may comprise to transfer acetic acid or acetic acid species from the solution comprising a relatively high concentration of acetic acid species (for example: first feed solution) to the solution without or with a relatively low concentration of acetic acid species (for example: second feed solution). In some embodiments, with a countercurrent flow configuration, the concentration of the product solutions may approach the concentration of their respective opposing feed solutions. For example, in some embodiments, a countercurrent configuration may enable a solution comprising sodium− sulfur dioxide with a very low concentration of acetic acid species (for example: an acetic acid species concentration approaching the very low concentration of acetic acid in the opposing feed solution comprising water or sodium sulfate) and a solution comprising acidic acid with a high concentration of acetic acid species (for example: acetic acid concentration approaching the high concentration of acetic acid in the opposing feed solution comprising sodium+sulfur dioxide+ acetic acid).
Diffusion-Driven Approach: In some embodiments, acetic acid or acetic acid species may be transferred from a solution with a high concentration of acetic acid species (for example: first feed solution) to the solution with a much lower concentration of acetic acid species (for example: second feed solution). For example, in some embodiments, in the pH range wherein sulfur dioxide comprises ionic species and acetic acid comprises non-ionic species, at least a portion of acetic acid species may diffuse across a semi-permeable membrane (such as an RO, or NF, or FO membrane), while at least a portion of sulfur dioxide species and/or sodium species may be retained by the membrane. For example, at least a portion of acetic acid permeation may be facilitated by applied pressure and osmotic pressure driven permeation (i.e. RO, or NF, or FO). In some embodiments, diffusion may provide a sufficient driving force for at least a portion of separation or transfer of acetic acid or acetic acid species due to, for example, the significant difference in acetic acid concentration between the two solutions.
Achieving Maximum Sodium Sulfite Purity/Yield: In some embodiments, during the separation of acetic acid, while the concentration of acetic acid may decrease in the solution comprising sodium+sulfur dioxide+ acetic acid, the pH of the solution may increase, and/or may eventually reach a sufficiently high pH wherein the residual acetic acid species may shift from a non-ionic species to an ionic species. In some embodiments, at least a portion of additional sulfur dioxide or other acid or acid species may be added to reduce the pH, which may shift the residual acetic acid species from ionic species to non-ionic species, and/or separate at least a portion of the residual acetic acid. In some embodiments, the pH may be adjusted from an acidic pH to basic pH by adding a portion of calcium carbonate. In some embodiments, for example, a solution with relatively low concentration of remaining excess acetic acid may be shifted to a basic pH by reacting the solution with calcium carbonate, which may be in about stoichiometric proportion to the excess acetic acid, which may be, if the proportional amount of excess acetic acid is low, then the proportional amount of calcium carbonate added to shift the pH from acetic to basic may also be low. In some embodiments, by shifting the pH to a more basic pH or a higher pH, at least a portion of the sulfur dioxide species may shift to divalent sulfite (SO₃²⁻) and/or the residual acetic acid species may shift to monovalent acetate (CH₃COO⁻), which may enable the separation of monovalent residual sodium acetate from divalent sodium sulfite using nanofiltration, which may enable ultra-high sodium sulfite purity and/or sodium hydroxide or sodium carbonate or sodium bicarbonate product yield and purity if desired.

### Example pH vs. Speciation of Sulfur Dioxide Species and Acetic Acid Species in Some Aqueous Solutions

Summary: In some embodiments, a pH in the range of about 3-4 may be favorable for separating at least a portion of non-ionic acetic acid (CH₃COOH) from at least a portion of ionic sulfur dioxide species (HSO₃⁻), while, in some embodiments, a pH range of as broad as 2-5.5 may be sufficient. In some embodiments, a pH greater than 8 may be favorable for separating monovalent acetate species (CH₃COO⁻) from divalent sulfite species (SO₃²⁻), while in some embodiments a pH greater than 7 may be sufficient.

In some embodiments:
Adding sulfur dioxide may decrease pH
Removing or separating acetic acid from the sodium+sulfur dioxide+ acetic solution may increase pH.
Adding a base, such as calcium carbonate, may increase pH. The pH may shift from acidic to basic if a base is added in an amount sufficient to neutralize at least a portion of any ‘free acid’ or acetic species.

In some embodiments, the following may be an example description of the pH vs. speciation of sulfur dioxide and acetic acid in some aqueous solutions:
At a pH of about 2-3, the acetic acid comprises almost entirely non-ionic free acetic acid species (CH₃COOH) and the sulfur dioxide comprises mostly ionic monovalent bisulfite species (HSO₃⁻) with some free sulfur dioxide (SO₂(aq)).
At a pH of about 3-4, the acetic acid comprises almost entirely non-ionic free acetic acid species (CH₃COOH) and the sulfur dioxide comprises almost entirely ionic monovalent bisulfite species (HSO₃⁻).
At a pH of about 4-5, the acetic acid comprises mostly non-ionic free acetic acid species (CH₃COOH) and the sulfur dioxide comprises almost entirely ionic monovalent bisulfite species (HSO₃⁻).
At a pH of about 5-5.5, the acetic acid comprises a mixture of free acetic acid species (CH₃COOH) and ionic monovalent acetate species (CH₃COO⁻), and the sulfur dioxide comprises almost entirely ionic monovalent bisulfite species (HSO₃⁻).
At a pH of about 5.5-7, the acetic acid comprises almost entirely ionic monovalent acetate species (CH₃COO⁻) and the sulfur dioxide comprises a mixture of ionic monovalent bisulfite species (HSO₃⁻) and divalent sulfite species (SO₃²⁻).
At a pH of about 7-8, the acetic acid comprises almost entirely ionic monovalent acetate species (CH₃COO⁻) and the sulfur dioxide comprises mostly ionic divalent sulfite species (SO₃²⁻) with some ionic monovalent bisulfite species (HSO₃⁻).
At a pH greater than 8, acetic acid comprises almost entirely ionic monovalent acetate species (CH₃COO⁻) and sulfur dioxide comprises almost entirely ionic divalent sulfite species (SO₃²⁻).

### Example Chemistry and/or Mechanisms of Separating Acetic Acid using an Example Countercurrent Exchange

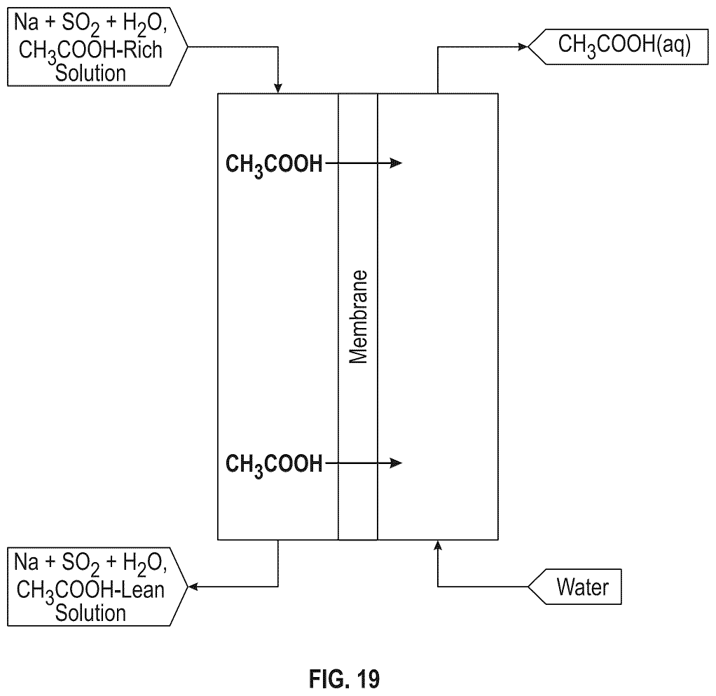

FIG. 19 may show a countercurrent exchange configuration embodiment with a first feed solution rich in acetic acid comprising sodium+sulfur dioxide+ acetic acid, a second feed solution comprising water, and a first product solution comprising aqueous acetic acid and a second product solution lean in acetic acid comprising sodium+sulfur dioxide.

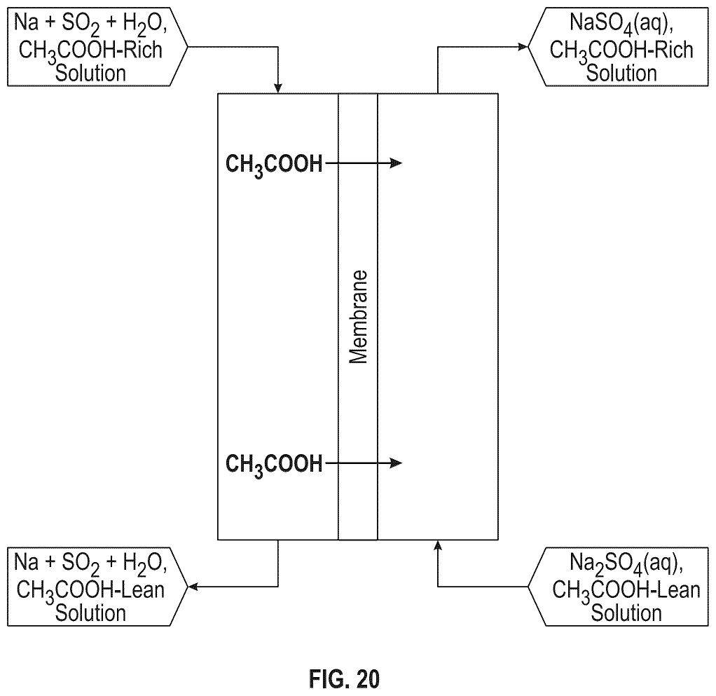

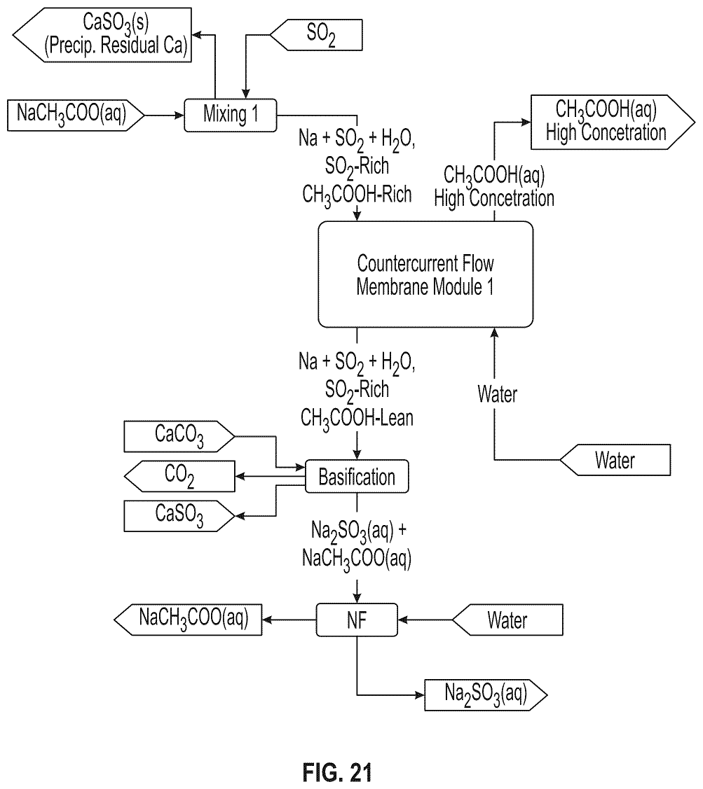

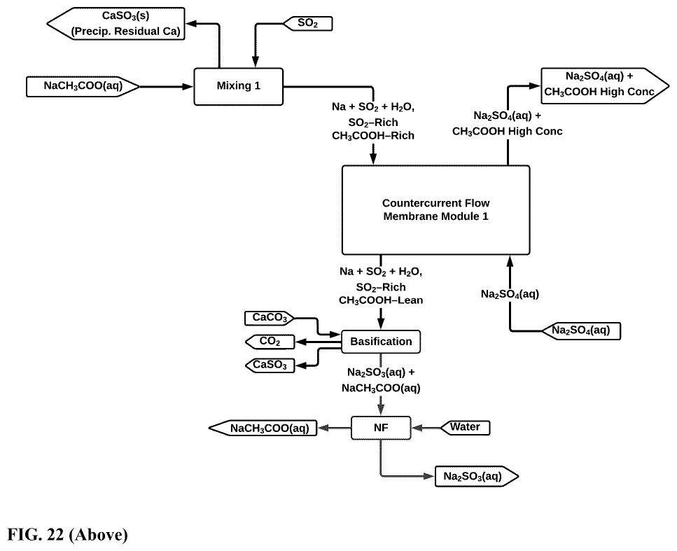

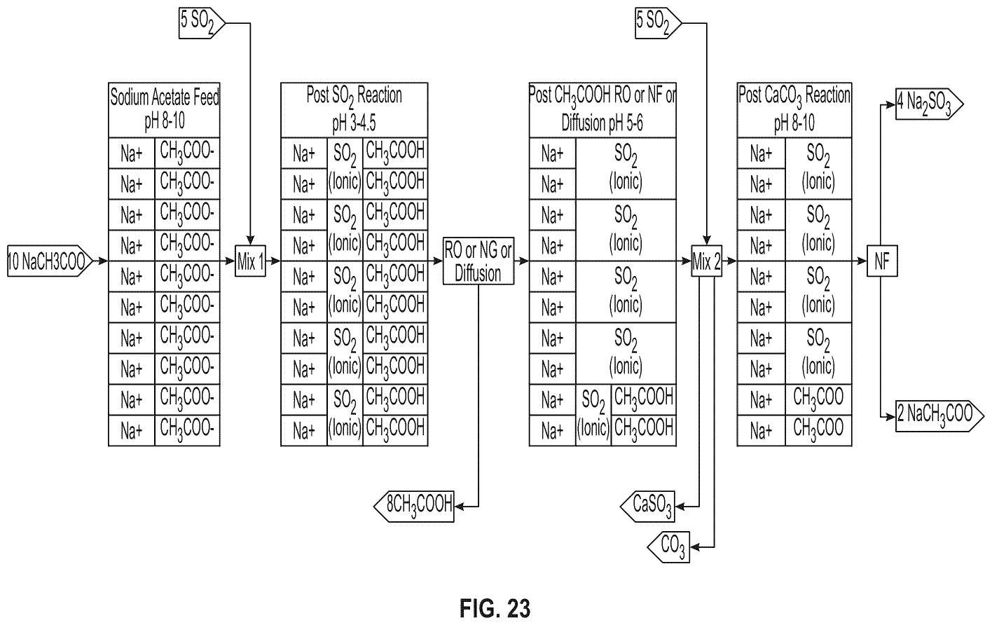

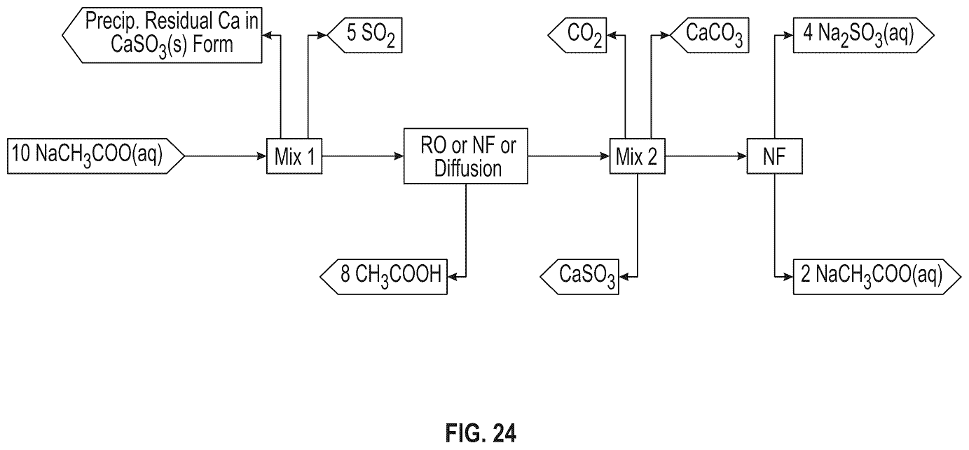

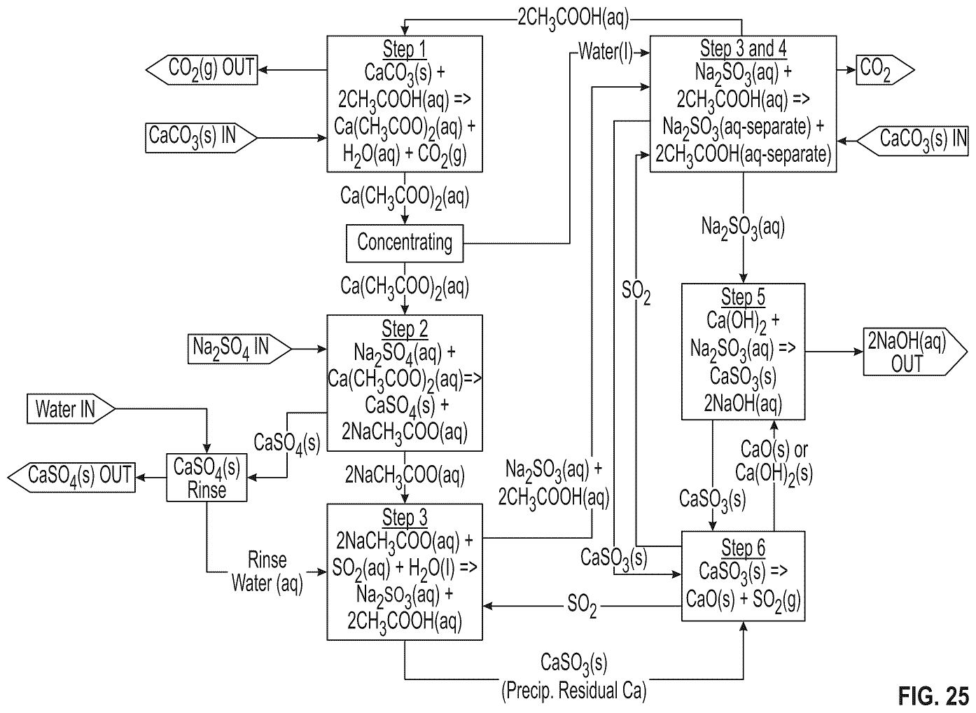

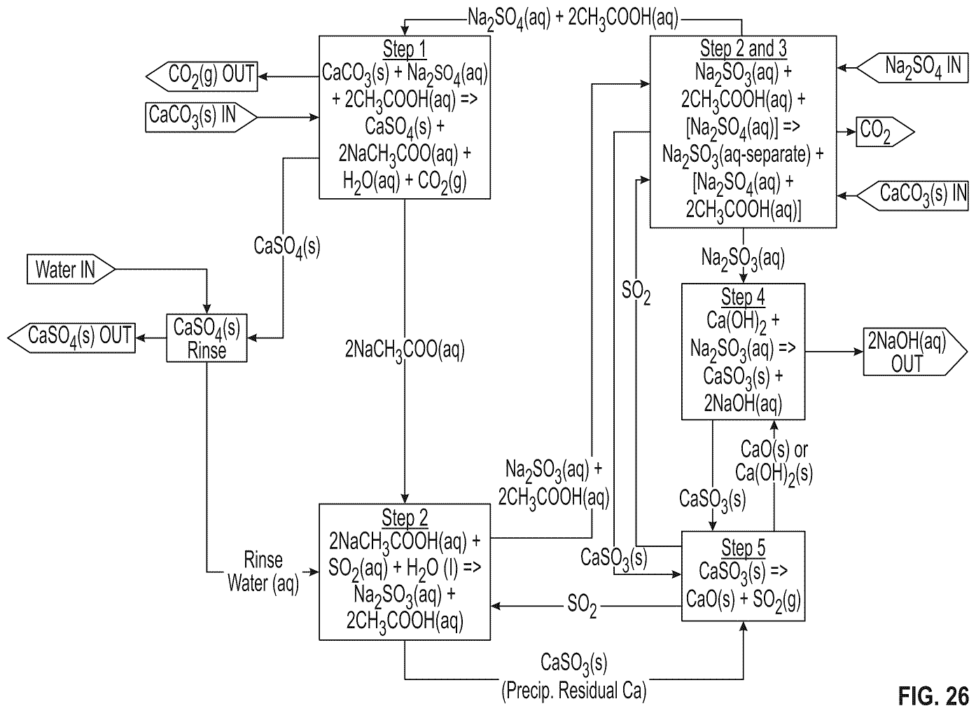

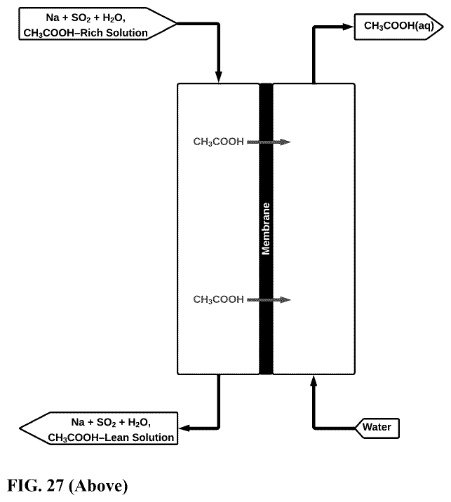

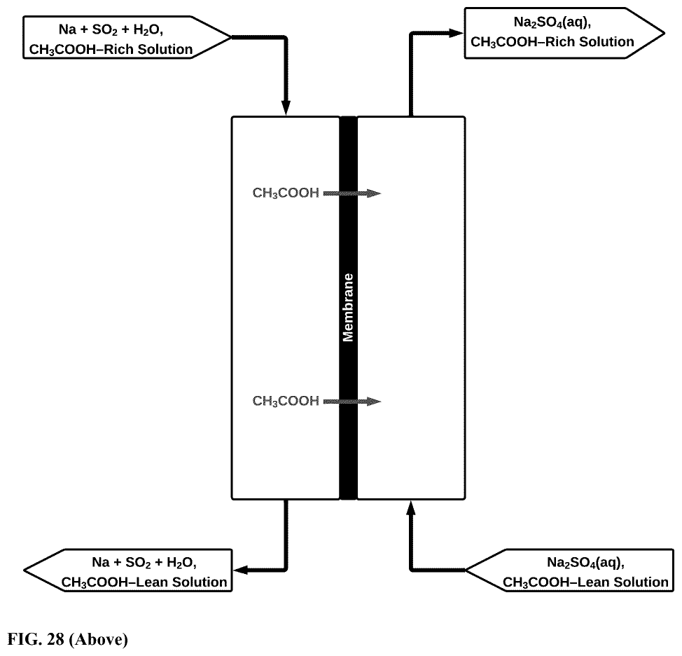

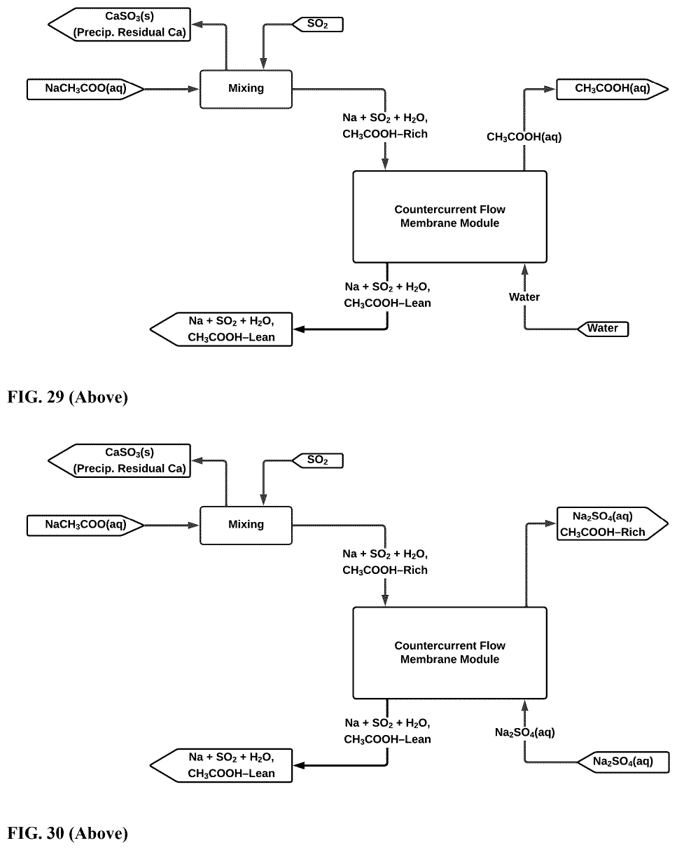

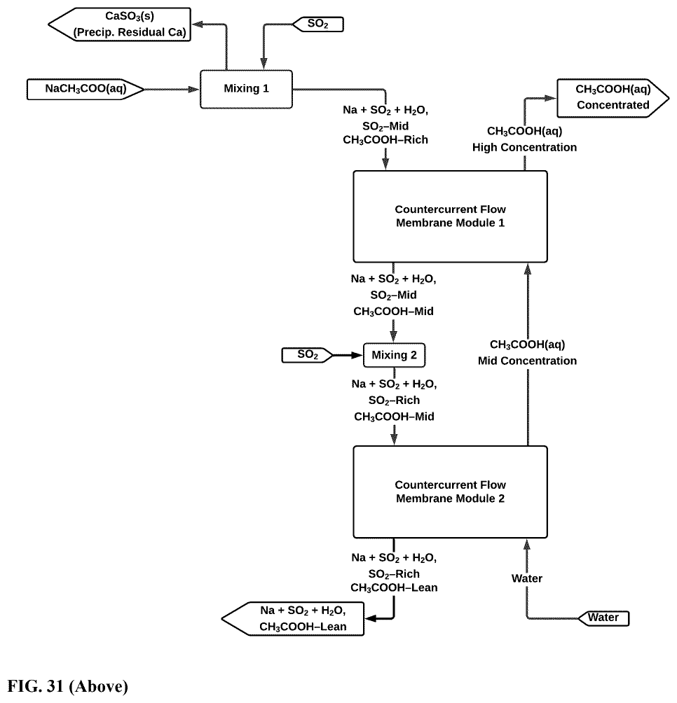

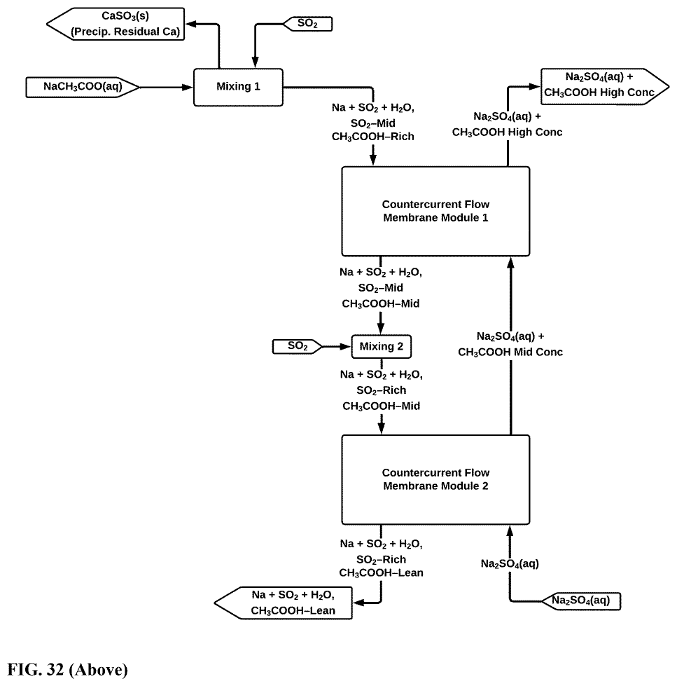

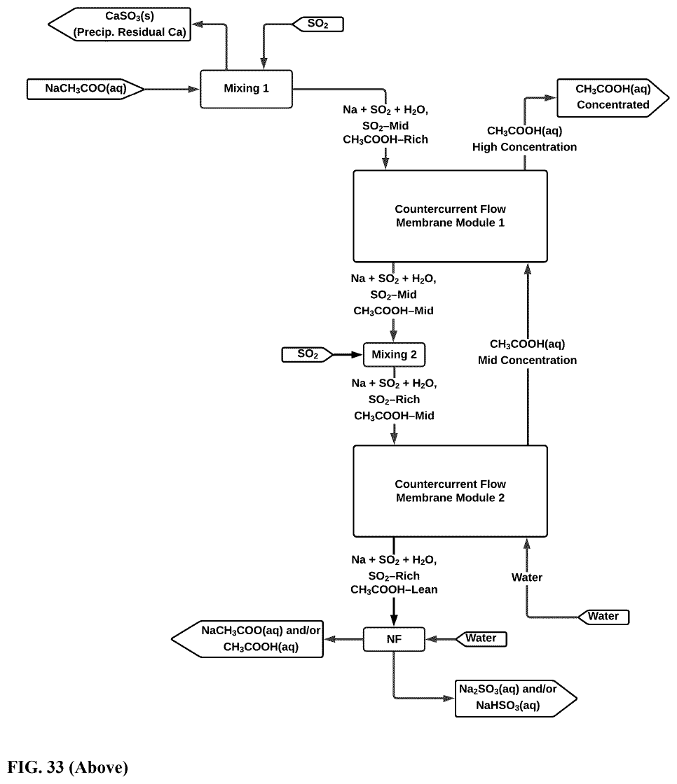

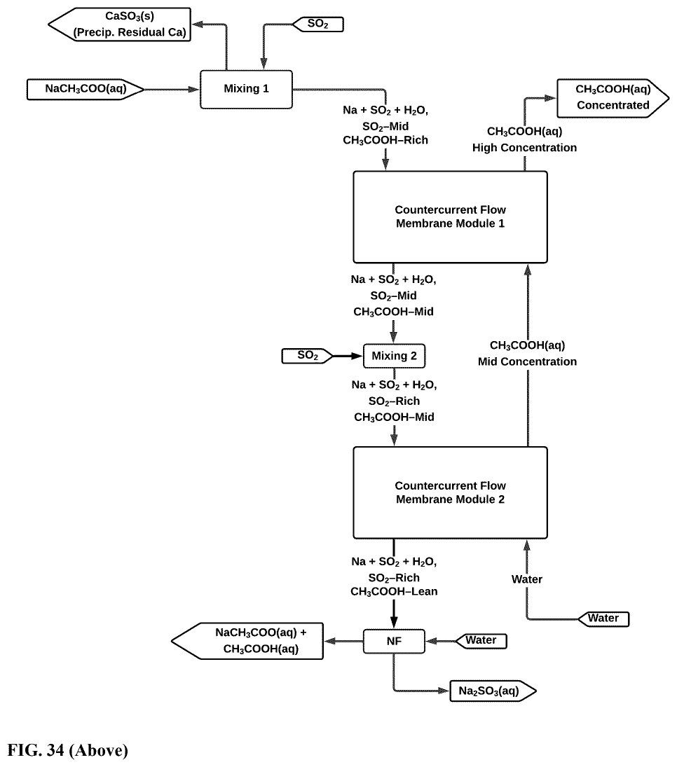

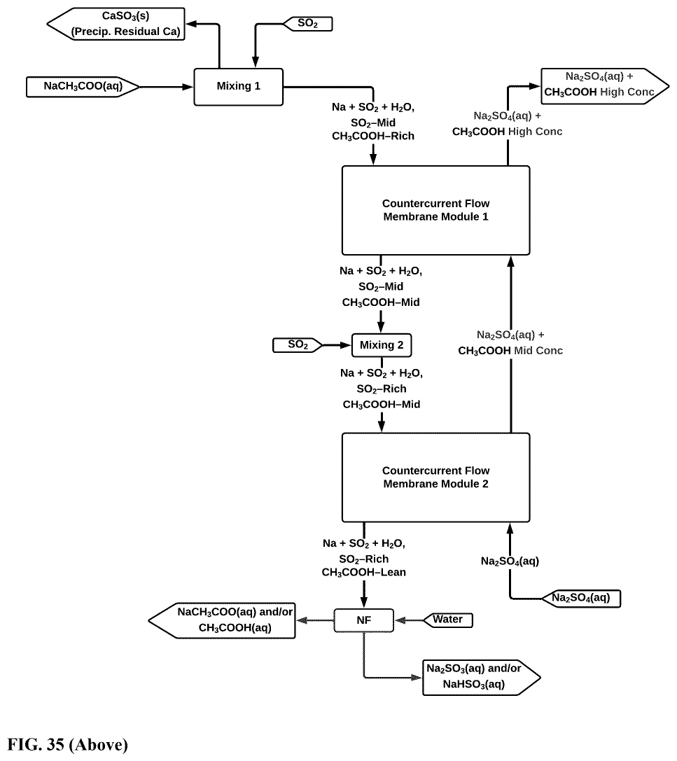

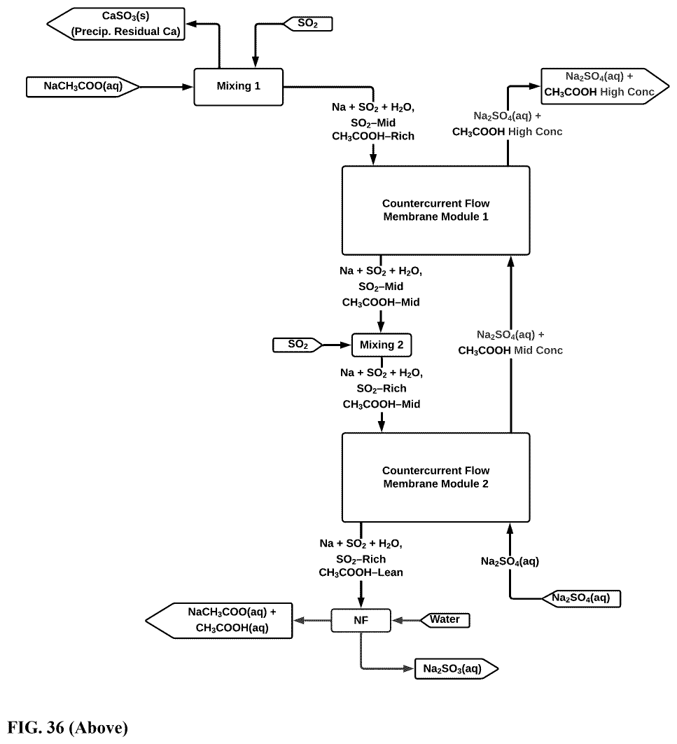

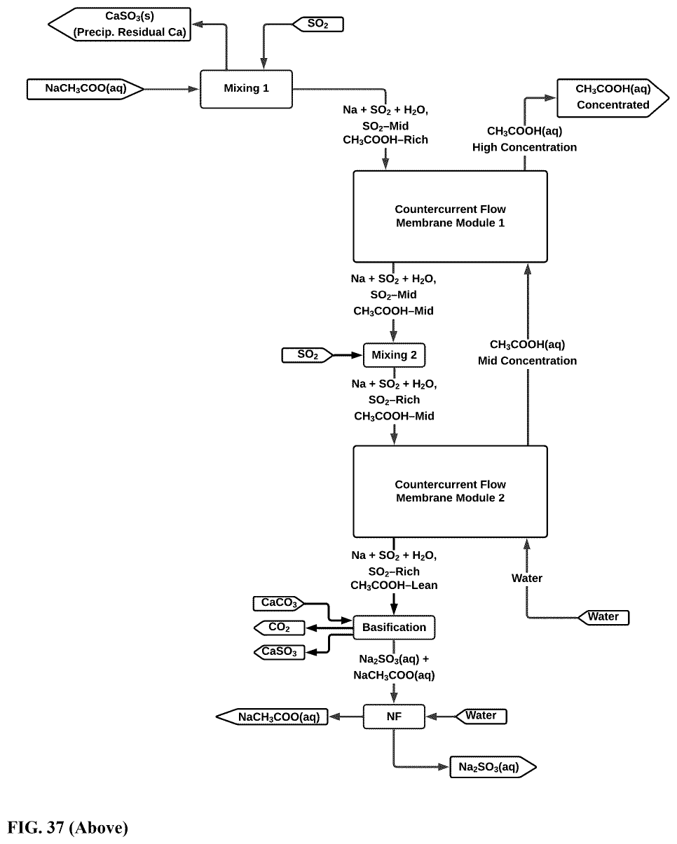

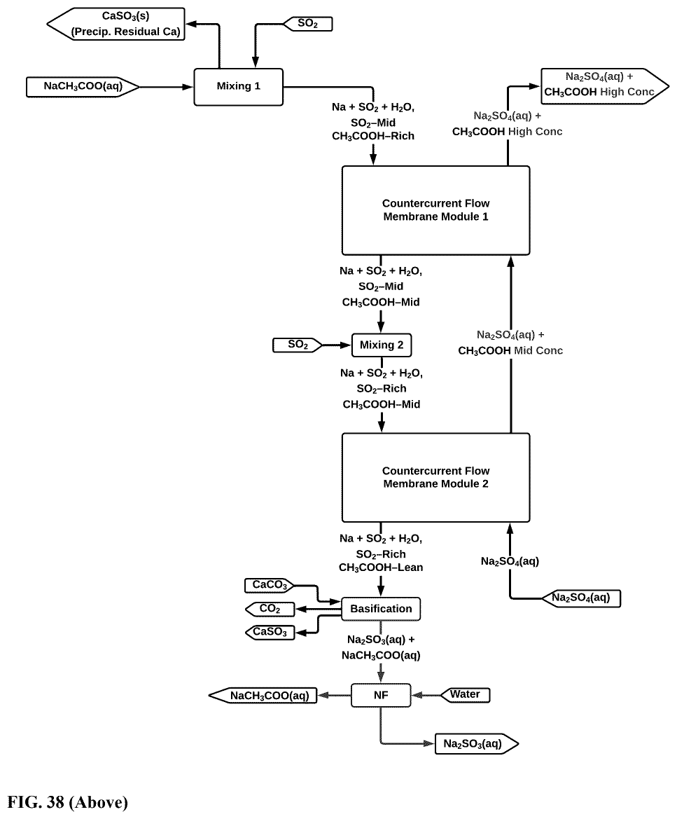

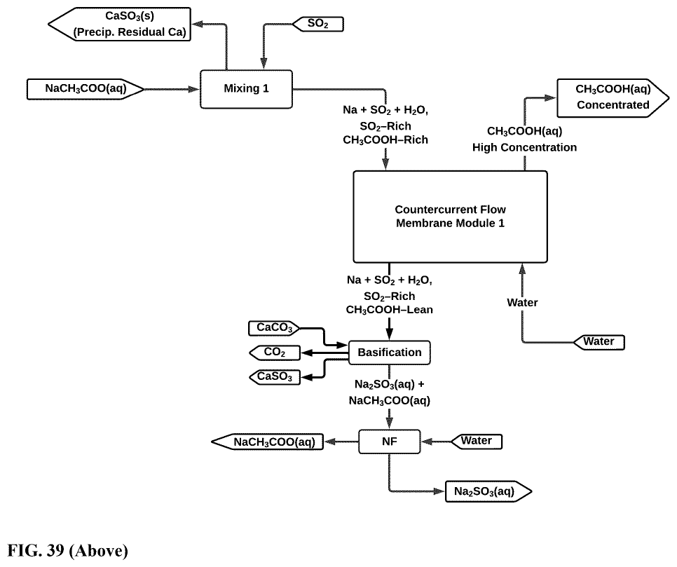

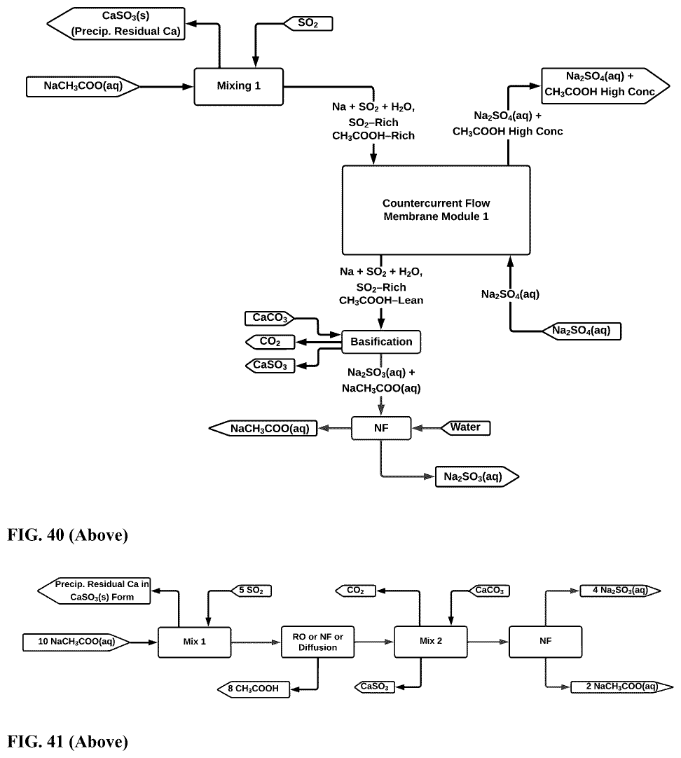

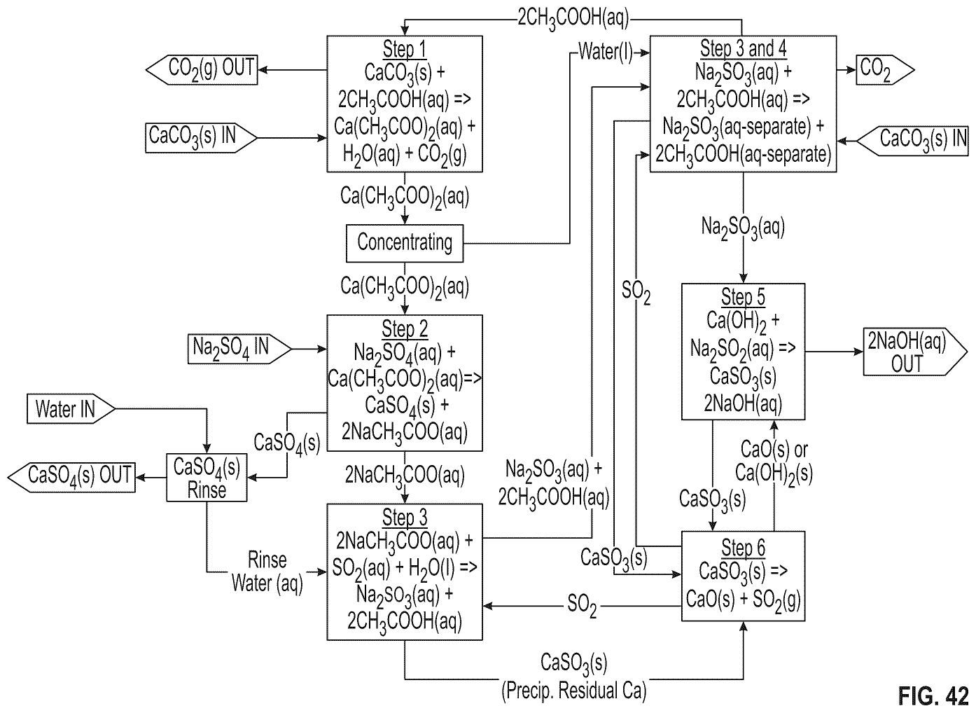

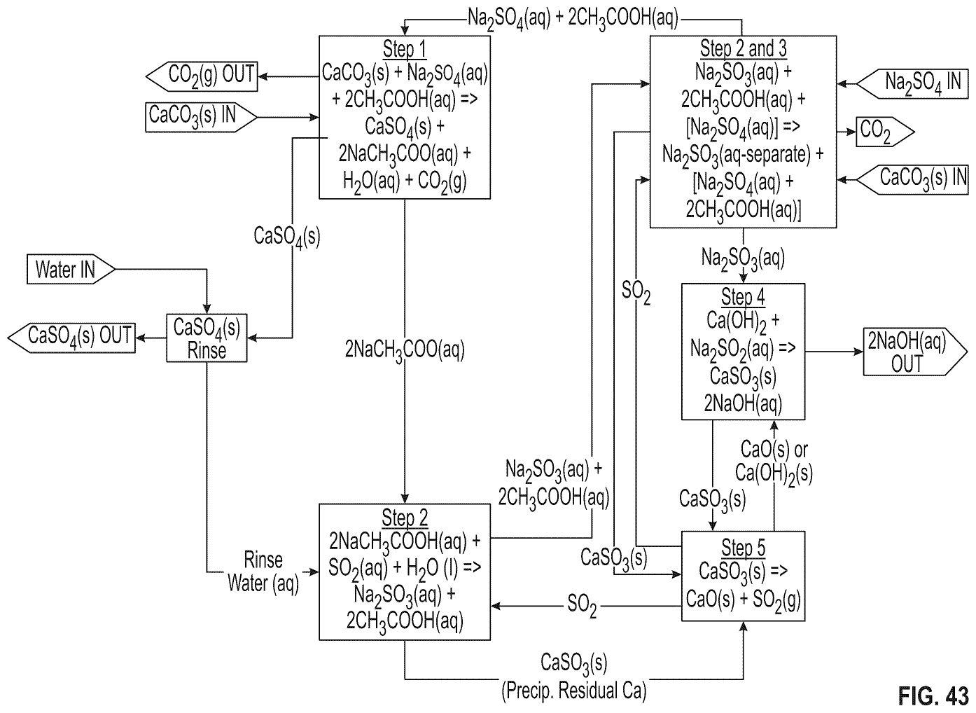

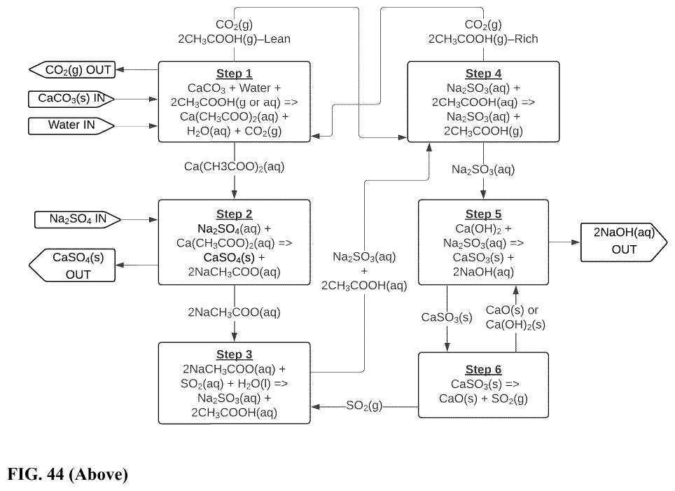

FIG. 20 may show a countercurrent exchange configuration embodiment with a first feed solution rich in acetic acid comprising sodium+sulfur dioxide+ acetic acid, a second feed solution comprising aqueous sodium sulfate, and a first product solution comprising aqueous sodium sulfate+acetic acid and a second product solution lean in acetic acid comprising sodium+sulfur dioxide.

FIG. 19 and FIG. 20 may show embodiments for separation of acetic acid using a countercurrent configuration. In some embodiments, a countercurrent configuration may enable the concentration of at least a portion of a product solution to achieve or approach the concentration of its respective opposing feed solutions and/or enable at least a portion of a separation to occur in a continuous regime.

In FIG. 19, for example, at least a portion of acetic acid may transfer from a solution comprising a high concentration of acetic acid species (‘Na+SO₂+H₂O, CH₃COOH-Rich’ or first feed solution) to a solution comprising a low concentration of acetic acid species (‘Water’ or second feed solution) due to, for example, diffusion, or applied pressure, or both. In FIG. 19, the osmotic pressure of the first feed solution (‘Na+SO₂+H₂O, CH₃COOH-Rich’) may be significantly greater than the osmotic pressure of the second feed solution (‘Water’). In some embodiments, for example, to prevent the transfer or flow of water from the solution with lower osmotic pressure (for example: second feed solution) to the solution with more osmotic pressure (for example: first feed solution), in some embodiments a pressure equal to or greater than the osmotic pressure difference between the first feed solution and the second feed solution may be applied to the first feed solution. In some embodiments, the applied pressure may not need to be greater than the osmotic pressure of one or more solutions, although it may be desired in some embodiments, for separation to occur acetic acid may transfer from the first feed solution to the second feed solution due to diffusion.

In FIG. 20, for example, at least a portion of acetic acid may transfer from a solution comprising a high concentration of acetic acid species (‘Na+SO₂+H₂O, CH₃COOH-Rich’ or ‘first feed solution’) to a solution comprising a low concentration of acetic acid species (‘Na₂SO₄(aq), CH₃COOH-Lean Solution’ or ‘second feed solution’). In some embodiments, the following premises may facilitate or enable at least a portion of acetic acid separation: (1) a solution comprising sodium sulfate, which may comprise an input solution, may comprise a low concentration, or very low concentration, or no concentration, or any combination thereof of acetic acid; (2) the reactions of calcium carbonate+ acetic acid and sodium sulfate+ calcium acetate may be at least partially conducted in one combined step, for example, wherein the solution comprising sodium sulfate entering the reaction with calcium carbonate or calcium acetate may comprise sodium sulfate+ acetic acid. In some embodiments, both the first feed solution and the second feed solution may have significant osmotic pressure. Some embodiments, such as some embodiments of FIG. 20, may be configured such that the osmotic pressure of the first feed solution may be greater than the osmotic pressure of the second feed solution, or the osmotic pressure of the second feed solution may be greater than the osmotic pressure of the first feed solution, or the osmotic pressure of the first feed solution may be about the same as the osmotic pressure of the second feed solution, or any combination thereof.

In some embodiments, such as some embodiments of FIG. 20, the osmotic pressure of the second feed solution may enable a significantly greater concentration (and osmotic pressure) of the first feed solution. In some embodiments, such as some embodiments of FIG. 20, the osmotic pressure of the second feed solution may enable a significantly greater concentration (and osmotic pressure) of the first feed solution because, for example, higher concentrations in the first feed stream in may be offset or counteracted by high osmotic pressures in the second feed solution, which reduce the required, if any, applied pressure, which may enable one or more or any combination of the following potential benefits:
Greater acetic acid concentration in first feed solution
Greater acetic acid concentration in the second product solution
Greater concentration difference in acetic acid species between the first feed solution and the second feed solution.
Smaller flow rates
Smaller process sizing
Less required membrane surface area
Greater acetic acid permeation rate
In some embodiments, enables the reaction of calcium carbonate+ acetic acid and the reaction of sodium sulfate+ calcium acetate to be conducted as one combined step.

In some embodiments, a countercurrent configuration may employ a semi-permeable membrane capable of permeating at least a portion of non-ionic acetic acid species, while retaining at least a portion of ionic species, such as sodium and sulfur dioxide species, or at least a portion of sulfur dioxide species, or any combination thereof. Example membranes include, but are not limited to, membranes employed in one or more or any combination of the following processes: reverse osmosis, or nanofiltration, or forward osmosis. In some embodiments, while any membrane configuration may be suitable, a high surface area density configuration, such as a spiral wound configuration, may be desirable to minimize size and/or maximize modularity.

### Example Chemistry and Mechanisms of Basification and Separation in Some Embodiments

In some embodiments, during the separation of at least a portion of acetic acid, the pH of the solution comprising sodium+sulfur dioxide+ acetic acid may increase while acetic acid concentration may decrease, and/or the solution may eventually reaching a high pH wherein, for example, at least a portion of the residual acetic acid species shifts from a non-ionic species to an ionic species. To continue the separation of acetic acid, one option may be to add sulfur dioxide to reduce the pH, which may shift at least a portion of the residual acetic acid species from ionic species to non-ionic species, and/or may enable the separation of at least a portion of the residual acetic acid. In some embodiments, however, at some point, the addition of sulfur dioxide to reduce the pH may have diminishing benefits relative to the proportionally low amount or low concentration of remaining or residual acetic acid species. In some embodiments, a proportionally small amount of a base, such as calcium carbonate, or calcium hydroxide, or sodium carbonate, or sodium hydroxide, or ammonia, or any combination thereof, may be added to, and/or, for example, may adjust the pH from acidic to basic, which may shift at least a portion of the sulfur dioxide species from comprising ionic monovalent bisulfite species (HSO₃⁻) to comprising ionic divalent sulfite species (SO₃²⁻) and/or may shift at least a portion of the acetic acid species to comprise ionic monovalent acetate species (CH₃COO⁻), which may enable the separation of at least a portion of the residual monovalent sodium acetate from the divalent sodium sulfite using, for example, including, but not limited to, one or more or any combination of the following: nanofiltration, or electrodialysis, or monovalent selective electrodialysis. In some embodiments, nanofiltration may separate at least a portion of sodium sulfite from at least a portion of sodium acetate by, for example, at least partially retaining or rejecting divalent sodium sulfite, while, for example, allowing the permeation of at least a portion of the sodium acetate. In some embodiments, a nanofiltration separation may enable tunable or controllable purity of sodium sulfite, which may enable very high purity of sodium sulfite, and/or sodium hydroxide yield the subsequent step(s), if desired.

In some embodiments, the required amount of a base, such as calcium carbonate, which may be added may be proportional or stoichiometric to the amount or concentration of residual acetic acid species. For example, if a solution comprises 2M sodium, 1M sulfite, and 0.1M residual acetic acid, then about 0.05M of calcium carbonate may be added to stoichiometrically react with the residual acetic acid. In some embodiments, the reaction of calcium carbonate with the solution may result in an increase in pH and/or the formation or precipitation of calcium sulfite, which may be according to the following reaction sequence which may occur in-situ if desired: (1) calcium carbonate(s)+ acetic acid(aq)→calcium acetate(aq)+ carbon dioxide(g)+water(aq); (2) calcium acetate(aq)+ sodium sulfite(aq)→calcium sulfite(s)+ sodium acetate(aq). In some embodiments, a precipitate or solid comprising calcium sulfite may be at least partially removed, and the resulting basic solution may comprise sulfur dioxide species in the form of sodium sulfite and/or a residual acetic acid species which may be in the form of sodium acetate, which may enable the separation of at least a portion of sodium sulfite species and at least a portion of sodium acetate species using one or more or any combination of separation methods, which may comprise, for example, including, but not limited to, one or more or any combination of the following: nanofiltration, or electrodialysis, or monovalent selective electrodialysis, or semi-permeable membrane process, or membrane process, or colligative property process, or freeze separation, or other separation.

### Example Description of Some Example Steps in an Example Embodiment

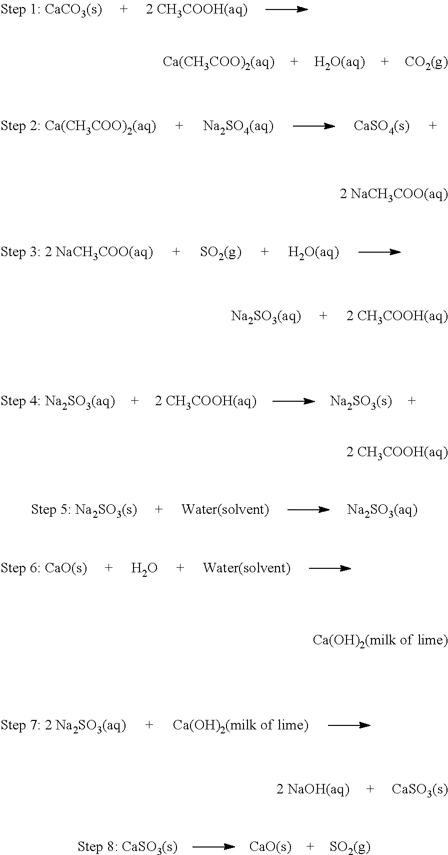

### Example Description of Some Steps in Some Embodiments

Note: In some embodiments, the purity and composition of the feed or input(s) and/or the desired purity or form of the products and/or if other treatment methods may be employed may determine of steps 2B and/or 2C may be employed. In some embodiments, other treatment or reaction steps may be employed. In some embodiments, other treatment or reaction steps may be employed instead of, or in addition to, steps 2B and/or 2C.

### Step 2 (A, B, C)

### Example Step 2A Reaction

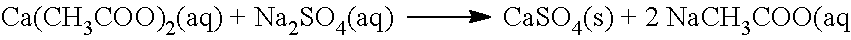

### Example Step 2A Reaction Summary

In some Embodiments, mix an aqueous solution comprising calcium acetate with an aqueous solution (or solid) comprising sodium sulfate to form a solid precipitate comprising calcium sulfate and an aqueous solution comprising sodium acetate and a small concentration of dissolved calcium sulfate. If insoluble impurities (e.g. lead sulfate) may be present in the sodium sulfate, these insoluble impurities may be removed from the sodium sulfate prior to mixing the sodium sulfate with the calcium acetate. If soluble heavy metal impurities may be present in the sodium sulfate (for example, such as: copper sulfate, or cobalt sulfate, or nickel sulfate, or copper, or cobalt, or nickel, or iron, or lead, or metals, or metal ions, or heavy metals, or heavy metal ions), at least a portion of impurities may be present or remain in the product aqueous solution comprising sodium acetate.

Example Step 2A Reaction Mass Balance (Dry Basis, per 1 kg NaOH Produced)

| | |
|---|---|
| Reactants | Products |

| Chemical | Mass (g) | Chemical | Mass (g) |
|---|---|---|---|
| Ca(CH₃COO)₂ | 1,977.25 | CaSO₄ | 1,701.88 |
| Na₂SO₄ | 1,775.63 | 2 NACH₃COO | 2,051.01 |

### Example Step 2A Reaction Wet-Chemistry Mass Balance (Wet-Basis, per 1 kg NaOH Produced)

| Reactants | | Products | |
|---|---|---|---|
| Chemical | Mass (g) | Chemical | Mass (g) |
| Ca(CH₃COO)₂(aq) | 1,977.25 | CaSO₄(s) | 1,644.89 |
| Na₂SO₄ (aq) | 1,775.63 | CaSO₄(aq) | 56.99 |
| | | 2 NACH₃COO(aq) | 2,051.01 |
| Nonparticipating | | Nonparticipating | |
| Present Components | | Present Components | |
| H₂O (solvent) | 21,919.58 | H₂O (solvent) | 21,919.58 |

Example Step 2A Wet-Basis Wet-Chemistry Mass Balance Assumptions
Calcium acetate (Ca(CH₃COO)₂) dissolved in water to form a solution comprising 277.6 g Ca(CH₃COO)₂ per kg of Water, a concentration comprising 80% of the maximum solubility of calcium acetate at 20° C. This solution represents calcium acetate produced from the reaction in Step 1.
Sodium sulfate (Na₂SO₄) dissolved in water to form a solution comprising 120 g Na₂SO₄ per kg of Water, a concentration comprising 80% of the maximum solubility of sodium sulfate at 20° C. This solution represents a synthetic sodium sulfate waste input or a sodium sulfate solution input.
Calcium sulfate (CaSO₄) solubility in the product solution may be estimated 2.6 g CaSO₄ per kg of Water at 20° C.

### Example Step 2B Reaction

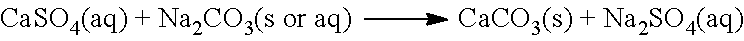

### Example Step 2B Reaction Summary

Step 2B may be a reaction used to remove calcium and prevent calcium sulfate scaling in Step 2C. In step 2B, the calcium may be transformed from a partially soluble form (calcium sulfate, 2.6 g/1000 g water) to a significantly less soluble form (calcium carbonate, 0.047 g/1000 g water). In step 2B, sodium carbonate may be mixed with a solution comprising at least a portion of aqueous calcium sulfate to form a precipitate comprising calcium carbonate and aqueous sodium sulfate. The calcium carbonate forms as solid precipitate and may be removed. Please note the very small mass flows of the reactants and products in reaction 2B in proportion to other mass flows in the process.

### Example Step 2B Mass Balance Wet-Basis

| Reactants | | Products | |
|---|---|---|---|
| Chemical | Mass (g) | Chemical | Mass (g) |
| CaSO₄(aq) | 56.99 | CaCO₃(s) | 40.86 |
| Na₂CO₃(aq) | 44.37 | CaCO₃(aq) | 1.04 |
| | | Na₂SO₄ (aq) | 59.46 |
| Nonparticipating | | Nonparticipating | |
| Present Components | | Present Components | |
| 2 NACH₃COO(aq) | 2,051.01 | 2 NACH₃ COO(aq) | 2,051.01 |
| H₂O (solvent) | 21,919.58 | H₂O (solvent) | 22,169.27 |
| H₂O (solvent Na₂CO₃) | 249.69 | | |

### Example Step 2B Mass Balance Assumptions

Sodium carbonate may be added as a solution rather than as a solid. The sodium carbonate solution comprises 44.37 g sodium carbonate and 249.69 g solvent water.
Solubility of calcium sulfate as a percentage of the water in the solution may be about the same as the solubility of calcium sulfate (g calcium sulfate per kg of deionized water) in literature.

Example Step 2B Considerations and Notes
In some embodiments, sodium carbonate may be added as a solid or an aqueous solution. Adding sodium carbonate as an aqueous solution may simplify mixing, although may increase the amount of water removal. Adding sodium carbonate as a solid may reduce the amount of water removal required after step 2A-C, although it may be more difficult to visually see if the reaction has reached completion due to the addition of a white solid (sodium carbonate) on the reactants side and the formation of a white solid (calcium carbonate) on the products side.
In some embodiments, 1.25 g of acetic acid may be added (or another acid may be stoichiometrically added) to the product solution to, for example, neutralize any aqueous calcium carbonate (1.04 g) and reduce the risk of any calcium scaling in subsequent steps (e.g nanofiltration).
Alternatively, or additionally), an antiscalant may be added to one or more or any combination of solutions.

### Example Step 2C Summary

Step 2C may comprise a nanofiltration step to remove any impurities (e.g. heavy metals) and/or any residual divalent ions (e.g. calcium or sulfate or carbonate). In some embodiments, Step 2C may be an ultra-high recovery nanofiltration step, producing a proportionally very small retentate and a proportionally very large permeate.

Example Step 2, or 3, or any Combination Thereof Mass Balance Assumptions and Example Design, Operation Conditions and Concentrations and Considerations or Design Considerations
If desired, excess water may be removed from the permeate solution (solution comprising 2 NaCH₃COO(aq)), using, for example, MED, or MVC, or HPRO, or FO, or MD. In some embodiments, the solution comprising 2 NaCH₃COO(aq) may be ionic and/or the NaCH₃COO may exhibit very high solubility, which may enable water removal and/or preventing crystallization or solids formation, if desired. In some embodiments, the concentration of acetic acid (step 1 and step 4) and/or the concentration of calcium acetate (step 1 and step 2) may be efficiently controlled by water removal during or after step 2, for example, because water removed from 2 NaCH₃COO(aq) may increase the concentration NaCH₃COO, and/or increasing the molar ratio of acetate ion. water. For example, in some embodiments, during water removal from 2 NaCH₃COO(aq), the amount of acetate ion remains constant while the amount of water decreases, which may increase the concentration of acetate ion. In some embodiments, water removal from a solution comprising NaCH₃COO(aq) may be conducted during step 2 and/or after step 2 and/or prior to step 3 and/or as a part of step 3. In some embodiments, water removal may be desired due to some feed streams or material inputs comprising at least a portion of water, and/or it may be desirable to remove at least a portion of the water.

In some embodiments, a feed material or solution may comprise sodium carbonate, or sodium bicarbonate, or sodium sulfate, or any combination thereof. For example, in some embodiments, a feed material or solution may comprise a mixture of sodium sulfate and sodium carbonate. For example, in some embodiments, a feed material or solution may comprise a mixture of sodium sulfate, sodium carbonate, and sodium bicarbonate. In some embodiments, at least a portion of sodium carbonate or sodium bicarbonate which may be present in the feed may react with at least a portion of calcium acetate which may form at least a portion of calcium carbonate, or calcium sulfate, or calcium bicarbonate, or any combination thereof. In some embodiments, a portion of acetic acid may be reacted with or mixed with the feed comprising sodium carbonate, or sodium bicarbonate, or sodium sulfate, or any combination thereof. In some embodiments, a portion of acetic acid may be reacted with or mixed with the feed comprising sodium carbonate, or sodium bicarbonate, or sodium sulfate, or any combination thereof, for example, prior to Step 2A to form sodium acetate and/or reduce the formation of calcium carbonate or the potential presence of calcium carbonate in calcium sulfate, if desired. In some embodiments, it may be desirable to react acetic acid in a stoichiometric amount to the sodium carbonate and/or sodium bicarbonate in the feed. In some embodiments, acetic acid may be reacted with the sodium carbonate or sodium bicarbonate to form sodium acetate, which may prevent or reduce the formation of calcium carbonate in the calcium sulfate product. In some embodiments, at least a portion of the acetic acid employed in a reaction with sodium carbonate and/or sodium bicarbonate may be generated within the process, such as, including, but not limited to, one or more or any combination of the following: portion of acetic acid generated from a reaction of sodium acetate with sulfur dioxide, or a portion of acetic acid diverted from or which would otherwise be reacted with calcium carbonate.

### Example Step 3 in Some Embodiments

### Example Step 3 Reaction in Some Embodiments

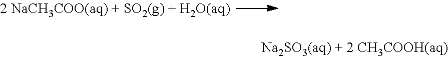

### Example Step 3 Reaction Summary

React a sulfur dioxide with an aqueous solution comprising sodium acetate to form sodium sulfite and aqueous acetic acid. At least a portion of sodium sulfite precipitate may form depending on the concentration of sodium acetate (or other salts) from step 2A-C and/or the amount of water removed from the solution or solid or any combination thereof comprising sodium acetate.

### Example Step 3 Mass Balance Wet-Basis

| Reactants | | Products | |
|---|---|---|---|
| Chemical | Mass (g) | Chemical | Mass (g) |
| 2 NACH₃COO(aq) | 2,051.01 | Na₂SO₃(aq) | 500.60 |
| SO₂(g) | 800.88 | Na₂SO₃(s) | 1075.06 |
| H₂O (reactant) | 225.21 | 2 CH₃COOH(aq) | 1501.41 |
| Nonparticipating | | Nonparticipating | |
| Present Components | | Present Components | |
| H₂O (solvent) | 1854.08 | H₂O (solvent) | 1854.08 |

Example Step 2, or 3, or any Combination Thereof Mass Balance Assumptions and Example Design, Operation Conditions and Concentrations and Considerations or Design Considerations In Some Embodiments
In some embodiments, after step 2 and before step 3, water may be removed from the solution comprising sodium acetate. In some embodiments, if it may be desired to prevent sodium sulfite precipitation during the step 3 reaction, the concentration of sodium acetate may be determined based on the solubility of the sodium sulfite product. In some embodiments, if it may be desired to produce at least a portion of precipitate during the step 3 reaction, then the concentration of sodium acetate may be determined based on the solubility of sodium acetate. In some embodiments, it may be desirable for the concentrating the sodium acetate solution to near maximum solubility may be desirable because it may reduce distillation/crystallization energy consumption in step 4, reduces the amount of crystallization required in step 4, reduces mass flows in step 3, reduces mass flows in step 4, the enables full water recovery including any excess water, and maximizes the concentration of acetic acid available for step 1.
   In some embodiments, if the amount of water removed between step 2 and step 3 may be determined by the solubility of sodium acetate, then the concentration of aqueous acetic acid separated in step 4 and transferred in step 1 may be greater than the concentration required in step 1 because the molar solubility of sodium acetate may be significantly greater than the molar solubility of calcium acetate in water, which may mean a portion of the water removed between step 2 and step 3 may be transferred to/added to the solution step 1.
   In some embodiments, the amount of water removed during step 2, or after step 2, or prior to step 3, or during step 3, or any combination thereof may be determined by the desired concentration of acetic acid in step 1, or the desired concentration of calcium acetate, or any combination thereof.
   In some embodiments, it may be desirable to determine the amount of water removed between step 2 and step 3 based on the desired concentration of acetic acid in step 1, for example, because the molar concentration of sodium acetate in the reactant solution in step 3 may determine the molar concentration of aqueous acetic acid in the product solution and, thus, the molar concentration of aqueous acetic acid in step 1.
The solution comprising sodium acetate may be at a concentration of 986.4 g/kg of water, a concentration comprising about 80% of the maximum solubility of sodium acetate at 20° C.
The amount of sodium sulfite solid and sodium sulfate aqueous in the reaction products may be based on a sodium sulfite solubility of 270 g/kg of water at 20° C.

Step 7, Example Reactions of Some Embodiments Mass Balance Wet-Basis

Step 7, Run 1, 2 Na₂SO₃, 2 Ca(OH)₂

| | |
|---|---|
| Reactants | Products |

| Chemical | Mass (g) | Chemical | Mass (g) |
|---|---|---|---|
| Na₂SO₃ (aq) | 1,575.66 | 2 NaOH(aq) | 1,000.00 |
| Ca(OH)₂ | 926.23 | CaSO₃(s) | 1,502.24 |

| | |
|---|---|
| Nonparticipating | Nonparticipating |
| Present Components | Present Components |

| | | | |
|---|---|---|---|
| H₂O (solvent) | 6,250.48 | H₂O (solvent) | 6,250.48 |

Step 7, Run 2, 1.5 Na₂SO₃, 1.5 Ca(OH)₂

| | |
|---|---|
| Reactants | Products |

| Chemical | Mass (g) | Chemical | Mass (g) |
|---|---|---|---|
| Na₂SO₃ (aq) | 1,575.66 | 2 NaOH(aq) | 1,000.00 |
| Ca(OH)₂ | 926.23 | CaSO₃(s) | 1,502.24 |

| | |
|---|---|
| Nonparticipating | Nonparticipating |
| Present Components | Present Components |

| | | | |
|---|---|---|---|
| H₂O (solvent) | 8,333.97 | H₂O (solvent) | 8,333.97 |

Step 7, Run 3, 1.0 Na₂SO₃, 1.0 Ca(OH)₂

| | |
|---|---|
| Reactants | Products |

| Chemical | Mass (g) | Chemical | Mass (g) |
|---|---|---|---|
| Na₂SO₃ (aq) | 1,575.66 | 2 NaOH(aq) | 1,000.00 |
| Ca(OH)₂ | 926.23 | CaSO₃(s) | 1,502.24 |

| | |
|---|---|
| Nonparticipating | Nonparticipating |
| Present Components | Present Components |

| | | | |
|---|---|---|---|
| H₂O (solvent) | 12,500.95 | H₂O (solvent) | 12,500.95 |

Step 7, Run 4, 0.5 Na₂SO₃, 0.5 Ca(OH)₂

| | |
|---|---|
| Reactants | Products |

| Chemical | Mass (g) | Chemical | Mass (g) |
|---|---|---|---|
| Na₂SO₃ (aq) | 1,575.66 | 2 NaOH(aq) | 1,000.00 |
| Ca(OH)₂ | 926.23 | CaSO₃(s) | 1,502.24 |

| | |
|---|---|
| Nonparticipating | Nonparticipating |
| Present Components | Present Components |

| | | | |
|---|---|---|---|
| H₂O (solvent) | 25,001.77 | H₂O (solvent) | 25,001.77 |

Step 7, Run 5, 0.588 Na₂SO₃, 1.0 Ca(OH)₂

| | |
|---|---|
| Reactants | Products |

| Chemical | Mass (g) | Chemical | Mass (g) |
|---|---|---|---|
| Na₂SO₃ (aq) | 1,575.66 | 2 NaOH(aq) | 1,000.00 |
| Ca(OH)₂ | 1,575.22 | CaSO₃(s) | 1,502.24 |
| | | Ca(OH)₂ | 648.99 |

| | |
|---|---|
| Nonparticipating | Nonparticipating |
| Present Components | Present Components |

| | | | |
|---|---|---|---|
| H₂O (solvent) | 21,260.14 | H₂O (solvent) | 21,260.14 |

### Example Production of Sodium Hydroxide In Some Embodiments

In some embodiments, at least a portion of sodium hydroxide produced may be separated from at least a portion of sodium sulfite. In some embodiments, at least a portion of sodium hydroxide produced may be separated from at least a portion of sodium sulfite, using, for example, nanofiltration. For example, in some embodiments, sodium hydroxide, which may be monovalent, may proportionally permeate a membrane, such as a nanofiltration membrane, while sodium sulfite, which may be divalent or multivalent, may proportionally be rejected by the membrane.

In some embodiments, sodium hydroxide may be produced using one or more or any combination of the following process steps:
1. A solid, or solution, or any combination thereof comprising sodium sulfite may be reacted with a solid, or solution, or any combination thereof comprising calcium hydroxide to form at least a portion of a sodium hydroxide and/or at least a portion of calcium sulfite. In some embodiments, at least a portion of the calcium sulfite crystals or solid may be separated or removed from the remaining solution using, for example, a solid-liquid separation. In some embodiments, the reaction may reach completion. In some embodiments, the reaction may reach partial completion. In some embodiments, the reaction may reach partial completion, for example, wherein the product solution may comprise sodium hydroxide and sodium sulfite.
2. The product solution comprising sodium hydroxide and sodium sulfite may be transferred to a separation process, which may separate at least a portion of sodium hydroxide from at least a portion of sodium sulfite. In some embodiments, the process may involve reacting sodium sulfite with calcium hydroxide, and/or separating at least a portion of the sodium hydroxide from the residual sodium sulfite, and/or transferring at least a portion of the at least partially separated residual sodium sulfite to the first reaction or the reaction of calcium hydroxide and sodium sulfite or mix at least a portion of the at least partially separated residual sodium sulfite with sodium sulfite feed to the reaction with calcium hydroxide or any combination thereof.
   a. For example, in some embodiments, the product solution comprising sodium hydroxide and sodium sulfite may be employed as or may comprise or may be transferred into a nanofiltration membrane or nanofiltration process as a feed solution, for example, wherein at least a portion of sodium hydroxide may be separated from at least a portion of sodium sulfite. For example, in some embodiments, a solution comprising sodium hydroxide and sodium sulfite may be transferred into a nanofiltration process as a feed solution, wherein at least a portion of the sodium hydroxide may permeate a nanofiltration membrane and/or wherein at least a portion of the sodium sulfite may be retained or rejected by the membrane; and/or forming a permeate comprising sodium hydroxide and a retentate comprising sodium sulfite. For example, in some embodiments, a solution comprising sodium hydroxide and sodium sulfite may be separated into a retentate comprising sodium sulfite and a diluate comprising sodium hydroxide. For example, in some embodiments, a solution comprising sodium hydroxide and sodium sulfite may be separated into a solution comprising a greater relative proportion of sodium hydroxide and a solution comprising a greater relative proportion of sodium sulfite. In some embodiments, the solution comprising a greater relative proportion of sodium hydroxide may comprise a product or output, or may be treated or concentrated, or may be reacted, or may be employed in another application, or may be employed in the same application, or any combination thereof. In some embodiments, the solution comprising a greater relative proportion of sodium sulfite may be transferred, or recycled, or recirculated, or circulated, or any combination thereof to step 7, or mixed with the sodium sulfite input to step 7, or employed in a reaction similar to step 7, or enter into one or more reactors of a cascade reactor in step 7, or any combination thereof
   b. For example, in some embodiments, at least a portion of sodium hydroxide may be separated from at least a portion of sodium sulfite using electrodialysis, or monovalent selective electrodialysis, or any combination thereof. For example, in some embodiments, at least a portion of sodium hydroxide may be separated from at least a portion of sodium sulfite using electrodialysis, or monovalent selective electrodialysis, or electrodeionization, or electrical method, or electrochemical method, or any combination thereof. For example, sodium ion and/or hydroxide ion may comprise monovalent, while sulfite ion may comprise divalent, which may enable the use of monovalent selective electrodialysis, or a monovalent selective anion exchange membrane, or any combination thereof, to enable the separation of at least a portion of sodium sulfite from at least a portion of sodium hydroxide. For example, in some embodiments, a solution comprising sodium hydroxide and sodium sulfite may be separated into a diluate comprising sodium sulfite and a concentrate comprising sodium hydroxide. For example, in some embodiments, a solution comprising sodium hydroxide and sodium sulfite may be separated into a solution comprising a greater relative proportion of sodium hydroxide and a solution comprising a greater relative proportion of sodium sulfite. In some embodiments, the solution comprising a greater relative proportion of sodium hydroxide may comprise a product or output, or may be treated or concentrated, or may be reacted, or may be employed in another application, or may be employed in the same application, or any combination thereof. In some embodiments, the solution comprising a greater relative proportion of sodium sulfite may be transferred, or recycled, or recirculated, or circulated, or any combination thereof to step 7, or mixed with the sodium sulfite input to step 7, or employed in a reaction similar to step 7, or enter into one or more reactors of a cascade reactor in step 7, or any combination thereof.

### Example Description of Chemistry Steps of Some Embodiments

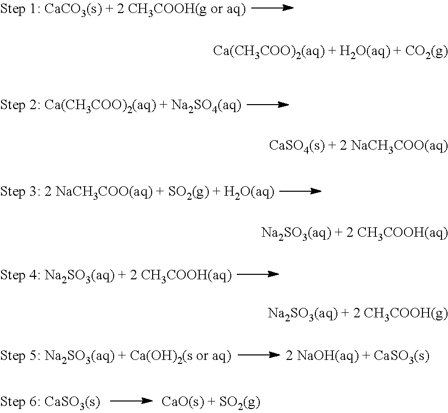

### Example Description of Some Steps in Some Embodiments

In some embodiments, Step 1 and Step 4 may be at least partially integrated. In some embodiments, at least a portion of acetic acid may be transferred from Step 4 to Step 1. For example, in some embodiments, vapor or vapor pressure or evaporate or any combination thereof may be exchanged between Step 4 and Step 1, wherein, for example, at least a portion of acetic acid may transfer from the solution comprising sodium sulfite to the solution comprising calcium carbonate, or calcium acetate, or any combination thereof. For example, in some embodiments, the vapor pressure of a solution in Step 1 or a solution in step 1 may comprise water vapor, while the vapor pressure of a solution in Step 4 may comprise water vapor and acetic acid. For example, in some embodiments, if at least a portion of the vapor pressure is exchanged between the solution(s) in Step 1 and the solution(s) in Step 4, at least a portion of acetic acid may be transfer from the solution(s) with higher acetic acid vapor pressure (Step 4 solution(s)) to the solution(s) with a lower acetic acid vapor pressure (Step 1 solutions(s)). In some embodiments, acetic acid vapor absorbed in a solution in Step 4 may react with calcium carbonate to form calcium acetate. In some embodiments, the reaction of calcium carbonate with acetic acid may inherently reduce the vapor pressure of acetic acid in Step 1 by fixing the acetic acid in the form of calcium acetate, which may have a negligible acetic acid vapor pressure, facilitating the acetic acid vapor pressure difference between at least a portion of the solution(s) in step 1 and at least a portion of the solution(s) in step 4 and/or facilitating the transfer of acetic acid from Step 4 to Step 1. For example, in some embodiments, at least a portion of acetic acid may be transferred from a solution comprising one or more solutions from step 4 to a solution comprising one or more solutions from step 1 using, including, but not limited to, one or more or any combination of the following: Carrier Gas Extraction (CGE), or vapor pressure exchange, or evaporate exchange, or carrier gas circulation, or stripping gas, or stripping gas circulation, or membrane contactor, or contactor, or vapor gas membrane, or wetted surface separator, or membrane distillation (MD), or membrane based process, or contactor, or exchanger, ion exchange resin, or ion exchange, or any combination thereof. In some embodiments, it may be desirable to employ a carrier gas which may be less likely to react with sulfite or sodium sulfite, such as a carrier gas reduce presence of or substantial absence of diatomic oxygen, such as a carrier gas comprising including, but not limited to, one or more or any combination of the following: carbon dioxide, or nitrogen, or steam, or refrigerant, or vapor, or argon, or condensable carrier gas, or any combination thereof. For example, in some embodiments, it may be desirable to employ a carrier gas comprising carbon dioxide, due to, for example, a reaction product in step 1 comprising carbon dioxide, and/or the use of carbon dioxide as a carrier gas may enable or facilitate the production of a captured or separated or high-quality carbon dioxide product. For example, some embodiments may comprise: (1) a carrier gas comprising carbon dioxide gas lean in acetic acid vapor may be contacted with a solution comprising sodium sulfite rich in acetic acid to form a carrier gas comprising carbon dioxide gas rich in acetic acid vapor and a solution comprising sodium sulfite lean in acetic acid; (2) the carrier gas comprising carbon dioxide gas rich in acetic acid vapor may be transferred to and/or contacted with a solution comprising calcium carbonate and water lean in calcium acetate to form a solution or slurry comprising water rich in calcium acetate and a carrier gas comprising carbon dioxide gas lean in acetic acid vapor and potentially additional generated carbon dioxide due to the reaction of calcium carbonate and acetic acid; (3) at least a portion the carrier gas comprising carbon dioxide lean in acetic acid may be transferred to ‘(1),’ or at least a portion the carrier gas comprising carbon dioxide lean in acetic acid may be removed or may be transferred from the process as a product, or at least a portion of the solution comprising calcium acetate may be transferred to Step 2, or at least a portion of the solution comprising sodium sulfite may be transferred to Step 5, or any combination thereof. In some embodiments, it may be desirable to transfer at least a portion of acetic acid from Step 4 to Step 1 while minimizing the proportional transfer of water or sulfur dioxide, for example, to reduce energy consumption, maximize process yield, or any combination thereof. In some embodiments, heat input may be employed, or temperature control may be desired, or heating may be employed, or any combination thereof. In some embodiments, the temperature of one or more or any combination of solutions may be controlled, or water vapor pressure may be controlled, or vapor pressure may be controlled, or vapor-liquid equilibrium may be controlled, or any combination thereof. In some embodiments, for example, it may be desirable for the temperature of a solution comprising sodium sulfite and acetic acid to be controlled to enable the water vapor pressure close to or about the same as the water vapor pressure in the solution comprising calcium carbonate, or calcium acetate, or water, or any combination thereof. For example, in some embodiments it may be desirable to minimize or prevent unnecessary or undesired water transfer or water evaporation, to, for example, optimize or energy consumption. In some embodiments, for example, it may be desirable for the water vapor pressures of two solutions undergoing vapor exchange to be about the same, while the vapor pressure of acetic acid vapor may be different, enabling or facilitating, for example, the transfer of acetic acid vapor from the solution of higher acetic acid vapor pressure to the solution of lower acetic acid vapor pressure and/or while, for example, minimizing potential transfer of water between solutions.
In some embodiments, a solution comprising water may be added during Step 1. In some embodiments, at least a portion of water may be added to the process. In some embodiments, at least a portion of water may be recirculated or recycled or recovered within the process. In some embodiments, a solution comprising water lean in recovered residual chemicals may be employed to rinse solids and/or otherwise recover or remove at least a portion of any residual, or embedded chemicals. In some embodiments, at least a portion of solids may be rinsed with a solution comprising water lean in recovered residual chemicals to form a solution comprising water rich in recovered residual chemicals, and/or said solution comprising water rich in recovered residual chemicals may be transferred to or added to step 1, or step 2, or other step, or any combination thereof. In some embodiments, residual or embedded reagents or chemicals may include, but is not limited to, one or more or any combination of the following: sodium acetate, or calcium acetate, or acetic acid, or acetate, or sodium sulfate, or sodium sulfite. In some embodiments, at least a portion of a solution comprising water, such as a solution comprising water lean in recovered residual chemicals, may be contacted with or otherwise employed to rinse, including, but not limited, one or more or any combination of the following: CaSO₄(s) from step 2, or any residual solids removed during step 1, or at least a portion of any solids generated during step 2, or at least a portion of any solids generated, or at least a portion of any solids generated between step 2 and step 3, or at least a portion of any solids generated during step 3, or any solids comprising calcium sulfite or other solids generated during the removal of any residual calcium or alkaline earth, or any solids comprising calcium sulfite or other solids generated during the removal of any residual calcium or alkaline earth by reacting a solution with sulfur dioxide or sodium sulfite or sodium carbonate or sodium bicarbonate, or other solids generated, or solids exiting the process, or any combination thereof.
In some embodiments, a solution comprising sodium sulfite may comprise at least a portion of residual sodium acetate and/or acetic acid. In some embodiments, it may be desirable to separate at least a portion of said residual sodium acetate and/or acetic acid from a solution comprising sodium sulfite. For example, in some embodiments, at least a portion of residual sodium acetate and/or acetic acid may be separated from a solution comprising sodium sulfite using, including, but not limited to, one or more or any combination of the following: the difference in hydration radius or ion size, or the difference in ion valence, or difference in vapor pressure, or difference in solubility, or difference in freezing point, or difference in phase transition point, or any combination thereof. For example, in some embodiments, at least a portion of residual sodium acetate and/or acetic acid may be separated from a solution comprising sodium sulfite using, including, but not limited to, one or more or any combination of the following: nanofiltration, or electrodialysis, or monovalent selective electrodialysis, or anion monovalent selective electrodialysis, or electrodeionization, or forward osmosis, or carrier gas extraction, or membrane distillation, or distillation, or separation methods described herein, or separation method in the art. In some embodiments, a solution comprising sodium sulfite comprising at least a portion of residual sodium acetate and/or acetic acid may comprise a feed solution into a nanofiltration process, forming a retentate comprising sodium sulfite and a permeate comprising sodium acetate and/or acetic acid. In some embodiments, for example, the permeate comprising sodium acetate and/or acetic acid may be transferred to step 3, and/or the retentate comprising sodium sulfite may be further treated and/or may be transferred to step 5. For example, in some embodiments, sodium sulfite may be proportionally retained or rejected by a nanofiltration membrane, while sodium acetate may proportionally permeate a nanofiltration membrane due to, for example, the difference in hydration radius, or due to the sulfite comprising a divalent ion and acetate comprising a monovalent ion, or any combination thereof. In some embodiments, a solution comprising sodium sulfite comprising at least a portion of residual sodium acetate and/or acetic acid may comprise a feed solution into an electrodialysis process. In some embodiments, a solution comprising sodium sulfite comprising at least a portion of residual sodium acetate and/or acetic acid may comprise a feed solution into a monovalent electrodialysis process, separating at least a portion of sodium sulfite from at least a portion of sodium acetate due to sulfite comprising a divalent ion and acetate comprising a monovalent ion. For example, in some embodiments, electrodialysis may form a separated diluate solution comprising sodium sulfite and a separated concentrate solution comprising sodium acetate. In some embodiments, a said separated solution comprising sodium sulfite may be transferred to step 5 and/or said separated solution comprising sodium acetate may be transferred to step 3.
Sodium may be provided as an example alkali. Other alkalis or alkali-like cations may be employed instead of, or in addition to, for example, sodium. For example, other alkalis or alkali-like cations may include, but may be not limited to, one or more or any combination of the following: lithium (Li), or sodium (Na), or potassium (K), or rubidium (Rb), or cesium (Cs), or ammonia, or ammonium, or amine, or ammonia-derivative, or nitrogenous cation.
Calcium may be provided as an example alkaline-earth. Other alkaline-earths or alkaline-earth-like cations may be employed instead of, or in addition to, for example, calcium. For example, other alkaline-earths or alkaline-earth-like cations may include, but may be not limited to, one or more or any combination of the following: beryllium (Be), magnesium (Mg), calcium (Ca), strontium (Sr), barium (Ba), and radium (Ra), or amine, or ammonia-derivative, or nitrogenous cation.
Acetic acid or acetate may be provided as an example carboxylic acid, or acid, or acid stronger than carbonic acid and weaker than sulfurous acid, or any combination thereof. Other carboxylic acids, or acids, or acids stronger than carbonic acid and weaker than sulfurous acid, or any combination thereof may be employed instead of, or in addition to, for example, acetic acid. For example, other carboxylic acids, or acids, or acids stronger than carbonic acid and weaker than sulfurous acid, or any combination thereof may include, but may be not limited to, one or more or any combination of the following: formic acid, or acetic acid, or propanoic acid, or volatile acid, or non-volatile acid, or citric acid, or malic acid, or oxalic acid, or Lactic acid, or glycolic acid, or glyoxylic acid, or C1 acids, or C2 acids, or C3 acids, or C4 acids, or C5 acids, or C6 acids, or C7 acids, or C8 acids, or C9 acids, or C10 acids, or acids known in the art.
Carbonate or bicarbonate or carbonic acid may be provided as an example of a weak acid, or an example of an acid weaker than some carboxylic acids, or any combination thereof. Other weak acids, or acids weaker than most carboxylic acids, or any combination thereof may be employed instead of, or in addition to, carbonate or bicarbonate or carbonic acid. Other weak acids, or acids weaker than some carboxylic acids, or anions weaker than some carboxylic acid cations, or any combination thereof may include, but may be not limited to, one or more or any combination of the following: silicates, or silicon derivatives, or iron derivatives, or transition metal derivatives, or metal derivative anions, or ferrites, or ferrates, or aluminates, or silicates, or oxide anions, or sulfides, or hydrogen sulfide, or nitrites.
In some embodiments, calcium oxide may be mixed with or reacted with water, or an aqueous solution, or any combination thereof. In some embodiments, calcium oxide may be mixed with or reacted with water, or an aqueous solution, or any combination thereof to form calcium hydroxide, or an intermediate comprising calcium hydroxide, or calcium sulfite, or any combination thereof. In some embodiments, at least a portion of calcium oxide may comprise calcium oxide produced in step 6.
In some embodiments, a solution comprising sodium acetate may comprise residual calcium. In some embodiments, for example, the solution comprising sodium acetate from step 2 may comprise residual calcium, such as residual calcium sulfate or residual calcium acetate. In some embodiments, at least a portion of residual calcium may be reacted, or precipitate, or removed, or otherwise separated, or otherwise removed. In some embodiments, at least a portion of residual calcium may be reacted, or precipitate, or removed, or otherwise separated, or otherwise removed by contacting or reacting the solution with at least a portion of sulfur dioxide, which may result in the formation of a precipitate comprising calcium sulfite, and/or at least a portion of said precipitate may be separated by a solid-liquid separation, such as filtration. For example, in some embodiments, it may be desirable to add sulfur dioxide in stoichiometric proportion to the amount or concentration of calcium in a solution comprising sodium acetate to enable or facilitate the precipitation of calcium. In some embodiments, at least a portion of calcium may be removed by reaction with sodium carbonate, or sodium bicarbonate, or sodium sulfide, or sodium oxalate, or any combination thereof. In some embodiments, at least a portion of calcium removal may be desirable to prevent scaling or fouling of surfaces, or membranes, or pipes, or heat exchangers, or any combination thereof.
In some embodiments, at least a portion of water may be removed or separated from a solution comprising sodium acetate. For example, in some embodiments, it may be desirable to concentrate or remove at least a portion of water from the solution comprising sodium acetate produced from step 2. In some embodiments, concentrating a solution comprising sodium acetate may enable a higher concentration and/or vapor pressure of acetic acid in, for example, step 4 and/or step 1. In some embodiments, water recovered from the concentrating may be employed, for example, where water may be added or used within the process, or for another application, or any combination thereof. In some embodiments, concentrating may comprise, including, but not limited to, one or more or any combination of the following: RO, or HPRO, or OARO, or distillation, or MED, or MVC, or MSF, or freeze separation, or melt crystallization, forward osmosis, membrane distillation, or carrier gas extraction, or a separation method described herein, or a separation method described in the art.
In some embodiments, a solution comprising sodium hydroxide may comprise sodium sulfite. In some embodiments, at least a portion of sodium hydroxide may be separated from at least a portion of sodium sulfite. In some embodiments, at least a portion of sulfite or sulfur may be separated or removed. For example, in some embodiments, at least a portion of sodium hydroxide may be separated from at least a portion of sodium sulfite using, for example, including, but not limited to, one or more or any combination of the following: nanofiltration, or electrodialysis, or monovalent selective electrodialysis, or solubility differences, crystallization, or electrodeionization, or ion exchange resin, or a membrane based process, or multi-effect distillation (MED), or mechanical vapor compression distillation (MVC), or mechanical vapor recompression distillation (MVR), or freeze concentrating, or melt crystallization, or carrier gas extraction, or membrane based process, or other separation methods described herein, or other separation methods known in the art.
In some embodiments, a solution comprising sodium hydroxide may comprise sodium acetate. In some embodiments, at least a portion of sodium hydroxide may be separated from at least a portion of sodium acetate. In some embodiments, at least a portion of acetate or acetate derivative may be separated or removed. In some embodiments, at least a portion of sodium hydroxide may be separated from at least a portion of sodium acetate. For example, in some embodiments, at least a portion of sodium hydroxide may be separated from at least a portion of sodium acetate using, for example, including, but not limited to, one or more or any combination of the following: nanofiltration, or electrodialysis, or monovalent selective electrodialysis, or solubility differences, crystallization, or electrodeionization, or ion exchange resin, or a membrane based process, or multi-effect distillation (MED), or mechanical vapor compression distillation (MVC), or mechanical vapor recompression distillation (MVR), or freeze concentrating, or melt crystallization, or carrier gas extraction, or membrane based process, or other separation methods described herein, or other separation methods known in the art.
In some embodiments, at least a portion of a solution comprising sodium hydroxide generated or produced may be further treated or concentrated. For example, in some embodiments, a solution comprising sodium hydroxide may undergo concentrating or at least a portion of water may be removed from a solution comprising sodium hydroxide to, for example, including, but not limited to, one or more or any combination of the following: increase the concentration of sodium hydroxide, or produce sodium hydroxide crystals or solid, or to recover water, or any combination thereof. In some embodiments, for example, a solution comprising sodium hydroxide may be concentrated using, for example, including, but not limited to, one or more or any combination of the following: multi-effect distillation (MED), or mechanical vapor compression distillation (MVC), or mechanical vapor recompression distillation (MVR), or electrodialysis, or electrodeionization, or freeze concentrating, or melt crystallization, or carrier gas extraction, or membrane based process, or other separation methods described herein, or other separation methods known in the art. In some embodiments, water may be separated and/or recovered from a solution comprising sodium hydroxide, and/or said water may be, for example, transferred to a step or sub-step in the process, or used in an application, or any combination thereof. In some embodiments, at least a portion of sodium hydroxide may be reacted with carbon dioxide to form sodium carbonate, or sodium bicarbonate, or sodium sesquicarbonate, or any combination thereof.
In some embodiments, a solution comprising sodium sulfite may comprise acetic acid, or sodium acetate, or any combination thereof. In some embodiments, at least a portion of acetic acid or sodium acetate may be separated from sodium sulfite using a semipermeable membrane, such as nanofiltration. In some embodiments, a solution comprising sodium sulfite comprising acetic acid or sodium acetate may comprise a feed solution into a nanofiltration process, forming a retentate comprising sodium sulfite and a permeate comprising acetic acid, or sodium acetate, or any combination thereof. In some embodiments, at least a portion acetic acid may be further separated from the retentate comprising sodium acetate using, for example, vapor pressure exchange, or carrier gas extraction, or membrane contactor, or membrane distillation, or distillation, or any combination thereof. In some embodiments, the permeate comprising acetic acid or sodium acetate may be transferred to a reaction with calcium carbonate or step 1, or transferred to step 3, or any combination thereof.
In some embodiments, solid-liquid separations may include, but are not limited to, one or more or any combination of the following:
   Separation of any residual or remaining or purge solids from step 1. In some embodiments, residual or remaining or purge solids may comprise residual calcium carbonate, or impurities, or potential impurities present in the calcium carbonate feed, or calcium sulfite, or calcium sulfate, or calcium sulfite from reaction with some sulfur dioxide, or any combination thereof.
   Separation of a solid comprising calcium sulfate from a solution comprising sodium acetate, such as in step 2.
   Separation of a solid comprising calcium sulfite or calcium carbonate, which may comprise recovered or separated or removed calcium from the reaction of the solution comprising sodium acetate from step 2 with sulfur dioxide or sodium sulfite or sodium carbonate or sodium bicarbonate, which may be separated from a solution comprising sodium acetate.
   Separation of other solids.
   Separation of a solid comprising calcium sulfite from a solution comprising sodium hydroxide, such as in step 6.
   Rinsing of residual or remaining or purge solids from step 1 and separation of at least a portion of the rinsed solids from rinsing water or rinsing medium.
   Rinsing of solid comprising calcium sulfate from step 2 and separation of at least a portion of the rinsed solid comprising calcium sulfate from rinsing water or rinsing medium.
   Rinsing of the solids comprising calcium sulfite or calcium carbonate comprising recovered calcium from the reaction of the solution comprising sodium acetate with sulfur dioxide or sodium sulfite or sodium carbonate or sodium bicarbonate and separation of at least a portion of the rinsed solid from rinsing water or rinsing medium.

### Production of Sodium Hydroxide and Recovery of Sodium Sulfite in Some Embodiments

In some embodiments, sodium hydroxide may be produced using one or more or any combination of the following process steps:
3. A solid, or solution, or any combination thereof comprising sodium sulfite may be reacted with a solid, or solution, or any combination thereof comprising calcium hydroxide to form at least a portion of a sodium hydroxide and/or at least a portion of calcium sulfite. In some embodiments, at least a portion of the calcium sulfite crystals or solid may be separated or removed from the remaining solution using, for example, a solid-liquid separation. In some embodiments, the reaction may reach completion. In some embodiments, the reaction may reach partial completion. In some embodiments, the reaction may reach partial completion, for example, wherein the product solution may comprise sodium hydroxide and sodium sulfite.
4. The product solution comprising sodium hydroxide and sodium sulfite may be transferred to a separation process, which may separate at least a portion of sodium hydroxide from at least a portion of sodium sulfite. In some embodiments, the process may involve reacting sodium sulfite with calcium hydroxide, and/or separating at least a portion of the sodium hydroxide from the residual sodium sulfite, and/or transferring at least a portion of the at least partially separated residual sodium sulfite to the first reaction or the reaction of calcium hydroxide and sodium sulfite or mix at least a portion of the at least partially separated residual sodium sulfite with sodium sulfite feed to the reaction with calcium hydroxide or any combination thereof.
   a. For example, in some embodiments, the product solution comprising sodium hydroxide and sodium sulfite may be employed as or may comprise or may be transferred into a nanofiltration membrane or nanofiltration process as a feed solution, for example, wherein at least a portion of sodium hydroxide may be separated from at least a portion of sodium sulfite. For example, in some embodiments, a solution comprising sodium hydroxide and sodium sulfite may be transferred into a nanofiltration process as a feed solution, wherein at least a portion of the sodium hydroxide may permeate a nanofiltration membrane and/or wherein at least a portion of the sodium sulfite may be retained or rejected by the membrane; and/or forming a permeate comprising sodium hydroxide and a retentate comprising sodium sulfite. For example, in some embodiments, a solution comprising sodium hydroxide and sodium sulfite may be separated into a retentate comprising sodium sulfite and a diluate comprising sodium hydroxide. For example, in some embodiments, a solution comprising sodium hydroxide and sodium sulfite may be separated into a solution comprising a greater relative proportion of sodium hydroxide and a solution comprising a greater relative proportion of sodium sulfite. In some embodiments, the solution comprising a greater relative proportion of sodium hydroxide may comprise a product or output, or may be treated or concentrated, or may be reacted, or may be employed in another application, or may be employed in the same application, or any combination thereof. In some embodiments, the solution comprising a greater relative proportion of sodium sulfite may be transferred, or recycled, or recirculated, or circulated, or any combination thereof to step 5, or mixed with the sodium sulfite input to step 5, or employed in a reaction similar to step 5, or enter into one or more reactors of a cascade reactor in step 5, or any combination thereof
   b. For example, in some embodiments, at least a portion of sodium hydroxide may be separated from at least a portion of sodium sulfite using electrodialysis, or monovalent selective electrodialysis, or any combination thereof. For example, in some embodiments, at least a portion of sodium hydroxide may be separated from at least a portion of sodium sulfite using electrodialysis, or monovalent selective electrodialysis, or electrodeionization, or electrical method, or electrochemical method, or any combination thereof. For example, sodium ion and/or hydroxide ion may comprise monovalent, while sulfite ion may comprise divalent, which may enable the use of monovalent selective electrodialysis, or a monovalent selective anion exchange membrane, or any combination thereof, to enable the separation of at least a portion of sodium sulfite from at least a portion of sodium hydroxide. For example, in some embodiments, a solution comprising sodium hydroxide and sodium sulfite may be separated into a diluate comprising sodium sulfite and a concentrate comprising sodium hydroxide. For example, in some embodiments, a solution comprising sodium hydroxide and sodium sulfite may be separated into a solution comprising a greater relative proportion of sodium hydroxide and a solution comprising a greater relative proportion of sodium sulfite. In some embodiments, the solution comprising a greater relative proportion of sodium hydroxide may comprise a product or output, or may be treated or concentrated, or may be reacted, or may be employed in another application, or may be employed in the same application, or any combination thereof. In some embodiments, the solution comprising a greater relative proportion of sodium sulfite may be transferred, or recycled, or recirculated, or circulated, or any combination thereof to step 5, or mixed with the sodium sulfite input to step 5, or employed in a reaction similar to step 5, or enter into one or more reactors of a cascade reactor in step 5, or any combination thereof.

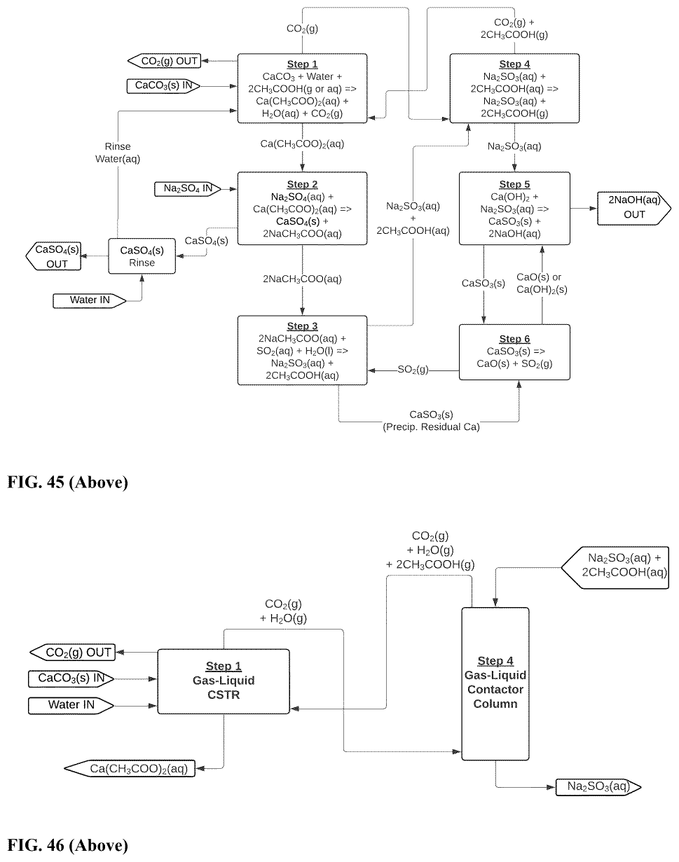

### Description of Some Example Embodiments in FIG. 45 and FIG. 46

FIG. 45: Example embodiment process with process design improvement enabling the transfer of acetic acid from an example step 1 to an example step 4.

FIG. 46: An example configuration of an example embodiment transferring an acid, such as acetic acid, from an example Step 4 to an example Step 1.

### Example Description

Some embodiments may employ the separation of acetic acid from the aqueous sodium sulfite+acetic acid solution and the transfer of the acetic acid from Step 4 to Step 1.

Example principles/basis of some embodiments:
The solution in Step 4 (sodium sulfite+ acetic acid solution) may have a vapor phase comprising water vapor+ acetic acid vapor (and potentially some SO₂ vapor).
The solution in Step 1 (calcium carbonate+water+calcium acetate slurry) may have a vapor phase comprising water vapor. Notably, the calcium carbonate+water+ calcium acetate solution may have minimal or very low acetic acid vapor phase because acetic acid reacts with the calcium carbonate, forming calcium acetate (calcium acetate at STP may not substantially have an acetic acid vapor phase).
Exchanging the vapor phases of the solution in Step 4 with the solution in Step 1 may naturally result in the transfer acetic acid from the solution in Step 4 to the solution in Step 1 due to, for example, the reactivity of the Step 1 solution with acetic acid in (CaCO₃+2CH₃COOH→Ca(CH₃COO)₂+CO₂) and the resulting substantial absence of acetic acid vapor pressure in the Step 1 solution.
High purity captured CO₂ may be produced from the reaction in Step 1, for example, by selecting CO₂ as the carrier gas. Other gases may be employed if desired. It may be desirable to minimize the diatomic oxygen concentration in the carrier gas, for example, to prevent reaction of oxygen with sulfite, or bisulfite, or any combination thereof or prevent potentially undesired formation of sulfate.
The water vapor pressure of the Step 1 solution may be adjusted to be about the same as the water vapor pressure of the Step 4 solution (for example, which may be achieved by controlling the temperature), water vapor transfer between the Step 1 solution and the Step 4 solution may be minimized.
The driving force is the Step 1 Reaction (CaCO₃+2CH₃COOH→Ca(CH₃COO)₂+CO2), potentially less so heat or pressure. As a result, power consumption and cost may be very low because electricity to circulate the carrier gas (e.g., blower fans) may be the required energy cost.
Sodium sulfite may remain in solution at an aqueous phase (i.e., liquid) and pumpable. This may greatly reduce the number of intermediate process steps, reduce potential exposure to air/oxygen, reduce CAPEX, reduce process size, reduce OPEX, improve modularity, and improve automatability.
The water entering the process in Step 1 (and/or Step 2) may be the same water as the water in the sodium hydroxide product (Step 7).
Water entering the process in Step 1 may be employed to rinse CaSO₄(s) product to recover at least a portion of any residual sodium acetate from the CaSO₄(s). After rinsing the CaSO₄(s), the water may be transferred to Step 1. This may enable the recovery of at least a portion of any residual reagents from the CaSO₄(s), while for example, minimally affecting process energy consumption.

### Example Step-by-Step Description of Some Embodiments

1. In some embodiments, a carrier gas comprising CO₂(g)+H₂O(g) may be contacted with an solution comprising sodium sulfite+water+acetic acid in a gas-liquid contactor, forming a solution comprising sodium sulfite+water and a carrier gas comprising CO₂(g)+H₂O(g)+CH₃COOH(g).
2. In some embodiments, a carrier gas comprising CO₂(g)+H₂O(g)+CH₃COOH(g) may be contacted with a slurry or solution comprising calcium carbonate+water+calcium acetate, forming a solution comprising calcium acetate and a carrier gas comprising CO₂(g)+H₂O(g).
3. In some embodiments, a portion of a carrier gas comprising CO₂(g)+H₂O(g) may be transferred from the process as the captured CO₂ product due to the reaction of calcium carbonate and acetic acid producing a CO₂ product.

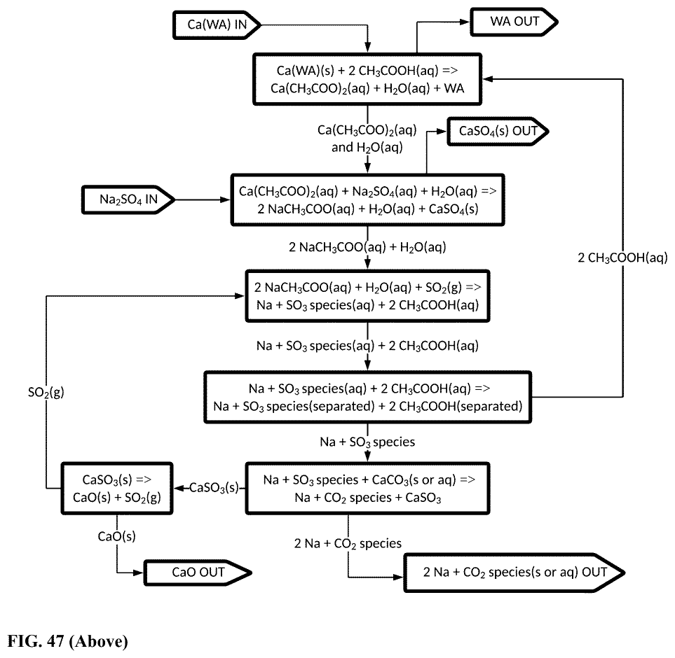

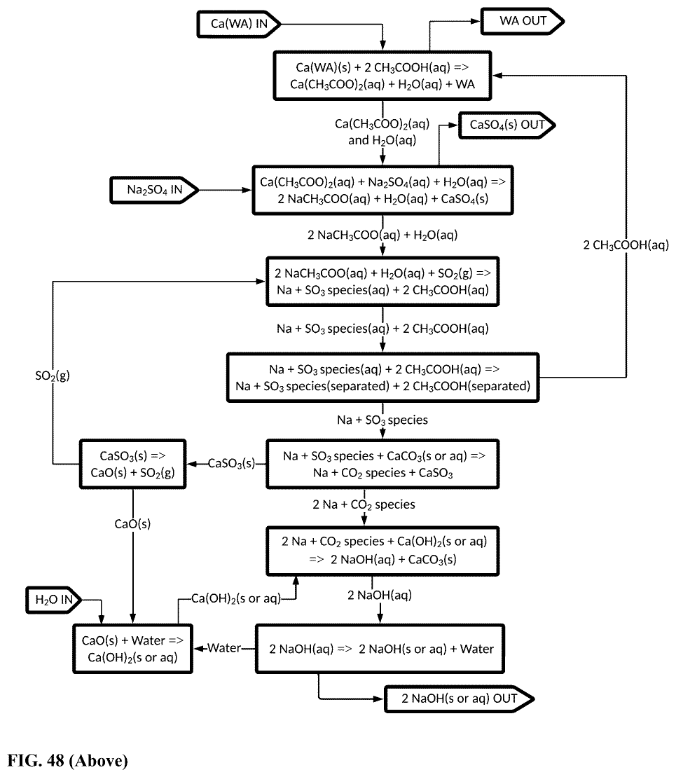

### Example Description of Some Embodiments which May be in, for Example, FIG. 47 and FIG. 48

Some embodiments may transform at least a portion of a salt comprising sodium sulfate and/or a salt comprising calcium carbonate to form at least a portion of a salt comprising sodium carbonate or sodium bicarbonate, or sodium sesquicarbonate, or any combination thereof, or calcium oxide, or calcium sulfate, or carbon dioxide, or captured carbon dioxide, or any combination thereof.

In some embodiments, a solution comprising an alkali sulfite or alkali+ sulfur dioxide species may be formed and/or said at least a portion of an alkaline-earth carbonate may be reacted with at least a portion of said solution comprising an alkali sulfite or alkali+ sulfur dioxide species to form, for example, at least a portion of an alkaline earth sulfite or a salt comprising an alkaline earth+ sulfur dioxide species and/or at least a portion of a solution or salt comprising alkali carbonate, or alkali bicarbonate, or alkali sesquicarbonate, or any combination thereof.

In some embodiments, a material comprising calcium carbonate may be reacted with a solution comprising at least a portion of sodium+sulfur dioxide species to form at least a portion of a material comprising calcium sulfite and/or a salt comprising sodium carbonate, or sodium bicarbonate, or sodium sesquicarbonate. In some embodiments, at least a portion of a solid comprising calcium sulfite may be separated from a solution comprising sodium+ carbon dioxide species, using, for example, a solid-liquid separation method. In some embodiments, a solution comprising sodium+sulfur dioxide species may further comprise at least a portion of a carboxylic acid, or a residual carboxylic acid, or a carboxylic acid species, such as acetic acid, or other carboxylic acids described herein, or other carboxylic acids in the art.

### Example Embodiment

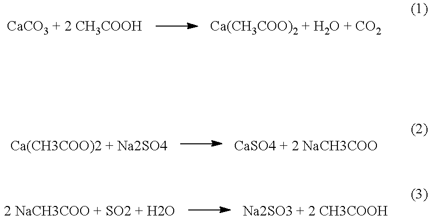

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method, or other separation process known in the art, or other separation method or any combination thereof.

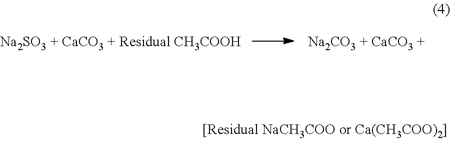

In some embodiments at least a portion of carbon dioxide may form from reaction of any excess acid, such as acetic acid or sulfur dioxide species, with at least a portion of calcium carbonate to form carbon dioxide.

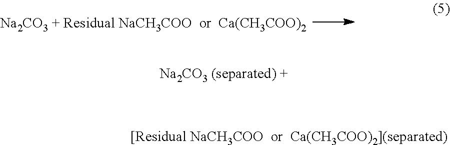

May be separated using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method or diffusion, or crystallization, or cooling crystallization, or distillation crystallization, or freeze separation, or other separation process known in the art, or other separation method or any combination thereof.

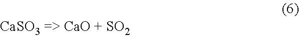

### Example Embodiment

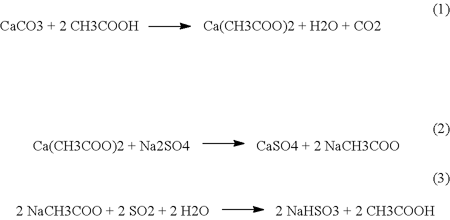

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation process described herein, or other separation process known in the art, or other separation method.

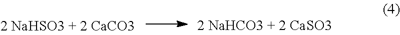

In some embodiments, it may be desirable to conduct this reaction or similar reactions in the presence of CO2 or dissolved CO2. For example, in some embodiments, the presence of CO2, or other pH reducer, may facilitate the dissolution of calcium carbonate and/or the reaction of calcium carbonate.

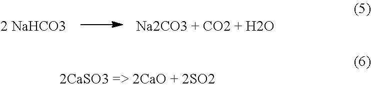

### Example Embodiment

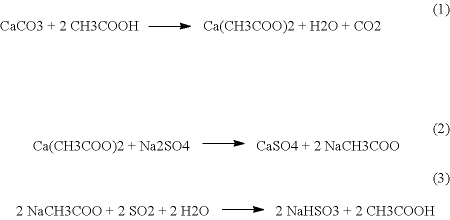

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method, or other separation process known in the art, or other separation method or any combination thereof.

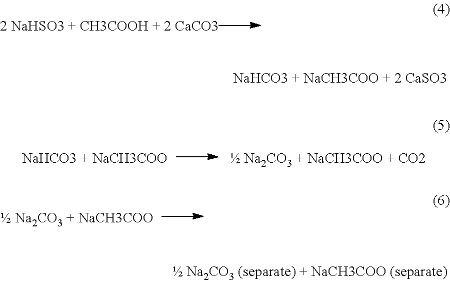

May be separated
May be separate using, for example, including, but not limited to, one or more or any combination of the following: nanofiltration, or cooling crystallization, or distillation crystallization, or other separation process described herein, or other separation process known in the art, or other separation method or any combination thereof.

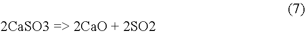

Some embodiments may transform at least a portion of a component comprising alkali sulfate and/or a component comprising an alkaline earth− weak acid anion to form at least a portion of a component comprising an alkali carbonate, or alkali bicarbonate, or alkali sesquicarbonate, or a derivative thereof, or any combination thereof, or alkaline earth oxide, or alkaline earth sulfate, or weak acid anion derivative, or water, or carbon dioxide, or captured carbon dioxide, or any combination thereof.

In some embodiments, a component comprising an alkali sulfite or alkali+ sulfur dioxide species may be formed and/or said at least a portion of a component comprising an alkaline-earth carbonate may be reacted with at least a portion of a component comprising an alkali sulfite or alkali+sulfur dioxide species to form, for example, at least a portion of a component comprising an alkaline earth sulfite or a component comprising an alkaline earth+ sulfur dioxide species and/or at least a portion of a component comprising alkali carbonate, or alkali bicarbonate, or alkali sesquicarbonate, or any combination thereof.

In some embodiments, a component comprising calcium carbonate may be reacted with a component comprising at least a portion of sodium+sulfur dioxide species to form at least a portion of a component comprising calcium sulfite and/or a component comprising sodium carbonate, or sodium bicarbonate, or sodium sesquicarbonate, or any combination thereof. In some embodiments, at least a portion of a component comprising calcium sulfite may be separated from a component comprising sodium+ carbon dioxide species, using, for example, a solid-liquid separation method. In some embodiments, a component comprising sodium+sulfur dioxide species may further comprise at least a portion of a component comprising carboxylic acid, or a residual carboxylic acid, or a carboxylic acid species, such as acetic acid, or other carboxylic acids described herein, or other carboxylic acids in the art, or a derivative thereof, or any combination thereof.

In some embodiments, a component comprising calcium oxide, or calcium hydroxide, or any combination thereof may comprise a product.

In some embodiments, a component comprising calcium oxide, or calcium hydroxide, or any combination thereof may comprise a derivative of calcium oxide, or calcium hydroxide, or any combination thereof. For example, in some embodiments, calcium oxide, or calcium hydroxide, or any combination thereof may comprise including, but not limited to, one or more or any combination of the following: a cementitious material, or a clinker, or a Portland cement, or a cement, or a cement clinker, or a calcium silicate, or an alkaline-earth silicate, or an alkaline-earth aluminate, or an aluminate, or a ferrite, or a silicate, or a cement, or a binder, or a binding material, or any combination thereof. For example, in some embodiments, a component comprising calcium sulfite may be reacted or decomposed in a manner, or in the presence of suitable reagents, or any combination thereof to form a cement, or cement clinker, or a silicate, or a derivative of calcium oxide, or any derivative thereof, or any combination thereof. For example, in some embodiments, a component comprising calcium sulfite may be reacted with shale, or clay, or mud, or aluminous material, or silicaceous material, or silicon-bearing material, or silicon dioxide, or sand, or rock, or any combination thereof.

In some embodiments, a component comprising calcium oxide, or calcium hydroxide, or any combination thereof produced may be transferred to the reaction of the component comprising alkaline-earth weak acid anion with the component comprising a carboxylic acid to form, wherein, for example, the component comprising calcium oxide, or calcium hydroxide, or any combination thereof may comprise the component comprising an alkaline-earth weak acid anion.

In some embodiments, for example, a component comprising calcium oxide, or calcium hydroxide, or any combination thereof may be reacted with at least a portion of a component comprising carbon dioxide to form, for example, at least a portion of component comprising calcium carbonate, or calcium bicarbonate, or any combination thereof. For example, in some embodiments, the reaction with carbon dioxide may comprise ‘CO₂ capture’ and/or the component comprising carbon dioxide may comprise CO₂ in a dilute gas source, which may include, but is not limited to, one or more or any combination of the following: air, or flue gas, or natural gas, or biogas, or emissions gas, or tail gas, or flare gas, or residual gas, or combustion gas, or synthesis gas, or gasification gas, or gas comprising CO2, or a gas comprising CO2 known described herein, or a gas comprising CO2 known in the art, or a solution comprising CO2 or a CO2 derivative species, or a solution comprising CO2 or a CO2 derivative species known described herein, or a solution comprising CO2 or a CO2 derivative species, or a component comprising a carbonate, or a component comprising carbonic acid, or a component comprising a carbamate, or a component comprising a bicarbonate, or a CO2 derivative species known in the art, or any combination thereof.

In some embodiments, a component comprising a calcium carbonate, which produced from a reaction of a component comprising calcium oxide, or calcium hydroxide, or any combination thereof with a component comprising carbon dioxide, may be employed in the first reaction step, or may be employed in the fifth reaction step.

In some embodiments, a component comprising sodium+sulfur dioxide species may be at least a partially separated from a component comprising carboxylic acid, such as acetic acid or acetate, using, for example, including, but not limited to, one or more or any combination of the following: reverse osmosis, or nanofiltration, or electrodialysis, or monovalent selective electrodialysis, or forward osmosis, or osmotically assisted reverse osmosis, or high pressure reverse osmosis, or a membrane based process, or a derivative thereof, or any combination thereof. In some embodiments, a component comprising carboxylic acid, such as acetic acid or acetate, may be at least a partially separated from a component comprising sodium+sulfur dioxide species using, for example, including, but not limited to, one or more or any combination of the following: reverse osmosis, or nanofiltration, or electrodialysis, or monovalent selective electrodialysis, or forward osmosis, or osmotically assisted reverse osmosis, or high pressure reverse osmosis, or a membrane based process, or a derivative thereof, or any combination thereof. In some embodiments, a component comprising sodium+sulfur dioxide species may comprise, including, but not limited to, one or more or any combination of the following: sodium, or alkali, or sulfur dioxide, or sulfurous acid, or sulfite, or bisulfite, or metabisulfite, or aqueous sulfur dioxide, or a derivative thereof, or any combination thereof.

### Example Embodiment

(1) React at least a portion of a component comprising an alkaline earth− weak acid with at least a portion of an acid to form at least a portion of a solution comprising alkaline earth+ acid anion and at least a portion of a component comprising weak acid derivative. Example chemistry may comprise including, but not limited to, one or more or any combination of the following:

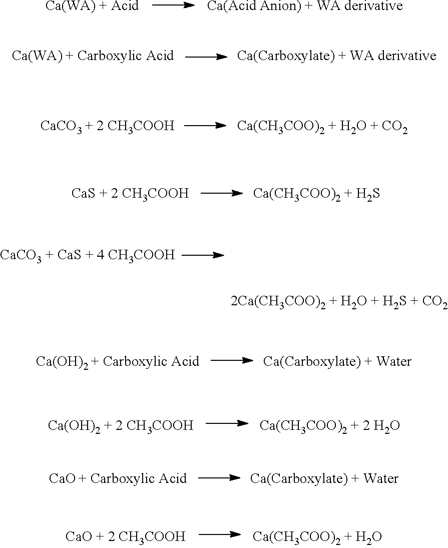

Note: A component comprising CO₂ may comprise high pressure or high purity, or high quality, or high partial pressure, or useful, or high concentration, or ‘captured’, or any combination thereof carbon dioxide.
(2) React at least a portion of a solution comprising alkaline− earth acid anion with at least a portion of a component comprising an alkali sulfate to form at least a portion of a component comprising an alkaline− earth sulfate and at least a portion of a component comprising an alkali− acid anion. Example chemistry may comprise including, but not limited to, one or more or any combination of the following:

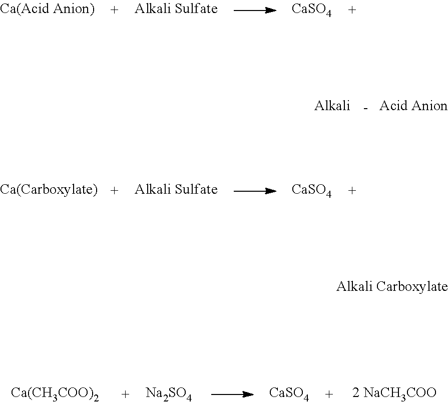

(3) React at least a portion of a component comprising alkali− acid anion with at least a portion of a component comprising sulfur dioxide or sulfurous acid or a derivative thereof to form at least a portion of a component comprising alkali+ sulfur dioxide species and/or at least a portion of a component comprising acid or acid anion derivative. Example chemistry may comprise including, but not limited to, one or more or any combination of the following:
Alkali− Acid Anion+ Sulfur Dioxide→Alkali+ Sulfur Dioxide species+ Anion Acid species
Alkali Carboxylate+ Sulfur Dioxide→Alkali+ Sulfur Dioxide species+ Carboxylic Acid species

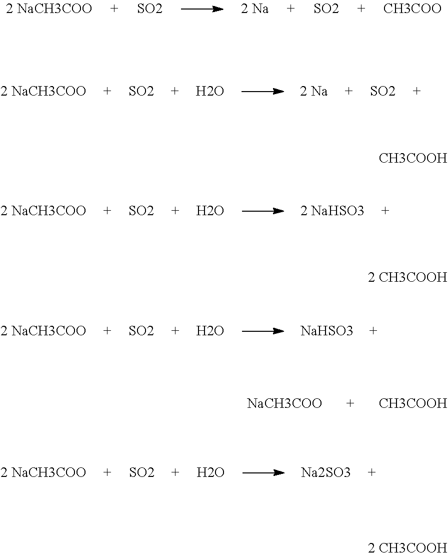

(4) Separate at least a portion of a component comprising alkali+ sulfur dioxide species from at least a portion of a component comprising acid or acid anion derivative. Example chemistry may comprise including, but not limited to, one or more or any combination of the following:

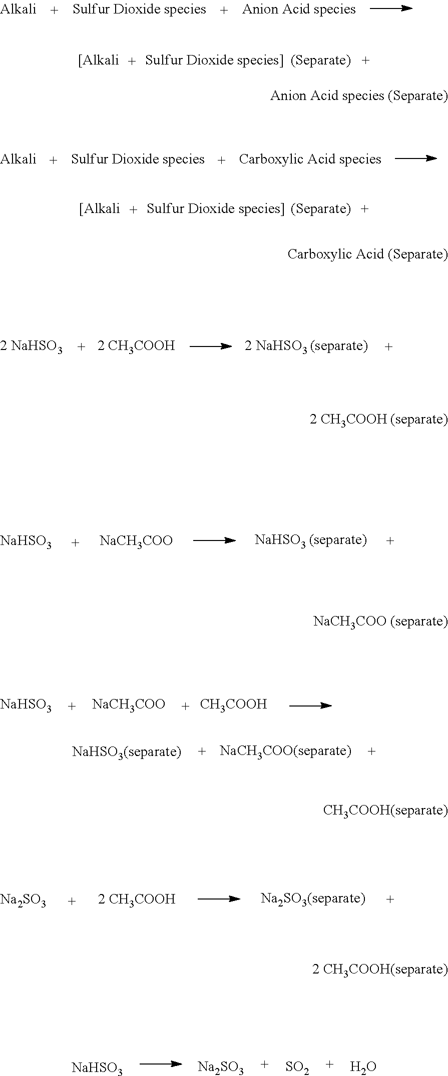

(5) React at least a portion of a component comprising alkali+ sulfur dioxide species with at least a portion of a component comprising alkaline-earth carbonate, or alkaline-earth hydroxide, or alkaline earth bicarbonate, or any combination thereof to form at least a portion of a component comprising an alkali carbonate, or alkali bicarbonate, or alkali hydroxide, or any combination thereof and/or at least a portion of a component comprising an alkaline-earth sulfite. Example chemistry may comprise including, but not limited to, one or more or any combination of the following:

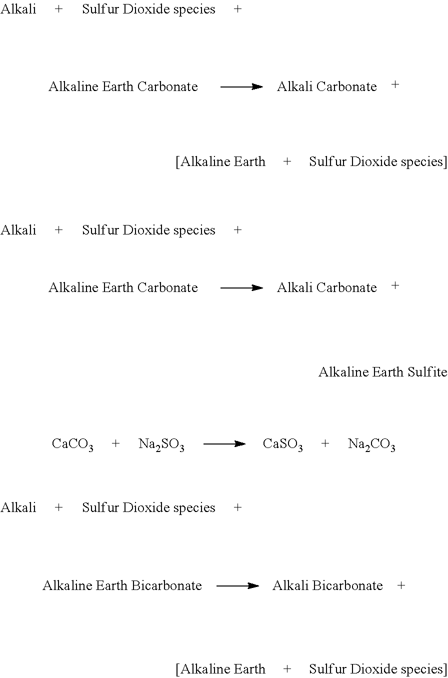

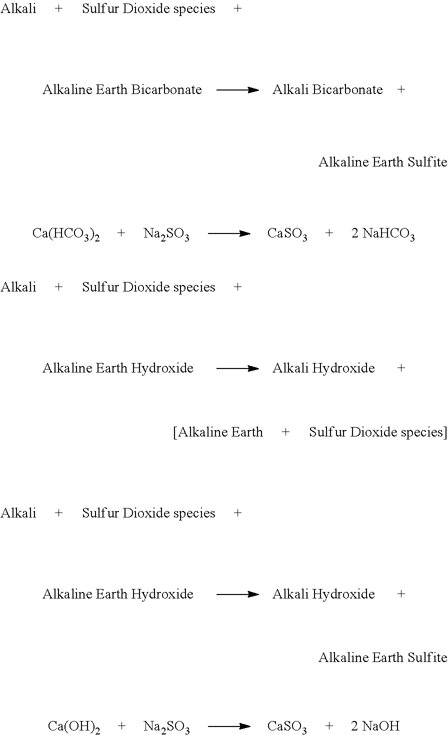

(6) Decompose at least a portion of a component comprising alkaline-earth sulfite to form at least a portion of a component comprising an alkaline earth oxide, or alkaline earth hydroxide, or any combination thereof and/or a component comprising sulfur dioxide, or a derivative thereof, or any combination thereof. Example chemistry may comprise including, but not limited to, one or more or any combination of the following:

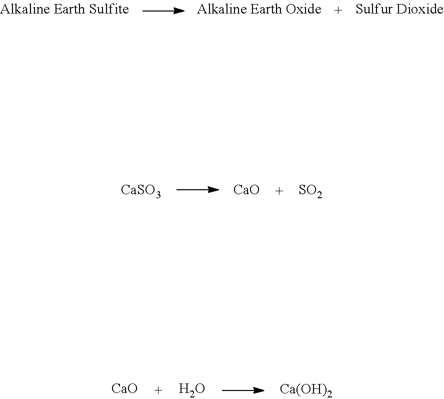

### Example Embodiment

(1) React at least a portion of a component comprising an alkaline earth− weak acid with at least a portion of an acid to form at least a portion of a solution comprising alkaline earth− acid anion and at least a portion of a component comprising weak acid derivative. Example chemistry may comprise including, but not limited to, one or more or any combination of the following:

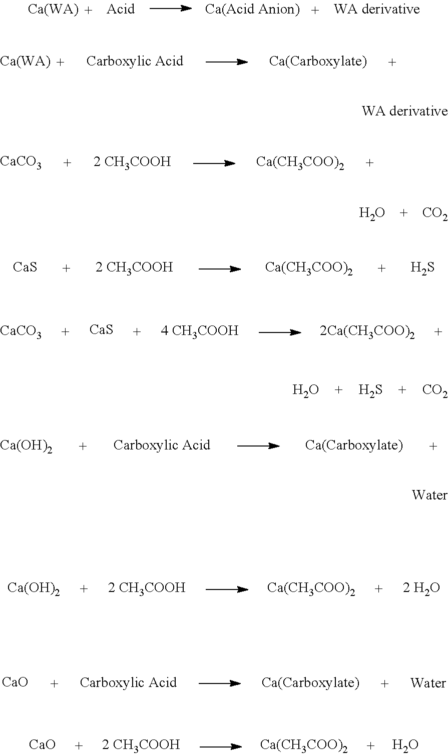

Note: A component comprising CO₂ may comprise high pressure or high purity, or high quality, or high partial pressure, or useful, or high concentration, or ‘captured’, or any combination thereof carbon dioxide.
(2) React at least a portion of a solution comprising alkaline− earth acid anion with at least a portion of a component comprising an alkali sulfate to form at least a portion of a component comprising an alkaline− earth sulfate and at least a portion of a component comprising an alkali− acid anion. Example chemistry may comprise including, but not limited to, one or more or any combination of the following:

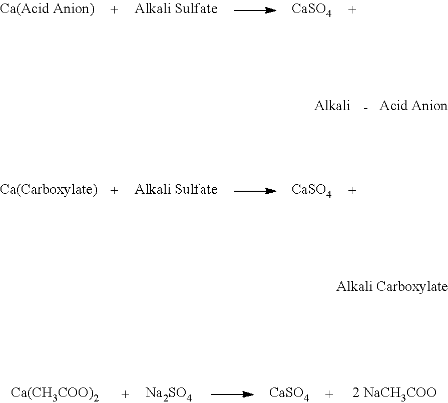

(3) React at least a portion of a component comprising alkali− acid anion with at least a portion of a component comprising sulfur dioxide or sulfurous acid or a derivative thereof to form at least a portion of a component comprising alkali+ sulfur dioxide species and/or at least a portion of a component comprising acid or acid anion derivative. Example chemistry may comprise including, but not limited to, one or more or any combination of the following:

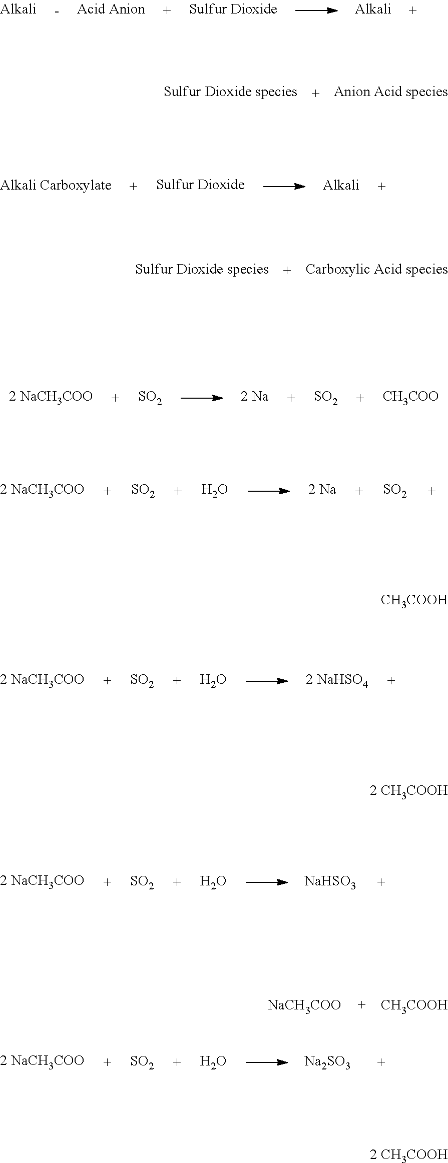

(4) Separate at least a portion of a component comprising alkali+ sulfur dioxide species from at least a portion of a component comprising acid or acid anion derivative. Example chemistry may comprise including, but not limited to, one or more or any combination of the following:

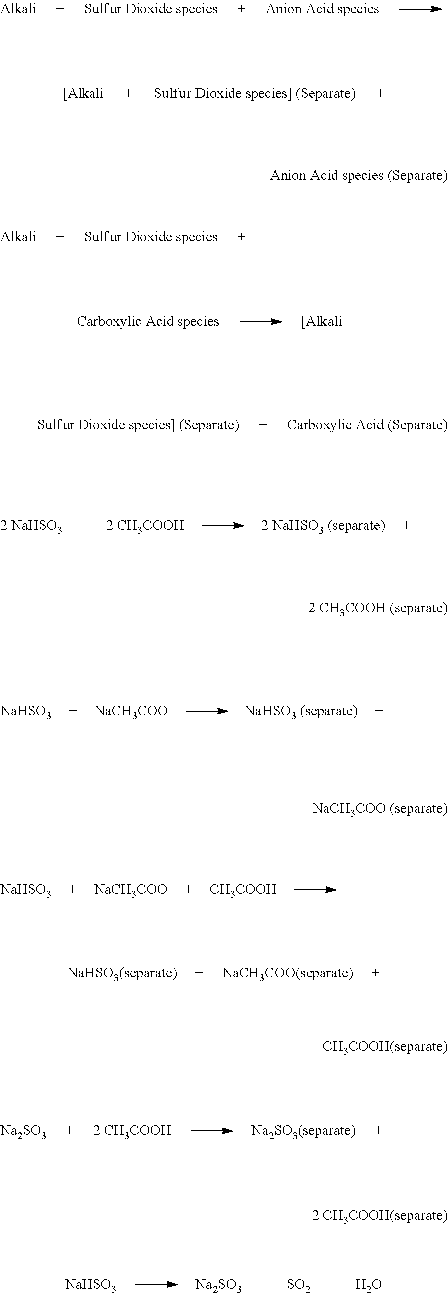

(5) React at least a portion of a component comprising alkali+ sulfur dioxide species with at least a portion of a component comprising alkaline-earth carbonate, or alkaline-earth hydroxide, or alkaline earth bicarbonate, or any combination thereof to form at least a portion of a component comprising an alkali carbonate, or alkali bicarbonate, or alkali hydroxide, or any combination thereof and/or at least a portion of a component comprising an alkaline-earth sulfite. Example chemistry may comprise including, but not limited to, one or more or any combination of the following:

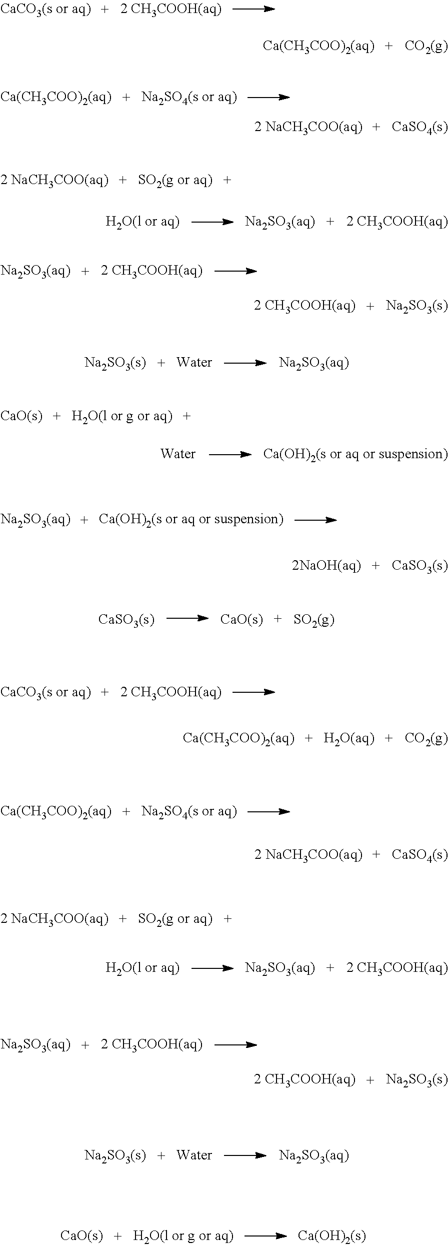

(6) Decompose at least a portion of a component comprising alkaline-earth sulfite to form at least a portion of a component comprising an alkaline earth oxide, or alkaline earth hydroxide, or any combination thereof and/or a component comprising sulfur dioxide, or a derivative thereof, or any combination thereof. Example chemistry may comprise including, but not limited to, one or more or any combination of the following:

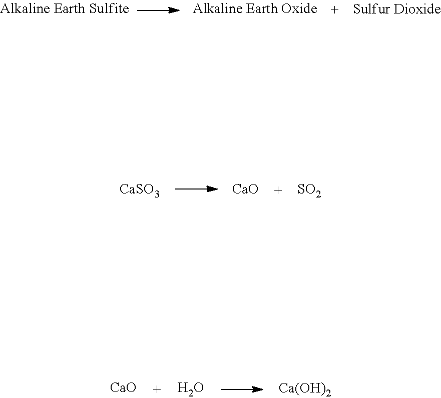

(7) React at least a portion of a component comprising alkaline-earth oxide, or alkaline earth hydroxide, or any combination thereof with at least a portion of a component comprising carbon dioxide or carbon dioxide species to form at least a portion of a component comprising an alkaline earth carbonate, or alkaline earth bicarbonate, or any combination thereof. Example chemistry may comprise including, but not limited to, one or more or any combination of the following:

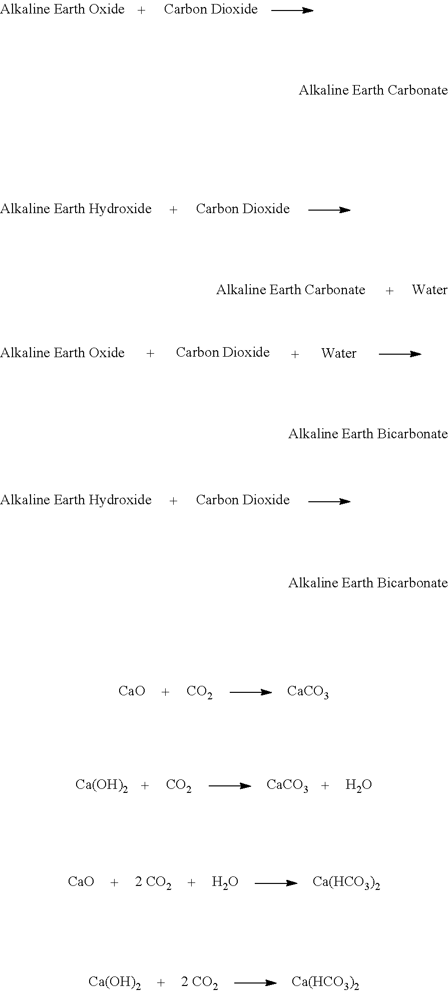

### Example Embodiment

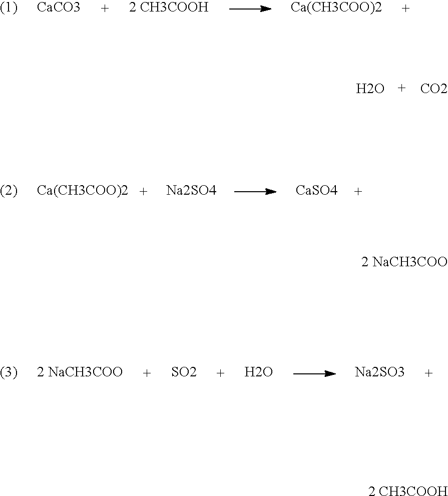

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method, or other separation process known in the art, or other separation method or any combination thereof.

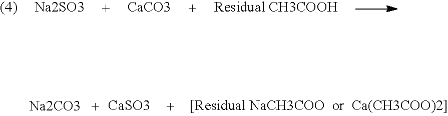

In some embodiments at least a portion of carbon dioxide may form from reaction of any excess acid, such as acetic acid or sulfur dioxide species, with at least a portion of calcium carbonate to form carbon dioxide.

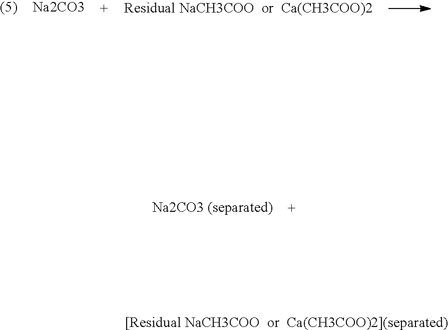

May be separated using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method or diffusion, or crystallization, or cooling crystallization, or distillation crystallization, or freeze separation, or other separation process known in the art, or other separation method or any combination thereof.

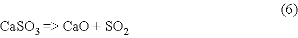

### Example Embodiment

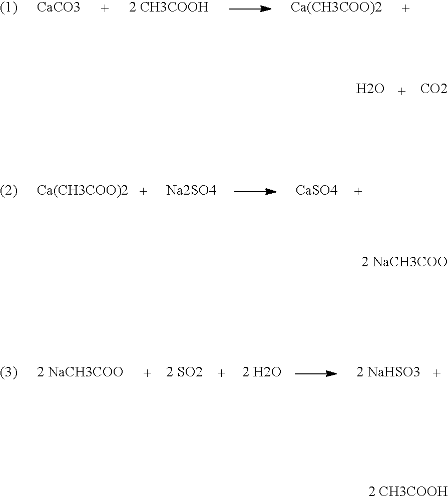

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation process described herein, or other separation process known in the art, or other separation method.

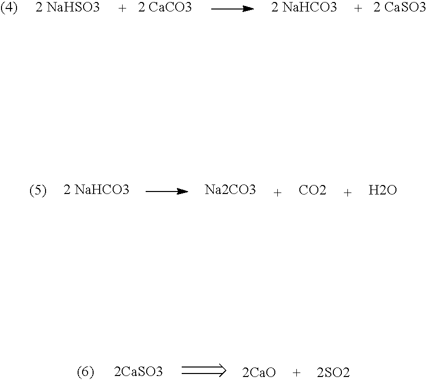

### Example Embodiment

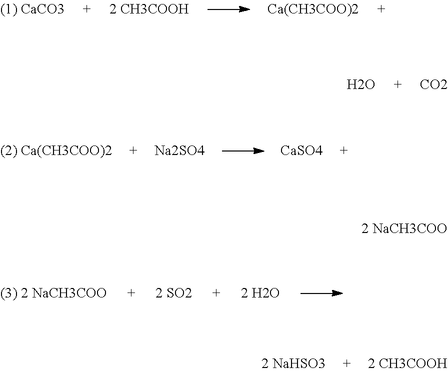

May be Conducted in multiple steps
CH3COOH may be at least partially separated from NaHSO3 or Na2SO3.
For example, in some embodiments, at least a portion of acetic acid may be separating from sodium+sulfur dioxide species using, including, but not limited to, one or more or any combination of the following: membrane based process, or reverse osmosis, or nanofiltration, or diffusion, or distillation, or multi-effect distillation, or multistage flash distillation, or mechanical vapor compression distillation, or forward osmosis, or electrodialysis, or ion exchange, or other separation method, or other separation process known in the art, or other separation method or any combination thereof.

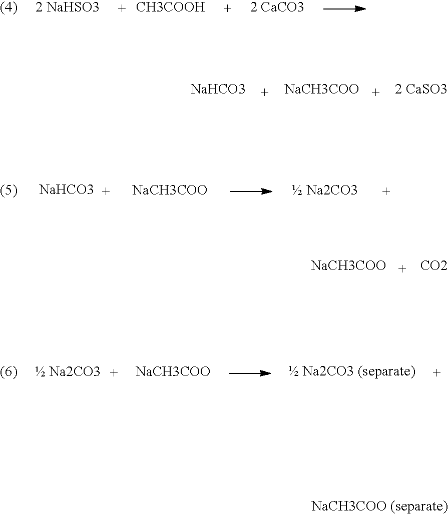

May be separated
May be separate using, for example, including, but not limited to, one or more or any combination of the following: nanofiltration, or cooling crystallization, or distillation crystallization, or other separation process described herein, or other separation process known in the art, or other separation method or any combination thereof.

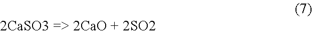

### Description of Some Embodiments

In some embodiments, sodium carbonate, or sodium bicarbonate, or sodium sesquicarbonate, or any combination thereof may be decomposed to form at least a portion of carbon dioxide and/or at least a portion of sodium carbonate.
In some embodiments, at least a portion of a salt comprising sodium carbonate, or sodium bicarbonate, or sodium sesquicarbonate, or any combination thereof may be reacted with at least a portion of a salt comprising calcium oxide or calcium hydroxide to form at least a portion of a salt comprising sodium hydroxide and/or at least a portion of a salt comprising calcium carbonate. In some embodiments, at least a portion of any formed salt comprising calcium carbonate may be utilized within the process or recirculated. In some embodiments, at least a portion of any formed salt comprising calcium carbonate may be decomposed or reacted in a manner to produce, for example, a salt comprising calcium oxide, or calcium hydroxide, or carbon dioxide, or captured carbon dioxide, or calcium carbonate, or calcium sulfite, or calcium carboxylate, or calcium sulfate, or any combination thereof. In some embodiments, at least a portion of any formed salt comprising sodium hydroxide may comprise a valuable product, or may comprise an intermediate, or may be purified, or may be further purified, or may be concentrated, or may be further concentrated, or may be crystallized, or any combination thereof.

### Example Embodiments

(1) A process comprising:
   reacting a component comprising an alkaline-earth cation− weak acid anion with a component comprising an acid to form a component comprising an alkaline-earth cation− acid anion and a component comprising a weak acid derivative;
   reacting at least a portion of the formed alkaline-earth cation− acid anion with a component comprising an alkali sulfate to form a component comprising an alkali cation− acid anion and a component comprising an alkaline-earth sulfate;
   dissolving at least a portion of a component comprising carbon dioxide in a solution comprising at least a portion of the component comprising an alkali cation− acid anion;
   separating at least a portion of the acid from at least a portion of the alkali in the presence of carbon dioxide and the presence of a membrane to form at least a portion component comprising an alkali cation− carbon dioxide species anion.
(2) The process of example embodiment 1 wherein the alkali in the alkali sulfate comprises lithium (Li), or sodium (Na), or potassium (K), or rubidium (Rb), or cesium (Cs), or ammonia (NH₃), ammonium (NH₄), or an amine.
(3) The process of example embodiment 1 wherein the acid comprises a carboxylic acid.
(4) The process of example embodiment 3 wherein the acid comprises acetic acid, or formic acid, or propanoic acid, or any combination thereof.
(5) The process of example embodiment 1 wherein the alkaline earth comprises calcium, or magnesium, or barium, or strontium, or beryllium.
(6) The process of example embodiment 1 wherein the weak acid anion comprises a carbonate and the weak acid derivative comprises carbon dioxide.
(7) The process of example embodiment 1 wherein the carbon dioxide comprises a pH reducer.
(8) The process of example embodiment 1 wherein a chemical comprising sulfur dioxide is added to the solution prior to or during the separation using the membrane to facilitate pH reduction or facilitate the separation.
(9) The process of example embodiment 1 wherein a chemical comprising a pH reducer is added or present to reduce pH and facilitate the separation.
(10) The process of example embodiment 1 wherein the separation of a portion of the acid is facilitated by reducing the pH of the solution to a pH less than 5.5
(11) The process of example embodiment 1 wherein the separation of a portion of the acid is facilitated by an applied pressure greater than 10 Bar.
(12) The process of example embodiment 1 wherein the membrane comprises a semi-permeable membrane selected from a reverse osmosis membrane, or nanofiltration membrane, or osmotically assisted reverse osmosis membrane, or a forward osmosis membrane, or a high pressure RO membrane, or a high pressure NF membrane, or a chemically resistant membrane, or a ion specific membrane, or an ion selective membrane, or a chemically selective membrane.
(13) The process of example embodiment 1 wherein the membrane comprises an electrochemical membrane-based process.
(14) The process of example embodiment 1 wherein the membrane comprises a charge selective membrane based process.
(15) The process of example embodiment 1 wherein the membrane comprises a size selective membrane based process.
(16) The process of example embodiment 1 wherein the acid has a molecular weight less than 200 g/mol
(17) The process of example embodiment 9 wherein the pH reducer is selected from: hydrogen sulfide, or sulfur dioxide, or acid gas.
(18) The process of example embodiment 1 wherein the membrane comprises a semi-permeable membrane and a portion of carbon dioxide permeates the membrane with the component comprising the acid.
(19) The process of example embodiment 1 wherein the membrane comprises a semi-permeable membrane; and wherein the pH of the solution is sufficiently low such that a portion of acid species comprises non-ionic acid species and a portion of the non-ionic acid species permeates the membrane to form a permeate solution comprising a portion of separated acid.
(20) The process of example embodiment 1 wherein a portion of the component comprising alkali− carbon dioxide species is separated to form a product comprising an alkali− carbon dioxide species.
(21) The process of example embodiment 1 wherein a portion of the separated acid is used in the reaction with a component comprising an alkaline-earth cation− weak acid anion.
(22) The process of example embodiment 1 wherein a portion of the component comprising an alkali− carbon dioxide species is reacted with calcium oxide or calcium hydroxide to form a chemical comprising an alkali hydroxide and a component comprising calcium carbonate.
(23) The process of example embodiment 22 wherein the component comprising calcium carbonate is decomposed to form calcium oxide in a manner to form at least a portion of captured carbon dioxide or high purity carbon dioxide.
(24) The process of example embodiment 1 wherein the alkali− carbon dioxide species comprises sodium carbonate, or sodium bicarbonate, or sodium sesquicarbonate, or any combination thereof.
(25) The process of example embodiment 1 wherein the alkali− carbon dioxide species comprises sodium bicarbonate, or sodium sesquicarbonate, or any combination thereof and is treated or decomposed to form a component comprising sodium carbonate.
(26) A process comprising:
   reacting a chemical comprising calcium carbonate with a component comprising a carboxylic acid to form a solution comprising a calcium carboxylate and a chemical comprising carbon dioxide;
   reacting at least a portion of the formed calcium carboxylate with a component comprising an alkali sulfate to form a component comprising an alkali carboxylate and a component comprising calcium sulfate;
   dissolving at least a portion of a component comprising carbon dioxide in a solution comprising at least a portion of the component comprising an alkali carboxylate;
   separating at least a portion of the carboxylic acid from at least a portion of the alkali in the presence of carbon dioxide and the presence of a membrane to form at least a portion component comprising an alkali cation− carbon dioxide species anion.
(27) A process comprising:
   reacting a chemical comprising calcium carbonate with a component comprising a carboxylic acid to form a solution comprising a calcium carboxylate and a chemical comprising carbon dioxide;
   reacting at least a portion of the formed calcium carboxylate with a component comprising an alkali sulfate to form a component comprising an alkali carboxylate and a component comprising calcium sulfate;
   reacting at least a portion of the component comprising an alkali carboxylate with carbon dioxide in the presence of a membrane to form a portion of a component comprising an alkali carbon dioxide species and a component comprising a carboxylic acid.
(28) The process of example embodiment 27 wherein the alkali− carbon dioxide species comprising sodium carbonate, or sodium bicarbonate, or sodium sesquicarbonate, or any combination thereof.

1. A process comprising:
reacting a component comprising an alkaline-earth cation− weak acid anion with a component comprising an acid to form a component comprising an alkaline-earth cation− acid anion and a component comprising a weak acid derivative;
reacting at least a portion of the formed alkaline-earth cation− acid anion with a component comprising an alkali sulfate to form a component comprising an alkali cation− acid anion and a component comprising an alkaline-earth sulfate;
reacting at least a portion of the component comprising the alkali cation− acid anion under conditions to form a component comprising an alkali cation− carbon dioxide species anion.

2. The process of claim 1 wherein the conditions comprise dissolving carbon dioxide in a solution comprising at least a portion of the component comprising the alkali cation− acid anion and then separating at least a portion of an acid formed from at least a portion of an alkali formed wherein the separating is conducted in the presence of carbon dioxide and a membrane to form the alkali cation− carbon dioxide species anion and wherein the alkali in the alkali sulfate comprises lithium (Li), or sodium (Na), or potassium (K), or rubidium (Rb), or cesium (Cs), or ammonia (NH₃), ammonium (NH₄), or an amine, or any combination thereof.

3. The process of claim 1 wherein the acid comprises a carboxylic acid.

4. The process of claim 3 wherein the carboxylic acid comprises acetic acid, or formic acid, or propanoic acid, or any combination thereof.

5. The process of claim 1 wherein the alkaline earth cation comprises calcium, or magnesium, or barium, or strontium, or beryllium, or any combination thereof.

6. The process of claim 1 wherein the weak acid anion comprises a carbonate and the weak acid derivative comprises carbon dioxide.

7. The process of claim 2 wherein the carbon dioxide is mixed with a pH reducer.

8. The process of claim 2 which further comprises adding sulfur dioxide to the solution prior to or during the separating to (1) facilitate pH reduction or (2) facilitate the separation or (3) facilitate pH reduction and separation.

9. The process of claim 2 which further comprises including an amount of a pH reducer to reduce pH sufficiently to facilitate the separation.

10. The process of claim 2 wherein the separating is facilitated by reducing the pH of the solution to a pH of less than about 5.5

11. The process of claim 2 wherein the separating is facilitated by applying a pressure greater than about 10 Bar.

12. The process of claim 2 wherein the membrane comprises a semi-permeable membrane selected from a reverse osmosis membrane, or nanofiltration membrane, or osmotically assisted reverse osmosis membrane, or a forward osmosis membrane, or a high pressure RO membrane, or a high pressure NF membrane, or a chemically resistant membrane, or a ion specific membrane, or an ion selective membrane, or a chemically selective membrane.

13. The process of claim 2 wherein the separating comprises an electrochemical separation.

14. The process of claim 2 wherein the membrane comprises a charge selective membrane.

15. The process of claim 2 wherein the membrane comprises a size selective membrane.

16. The process of claim 1 wherein the acid has a formula molecular weight of less than about 200 g/mol

17. The process of claim 9 wherein the pH reducer is selected from: hydrogen sulfide, or sulfur dioxide, or acid gas, or any combination thereof.

18. The process of claim 2 wherein the membrane comprises a semi-permeable membrane and wherein a portion of carbon dioxide and the formed acid permeates the membrane.

19. The process of claim 2 wherein the membrane comprises a semi-permeable membrane; and wherein the pH of the solution is sufficiently low such that a portion of the formed acid comprises a non-ionic acid species and a portion of the non-ionic acid species permeates the membrane to form a permeate solution comprising at least a portion of separated acid.

20. The process of claim 2 which further comprises employing at least a portion of the separated acid in the reacting of the alkaline-earth cation− weak acid anion.

21. The process of claim 1 which further comprises reacting at least a portion of the component comprising an alkali cation-carbon dioxide species anion with calcium oxide or calcium hydroxide to form an alkali hydroxide and calcium carbonate.

22. The process of claim 21 which further comprises decomposing at least a portion of calcium carbonate to form calcium oxide and carbon dioxide.

23. The process of claim 1 wherein the alkali cation− carbon dioxide species anion comprises sodium carbonate, or sodium bicarbonate, or sodium sesquicarbonate, or any combination thereof.

24. The process of claim 1 wherein the alkali cation− carbon dioxide species anion comprises sodium bicarbonate, or sodium sesquicarbonate, or any combination thereof and wherein the process further comprising forming a component comprising sodium carbonate from the alkali cation− carbon dioxide species anion.

25. The process of claim 2 wherein the separating comprises depressurization.

26. The process of claim 25 wherein the depressurization produces power and wherein the process further comprises recovering at least a portion of the produced power using a power recovery turbine, or pressure exchanger.

27. A process comprising:
reacting a chemical comprising calcium carbonate with a component comprising a carboxylic acid to form a solution comprising calcium carboxylate and carbon dioxide;
reacting at least a portion of the formed calcium carboxylate with a component comprising an alkali sulfate to form a component comprising an alkali carboxylate and a component comprising calcium sulfate;
dissolving carbon dioxide in a solution comprising at least a portion of the component comprising an alkali carboxylate; and
separating at least a portion of a formed carboxylic acid from at least a portion of a formed alkali in the presence of carbon dioxide and the presence of a membrane to form at least a portion of a component comprising an alkali cation− carbon dioxide species anion.

28. A process comprising:
reacting a chemical comprising calcium carbonate with a component comprising a carboxylic acid to form a solution comprising a calcium carboxylate and carbon dioxide;
reacting at least a portion of the formed calcium carboxylate with a component comprising an alkali sulfate to form a component comprising an alkali carboxylate and a component comprising calcium sulfate;
reacting at least a portion of the component comprising an alkali carboxylate with carbon dioxide in the presence of a membrane to form a component comprising an alkali carbon dioxide species and a component comprising a carboxylic acid.

29. The process of claim 28 wherein the alkali− carbon dioxide species comprises sodium carbonate, or sodium bicarbonate, or sodium sesquicarbonate, or any combination thereof.
